(19) United States
(12) Patent Application Publication
(10) Pub. No.: US 2026/0228169 A1
(43) Pub. Date: Aug. 6, 2026

(54) Translating Between NVLink and CXL.cache for High-Performance and Low-Latency Access from GPUs to CPU Memory

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/632,305

(22) Filed: Mar. 29, 2026

Related U.S. Application Data
(63) Continuation-in-part of application No. 19/371,779, filed on Oct. 28, 2025, now Pat. No. 12,657,153.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/695,957, filed on Sep. 18, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.

(51) Int. Cl. G06F 13/42

(52) U.S. Cl. CPC G06F 13/4221; G06F 2213/0026

(57) ABSTRACT

Translating between NVLink-based protocols and CXL.cache Device-to-Host (D2H) and Host-to-Device (H2D) messages enables memory access across different protocol domains. In some implementations, a resource provisioning unit (RPU) receives an NVLink-based request from a first entity via an NVLink interface, translates the NVLink-based request to a CXL.cache D2H request comprising an opcode and a physical address, sends the CXL.cache D2H request to a second entity, receives a CXL.cache H2D response comprising data, and sends an NVLink-based response comprising the data to the first entity. The translation may utilize CXL.cache as an intermediate protocol for accessing a processor's coherent interconnect. In other implementations, a computer receives a CXL.cache H2D request from a first entity, translates it to an NVLink-based request sent to a second entity, receives an NVLink-based response, translates the response to CXL.cache D2H messages, and sends the D2H messages to the first entity.

### CROSS-REFERENCE TO RELATED APPLICATIONS

This Application claims priority to: U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; U.S. Provisional Patent Application No. 63/811,859, filed May 25, 2025; and U.S. Provisional Patent Application No. 63/784,089, filed Apr. 5, 2025. This Application is also a Continuation-In-Part of U.S. patent application Ser. No. 19/371,779, filed Oct. 28, 2025, which claims priority to: U.S. Provisional Patent Application No. 63/752,940, filed Feb. 3, 2025; U.S. Provisional Patent Application No. 63/743,658, filed Jan. 10, 2025; and U.S. Provisional Patent Application No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Patent Application No. 63/719,640, filed 12 Nov. 2024; U.S. Provisional Patent Application No. 63/701,554, filed 30 Sep. 2024; U.S. Provisional Patent Application No. 63/695,957, filed 18 Sep. 2024; U.S. Provisional Patent Application No. 63/678,045, filed 31 Jul. 2024; U.S. Provisional Patent Application No. 63/652,165, filed 27 May 2024; and U.S. Provisional Patent Application No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Patent Application No. 63/609,833, filed 13 Dec. 2023.

### BACKGROUND

NVLink is a high-bandwidth, low-latency interconnect technology designed for communication between GPUs, accelerators, and switches. NVLink enables entities such as GPUs and accelerators to exchange data at rates that may exceed those provided by other interconnect technologies, thereby supporting the parallelization demands of artificial intelligence (AI) training, inference, and high-performance computing (HPC) workloads. NVLink-based protocols define transaction types for memory read and write operations, along with fields such as physical addresses, transaction Tags, source and destination identifiers, and data payloads.

Compute Express Link (CXL) is an interconnect technology that enables cache-coherent memory access and high-bandwidth communication between hosts and devices in computing systems. CXL builds upon the physical and electrical interface defined by PCI Express (PCIe) while adding protocols that support memory semantics and cache coherency operations. The CXL specification defines sub-protocols, including CXL.io for input/output operations, CXL.mem for memory access between hosts and memory devices, and CXL.cache for cache coherency between hosts and devices. CXL.cache enables devices to issue requests for cacheline data and to respond to snoop requests from hosts, utilizing distinct message channels for Device-to-Host (D2H) and Host-to-Device (H2D) communication directions. CXL devices include Type-1 devices supporting CXL.io and CXL.cache, Type-2 devices supporting CXL.io, CXL.cache, and CXL.mem, and Type-3 devices supporting CXL.io and CXL.mem for memory expansion. Processors may include CXL root ports that provide root complex functionality for CXL devices coupled to the processor.

Modern processors incorporate coherent interconnects, such as mesh or crossbar topologies, that couple processing cores, cache controllers, memory controllers, and interface agents. These coherent interconnects maintain data consistency among caches and memory controllers utilizing coherency protocols. Processors may include interface components, such as CXL root ports, that couple external devices to the coherent interconnect.

### SUMMARY

AI workloads such as large language models, generative AI applications, and distributed training demand access to large memory capacities distributed across accelerators. The aggregate memory requirements of these workloads may exceed the local memory capacity of individual accelerators, motivating architectures in which accelerators access memory resources coupled to processors or other entities across high-speed interconnects. Some of the following implementations describe methods and systems for translating between NVLink-based protocols and CXL.cache protocols, enabling entities communicating via NVLink to access memory resources accessible via CXL.cache, and enabling entities communicating via CXL.cache to access resources accessible via NVLink. The translation may utilize CXL.cache as an intermediate protocol for accessing a processor's coherent interconnect, or may bridge CXL.cache snoop operations with NVLink-based requests targeting NVLink-attached entities.

In various implementations, a method comprises receiving, by a resource provisioning unit (RPU) from a first entity via an NVLink interface, an NVLink-based request comprising a first physical address; translating the NVLink-based request to a CXL.cache D2H request comprising an opcode and a second physical address; sending the CXL.cache D2H request to a second entity; receiving a CXL.cache H2D response comprising data accessed via the second physical address; and sending an NVLink-based response comprising the data to the first entity. The second entity may include a CXL root port coupled to a coherent interconnect of a processor, and the data may be retrieved via the coherent interconnect from a cache, a memory controller coupled to memory, or a CXL memory expander. The RPU may present as a CXL endpoint to the second entity. The RPU may translate NVLink Tags to CXL.cache CQIDs, may translate physical addresses between GPU or NVLink address spaces and Host Physical Addresses, and may translate an NVLink-based request to multiple CXL.cache D2H requests when the requested data payload exceeds a cacheline size.

In other implementations, a system comprises a processor comprising a CXL root port, a coherent interconnect, and memory controllers coupled to the coherent interconnect and to memory; and an RPU comprising an NVLink interface configured to communicate with an entity according to an NVLink-based protocol, and a CXL endpoint coupled to the CXL root port. The RPU is configured to translate between NVLink-based requests received via the NVLink interface and CXL.cache D2H requests sent to the CXL root port, to enable the entity to access memory resources via the coherent interconnect. The RPU may further translate CXL.cache H2D requests received from the CXL root port to NVLink-based requests sent to the entity, enabling the processor to access resources of the entity.

In yet other implementations, a method comprises receiving, by a computer from a first entity, a CXL.cache Host-to-Device (H2D) request comprising an opcode and a first address; translating the CXL.cache H2D request to an NVLink-based request comprising a second physical address; sending the NVLink-based request to a second entity via an NVLink interface; receiving an NVLink-based response from the second entity; and translating the NVLink-based response to one or more CXL.cache Device-to-Host (D2H) messages, and sending the D2H messages to the first entity. The opcode may include a snoop opcode, and the one or more D2H messages may include a D2H response and a D2H Data message. The computer may issue additional NVLink-based requests as prefetch requests based on detected access patterns.

In still other implementations, a system comprises a first interface configured to communicate according to CXL.cache with a first entity, a second interface configured to communicate according to an NVLink-based protocol with a second entity, and a computer coupled between the first and second interfaces. The computer is configured to translate CXL.cache H2D requests received via the first interface to NVLink-based requests transmitted via the second interface, and to translate NVLink-based responses received via the second interface to CXL.cache D2H messages transmitted via the first interface. The computer may be included in a switch or a bridge, and may further translate NVLink-based requests to CXL.cache D2H requests for bidirectional access.

### BRIEF DESCRIPTION OF THE DRAWINGS

FIG. 1A illustrates an example of a system comprising a processor comprising an NVLink interface, processing cores, LLC, a CXL RP, and memory controllers coupled via memory channels to memory;

FIG. 1B illustrates an example of a transaction flow diagram (TFD) demonstrating translations from NVLink traffic to traffic conforming to a protocol utilized by a processor's coherent interconnect, utilizing CXL.cache as an intermediate protocol;

FIG. 2A illustrates an example of a system comprising a computer coupled between a first interface communicating according to an NVLink-based protocol and a second interface communicating according to CXL.cache;

FIG. 2B illustrates an example of a cable comprising an NVLink port and a CXL port, with an RPU integrated into the cable;

FIG. 2C illustrates an example of a TFD demonstrating translations between NVLink-based requests and CXL.cache requests;

FIG. 3A illustrates an example of a system comprising an xPU with an RPU that translates between CXL.cache and NVLink;

FIG. 3B illustrates an example of a TFD demonstrating translation of a CXL.cache D2H request to an NVLink read request and translation of the NVLink response to a CXL.cache H2D Data message;

FIG. 4A illustrates an example of a system comprising an xPU with an RPU, a cache, and a local memory, showing two access paths for CXL.cache D2H requests;

FIG. 4B illustrates an example of a TFD demonstrating two CXL.cache D2H request flows: a first flow served from local memory with cache state transition, and a second flow translated to an NVLink read request;

FIG. 5A illustrates an example of a system comprising a computer coupled between an NVLink-based interface and a CXL.cache interface;

FIG. 5B illustrates an example of a TFD demonstrating translation of an NVLink read request to a CXL.cache H2D request comprising SnpCur;

FIG. 5C illustrates an example of a TFD demonstrating translation of an NVLink read request to a CXL.cache H2D request comprising SnpData;

FIG. 6A illustrates an example of a system comprising a processor comprising an NVLink-C2C interface;

FIG. 6B illustrates an example of a system comprising a CPU comprising an NVLink-C2C chiplet, such as NVLink Fusion;

FIG. 7A illustrates an example of a system comprising a cable configured to translate between CXL and NVLink;

FIG. 7B illustrates an example of a TFD demonstrating translating between CXL.mem M2S MemRd request and NVLink read request;

FIG. 8A illustrates an example of a system that translates between first and second CXL.cache;

FIG. 8B illustrates an example of a transaction flow diagram (TFD) demonstrating translations between CXL.cache H2D SnpInv request and CXL.cache D2H CLFlush request;

FIG. 8C illustrates an example of a TFD demonstrating translations between CXL.cache H2D SnpCur request and CXL.cache D2H RdCurr request;

FIG. 9A illustrates an example of a system that translates between CXL.cache messages, such as between CXL.cache Host-to-Device (H2D) requests and CXL.cache Device-to-Host (D2H) requests;

FIG. 9B illustrates an example of a TFD demonstrating translations between CXL.cache transactions;

FIG. 10A illustrates an example of a system that translates between CXL.cache messages, such as between CXL.cache H2D requests comprising Snoops and CXL.cache D2H requests comprising read opcodes;

FIG. 10B illustrates an example of a TFD demonstrating translations between CXL.cache H2D request comprising SnpData and CXL.cache D2H request comprising RdShared;

FIG. 10C illustrates an example of a TFD demonstrating translations between CXL.cache H2D request comprising SnpData and CXL.cache D2H request comprising RdOwn;

FIG. 10D illustrates an example of a TFD demonstrating translations between CXL.cache H2D request comprising SnpInv and CXL.cache D2H request comprising CLFlush;

FIG. 11A illustrates an example of a TFD demonstrating translations between CXL.cache H2D SnpInv and CXL.cache D2H RdOwnNoData;

FIG. 11B illustrates an example of a TFD demonstrating translations between CXL.cache H2D SnpInv and CXL.cache D2H RdOwn, returning a cacheline in Modified state (GO-M);

FIG. 11C illustrates an example of a TFD demonstrating translations between CXL.cache H2D SnpInv and CXL.cache D2H RdOwn, returning a cacheline in Exclusive state (GO-E);

FIG. 12A illustrates an example of a system that translates between CXL.cache messages;

FIG. 12B illustrates an example of a TFD demonstrating translations between CXL.cache H2D SnpData and CXL.cache D2H RdShared, returning a cacheline in Shared state (GO-S);

FIG. 13A illustrates an example of a system that translates between CXL.cache messages that affect cacheline state transitions;

FIG. 13B illustrates an example of a transaction flow diagram (TFD) demonstrating translations between CXL.cache D2H CLFlush request and CXL.cache H2D SnpInv request;

FIG. 13C illustrates an example of a TFD demonstrating translations between CXL.cache D2H RdCurr and CXL.cache H2D SnpCur;

FIG. 14A illustrates an example of a system that translates between NVLink-based traffic and PCIe-based traffic;

FIG. 14B illustrates an example of a TFD demonstrating translations between an NVLink read request and a PCIe UIOMRd;

FIG. 14C illustrates an example of a TFD demonstrating translations between an NVLink read request and a PCIe MRd;

FIG. 15A illustrates an example of a cable comprising an RPU that translates between PCIe-based traffic and NVLink-based traffic;

FIG. 15B illustrates an example of a TFD demonstrating translations between PCIe-based requests and NVLink-based requests;

FIG. 16A illustrates an example of a system that may function as an NVLink memory switch appliance or an NVLink memory pool;

FIG. 16B illustrates an example of a TFD depicting a multi-entity memory access scenario wherein GPUs access memory mapped to physical address spaces through NVLink to ARM CHI translations;

FIG. 17A illustrates an example of a system comprising an apparatus that translates between NVLink-based traffic and CXL.mem traffic;

FIG. 17B illustrates an example of a TFD demonstrating translations between NVLink-based traffic and CXL.mem traffic;

FIG. 18A illustrates an example of a system, comprising an RPU having an NVLink interface, which enables a GPU to access resources coupled to the RPU over CXL.mem;

FIG. 18B illustrates an example of a TFD demonstrating translations between an NVLink-based protocol and CXL.mem utilized for communicating with a CXL device or CXL memory;

FIG. 18C illustrates an example of a TFD demonstrating translations between NVLink-based requests and CXL.mem requests;

FIG. 19A illustrates an example of a system that translates between an NVLink-based protocol and a CXL protocol;

FIG. 19B illustrates an example of a system comprising an RPU in an NVLink switch or NVSwitch, coupled to NVLink and CXL.mem entities;

FIG. 19C illustrates an example of a system comprising an xPU with an NVLink Fusion chiplet;

FIG. 20A illustrates an example of a system comprising a processor including a coherent interconnect and an NVLink interface;

FIG. 20B illustrates an example of a TFD demonstrating two NVLink read requests forwarded to different memories via a coherent interconnect;

FIG. 21A illustrates an example of a system comprising a processor comprising an NVLink interface and a CXL RP;

FIG. 21B illustrates an example of a TFD demonstrating translating a first NVLink request to a coherent interconnect protocol, and translating a second NVLink read request to a CXL.mem M2S MemRd request;

FIG. 22A illustrates an example of a system that translates between NVLink-based traffic and CXL-based traffic;

FIG. 22B illustrates an example of a TFD demonstrating translations between an NVLink request and a CXL.io request;

FIG. 23A illustrates an example of a system that translates between NVLink-based traffic and CXL-based traffic;

FIG. 23B illustrates an example of a TFD demonstrating translations between NVLink-based read requests and CXL.io UIO TLPs;

FIG. 23C illustrates an example of a TFD demonstrating translations between NVLink-based read requests and CXL.io MRd TLPs;

FIG. 24A illustrates an example of a system comprising a computer configured to translate between CXL.io traffic and NVLink-based traffic;

FIG. 24B illustrates an example of a TFD demonstrating translations between CXL.io read requests and NVLink-based read requests;

FIG. 25A illustrates an example of a system comprising a CXL host coupled to a CXL device over two bridges that utilize an NVLink PHY;

FIG. 25B illustrates an example of a TFD depicting tunneling of CXL.io transactions between a host and a device through two bridges that utilize IEEE 802.3 and NVLink flits;

FIG. 26A illustrates an example of a system configured to enable CXL over NVLink, such as via CXL tunneling over NVLink;

FIG. 26B illustrates an example of a TFD demonstrating CXL communications over NVLink, such as CXL over NVLink, or CXL tunneling over NVLink;

FIG. 27A illustrates an example of a system configured to enable PCIe over NVLink, such as via PCIe tunneling over NVLink;

FIG. 27B illustrates an example of a TFD demonstrating PCIe UIO communications over NVLink, such as PCIe UIO over NVLink, or PCIe UIO tunneling over NVLink;

FIG. 28A illustrates an example of a processor comprising an NVLink interface, processing cores, LLCs, and a coherent interconnect;

FIG. 28B illustrates an example of a processor comprising NVLink interfaces and DDR channels;

FIG. 29A illustrates an example of a processor comprising an NVLink interface, processing cores, caches, and a coherent interconnect;

FIG. 29B illustrates an example of a TFD demonstrating translating an NVLink read request to a read transactions of a protocol utilized by a processor's coherent interconnect to access memory;

FIG. 30A illustrates an example of a system comprising a processor that includes an NVLink interface;

FIG. 30B illustrates an example of a TFD demonstrating two translations from NVLink-based traffic to traffic conforming to a protocol utilized by a processor's coherent interconnect;

FIG. 31A illustrates an example of a system that translates between NVLink-based traffic and ISoL traffic;

FIG. 31B illustrates an example of a TFD demonstrating translations between NVLink-based traffic and Intel UPI traffic;

FIG. 32A illustrates an example of a TFD demonstrating intent-based translations between CXL.mem M2S SnpCur and CXL.cache D2H RdCurr;

FIG. 32B illustrates an example of a TFD demonstrating intent-based translations between CXL.mem M2S SnpData and CXL.cache D2H RdShared;

FIG. 32C illustrates an example of a TFD demonstrating intent-based translations between CXL.mem M2S SnpInv and CXL.cache D2H RdOwn;

FIG. 33A illustrates an example of a TFD demonstrating intent-based translations between CXL.cache D2H RdCurr and CXL.mem M2S SnpCur;

FIG. 33B illustrates an example of a TFD demonstrating intent-based translations between CXL.cache D2H RdShared and CXL.mem M2S SnpData;

FIG. 33C illustrates an example of a TFD demonstrating intent-based translations between CXL.cache D2H RdOwn and CXL.mem M2S SnpInv;

FIG. 34A illustrates an example of a system that translates between UALink-based traffic and CXL.cache traffic when communicating with a host;

FIG. 34B illustrates an example of a TFD demonstrating translations between a UPLI request and a CXL.cache D2H RdCurr request;

FIG. 34C illustrates an example of a TFD demonstrating translations between a UPLI request and a CXL.cache D2H RdShared request;

FIG. 35A illustrates an example of a system that translates between UALink-based traffic and CXL.cache traffic when communicating with a device;

FIG. 35B illustrates an example of a TFD demonstrating translations between a UPLI request and a CXL.cache H2D SnpCur request;

FIG. 35C illustrates an example of a TFD demonstrating translations between a UPLI request and a CXL.cache H2D SnpData request;

FIG. 36A illustrates an example of a system comprising a processor comprising an RPU chiplet that translates between UALink and CXL;

FIG. 36B illustrates an example of a TFD demonstrating translating a UPLI request to a protocol utilized by a processor's coherent interconnect;

FIG. 37A illustrates an example of a system comprising a cable that translates between UALink-based traffic and CXL-based traffic;

FIG. 37B illustrates an example of an active optical cable comprising an RPU that translates between UALink-based traffic and CXL-based traffic;

FIG. 38A illustrates an example of a system that translates between UALink-based traffic and CXL-based traffic;

FIG. 38B illustrates an example of a TFD demonstrating translations between a UPLI transaction comprising UPLI read response/data and a CXL transaction;

FIG. 38C illustrates an example of a TFD demonstrating translations between a UPLI transaction comprising UPLI write response and a CXL transaction;

FIG. 39A illustrates an example of a memory switch configured to provide memory to its coupled entities;

FIG. 39B illustrates an example of a TFD demonstrating NVLink requests from entities to access memory;

FIG. 40A illustrates an example of a system that implements an NVLink-based switch, or an NVLink Memory Switch, utilizing a CHI-based interconnect;

FIG. 40B illustrates an example of a TFD demonstrating NVLink switching operation between entities through a switch interconnect;

FIG. 41 illustrates an example of a system wherein inference context data is migrated between accelerator local memory and the CXL memory device across UALink and CXL protocol domains;

FIG. 42A illustrates an example of a system comprising a processor comprising a CXL endpoint;

FIG. 42B illustrates an example of a TFD demonstrating translations between CXL.mem and CXL.cache messages;

FIG. 43A illustrates an example of a system comprising a processor comprising a CXL EP coupled to the processor's coherent interconnect via an ISoL interface;

FIG. 43B illustrates an example of a TFD demonstrating a translating a CXL.mem M2S Read request to an ISoL request;

FIG. 44A illustrates an example of a system comprising an entity, such as a processor or a node controller, configured to translate between CXL-based messages and ISoL messages;

FIG. 44B illustrates an example of a TFD demonstrating translations between CXL.mem and Intel UPI;

FIG. 45A illustrates an example of a system comprising a processor, a node controller, or a switch, which includes a CXL device, configured to translate between CXL-based traffic and ISoL traffic;

FIG. 45B illustrates an example of a TFD demonstrating translations between CXL.mem and UPI, including translating error and data corruption indications, such as poison;

FIG. 46A illustrates an example of a system comprising a processor or an RPU, configured to translate between CXL-based traffic and ISoL traffic; and

FIG. 46B illustrates an example of a TFD demonstrating translations between CXL.mem messages and ISoL messages.

### DETAILED DESCRIPTION

In computing systems where NVLink-attached entities, such as accelerators/GPUs, require access to memory resources managed by a processor, an RPU may translate between NVLink-based traffic and CXL.cache traffic. The RPU may utilize CXL.cache as an intermediate protocol for reaching the processor's coherent interconnect, by presenting itself to a CXL host as a CXL endpoint and issuing CXL.cache D2H requests. The CXL host, which may be a CXL root port or another CXL-capable entity, may process the D2H requests and return data via CXL.cache H2D responses. The RPU may perform address translations between NVLink address spaces (such as GPU physical addresses or NVLink network addresses) and address spaces utilized by the CXL host (such as Host Physical Addresses), as well as Tag translations between NVLink Tags and CXL.cache CQIDs. In some examples, the RPU may split an NVLink-based request to multiple CXL.cache D2H requests when the requested data payload exceeds a cacheline size.

In various implementations, a method comprising: receiving, by a resource provisioning unit (RPU) from a first entity via an NVLink interface that communicates according to an NVLink-based protocol, an NVLink-based request comprising a first physical address; translating, by the RPU, the NVLink-based request to a CXL.cache Device-to-Host (D2H) request comprising an opcode and a second physical address, wherein CXL denotes Compute Express Link; sending, by the RPU, the CXL.cache D2H request to a second entity; receiving, by the RPU from the second entity, a CXL.cache Host-to-Device (H2D) response comprising data accessed via the second physical address; and sending, by the RPU, an NVLink-based response comprising the data to the first entity. The RPU may receive NVLink-based requests from various types of NVLink-attached entities, such as GPUs, accelerators, or NVLink switches, and may translate these requests to CXL.cache D2H requests directed at a CXL host. The second entity may include a CXL root port of a processor, a CXL switch, or another entity that processes CXL.cache D2H requests and returns CXL.cache H2D responses. The opcode in the CXL.cache D2H request may be selected based on the type of NVLink-based request, the caching policy of the RPU, and the coherency requirements of the access. The CXL.cache H2D response may include a Global Observation (GO) indication along with data, or may include data delivered via an H2D Data message. The RPU may aggregate data from one or more H2D responses or H2D Data messages before sending the NVLink-based response to the first entity.

In some implementations of the method, the second entity comprises a CXL root port (RP) coupled to a coherent interconnect of a processor, and the data is retrieved via the coherent interconnect from at least one of: a cache of the processor, a memory controller coupled to memory, or a CXL memory expander. The cache may include an LLC. The memory may include DRAM coupled to the memory controller via memory channels. The CXL memory expander may be coupled to a separate CXL port of the processor. The coherent interconnect may route the request to the appropriate resource based on address decoding.

In some implementations of the method, the CXL RP is coupled to the coherent interconnect via an interconnect interface, and the coherent interconnect utilizes a protocol selected from at least one of: ARM CHI, Intel UPI, or AMD Infinity Fabric. The interconnect interface may be a Ring-to-CXL (R2CXL) interface or a mesh-to-CXL interface that translates between the CXL protocol domain and the coherent interconnect protocol domain.

In some implementations of the method, the translating comprises translating an NVLink Tag carried in the NVLink-based request to a command queue identifier (CQID) carried in the CXL.cache D2H request, and maintaining a mapping between the NVLink Tag and the CQID for correlating the CXL.cache H2D response with the NVLink-based response. The mapping may be maintained in a translation table or tracker. The CQID may identify the RPU's tracker entry for the transaction. Upon receiving an H2D response carrying the CQID, the RPU may look up the corresponding NVLink Tag to route the response to the originating entity.

In some implementations of the method, the translating comprises translating the NVLink-based request to CXL.cache D2H requests when the NVLink-based request specifies a data payload larger than a cacheline, and wherein each of the CXL.cache D2H requests comprises an opcode selected from RdOwn or RdShared. NVLink-based requests may specify data payloads of up to 256 bytes, while CXL.cache D2H requests may operate on cacheline granularity, such as 64 bytes. The RPU may split an NVLink-based request to multiple D2H requests with consecutive addresses. RdOwn or RdShared may be selected based on the caching policy of the RPU.

In some implementations of the method, the translating comprises translating the first physical address from a GPU physical address or an NVLink network address to a Host Physical Address (HPA) carried as the second physical address in the CXL.cache D2H request. The address translation may be implemented utilizing address range registers, translation tables, page tables, or algorithmic mappings. The GPU physical address or NVLink network address may be utilized by the NVLink-attached entity for routing within the NVLink domain, while the HPA may be utilized by the CXL host for accessing memory resources.

In some implementations of the method, the RPU, the NVLink interface, and a CXL device are implemented in a chiplet within an integrated circuit (IC) package of a processor, and the second entity comprises a CXL root port (RP) of the processor. The chiplet may be an NVLink chiplet, or NVLink Fusion, coupled to other dies within the IC package via a chip-to-chip (C2C) interface, such as UCIe or NVLink-C2C. The CXL device may present as a CXL EP to the CXL RP of the processor.

In some implementations of the method, the RPU presents as a CXL endpoint (CXL EP) to the second entity, the CXL EP comprising a Type-1 CXL device or a Type-2 CXL device, and wherein the opcode of the CXL.cache D2H request comprises RdCurr. A Type-1 CXL device may support CXL.io and CXL.cache, enabling the RPU to issue D2H requests and receive H2D responses from the second entity. A Type-2 CXL device may additionally support CXL.mem, enabling the second entity to also access memory resources of the RPU via M2S requests in addition to cache coherency operations. The selection between Type-1 and Type-2 may depend on whether the RPU exposes memory resources to the second entity beyond cache coherency functionality.

In some implementations of the method, the opcode of the CXL.cache D2H request comprises RdCurr, and the data received via the CXL.cache H2D response is forwarded to the first entity without being cached by the RPU, whereby the RPU provides I/O-coherent access to resources accessible via the second entity. I/O-coherent access may be suitable for streaming or peer data transfers where cacheline residency at the RPU is not required and snoop filter overhead at the second entity is to be avoided. The RPU may forward data directly to the first entity upon receipt, without allocating cache entries, maintaining coherency state, or participating in snoop exchanges beyond those inherent to the RdCurr transaction.

In some implementations of the method, the RPU comprises a cache, the opcode of the CXL.cache D2H request is selected from RdOwn, RdShared, or RdAny, and the data received via the CXL.cache H2D response is stored in the cache of the RPU; and further comprising receiving, by the RPU from the second entity, a CXL.cache H2D request comprising a snoop opcode targeting a cacheline stored in the cache, and sending, by the RPU, a CXL.cache D2H response to the second entity. The RPU cache may reduce cross-protocol round trips by serving subsequent requests from cached data. RdOwn may request exclusive ownership, RdShared may request shared state, and RdAny may allow the host to determine the state. The snoop opcode may include SnpData, SnpInv, or SnpCur. The D2H response may include RspIHitI, RspIHitSE, RspSHitSE, RspVHitV, RspSFwdM, RspIFwdM, or RspVFwdV based on the cache state and the snoop type. When the D2H response includes a data-forwarding opcode such as RspSFwdM, RspIFwdM, or RspVFwdV, the RPU may also send a CXL.cache D2H Data comprising the cached data.

In some implementations of the method, a non-transitory computer-readable medium comprising instructions which, when executed by a processor, cause the processor to perform the method. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

The following system may include a processor with a CXL root port coupled to a coherent interconnect, and an RPU comprising an NVLink interface and a CXL EP. The RPU may translate between NVLink-based requests and CXL.cache D2H requests, enabling NVLink-attached entities to access processor memory resources via the coherent interconnect. The CXL EP may present the RPU to the CXL RP as a CXL device, such as a Type-1 or Type-2 CXL device. The processor may include processing cores, caches, and memory controllers coupled to the coherent interconnect. In some examples, the RPU and NVLink interface may reside on a separate silicon die or chiplet within the processor's IC package.

In various implementations, a system comprising: a processor comprising a Compute Express Link (CXL) root port (RP), a coherent interconnect, and memory controllers; wherein the memory controllers are coupled to the coherent interconnect and coupled to memory; a resource provisioning unit (RPU) comprising: an NVLink interface configured to communicate with an entity according to an NVLink-based protocol, and a CXL endpoint (CXL EP) coupled to the CXL RP; and wherein the RPU is configured to translate between NVLink-based requests received via the NVLink interface and CXL.cache Device-to-Host (D2H) requests sent to the CXL RP, to enable the entity to access memory resources via the coherent interconnect. The system may be implemented as a monolithic processor die, as chiplets within an IC package, or as components on a board. The CXL RP may process the CXL.cache D2H requests and access memory resources via the coherent interconnect, such as from DRAM coupled to the memory controllers, from a cache of the processor, or from a CXL memory expander coupled to a separate CXL port. The RPU may perform address translations between NVLink address spaces and Host Physical Addresses, Tag translations between NVLink Tags and CXL.cache CQIDs, and opcode translations between NVLink request types and CXL.cache D2H opcodes. The entity may include a GPU, an accelerator, or an NVLink switch.

In some implementations of the system, the CXL EP comprises a Type-1 CXL device or a Type-2 CXL device, and the coherent interconnect utilizes a protocol selected from at least one of: ARM CHI, Intel UPI, or AMD Infinity Fabric. A Type-1 CXL device may support CXL.io and CXL.cache. A Type-2 CXL device may additionally support CXL.mem. The coherent interconnect protocol may determine how the CXL RP communicates with processing cores, caches, and memory controllers within the processor.

In some implementations, the system further comprises processing cores and a last level cache (LLC) coupled to the coherent interconnect, and wherein the CXL RP is coupled to the coherent interconnect via an interconnect interface. The interconnect interface may be a Ring-to-CXL (R2CXL) interface or a mesh-to-CXL interface. The processing cores and LLC may be implemented as distributed slices coupled to the coherent interconnect. The CXL.cache D2H requests from the RPU may be served by the LLC on a cache hit, avoiding access to DRAM.

In some implementations of the system, the RPU, the NVLink interface, and the CXL EP are on a first silicon die, and the CXL RP and the coherent interconnect are on a second silicon die, the first and second silicon dies within an IC package. The first silicon die may be an NVLink chiplet, such as NVLink Fusion, coupled to the second silicon die via a chip-to-chip (C2C) interface, such as UCIe or NVLink-C2C.

In some implementations of the system, the RPU is further configured to translate CXL.cache Host-to-Device (H2D) requests received from the CXL RP to NVLink-based requests sent to the entity via the NVLink interface, enabling the processor to access resources of the entity. The translation may enable the processor's cores to access memory or resources coupled to the NVLink-attached entity, such as GPU memory. The RPU may maintain separate translation contexts for inbound (NVLink-to-CXL.cache) and outbound (CXL.cache-to-NVLink) traffic.

In some implementations, a computer may translate CXL.cache H2D requests, such as snoops, to NVLink-based requests targeting NVLink-attached entities. This translation may enable a CXL host, such as a processor, to access resources coupled to NVLink-attached entities, such as GPU memory or accelerator memory, by issuing CXL.cache H2D requests that the computer translates to NVLink-based requests. The computer may translate UQIDs carried in H2D requests to NVLink Tags, perform address translations between Host Physical Addresses and NVLink or GPU physical addresses, and generate CXL.cache D2H response and D2H Data messages from NVLink-based responses. The computer may be implemented in a switch, a bridge, a semiconductor device, a chiplet, or an active cable.

In various implementations, a method comprising: receiving, by a computer from a first entity, a CXL.cache Host-to-Device (H2D) request comprising an opcode and a first address, wherein CXL denotes Compute Express Link; translating, by the computer, the CXL.cache H2D request to an NVLink-based request comprising a second physical address; sending, by the computer via an NVLink interface that communicates according to an NVLink-based protocol, the NVLink-based request to a second entity; receiving, by the computer from the second entity, an NVLink-based response; and translating, by the computer, the NVLink-based response to one or more CXL.cache Device-to-Host (D2H) messages, and sending the one or more CXL.cache D2H messages to the first entity. The first entity may be a CXL host, such as a processor comprising a CXL root port, or another entity that issues CXL.cache H2D requests. The second entity may be a GPU, an accelerator, or an NVLink switch that processes NVLink-based requests and returns NVLink-based responses. The opcode in the H2D request may include a snoop opcode, such as SnpData, SnpInv, or SnpCur, and the computer may generate an appropriate NVLink-based request type based on the snoop intent. The one or more CXL.cache D2H messages may include a CXL.cache D2H response, a CXL.cache D2H Data, or both, depending on whether data return is indicated by the snoop type and the NVLink-based response.

In some implementations of the method, the translating of the CXL.cache H2D request comprises translating a Unique Queue ID (UQID) carried in the CXL.cache H2D request to an NVLink Tag carried in the NVLink-based request, and maintaining a mapping between the UQID and the NVLink Tag for correlating the NVLink-based response with the one or more CXL.cache D2H messages. The UQID may identify the host entry that originated the H2D request. Upon receiving the NVLink-based response, the computer may look up the mapping to recover the UQID for inclusion in the D2H response and D2H Data messages.

In some implementations of the method, the opcode of the CXL.cache H2D request comprises a snoop opcode selected from SnpData, SnpInv, or SnpCur, the NVLink-based request comprises a read or invalidation request type corresponding to the snoop opcode, the first entity comprises a CXL host, and the second entity comprises a GPU, an NVLink switch, or an accelerator. SnpData may be translated to an NVLink read with data return. SnpInv may be translated to an NVLink invalidation or read for exclusive ownership. SnpCur may be translated to an NVLink read without cache state change. The NVLink request type may be selected based on the snoop intent.

In some implementations of the method, the NVLink-based response comprises data, and the one or more CXL.cache D2H messages comprise a CXL.cache D2H response comprising a snoop response opcode and a Unique Queue ID (UQID), and a CXL.cache D2H Data comprising the data and the UQID. The snoop response opcode may include RspSFwdM, RspIFwdM, or RspVFwdV, indicating data forwarding with the corresponding cache state transition. The UQID in both the D2H response and D2H Data may be reflected from the H2D request to enable the first entity to correlate the response with the originating snoop.

In some implementations, the method further comprises issuing, by the computer via the NVLink interface, additional NVLink-based requests to the second entity as prefetch requests based on a detected access pattern of CXL.cache H2D requests received from the first entity. The computer may detect sequential, strided, or other access patterns from the addresses in the H2D requests and may issue speculative NVLink-based requests to reduce latency for subsequent H2D requests. Prefetched data may be stored in a local buffer or cache of the computer.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface communicating according to CXL.cache with a first entity and a second interface communicating according to an NVLink-based protocol with a second entity, with a computer coupled between the two interfaces. The computer may translate CXL.cache H2D requests to NVLink-based requests and NVLink-based responses to CXL.cache D2H messages, enabling the first entity to access resources of the second entity across the protocol boundary. The computer may be included in a switch, a bridge, or a standalone semiconductor device, and may further support bidirectional translation.

In various implementations, a system comprising: a first interface configured to communicate according to CXL.cache with a first entity, wherein CXL denotes Compute Express Link; a second interface configured to communicate according to an NVLink-based protocol with a second entity; and a computer coupled between the first and second interfaces, configured to translate CXL.cache Host-to-Device (H2D) requests received via the first interface to NVLink-based requests transmitted via the second interface, and to translate NVLink-based responses received via the second interface to CXL.cache Device-to-Host (D2H) messages transmitted via the first interface. The first entity may be a CXL host, such as a processor, and the second entity may be a GPU, an accelerator, or an NVLink switch. The computer may perform address translations, transaction identifier translations, and opcode translations between the CXL.cache and NVLink protocol domains. The CXL.cache D2H messages may include D2H responses, D2H Data, or both. The system may be implemented in an IC package, on a PCB, or integrated into a cable form factor.

In some implementations of the system, the CXL.cache D2H messages comprise a CXL.cache D2H response comprising an opcode selected from RspSFwdM, RspIFwdM, or RspVFwdV, and a CXL.cache D2H Data comprising data sourced from a memory or a cache of the second entity. The selection of the D2H response opcode may depend on the snoop type in the H2D request and the data returned by the second entity. The memory of the second entity may include HBM, HBF, or DRAM. The cache of the second entity may include an L2 cache or an LLC of a GPU or accelerator.

In some implementations of the system, the computer is configured to translate Host Physical Addresses (HPAs) carried in the CXL.cache H2D requests to NVLink network addresses or GPU physical addresses carried in the NVLink-based requests. The address translation may be implemented utilizing address range registers, translation tables, or algorithmic mappings. HPAs may be utilized by the first entity, such as a processor, and NVLink network addresses or GPU physical addresses may be utilized for routing within the NVLink domain.

In some implementations of the system, the computer is included in a switch or a bridge, and the computer is further configured to translate NVLink-based requests received via the second interface to CXL.cache D2H requests transmitted via the first interface, enabling the second entity to access resources coupled to the first entity. The translation may enable both the first entity to access resources of the second entity and the second entity to access resources of the first entity through the same switch or bridge. The switch may be an NVLink switch or a CXL switch.

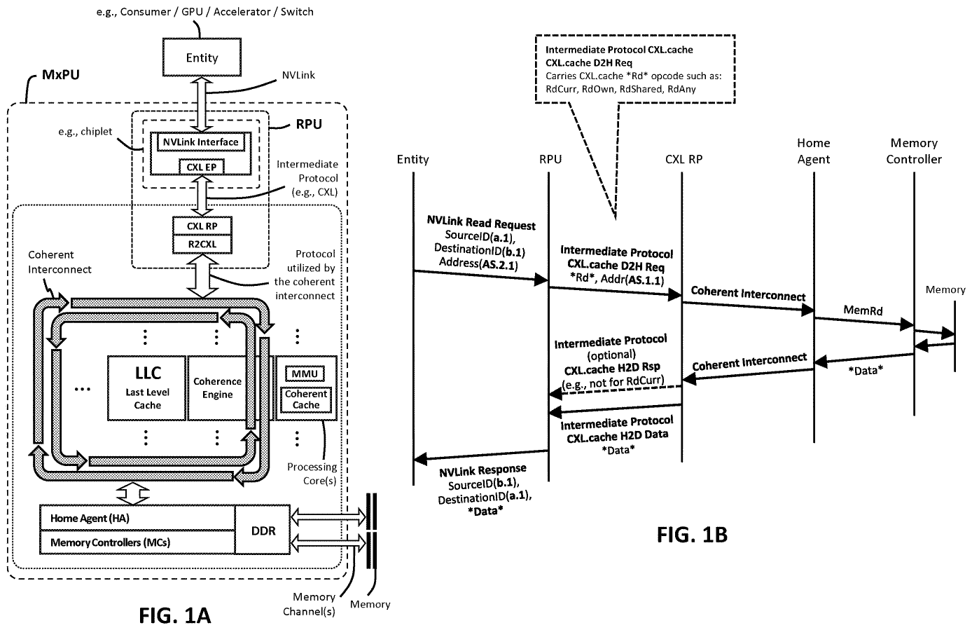

FIG. 1A illustrates an example of a system comprising a processor (such as an MxPU) comprising processing cores, LLC, a CXL RP, and memory controllers coupled via memory channels to memory, such as DRAM. The processor may include a coherent interconnect, such as a ring or mesh interconnect. The coherent interconnect may couple the processing cores, the LLC, and the memory controllers, and may further couple a coherence engine. The processing cores may each include an MMU and a coherent cache. The CXL RP may be coupled to the coherent interconnect via a Ring-to-CXL (R2CXL) interconnect interface that may communicate with the coherent interconnect according to a protocol utilized by the coherent interconnect, such as ARM CHI, Intel UPI, or AMD Infinity Fabric. A Home Agent (HA) may be coupled to the memory controllers, and the memory controllers may communicate with the memory via DDR memory channels.

An RPU, which may be included in the processor, may perform physical address translations that may enable an entity, such as a GPU, an accelerator, or a switch, to access the memory. The processor may expose to the entity, optionally via the RPU, an NVLink interface that may communicate with the entity according to an NVLink-based protocol. The RPU may further perform translations, such as from NVLink to a protocol utilized by the coherent interconnect, wherein the RPU may utilize an intermediate protocol, such as CXL (e.g., CXL.cache), to provide the translations. The RPU may expose to the processor, via the CXL RP, a CXL device utilizing a CXL endpoint (CXL EP), such as a Type-1 CXL device or a Type-2 CXL device. The R2CXL interconnect interface, that may reside in the RPU or between the RPU and the coherent interconnect, may couple the CXL RP to the coherent interconnect and complete the translation path from NVLink, via the intermediate protocol, to traffic based on the protocol utilized by the coherent interconnect. In some examples, the RPU, the NVLink interface, and the CXL device (e.g., CXL EP) may be implemented in a chiplet, such as an NVLink chiplet or NVLink Fusion, inside an IC package of the processor. In other examples, the RPU, the NVLink interface, and the CXL device may be implemented as functional blocks on the same die with the CXL RP of the processor, or split between silicon dies or chiplets inside the IC package of the processor.

FIG. 1B illustrates an example of a TFD demonstrating an NVLink read request received from an entity (such as a consumer, GPU, accelerator, or a switch), wherein the RPU may translate the NVLink read request to traffic conforming to a protocol utilized by the processor's coherent interconnect, utilizing CXL.cache as an intermediate protocol. The entity may send an NVLink request, such as an NVLink read request, comprising SourceID(a.1), DestinationID(b.1), and Address(AS.2.1), to the RPU. The RPU may translate the physical address (AS.2.1) carried in the NVLink request to a physical address (AS.1.1) utilized for accessing the memory. The RPU may perform further translations, such as opcode translations and Tag translations, e.g., translating from NVLink Tags to CXL.cache CQIDs. The RPU may generate a CXL.cache D2H request carrying the translated address (AS.1.1) and a CXL.cache read opcode (*Rd*) which indicates that the CXL.cache D2H request may carry an opcode such as RdCurr, RdOwn, RdShared, or RdAny. The CXL.cache D2H request is sent to the CXL RP for further processing. The CXL RP may communicate with a Home Agent via the coherent interconnect, and the Home Agent may issue a MemRd to a memory controller to retrieve data (*Data*) from the memory. The data may return over the coherent interconnect to the CXL RP, which may send an optional CXL.cache H2D response (when the opcode is not RdCurr) and a CXL.cache H2D Data comprising *Data* to the RPU. The RPU may then send an NVLink response comprising SourceID(b.1), DestinationID(a.1), and *Data* to the requesting entity. In some examples, the data may be provided by an LLC of the processor over the coherent interconnect, instead of by the memory via the memory controller.

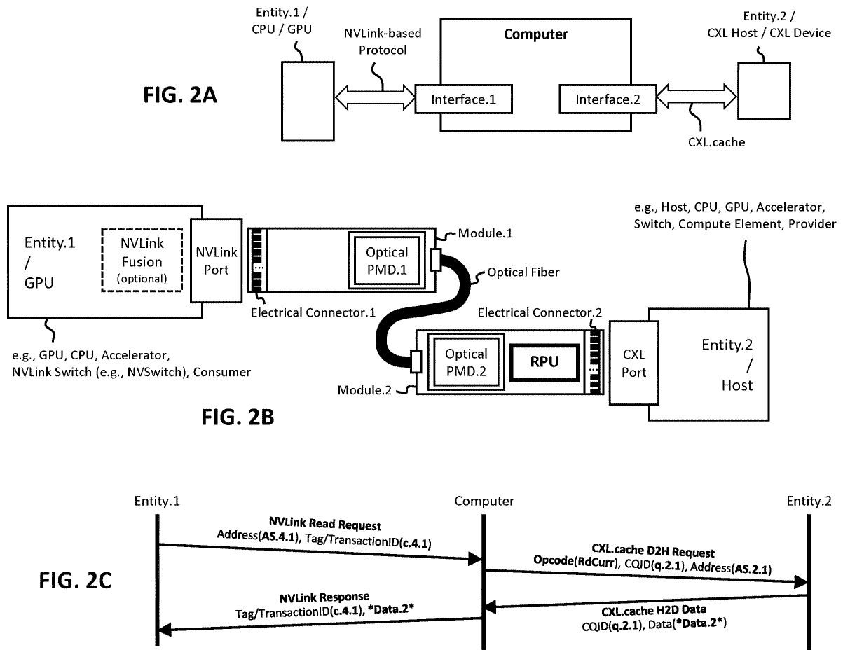

FIG. 2A illustrates an example of a system comprising a computer coupled between a first interface (Interface.1) communicating according to an NVLink-based protocol with a first entity (Entity.1), and a second interface (Interface.2) communicating according to CXL.cache with a second entity (Entity.2). The first entity may be a CPU or a GPU. The second entity may be a CXL host or a CXL device. The computer may extract addresses from requests received via either the first interface or the second interface, translate the addresses, and generate requests carrying the translated addresses for transmission via the other interface. In one direction, the computer may translate NVLink-based requests from the first entity to CXL.cache requests sent to the second entity. In the other direction, the computer may translate CXL.cache requests from the second entity to NVLink-based requests sent to the first entity. The addresses carried in NVLink-based requests may refer to a first address space, such as an NVLink-based address space, an NVLink-based network address space, or a GPU address space utilized by the first entity. The translated addresses carried in CXL.cache requests may refer to a second address space utilized by the second entity, such as a Host Physical Address (HPA) space.

FIG. 2B illustrates an example of a cable comprising an NVLink port and a CXL port, with an RPU integrated into the cable. The cable couples a first entity (Entity.1), such as a GPU, CPU, accelerator, NVLink switch (e.g., NVSwitch), or consumer, to a second entity (Entity.2), such as a host, CPU, GPU, accelerator, switch, compute element, or provider. The first entity may include an NVLink Fusion chiplet or IP block (optional) coupled to an NVLink port. The second entity may include a CXL port. The cable may include a first module (Module.1) including an optical physical medium dependent (Optical PMD.1) sublayer, and a second module (Module.2) including an optical physical medium dependent (Optical PMD.2) sublayer and an RPU. The first module may be coupled to the first entity via a first electrical connector (Electrical Connector.1) and the second module may be coupled to the second entity via a second electrical connector (Electrical Connector.2). An optical fiber may couple the first module to the second module. The RPU may translate between messages conforming to the NVLink-based protocol utilized by the first entity and messages conforming to CXL.cache utilized by the second entity. In the illustrated example, the RPU is placed in Module.2 closer to the CXL port. CXL, which runs over PCIe electricals, is designed as a shorter-reach interface, while some versions of NVLink incorporate electrical signaling characteristics designed for longer-reach interconnects. Placing the RPU closer to the CXL port may improve signal integrity and may allow for reducing the number of optical fibers or copper wires between the modules, since NVLink may utilize a higher signaling rate than CXL and therefore may require fewer lanes for the same bandwidth.

FIG. 2C illustrates an example of a TFD demonstrating translations performed by a computer between NVLink-based requests and CXL.cache requests. A first entity (Entity.1), which may be a CPU or a GPU, may initiate an NVLink request, such as an NVLink read request, comprising Address(AS.4.1) and Tag/TransactionID(c.4.1). The, wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.cache D2H request comprising Opcode(RdCurr), CQID(q.2.1), and Address(AS.2.1), and may send the CXL.cache D2H request to a second entity (Entity.2), which may be a CXL host. The computer may translate the physical address (AS.4.1) carried in the NVLink request to a physical address (AS.2.1) carried in the CXL.cache D2H request, and may translate the NVLink Tag/TransactionID(c.4.1) to a CXL.cache CQID(q.2.1). Upon receiving one or more responses from the second entity, which may include a CXL.cache H2D Data comprising CQID(q.2.1) and Data(*Data.2*), the computer may translate the one or more responses to an NVLink response comprising Tag/TransactionID(c.4.1) and *Data.2*, and send the NVLink response to the first entity. In some examples, the computer may issue multiple CXL.cache D2H requests in response to receiving an NVLink request from the first entity, such as when splitting an NVLink request for a large block of data (e.g., 256 bytes) to smaller CXL.cache D2H requests (e.g., 64 bytes each), or when prefetching data from the second entity utilizing CXL.cache reads.

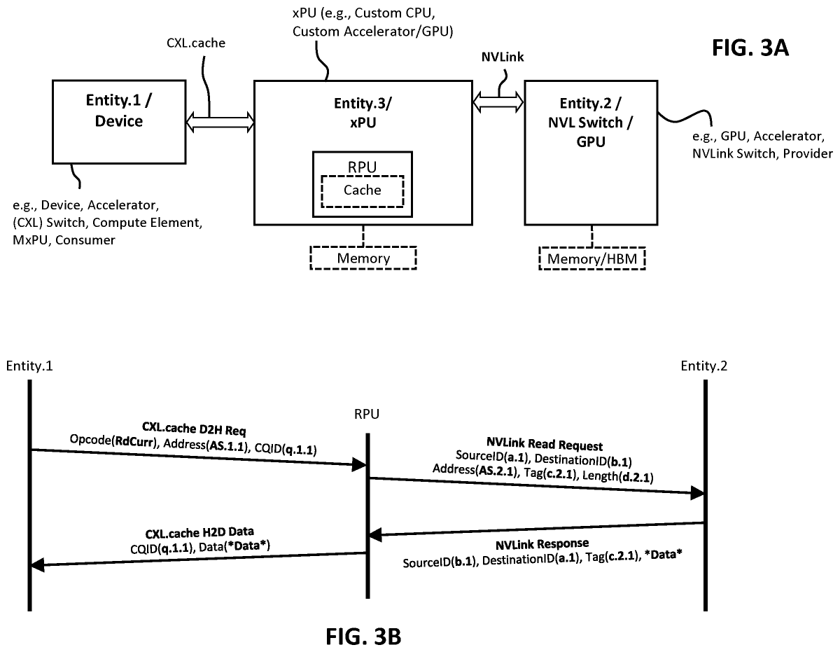

FIG. 3A illustrates an example of a system comprising an xPU (Entity.3), such as a custom CPU or a custom accelerator/GPU, coupled between a first entity (Entity.1) via CXL.cache and a second entity (Entity.2) via NVLink. Entity.1 may be a device, an accelerator, a CXL switch, a compute element, an MxPU, or a consumer. Entity.2 may be a GPU, an accelerator, an NVLink switch, or a provider. The xPU may include an RPU with an optional cache and an optional memory coupled to the RPU. The RPU may translate CXL.cache D2H requests received from Entity.1 to NVLink read requests sent to Entity.2, and may translate NVLink responses to CXL.cache H2D messages returned to Entity.1. Entity.2 may include Memory/HBM accessible via NVLink.

FIG. 3B illustrates an example of a TFD demonstrating translation of a CXL.cache D2H request to an NVLink read request. Entity.1 sends a CXL.cache D2H Req comprising Opcode(RdCurr), Address(AS.1.1), and CQID(q.1.1) to the RPU. The RPU translates the D2H request to an NVLink Read Request comprising SourceID(a.1), DestinationID(b.1), Address(AS.2.1), Tag(c.2.1), and Length(d.2.1), and sends the NVLink Read Request to Entity.2. Entity.2 returns an NVLink Response comprising SourceID(b.1), DestinationID(a.1), Tag(c.2.1), and *Data*. The RPU translates the NVLink Response to a CXL.cache H2D Data comprising CQID(q.1.1) and Data(*Data*), and sends the H2D Data to Entity.1. Because the opcode is RdCurr, no CXL.cache H2D Response (GO) is sent.

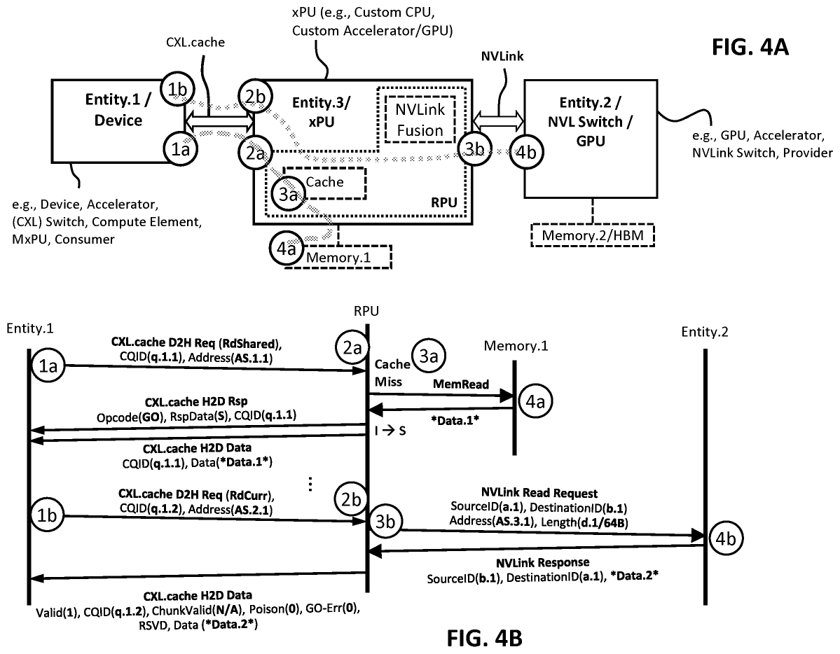

FIG. 4A illustrates an example of a system comprising an xPU (Entity.3), such as a custom CPU or a custom accelerator/GPU, coupled between Entity.1 via CXL.cache and Entity.2 via NVLink. The xPU may include an optional NVLink Fusion chiplet, an RPU with a cache, and a local memory (Memory.1). Entity.1 may be a device, an accelerator, a CXL switch, a compute element, an MxPU, or a consumer. Entity.2 may be a GPU, an accelerator, an NVLink switch, or a provider. Entity.2 may include Memory.2/HBM. The figure illustrates two access paths for CXL.cache D2H requests from Entity.1. A first path (1a, 2a, 3a, 4a) routes a D2H request from Entity.1 to the RPU, through the cache, and to Memory.1 of the xPU. A second path (1b, 2b, 3b, 4b) routes a D2H request from Entity.1 to the RPU, through NVLink, to Entity.2 and its Memory.2/HBM.

FIG. 4B illustrates an example of a TFD demonstrating two CXL.cache D2H request flows processed by an RPU with a cache. In a first flow, Entity.1 sends a CXL.cache D2H Req comprising Opcode(RdShared), CQID(q.1.1), and Address(AS.1.1) to the RPU (step 1a). The RPU performs a cache lookup (step 2a), which results in a cache miss. The RPU issues a MemRead to Memory.1 (step 3a), and Memory.1 returns *Data.1* (step 4a). The RPU stores *Data.1* in the cache and transitions the cache state from Invalid (I) to Shared (S). The RPU sends to Entity.1 a CXL.cache H2D Rsp comprising Opcode(GO) with RspData indicating Shared state and CQID(q.1.1), followed by a CXL.cache H2D Data comprising CQID(q.1.1) and Data(*Data.1*). In a second flow, Entity.1 sends a CXL.cache D2H Req comprising Opcode(RdCurr), CQID(q.1.2), and Address(AS.2.1) to the RPU (step 1b). The RPU translates the D2H request to an NVLink Read Request comprising SourceID(a.1), DestinationID(b.1), Address(AS.3.1), and Length(d.1/64 B), and sends the NVLink Read Request to Entity.2 (steps 2b, 3b). Entity.2 returns an NVLink Response comprising SourceID(b.1), DestinationID(a.1), and *Data.2* (step 4b). The RPU translates the NVLink Response to a CXL.cache H2D Data comprising Valid(1), CQID(q.1.2), ChunkValid(N/A), Poison(0), GO-Err(0), RSVD, and Data(*Data.2*), and sends the H2D Data to Entity.1. Because the opcode is RdCurr, no CXL.cache H2D Response (GO) is sent, and the data is not cached by the RPU.

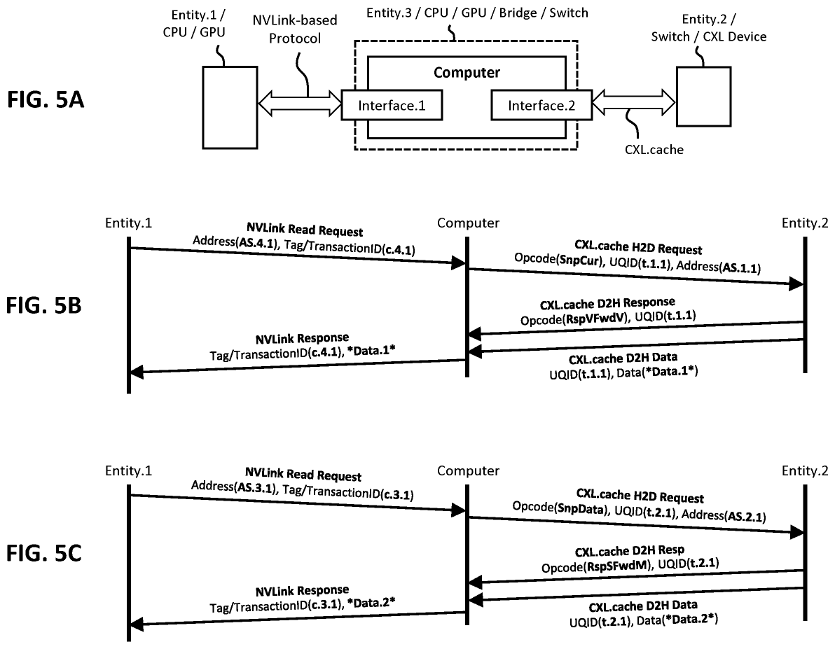

FIG. 5A illustrates an example of a system comprising a computer (Entity.3), such as a CPU, GPU, bridge, or switch, coupled between a first entity (Entity.1) via an NVLink-based protocol and a second entity (Entity.2) via CXL.cache. Entity.1 may be a CPU or a GPU. Entity.2 may be a switch or a CXL device. The computer may include a first interface (Interface.1) communicating according to the NVLink-based protocol and a second interface (Interface.2) communicating according to CXL.cache. The computer may translate NVLink read requests received from Entity.1 to CXL.cache H2D requests sent to Entity.2, and may translate CXL.cache D2H messages received from Entity.2 to NVLink responses sent to Entity.1.

FIG. 5B illustrates an example of a TFD demonstrating translation of an NVLink read request to a CXL.cache H2D request comprising SnpCur. Entity.1 sends an NVLink Read Request comprising Address(AS.4.1) and Tag/TransactionID(c.4.1) to the computer. The computer translates the NVLink Read Request to a CXL.cache H2D request comprising Opcode(SnpCur), UQID(t.1.1), and Address(AS.1.1), and sends the H2D request to Entity.2. Entity.2 returns a CXL.cache D2H Response comprising Opcode(RspVFwdV) and UQID(t.1.1), and a CXL.cache D2H Data comprising UQID(t.1.1) and Data(*Data.1*). The computer translates the D2H messages to an NVLink Response comprising Tag/TransactionID(c.4.1) and *Data.1*, and sends the NVLink Response to Entity.1. RspVFwdV indicates that the data is returned without changing cache state at Entity.2.

FIG. 5C illustrates an example of a TFD demonstrating translation of an NVLink read request to a CXL.cache H2D request comprising SnpData. Entity.1 sends an NVLink Read Request comprising Address(AS.3.1) and Tag/TransactionID(c.3.1) to the computer. The computer translates the NVLink Read Request to a CXL.cache H2D request comprising Opcode(SnpData), UQID(t.2.1), and Address(AS.2.1), and sends the H2D request to Entity.2. Entity.2 returns a CXL.cache D2H Resp comprising Opcode(RspSFwdM) and UQID(t.2.1), and a CXL.cache D2H Data comprising UQID(t.2.1) and Data(*Data.2*). The computer translates the D2H messages to an NVLink Response comprising Tag/TransactionID(c.3.1) and *Data.2*, and sends the NVLink Response to Entity.1. RspSFwdM indicates that the cacheline was in Modified state at Entity.2 and has been downgraded to Shared state, with the data forwarded.

In various implementations, an apparatus comprising: processing cores coupled via a coherent interconnect to memory controllers, wherein the coherent interconnect is based on Coherent Hub Interface (CHI) protocol (CHI-based protocol), and the memory controllers are coupled to memory channels capable of supporting memory having a capacity of at least 64 GB; interconnect gateway coupled to the coherent interconnect, or a Fully Coherent Request Node (RN-F) comprising a hardware-coherent cache and a Fully Coherent Home Node (HN-F) comprising a Point of Coherence (PoC) coupled to the coherent interconnect; an NVLink Chip-to-Chip (NVLink-C2C) interface configured to communicate according to NVLink-C2C coherent protocol with an entity external to the apparatus; and an NVLink-C2C to CHI adapter configured to translate between messages conforming to the NVLink-C2C coherent protocol and messages conforming to the CHI-based protocol, wherein the adapter couples the NVLink-C2C interface to the CCGs or the RN-F and HN-F to enable bidirectional coherent memory access between the entity and the processing cores. The following are two examples according to which the apparatus enables full cache-coherent communication between entities using NVLink-C2C protocol and the CHI-based system. In the first example, RN-F and HN-F nodes provide coherent connectivity, wherein the RN-F node may generate transactions defined by the CHI-based protocol and support snoop transactions, while the HN-F node manages coherency by snooping required RN-F nodes and serving as both the Point of Coherence and Point of Serialization. In the second example, CCGs provide integrated coherent gateway functionality that internally implements RN-F and HN-F capabilities. The adapter may perform coherency-preserving translations that enable the external entity to read from the apparatus's DRAM through the coherent request path while the processing cores may read from the entity's memory through the coherent home path, maintaining full cache coherency across both directions of communication.

In some implementations of the apparatus, the entity comprises a graphics processing unit (GPU), and wherein: the GPU accesses dynamic random-access memory (DRAM) coupled to the memory channels through the NVLink-C2C interface, the adapter, and the coherent interconnect; and the processing cores access memory attached to the GPU through the coherent interconnect, the adapter, and the NVLink-C2C interface. The bidirectional coherent access may enable the GPU to read from the processor's DRAM while maintaining cache coherency utilizing the coherent request functionality, and simultaneously allows the processor cores to access GPU-attached memory such as High Bandwidth Memory (HBM) or High-Bandwidth Flash (HBF) through the coherent home functionality, creating a coherent memory space across heterogeneous processing elements.

In some implementations of the apparatus, the NVLink-C2C interface comprises an NVLink Fusion chiplet coupled to the adapter via a physical layer (PHY), wherein the PHY is a UCIe PHY configured for chiplet-to-chiplet communication. The NVLink Fusion chiplet may provide a modular other implementation of NVLink-C2C protocol processing, with the UCIe PHY offering a standardized chiplet interconnect that enables integration of NVLink-C2C coherent capabilities into processors that may not have native NVLink support.

In some implementations of the apparatus, the adapter comprises a CHI C2C die-to-die adapter with UCIe streaming, configured to bridge between the UCIe PHY domain and the CHI-based domain while maintaining coherency. The ARM CHI C2C die-to-die adapter may implement streaming optimizations for UCIe transfers while performing the applicable translations between NVLink-C2C and CHI, managing credit flow, transaction ordering, and coherency state transitions required for maintaining cache coherency across the die boundary.

In some implementations of the apparatus, the apparatus comprises the RN-F and HN-F coupled to the coherent interconnect, and the adapter couples the NVLink-C2C interface to the RN-F and HN-F; and wherein the apparatus further comprises additional CCGs coupled to the coherent interconnect, and a Compute Express Link (CXL) device coupled to the additional CCGs, configured to communicate with a second entity based on a CXL protocol, wherein the CXL device and the NVLink-C2C interface share access to the memory channels through their respective coherent nodes. Optionally, this configuration provides dedicated coherent paths for different protocols, with the NVLink-C2C interface utilizing discrete RN-F and HN-F nodes while the CXL device utilizes CCGs that internally implement their own coherent functionality, enabling optimizations of protocol paths while sharing access to memory resources.

In some implementations of the apparatus, the CXL device is configured to route CXL.mem and/or CXL.cache transactions through the additional CCGs via a CXS interface; the apparatus further comprises an I/O-coherent Request Node with Distributed Virtual Memory support (RN-D) coupled to the coherent interconnect; and the CXL device is further configured to route CXL.io transactions through the RN-D via an AXI interface. The separation of CXL protocol types may leverage the additional CCGs'coherency management capabilities for CXL.mem and/or CXL.cache transactions while utilizing the simpler RN-D path for CXL.io transactions, with the CXS interface providing an optimized bridge protocol for coherent transactions and the AXI interface handling I/O transactions similar to PCIe.

In some implementations of the apparatus, the CXL device comprises a Global Fabric-Attached Memory (G-FAM) Device (GFD) configured to support only CXL.mem transactions through the additional CCGs. The GFD may allow the CXL transactions to be processed through the coherent path provided by the additional CCGs, which is suitable for memory pooling applications wherein I/O functionality is not required.

In some implementations of the apparatus, the second entity communicates with the CXL device via a physical layer based on IEEE 802.3 physical medium attachment (PMA) coupled to a resource provisioning unit (RPU) that includes the CXL device. The physical layer based on IEEE 802.3 PMA may enable the CXL device to receive CXL protocol messages encapsulated within a carrier protocol, extending the reach of CXL communications beyond traditional PCIe-based physical layers while the NVLink-C2C interface provides high-bandwidth coherent connectivity for tightly-coupled accelerators.

In some implementations of the apparatus, the apparatus comprises the CCGs coupled to the coherent interconnect, and the adapter couples the NVLink-C2C interface to the CCGs; and wherein the apparatus further comprises a Compute Express Link (CXL) device coupled to additional CCGs, wherein the additional CCGs provide shared coherent infrastructure for both the NVLink-C2C interface and the CXL device. Optionally, this configuration leverages the CCGs as unified coherent gateways that handle both NVLink-C2C and CXL protocols, with the CCGs internally implementing the coherent request and home functionality required for coherent transactions, potentially simplifying the system architecture by consolidating coherent protocol handling within shared CCG blocks.

In some implementations of the apparatus, the processing cores are part of a custom CPU comprising an integrated NVLink-C2C interface; and wherein the entity comprises an NVIDIA Blackwell GPU, an accelerator processing unit, or a second custom CPU with an NVLink-C2C interface. The custom CPU design may incorporate native NVLink-C2C support to enable direct coherent communication with NVIDIA GPUs or other NVLink-C2C capable devices, eliminating the need for protocol bridges in GPU-accelerated computing systems while maintaining full cache coherency between the CPU and accelerator domains.

In some implementations of the apparatus, the interconnect gateway comprises at least one of Coherent Multichip Link (CML) or Cache Coherent Interconnect for Accelerators (CCIX) Gateway (CXG) that utilizes a streaming interface protocol; and wherein the gateway is configured to utilize a 32-bit cyclic-redundancy check (CRC-32) to protect transactions conforming to the streaming interface protocol.

In various implementations, a system comprising: a processor comprising processing cores coupled via a coherent interconnect to memory controllers, wherein the coherent interconnect is based on Coherent Hub Interface (CHI) protocol (CHI-based protocol), and the memory controllers are coupled to memory channels coupled to memory having a capacity of at least 64 GB; a first graphics processing unit (GPU) coupled to the coherent interconnect via a first interface path comprising a first NVLink interface and a first adapter; a second GPU coupled to the coherent interconnect via a second interface path comprising a second NVLink interface and a second adapter; and wherein the first adapter and the second adapter are configured to translate between messages conforming to NVLink-based protocol and messages conforming to the CHI-based protocol, enabling the first GPU and the second GPU to communicate with each other through the coherent interconnect while the first and second GPUs have access to the memory via the coherent interconnect. The system may enable GPU-to-GPU communication through the processor's coherent interconnect rather than through direct GPU-to-GPU links or NVSwitch, providing a flexible communication architecture wherein GPUs may exchange data while sharing access to the processor's memory resources. The adapters translate between the NVLink domains and the CHI domain, managing differences in transaction formats, flow control, and addressing. The coherent interconnect serves as a common communication fabric that routes transactions between the GPUs while also handling memory access requests from the GPUs and the processor cores, potentially enabling new computational models wherein GPUs collaborate utilizing shared memory spaces managed by the processor.

Optionally, this implementation may route GPU-to-GPU communications through a processor's coherent interconnect, potentially offering several technical advantages, such as leveraging existing processor interconnect infrastructure without requiring additional dedicated GPU switching hardware, enabling GPUs to communicate while simultaneously accessing processor-attached memory through the same interconnect, and/or allowing heterogeneous accelerators using different protocols to participate in the same communication fabric. This implementation may also facilitate integration scenarios wherein the number or configuration of GPUs is not known at processor design time, as the coherent interconnect may dynamically route communications between whatever GPUs are coupled. Furthermore, by translating GPU protocols to the processor's native coherent protocol, the system may apply the processor's existing quality-of-service, security, and routing mechanisms to GPU traffic, potentially simplifying system-level traffic management. The translations performed by the adapters may enable memory architectures wherein GPUs, CPUs, and other accelerators share common view(s) of memory resources.

In some implementations of the system, the first NVLink interface and the second NVLink interface are NVLink interfaces configured for I/O-coherent communication; the first adapter couples the first NVLink interface to an I/O-coherent Request Node with Distributed Virtual Memory support (RN-D) and a I/O-coherent Home Node (HN-I); and wherein the second adapter couples the second NVLink interface to a second RN-D and a second HN-I. The I/O-coherent NVLink configuration may utilize I/O-Coherent nodes that do not maintain hardware cache coherency, suitable for GPU workloads that manage their own memory consistency, with the RN-D nodes handling DVM transactions and the HN-I nodes managing IO ordering for GPU-initiated operations.

In some implementations of the system, the first NVLink interface and the second NVLink interface are NVLink-C2C interfaces configured for coherent communication; the first adapter couples the first NVLink-C2C interface to a Fully Coherent Request Node (RN-F) and a Fully Coherent Home Node (HN-F); and the second adapter couples the second NVLink-C2C interface to a second RN-F and a second HN-F, enabling cache-coherent GPU-to-GPU communication through the coherent interconnect. The coherent NVLink-C2C configuration may enable the GPUs to participate in the processor's cache coherency protocol, with the RN-F nodes supporting snoop transactions and the HN-F nodes managing coherency as Points of Coherence, allowing GPUs to maintain cache-coherent views of shared data structures during communication.

In some implementations of the system, the first interface path further comprises a first NVLink Fusion chiplet coupled to the first adapter via a first physical layer (PHY); the second interface path further comprises a second NVLink Fusion chiplet coupled to the second adapter via a second PHY; and the first and second PHYs are selected from a UCIe PHY, an NVLink-C2C PHY, or a custom PHY. The NVLink Fusion chiplets may provide modular NVLink-based protocol processing capabilities that can be integrated into systems without native NVLink support, with the PHY selection enabling different physical layer implementations based on packaging technology and bandwidth requirements.

In some implementations, the system further comprises a third accelerator coupled to the coherent interconnect via a third interface path; wherein the third accelerator is selected from a custom accelerator, an xPU, or a third GPU; and wherein the third interface path comprises a Compute Express Link (CXL) device coupled to CXL/CCIX Gateways (CCGs), enabling the third accelerator to communicate with the first GPU and the second GPU through the coherent interconnect. This mixed configuration demonstrates the flexibility of the coherent interconnect to support heterogeneous accelerators using different protocols, with CXL-attached accelerators communicating with NVLink-attached GPUs based on appropriate translations at their respective adapter/gateway interfaces.

In some implementations of the system, the first GPU reads data from the memory through the first adapter and the coherent interconnect while the second GPU reads the same data from the memory; and the first GPU writes results to the memory that are subsequently read by the second GPU, implementing a producer-consumer pattern utilizing the processor's memory. The shared memory access patterns may enable collaborative computing models wherein GPUs coordinate utilizing processor memory rather than utilizing direct GPU memory transfers, potentially simplifying programming models and enabling dynamic work distribution among GPUs.

In some implementations of the system, the first adapter comprises a CHI C2C die-to-die adapter configured to translate between the first NVLink Fusion chiplet's domain and the CHI-based domain; and the second adapter comprises a second CHI C2C die-to-die adapter configured to translate between the second NVLink Fusion chiplet's domain and the CHI-based domain. The ARM CHI C2C die-to-die adapters may provide the translations while managing inter-die communication requirements including credit flow, transaction ordering, and optional support for UCIe streaming when coupled with UCIe PHYs.

In some implementations of the system, the first GPU is an NVIDIA Blackwell GPU with High Bandwidth Memory (HBM); the second GPU is a different GPU architecture; and the coherent interconnect enables the asymmetric GPUs to exchange data despite differences in their native memory architectures and protocol implementations. The support for asymmetric GPU configurations may enable systems to combine GPUs with different capabilities, memory hierarchies, or vendor implementations, with the coherent interconnect and adapters abstracting protocol differences to enable interoperability.

In some implementations of the system, the first adapter translates GPU physical addresses within a first GPU physical address space to CHI physical addresses within the coherent interconnect's physical address space; the second adapter translates GPU physical addresses within a second GPU physical address space to CHI physical addresses; and the processor maintains address mappings that enable the first GPU to access memory regions allocated to the second GPU through the coherent interconnect. The multi-level address translation may enable the GPUs to maintain their own physical address spaces while the processor's coherent interconnect provides a unified addressing scheme for routing transactions, with the processor potentially implementing memory protection and isolation between GPU physical address spaces.

In some implementations, the system further comprises additional GPUs coupled to the coherent interconnect via additional interface paths, the additional interface paths comprise NVLink interfaces and adapters; wherein the GPUs communicate with each other through the coherent interconnect in a fully-connected logical topology without requiring a dedicated GPU switch. The scalable architecture may support arbitrary numbers of GPUs limited by the coherent interconnect's capacity rather than by the dedicated GPU switching hardware, with the GPUs able to communicate with each other through the processor's routing infrastructure.

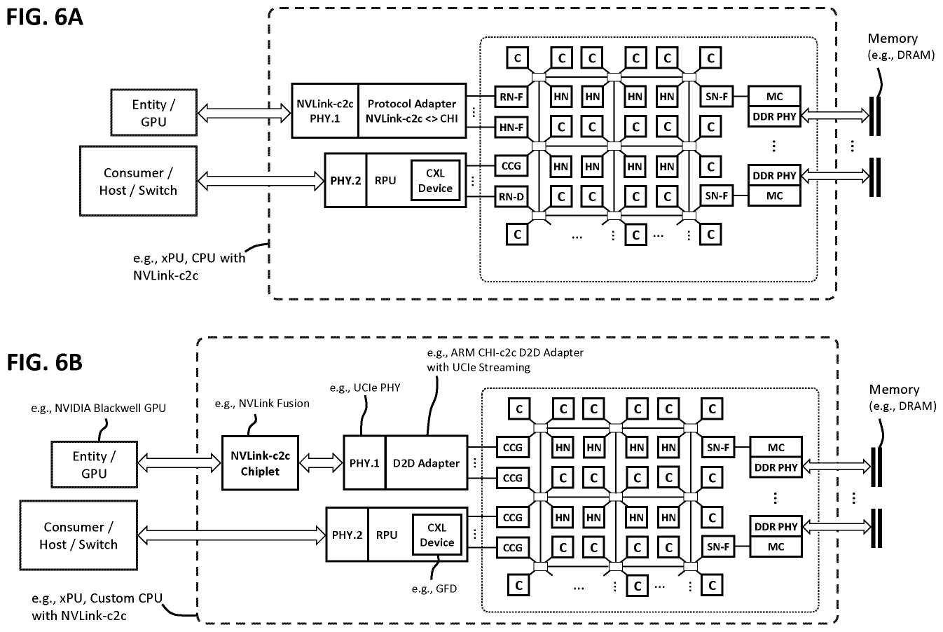

FIG. 6A illustrates an example of a system comprising a processor incorporating protocol interfaces integrating an RPU with a CXL device. The RPU includes or is coupled to a CXL device that is coupled to both (i) a CCG node for handling coherent CXL.mem and/or CXL.cache transactions, and (ii) an RN-D node for handling non-coherent CXL.io transactions. The system may couple the RPU to the CCG over a CXS interface, providing a path for coherent communications. The connection of NVLink-C2C interfaces to fully coherent request nodes (RN-F) and fully coherent home nodes (HN-F) may be included within a gateway node structure, enabling bidirectional coherent access wherein a GPU may read from the processor's DRAM through the RN-F node and the processor cores may read from the GPU's HBM through the HN-F node.

FIG. 6B illustrates an example of a system including a CPU, which may be a custom CPU design, incorporating NVLink-C2C capabilities and optionally including an NVLink-C2C chiplet, such as NVLink Fusion. The system integrates a Global Fabric-Attached Memory (G-FAM) Device (GFD) that operates as a specialized CXL device. The GFD may support only CXL.mem transactions, allowing it to service external requests through CCG nodes that are optimized for handling CXL.mem traffic, thereby simplifying the design by eliminating the need for separate CXL.io handling paths typically managed by RN-D or RN-I nodes.

In computing environments where a host, such as a CPU, accesses memory resources on a device, such as an accelerator, the device may expose memory regions to the host via CXL. Different memory regions may have different coherency requirements and may be backed by different types of memory. For example, a first memory region may be backed by local memory coupled to the device, such as HBM and/or High-Bandwidth Flash (HBF), and may benefit from device coherency where the device participates in cache coherency with the host. A second memory region may be backed by memory accessible via a UALink network, such as memory residing on remote accelerators, and may not require device coherency participation. The CXL specification defines different HDM types and device type flows that correspond to different coherency models, and a device may expose concurrent HDM regions utilizing different device type flows. An RPU or translation logic within the device may translate between CXL protocol messages received from the host and UPLI messages for accessing memory in the UALink domain, while maintaining the appropriate coherency semantics for each memory region.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an Ultra Accelerator Link (UALink)-based protocol; and translating, by the device, between a protocol based on CXL and UALink Protocol Level Interface (UPLI) for at least one of the first memory region or the second memory region. The method may be implemented in hardware, firmware, software, or combinations thereof, and may be performed by various types of devices, such as an accelerator, an RPU, a semiconductor device, or a chiplet within an IC package. The first and second CXL device type flows may correspond to any combination of CXL Type-2 and Type-3 device flows, and may further include CXL Type-1 device flows in some examples. The device may expose additional memory regions beyond the first and second memory regions, each utilizing different or the same CXL device type flows. Translations between the protocol based on CXL and UPLI may include translations of opcodes, addresses, Tags, and additional fields, and may further include address translations between different address spaces such as a Host Physical Address (HPA) space and a Network Physical Address (NPA) space. The first memory may include memory coupled to the device, such as HBM, HBF, DRAM, or GDDR, while the second memory may include memory accessible via a UALink switch, a UALink network, or remote accelerators within a UALink domain. The elements may communicate through one or more intermediary components, such as a switch, a retimer, or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to utilize both CXL.mem and CXL.cache protocols for the HDM-D region, allowing the device to maintain cached copies of data and participate in coherency negotiations with the host. The CXL Type-3 device flow may utilize CXL.mem without CXL.cache for the HDM-H region, where the host manages coherency without device cache participation.

In some implementations, the method further comprises receiving, from the host, a CXL.mem Master-to-Subordinate (M2S) request comprising MemRd* and an address targeting the first memory region, wherein the CXL.mem M2S request further comprises a SnpType field, a MetaField field, and a MetaValue field; translating the CXL.mem M2S request to a UPLI request; receiving a UPLI response comprising data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. The SnpType, MetaField, and MetaValue fields in the CXL.mem M2S request may indicate the cacheline state intent of the host, such as requesting a shared copy (SnpData) or an exclusive copy (SnpInv). The device may utilize these fields to determine the appropriate coherency response. The device coherency engine (DCOH) may select Cmp-S when the device retains a cached copy of the data, or Cmp-E when the device relinquishes its cached copy. The device may translate the CXL.mem M2S request to a UPLI request to fetch the data from the UALink domain before responding.

In some implementations of the method, the device comprises a cache; and wherein the device stores the data from the UPLI response in the cache and sends the CXL.mem S2M NDR comprising Cmp-S indicating that the device retains a cached copy of the cacheline at the address. By caching the fetched data and responding with Cmp-S, the device may enable subsequent accesses to the same cacheline to be served from its local cache without requiring another UPLI transaction. A device with cache, or a device that controls or utilizes a cache, may include a cache memory, a cache controller, or cache allocation and eviction logic.

In some implementations of the method, the UPLI request comprises a ReqSrcPhysAccID field, a ReqDstPhysAccID field, a ReqTag field, a ReqAddr field, and a ReqCmd field comprising a read command; and further comprising translating a Tag of the CXL.mem M2S request to the ReqTag of the UPLI request. The ReqSrcPhysAccID and ReqDstPhysAccID fields may carry identifiers utilized by the UALink network for routing the UPLI request. The Tag translation may involve maintaining a bidirectional mapping between CXL.mem Tag values and UPLI ReqTag values, enabling proper correlation of UPLI responses with their corresponding CXL.mem requests.

In some implementations, the method further comprises receiving, from the host, a CXL.mem Master-to-Subordinate (M2S) request comprising MemRd* and an address targeting the second memory region; translating the CXL.mem M2S request to a UPLI request; receiving a UPLI response comprising data; and sending to the host a CXL.mem Subordinate-to-Master Data Response (S2M DRS) comprising MemData and the data. For the second memory region, the device may operate as a passthrough translator that fetches data from the UALink domain and returns it to the host without maintaining cached copies or participating in coherency negotiations. The CXL.mem S2M DRS may carry MemData without an accompanying S2M NDR indicating Cmp-S or Cmp-E, because the device does not track cache state for this memory region.

In some implementations of the method, the UPLI response further comprises a RdRspDataError field indicating a data error; and further comprising translating the RdRspDataError field to a Poison field of the CXL.mem S2M DRS sent to the host. The RdRspDataError field in the UPLI response may serve as a per-beat data poison indicator. The translation of error indications across protocol boundaries may enable the host to detect data corruption that originated in the UALink domain and to take appropriate recovery actions.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region. RdOwn may acquire exclusive ownership, RdShared may acquire a shared copy, RdCurr may request a non-cacheable current value, and RdAny may accept any coherency state.

In some implementations of the method, the first memory comprises at least one of High Bandwidth Memory (HBM) or High-Bandwidth Flash (HBF) coupled to the device, the second memory comprises memory accessible via a UALink switch or a UALink network, and the device comprises an accelerator. The accelerator may be a GPU, a TPU, or other processing unit with HBM and/or HBF that may benefit from device coherency for its local memory. The UALink switch or fabric may couple the accelerator to remote accelerators, and the second memory may reside on the remote accelerators or on other memory resources within the UALink domain.

In some implementations, the method further comprises translating, by the device, between a first address associated with a first address space utilized by the host and a second address associated with a second address space utilized by the UALink-based protocol; wherein the first address space comprises a Host Physical Address (HPA) space, and the second address space comprises a Network Physical Address (NPA) space or a System Physical Address (SPA) space. The address translation may be implemented utilizing lookup tables, page tables, base-and-offset calculations, or programmable translation functions. The HPA space may represent the host's view of the memory, while the NPA or SPA space may represent the address used by the UALink network for routing and accessing memory resources.

In some implementations of the method, at least one of the first memory region or the second memory region comprises a Host-managed Device Memory with Back-Invalidate (HDM-DB) region; and wherein the device sends a CXL.mem Subordinate-to-Master Back-Invalidate Snoop (S2M BISnp) to the host, and the host responds with a CXL.mem Master-to-Subordinate Back-Invalidate Response (M2S BIRsp). The HDM-DB region may enable the device to snoop the host's cache when the device needs to modify or evict cached data. The S2M BISnp may carry opcodes such as BISnpInv, BISnpData, or BISnpCur, and the M2S BIRsp may carry opcodes such as BIRspI, BIRspS, or BIRspE indicating the resulting host cache state. HDM-DB may be utilized with either CXL Type-2 or CXL Type-3 device flows.

In some implementations, the method further comprises receiving, from the host, a CXL.mem Master-to-Subordinate Request with Data (M2S RwD) comprising MemWr* and write data; translating the CXL.mem M2S RwD to a UPLI request comprising a write command and the write data; and sending a CXL.mem Subordinate-to-Master No Data Response (S2M NDR) to the host. The write command in the UPLI request may include Write or WriteFull commands. The device may send the S2M NDR before or after the UPLI write completes, depending on ordering requirements and system configuration.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

In computing systems where a host accesses memory resources on a device coupled via CXL, the device may expose memory regions with different coherency characteristics to the host. A first memory region associated with local memory, such as HBM, may be exposed via a CXL device type flow that supports device coherency, enabling the host and device to maintain coherent cached copies of data. A second memory region associated with memory accessible via a UALink port may be exposed via a different CXL device type flow that does not require device coherency participation. The device may include an RPU or translation logic configured to translate between CXL protocol messages and UPLI messages for memory access operations targeting the UALink-accessible memory. A UALink switch may couple the device to one or more remote accelerators whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an Ultra Accelerator Link (UALink) port of the device; and wherein the device is configured to translate between a protocol based on CXL and UALink Protocol Level Interface (UPLI) for requests targeting at least one of the first memory region or the second memory region. The system may enable a host to access both local and remote memory resources on the device through a CXL link, with differentiated coherency semantics for different memory regions. The device may include an RPU, translation logic, or a combination of hardware and firmware that performs the translations between CXL and UPLI. The device may configure the boundaries between the first and second memory regions dynamically or statically, for example utilizing HDM decoder registers or programmable address range registers.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region. In some examples, the assignment of HDM types to memory regions may be configurable at system initialization or runtime.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to UPLI requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state of the cacheline at the device. For the second memory region, the device may translate the request to UPLI, fetch the data from the UALink domain, and return the data.

In some implementations of the system, the host communicates with the device via CXL.mem and CXL.cache for the first memory region, and the host communicates with the device via CXL.mem without CXL.cache for the second memory region. The use of CXL.cache for the first memory region may enable the device to initiate coherency transactions and respond to host snoops, supporting scenarios where the device and host may both cache data from the first memory region. The absence of CXL.cache for the second memory region may simplify the memory access path for remote memory.

In some implementations of the system, the device comprises an accelerator comprising a resource provisioning unit (RPU), and the first memory comprises at least one of High Bandwidth Memory (HBM) or High-Bandwidth Flash (HBF) coupled to the accelerator; and further comprising a UALink switch coupling the UALink port of the device to one or more remote accelerators, wherein the second memory is accessible via the UALink switch. The RPU may be implemented as an IP block embedded within the accelerator, or as a chiplet within an IC package containing the accelerator. The UALink switch may route UPLI traffic based on destination accelerator identifiers carried in the UPLI requests. The one or more remote accelerators may each have their own HBM, HBF, or other memory that collectively forms the second memory accessible from the device.

In computing environments where a host, such as a CPU, accesses memory resources on a device coupled via CXL, the device may expose memory regions to the host with different connectivity. A first memory region may be backed by local memory coupled to the device, while a second memory region may be backed by memory accessible via an NVLink fabric, such as memory residing on GPUs or other NVLink-connected devices. NVLink provides high-bandwidth communication between GPUs and accelerators, and may support distributed memory models where devices access memory via other devices. The device may translate between CXL protocol messages received from the host and NVLink messages for accessing memory in the NVLink domain, while exposing different CXL device type flows for different memory regions to provide appropriate coherency semantics. NVLink messages may carry fields such as source and destination identifiers for routing, addresses for memory location, transaction tags for response correlation, length fields for transfer size, and data payloads.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an NVLink-based protocol; and translating, by the device, between a protocol based on CXL and the NVLink-based protocol for at least one of the first memory region or the second memory region. The method may be implemented in hardware, firmware, software, or combinations thereof, and may be performed by various types of devices, such as an accelerator, an RPU, a semiconductor device, an active cable, or a chiplet within an IC package. The first and second CXL device type flows may correspond to any combination of CXL Type-2 and Type-3 device flows. Translations between CXL and NVLink may include translations of opcodes, addresses, transaction identifiers, and additional fields. NVLink messages may carry functional fields corresponding to source identifiers, destination identifiers, addresses, transaction tags, transfer lengths, and data payloads; the specific field names may vary across NVLink versions or implementations, and the translation may accommodate such variations. The first memory may include memory coupled to the device, such as HBM and/or HBF, while the second memory may include memory accessible via GPUs or other NVLink-connected devices. The device may be positioned in an active cable, in a module coupled to a CXL port, or within a computing platform, and may provide a bridge between the CXL domain and the NVLink domain. The elements may communicate through one or more intermediary components, such as an NVLink switch or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to maintain cached copies of data from the first memory and to participate in coherency negotiations with the host via CXL.cache. The CXL Type-3 device flow for the HDM-H region may enable simpler passthrough access to NVLink-accessible memory without device coherency overhead.

In some implementations, the method further comprises receiving, from the host, a CXL.mem Master-to-Subordinate (M2S) request comprising MemRd* and a first address targeting the second memory region; translating the CXL.mem M2S request to an NVLink read request comprising a SourceID, a DestinationID, a second address, a Tag, and a Length; receiving an NVLink read response comprising *Data*; and sending to the host a CXL.mem Subordinate-to-Master Data Response (S2M DRS) comprising MemData and data from the NVLink read response. The SourceID may identify the device or RPU that originated the NVLink read request, while the DestinationID may identify the target entity, such as a GPU, in the NVLink fabric. The second address may be an NVLink network address that may be utilized to route the NVLink read request to its destination, and may go through additional address translation phases facilitated by one or more Link TLBs in the NVLink domain. The Tag may be a transaction identifier maintained by the device for correlating the NVLink read response with the original CXL.mem M2S request. The Length may indicate the requested transfer size. The *Data* in the NVLink read response may represent data carried in one or more response packets. Different NVLink versions or implementations may use different naming conventions for these functional fields; for example, a source identifier may alternatively be referred to as a requester identifier, a source node identifier, or a similar designation, and a destination identifier may alternatively be referred to as a target identifier, a destination node identifier, or a similar designation.

In some implementations, the method further comprises receiving, from the host, a CXL.mem Master-to-Subordinate (M2S) request comprising MemRd* and an address targeting the first memory region; accessing the first memory to obtain data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. For the first memory region, the device may access local memory, such as HBM and/or HBF, without performing protocol translation to NVLink. The device may respond with Cmp-S or Cmp-E based on the device's caching policy and the host's requested coherency state as indicated by SnpType and MetaValue fields in the M2S request.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region, such as when the device needs to read or modify data that the host may have cached.

In some implementations, the method further comprises translating, by the device, between a first address associated with a Host Physical Address (HPA) space utilized by the host and a second address associated with an NVLink network address space utilized by the NVLink-based protocol. The address translation may be implemented utilizing lookup tables, page tables, base-and-offset calculations, or programmable translation functions. The NVLink network address may be utilized to route NVLink transactions to specific GPUs or memory resources within the NVLink fabric.

In some implementations of the method, a non-transitory computer-readable medium comprising instructions which, when executed by a processor, cause the processor to perform the method.

In computing systems where a host accesses memory resources on a device coupled via CXL, the device may expose memory regions with different connectivity and coherency models. A first memory region may be backed by local memory coupled to the device, and may be exposed via a CXL device type flow that supports device coherency. A second memory region may be backed by memory accessible via an NVLink port, such as memory residing on GPUs or other NVLink-connected devices, and may be exposed via a different CXL device type flow. The device may include an RPU or translation logic configured to translate between CXL protocol messages and NVLink messages for memory access operations targeting the NVLink-accessible memory. An NVLink switch, such as NVSwitch, may couple the device to one or more GPUs whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an NVLink port of the device; and wherein the device is configured to translate between a protocol based on CXL and an NVLink-based protocol for requests targeting at least one of the first memory region or the second memory region. The system may enable a host to access both local and NVLink-domain memory resources on the device through a CXL link, with differentiated coherency semantics for different memory regions. The device may include an RPU, translation logic, or a combination of hardware and firmware that translate between CXL and the NVLink-based protocol. The device may be an accelerator, an RPU, a bridge device, or a component within an active cable positioned between the CXL domain and the NVLink domain. The device may configure the boundaries between the first and second memory regions dynamically or statically, for example utilizing HDM decoder registers or programmable address range registers. The system may be deployed in datacenter environments where CXL-enabled CPUs participate with NVLink GPUs in inference or training of AI models.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to NVLink read requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state maintained by the device. For the second memory region, the device may translate the request to an NVLink read request, receive data from the NVLink domain, and return the data to the host.

In some implementations of the system, the device comprises an accelerator or a resource provisioning unit (RPU), and the first memory comprises at least one of High Bandwidth Memory (HBM) or High-Bandwidth Flash (HBF) coupled to the device; and further comprising an NVLink switch coupling the NVLink port of the device to one or more GPUs, wherein the second memory is accessible via the NVLink switch. The NVLink switch may be an NVSwitch or similar switch device that provides high-bandwidth routing between the device and GPUs within an NVLink fabric. The one or more GPUs may each have their own HBM, HBF, or other memory that collectively forms the second memory accessible from the device via the NVLink port.

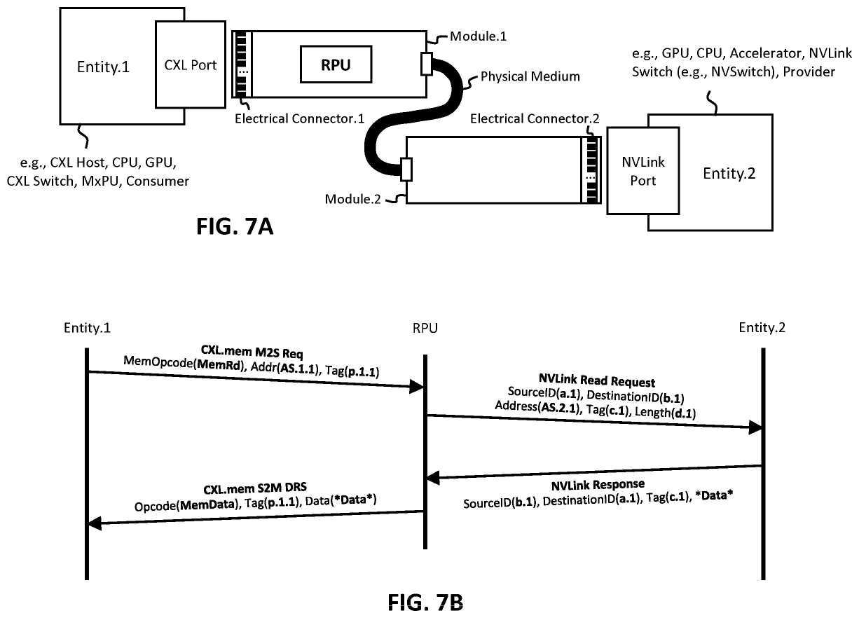

FIG. 7A illustrates an example of a system comprising an active cable that includes an RPU. The cable comprises a first pluggable module (Module.1) and a second pluggable module (Module.2) coupled by a Physical Medium. Module.1 includes the RPU and is coupled via a first electrical connector (Electrical Connector.1) to a CXL Port of a first entity (Entity.1). Module.2 is coupled via a second electrical connector (Electrical Connector.2) to an NVLink Port of a second entity (Entity.2). Entity.1 may be a CXL Host, CPU, GPU, CXL Switch, MxPU, or Consumer. Entity.2 may be a GPU, CPU, Accelerator, NVLink Switch (e.g., NVSwitch), or Provider. The RPU may be placed in various locations as a function of the requirements. In one example, the RPU is placed in Module.1 closer to the CXL Port of Entity.1, since CXL, which runs over PCIe electricals, is designed as a shorter-reach interface utilized for connecting devices to CPUs within a compute platform. Some versions of NVLink incorporate electrical signaling characteristics compatible with Ethernet and/or InfiniBand connectivity, designed for longer-reach interconnects that fit rack-level deployments and beyond. Placing the RPU closer to the CXL port may improve signal integrity. Additionally, NVLink typically utilizes a signaling rate higher than CXL, and consequently NVLink may require fewer lanes than CXL for the same bandwidth, which may allow for reducing the amount of copper wires or optical fibers in the Physical Medium.

FIG. 7B illustrates an example of a TFD demonstrating an RPU that translates between CXL.mem requests and NVLink requests. The TFD shows three entities: Entity.1/Consumer on the left, the RPU in the center, and Entity.2/Provider on the right. Entity.1 may send a CXL.mem M2S Req comprising MemOpcode(MemRd), Addr(AS.1.1), and Tag(p.1.1) to the RPU. Address (AS.1.1) may be an HPA of a Host, such as a CXL-enabled CPU coupled to the RPU. The RPU may translate the CXL.mem M2S Req to an NVLink Request Read comprising SourceID(a.1), DestinationID(b.1), Address(AS.2.1), Tag(c.1), and Length(d.1). Address (AS.2.1) may be an NVLink Network Address utilized to route the NVLink request to its destination on the NVLink fabric. In the response direction, Entity.2 may send an NVLink Response comprising SourceID(b.1), DestinationID(a.1), Tag(c.1), and *Data* to the RPU. The RPU may translate the NVLink Response to a CXL.mem S2M DRS comprising Opcode(MemData), Tag(p.1.1), and Data(*Data*), and may send the CXL.mem S2M DRS to Entity.1. The RPU may map the Tag from the NVLink response back to the original CXL.mem Tag (p.1.1) to enable proper transaction completion at Entity.1. In some examples, the NVLink Network Address may go through additional address translation phases, which may be facilitated by one or more Link TLBs residing on the transaction path. For example, in a GPU, a Link TLB may translate an NVLink Network Address to a GPU Physical Address that may reference memory resources integrated in or adjacent to the destination GPU. The RPU may perform another address translation to translate the HPA utilized by CXL.mem to the NVLink Network Address before the NVLink request is sent. Moreover, NVLink provides a distributed memory model where GPUs may access memory via other GPUs. This example provides a generic CXL.mem bridge/gateway for other, possibly non-NVLink compute elements, such as CPUs, to access memory residing on the NVLink Fabric, for example, where x86 GP-CPUs participate with NVLink GPUs in inference or training of AI models.

Heterogeneous computing architectures may incorporate hosts within computing systems, wherein these hosts may utilize different address spaces while requiring coordinated access to shared resources. In such multi-host environments, there may be scenarios where a first host operating with a first Host Physical Address (HPA) space needs to maintain cache coherency with a second host operating with a second HPA space, wherein both hosts communicate using CXL.cache. Translations between CXL.cache messages associated with different hosts may facilitate memory coherency operations, cacheline invalidations, and data transfers across different address spaces while maintaining the requirements of CXL.cache.

In various implementations, a method for translating between Compute Express Link (CXL) messages, comprising: receiving, from a first entity, a CXL.cache Host-to-Device (H2D) request; translating the CXL.cache H2D request to a CXL.cache Device-to-Host (D2H) request; and sending the CXL.cache D2H request to a second entity. The translation process may encompass various aspects of the protocol messages, including opcodes, addresses, and transaction identifiers, thereby enabling coherent communication between hosts that cannot communicate directly, such as due to protocol limitations or direction mismatches. The method may be implemented in hardware, firmware, software, or combinations thereof, and may be performed by various types of devices, such as semiconductor devices and/or RPUs.

In some implementations of the method, the first entity comprises a first host, and the CXL.cache H2D request comprises a first address belonging to a first Host Physical Address (HPA) space utilized by the first host; and wherein the second entity comprises a second host, and wherein the CXL.cache D2H request comprises a second address belonging to a second HPA space utilized by the second host. In some examples, the address translation may be implemented utilizing lookup tables, page tables, hash tables, base-and-offset calculations, and/or programmable translation functions. The first and second HPA spaces may have different sizes, different base addresses, or different memory layouts, and the translation may accommodate these differences while maintaining the meaning of the memory operations.

In some implementations of the method, the CXL.cache H2D request comprises snoop invalidate (SnpInv) and Unique Queue ID (UQID), and wherein the CXL.cache D2H request comprises CacheLine Flush (CLFlush) and command queue identifier (CQID). The translation from SnpInv to CLFlush may enable the first host to invalidate cachelines in the second host's cache hierarchy. The UQID from the H2D request may be mapped to the CQID in the D2H request, wherein this mapping may be maintained in a translation table, a tracker entry, or similar data structure.

In some implementations of the method, the CXL.cache H2D request comprises snoop invalidate (SnpInv) and Unique Queue ID (UQID), and the CXL.cache D2H request comprises command queue identifier (CQID) and Read for Ownership No Data (RdOwnNoData) or Read for Ownership (RdOwn). The translation from SnpInv to RdOwnNoData or to RdOwn may enable the first host to perform cross-orchestration of cacheline states between the cache coherency subsystems of the first host and the second host, by optionally invalidating a cacheline address in the cache hierarchy of the second host and marking the cacheline address in exclusive state, possibly preceding a write operation by the first host.

In some implementations, the method further comprises receiving from the second host a CXL.cache H2D Data, translating the CXL.cache H2D Data to a CXL.cache Device-to-Host (D2H) Data, and sending the CXL.cache D2H Data to the first host.

In some implementations of the method, the CXL.cache H2D request comprises SnpData and Unique Queue ID (UQID), and the CXL.cache D2H request comprises RdShared and command queue identifier (CQID). The translation from SnpData to RdShared may enable the first host to acquire a cacheline in shared state from the second host's cache hierarchy. RdShared may request the cacheline to be cached in shared state, which may permit both the first host and the second host to retain cached copies of the cacheline. The UQID from the H2D request may be mapped to the CQID in the D2H request, wherein this mapping may be maintained in a translation table or tracker entry.

In some implementations of the method, the CXL.cache H2D request comprises SnpData and Unique Queue ID (UQID), and the CXL.cache D2H request comprises RdOwn and command queue identifier (CQID). The translation from SnpData to RdOwn may enable the first host to acquire a cacheline in exclusive state, even though SnpData may indicate an intent to acquire shared or exclusive state. The translation logic may select RdOwn based on additional factors such as system configuration, anticipated access patterns, or optimization policies. RdOwn may cause the second host to relinquish ownership of the cacheline and provide cacheline data to the translation logic, which may forward the data to the first host.

In some implementations of the method, the CXL.cache H2D request comprises snoop invalidate (SnpInv) and Unique Queue ID (UQID), the CXL.cache D2H request comprises RdOwn and command queue identifier (CQID), and further comprising receiving from the second host a CXL.cache H2D Data message comprising cacheline data. The translation from SnpInv to RdOwn may enable the first host to acquire exclusive ownership of the cacheline while also receiving cacheline data from the second host. The second host may respond with a GO-M or GO-E indication along with the cacheline data, which may indicate that the second host previously held the cacheline in modified state, or provides the cacheline in exclusive state. The translation logic may translate the received H2D Data message to a D2H Data message for delivery to the first host, thereby completing the data transfer and cache state transition. In one example, the CXL.cache H2D request comprises an opcode selected from SnpData, or SnpCur; and wherein the CXL.cache D2H request comprises an opcode selected from RdCurr, RdOwn, RdShared, RdAny, RdOwnNoData, ItoMWr, WrCur, CleanEvict, DirtyEvict, CleanEvictNoData, WOWrInv, WOWrInvF, WrInv, or CacheFlushed. The translation logic may select appropriate D2H opcodes based on the specific H2D opcode received, preserving the intent of the original operation while adapting to the protocol requirements of the receiving host. For example, in some implementations the translation logic may translate an H2D request comprising SnpCur to a D2H request comprising RdCurr, and may further respond to the H2D request with a D2H response comprising RspSFwdM, RspIFwdM or RspVFwdV and with a D2H Data comprising data retrieved by the RdCurr D2H request. In other implementations, the translation logic may translate an H2D request comprising SnpData to a D2H request comprising RdShared; and may further respond to the H2D request with a D2H response comprising RspSFwdM and with a D2H Data comprising data retrieved by the RdShared D2H request.

In some implementations, the method further comprises receiving, from the second entity, a CXL.cache H2D Data message comprising cacheline data and command queue identifier (CQID); translating the CXL.cache H2D Data message to a CXL.cache D2H Data message comprising the cacheline data and Unique Queue ID (UQID); and sending the CXL.cache D2H Data message to the first entity. The translation of data messages may enable cacheline data to flow from the second host to the first host via the translation logic. The CQID in the H2D Data message may be translated to a corresponding UQID utilizing a previously stored mapping, enabling proper correlation with the originating request. The cacheline data may include 64 bytes or other cacheline sizes supported by CXL.cache, and may be forwarded without modification or may be subjected to additional processing such as address translation or data transformation.

In some implementations, the method further comprises receiving, from the second entity, a CXL.cache H2D response comprising a GO opcode and command queue identifier (CQID); translating the CXL.cache H2D response to a CXL.cache D2H response comprising Rsp* and Unique Queue ID (UQID); and sending the CXL.cache D2H response to the first entity. The GO response from the second host, such as GO-I, may be translated to Rsp*, such as RspIHitI, for the first host, indicating that the cacheline was not found in the device cache (i.e., the cacheline is in Invalid state). The translation may utilize the previously stored UQID-to-CQID mapping to correctly route the response back to the originating transaction.

In some implementations of the method, the CXL.cache H2D response comprises a GO opcode and a field indicating an Invalid state (GO-I), and wherein the CXL.cache D2H response comprises RspIHitI.

In some implementations, the method further comprises receiving, from the second entity, a CXL.cache H2D Data comprising command queue identifier (CQID); translating the CXL.cache H2D Data to a CXL.cache D2H response comprising *Fwd* and Unique Queue ID (UQID); and sending the CXL.cache D2H response to the first entity. The CXL.cache H2D Data from the second host may be translated to a CXL.cache D2H response comprising *Fwd*, such as RspSFwdM, RspIFwdM, or RspVFwdV, sent to the first host, indicating that a CXL.cache D2H response may be followed by a CXL.cache D2H Data, possibly enabling data transfer from the second host to the first host via the RPU.

In some implementations of the method, the CXL.cache D2H request comprises RdCurr and command queue identifier (CQID); and further comprising translating the CXL.cache H2D Data to a CXL.cache D2H response comprising RspVFwdV and Unique Queue ID (UQID).

In some implementations, the method further comprises receiving, from the second entity, a CXL.cache H2D response comprising a GO opcode and command queue identifier (CQID); translating the CXL.cache H2D response to a CXL.cache D2H Data comprising Unique Queue ID (UQID); and sending the CXL.cache D2H Data to the first entity. The CXL.cache H2D response from the second host may be translated to a CXL.cache D2H Data and sent to the first host, such as in error scenarios where synthesized data may be generated based on error responses from the second host.

In some implementations, the method further comprises exposing a CXL Type-1 device or a CXL Type-2 device to the first entity via a first interface, and exposing a CXL Type-1 device or a CXL Type-2 device to the second entity via a second interface. The device type exposure may determine the types of CXL.cache transactions that can be initiated and received by each interface. By exposing appropriate device types to each host, the translation may accommodate different system configurations and use cases. Similar or different device types may be exposed to different hosts simultaneously based on system configuration requirements.

In some implementations of the method, the translating comprises performing translations between the CXL.cache H2D request and the CXL.cache D2H request, wherein the translations comprise translations between Unique Queue ID (UQID) and command queue identifier (CQID), translations between reserved fields, and/or translations between reserved and non-reserved fields. UQIDs and CQIDs may serve as transaction identifiers in their respective protocol directions. Reserved fields in one protocol direction may be mapped to active fields in the other direction, potentially carrying additional metadata or control information.

In some implementations, the method further comprises receiving, from the second entity, a CXL.cache H2D response comprising a GO-S indication and command queue identifier (CQID); translating the CXL.cache H2D response to a CXL.cache D2H response comprising RspSHitSE and Unique Queue ID (UQID); and sending the CXL.cache D2H response to the first entity. The GO-S indication may signify that the second host is providing the cacheline in shared state, permitting concurrent caching by multiple entities. RspSHitSE may indicate to the first host that the cacheline was hit in a clean state and its current state is shared, enabling cacheline state orchestration wherein both the first host and the second host may store the cacheline in shared state. The translation may utilize a previously stored UQID-to-CQID mapping to correctly route the response back to the originating transaction.

In some implementations, the method further comprises receiving, from the second entity, a CXL.cache H2D response comprising a GO-E indication and command queue identifier (CQID); translating the CXL.cache H2D response to a CXL.cache D2H response comprising an opcode selected from RspIHitI, RspIHitSE, or RspIFwdM, and comprising Unique Queue ID (UQID); and sending the CXL.cache D2H response to the first entity. The GO-E indication may signify that the second host has granted exclusive ownership of the cacheline address. The translated D2H response opcode may indicate to the first host that the cacheline is no longer present in the cache abstraction exposed by the translation logic, enabling the first host to transition the cacheline state to exclusive. The selection among RspIHitI, RspIHitSE, or RspIFwdM may depend on the prior state of the cacheline and whether data forwarding is involved, and may enable proper cache coherency protocol completion at the first host.

In some implementations, the method further comprises receiving, from the second entity, a CXL.cache H2D response comprising a GO-M indication and command queue identifier (CQID), and a CXL.cache H2D Data message comprising cacheline data; translating the CXL.cache H2D response to a CXL.cache D2H response comprising RspIFwdM and Unique Queue ID (UQID); and sending the CXL.cache D2H response to the first entity. The GO-M indication may signify that the second host previously held the cacheline in modified state and is relinquishing ownership along with the modified data. RspIFwdM may indicate to the first host that the cacheline was found in modified state and is being forwarded, possibly enabling the first host to transition the cacheline state to modified. The modified cacheline data may be translated from the H2D Data message to a D2H Data message and forwarded to the first host, thereby completing the ownership transfer and data delivery.

In some implementations, the method further comprises exposing a cache abstraction to the first entity via a CXL.cache interface, wherein the cache abstraction acts as a proxy for a cache included in the second entity, and the CXL.cache H2D request targets the cache abstraction. The cache abstraction may appear to the first host as a device cache accessible utilizing CXL.cache transactions, while internally representing or proxying cache resources maintained by the second host. The first host may issue CXL.cache H2D requests, such as snoop requests, that target the cache abstraction, wherein the translation logic may translate these requests to CXL.cache D2H requests that affect actual caches in the second host. This proxy arrangement may enable cache coherency operations between hosts that cannot communicate directly, such as due to protocol direction constraints or address space differences.

In some implementations of the method, the translating enables cacheline state orchestration between a first cache maintained by the first entity and a second cache maintained by the second entity. The cacheline state orchestration may coordinate transitions between cache states, such as Modified, Exclusive, Shared, or Invalid (MESI) states, across the first and second caches maintained by the first and second entities, respectively, wherein a transition of the first cache to a first cache state (e.g., Exclusive) may be coordinated with a transition of the second cache to a second cache state (e.g., Invalid). The translation logic may enable the first entity to influence the cacheline state in the second entity's cache hierarchy by translating H2D requests into corresponding D2H requests that trigger appropriate cache state transitions at the second entity.

In some implementations of the method, the cacheline state orchestration comprises cross invalidation of cacheline states; and/or wherein the cacheline state orchestration enables cache-coherent memory sharing between the first entity and the second entity. Cross invalidation may enable the first host to cause invalidation of cacheline entries in the second host's cache hierarchy, or vice versa, thereby maintaining cache coherency across the multi-host system. The cacheline state orchestration may encompass transitions between various cache states such as Modified, Exclusive, Shared, or Invalid (MESI), or similar cache coherency protocols. The translation logic may track pending transactions and coordinate state transitions to maintain coherency invariants across both cache hierarchies. Additionally or alternatively, cache-coherent memory sharing may enable the first host and the second host to access shared memory regions while maintaining data consistency through the cache coherency protocol. The translation logic may facilitate coherent access by translating snoop operations, read requests, and writeback operations between the hosts, such that memory updates by one host are visible to the other host in accordance with the memory consistency model. Such cache-coherent memory sharing may be utilized in disaggregated memory systems, multi-GPU clusters, heterogeneous computing platforms, or other multi-host architectures.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: first and second interfaces based on Compute Express Link (CXL); a computer coupled to the first and second interfaces, wherein the computer is configured to: receive, from a first entity via the first interface, a CXL.cache Host-to-Device (H2D) request comprising a first address belonging to a first Host Physical Address (HPA) space; translate the CXL.cache H2D request to a CXL.cache Device-to-Host (D2H) request comprising a second address belonging to a second HPA space; and send the CXL.cache D2H request to a second entity via the second interface. The computer may include processing logic, memory for storing translation tables and transaction state, and interface controllers for managing CXL.cache communications with each host. The system may be implemented as a standalone device, integrated into a larger semiconductor component, or distributed across components within a computing platform. The translation capabilities may enable diverse system architectures such as disaggregated memory systems, multi-GPU clusters, or heterogeneous computing platforms. Additionally or alternatively, the computer may further expose a cache abstraction to the first entity via the first interface, wherein the cache abstraction acts as a proxy for a cache included in the second entity. The first host may enumerate and interact with the cache abstraction as a local device cache, while the computer internally translates cache operations to CXL.cache D2H requests directed to the second host. It may enable transparent cache coherency operations across hosts without requiring direct host-to-host communication or protocol-level awareness of the multi-host topology.

In some implementations of the system, the first entity comprises a first host utilizing the first HPA space, and the second entity comprises a second host utilizing the second HPA space; and wherein the computer is further configured to identify an intent indicated by the CXL.cache H2D request, wherein the intent comprises a cacheline state intent for a cacheline address, and wherein the translating is based at least in part on the identified intent. The computer may include logic circuits, processing elements, or firmware that analyze incoming CXL.cache H2D requests and determine the cacheline state intent from request attributes such as opcodes and address values. The identified intent may be utilized to select appropriate translation mappings, D2H request opcodes, and/or address translations. The computer may maintain intent-to-opcode mapping tables or may implement intent identification through combinational logic or state machines.

In various implementations, a system comprising: first and second interfaces based on Compute Express Link (CXL); a computer coupled to the first and second interfaces, wherein the computer is configured to: receive, from a first entity via the first interface, a CXL.cache Host-to-Device (H2D) request; translate the CXL.cache H2D request to a CXL.cache Device-to-Host (D2H) request; and send the CXL.cache D2H request to a second entity via the second interface; wherein the translation enables cacheline state orchestration between a first cache maintained by the first entity and a second cache maintained by the second entity. The system may be implemented as a standalone semiconductor device, integrated into a larger component such as an RPU, or distributed across components within a computing platform. The cacheline state orchestration may coordinate transitions between cache states across both entities, such as transition of the first cache to Exclusive state that is coordinated with transition of the second cache to an Invalid state, wherein translating the CXL.cache messages enables coherency operations that would otherwise be prevented by protocol constraints. The first and second interfaces may expose CXL Type-1 or CXL Type-2 device interfaces to the respective entities, enabling the entities to interact with the system utilizing CXL.cache transactions.

In some implementations of the system, the cacheline state orchestration comprises cross invalidation of cacheline states, and wherein the cacheline state orchestration enables cache-coherent memory sharing between the first entity and the second entity. Cross invalidation may enable the first entity to cause invalidation of cacheline entries in the second entity's cache hierarchy, or vice versa, which may enable the first cache to transition to an Exclusive state coordinated with a transition of the second cache to an Invalid state, thereby maintaining cache coherency across a multi-entity system. Cache-coherent memory sharing may enable the first entity and the second entity to access shared memory regions while maintaining data consistency through the cache coherency protocol. The computer may facilitate coherent access by translating snoop operations, read requests, and writeback operations between the entities, and may be utilized in disaggregated memory systems, multi-GPU clusters, heterogeneous computing platforms, or other multi-entity architectures.

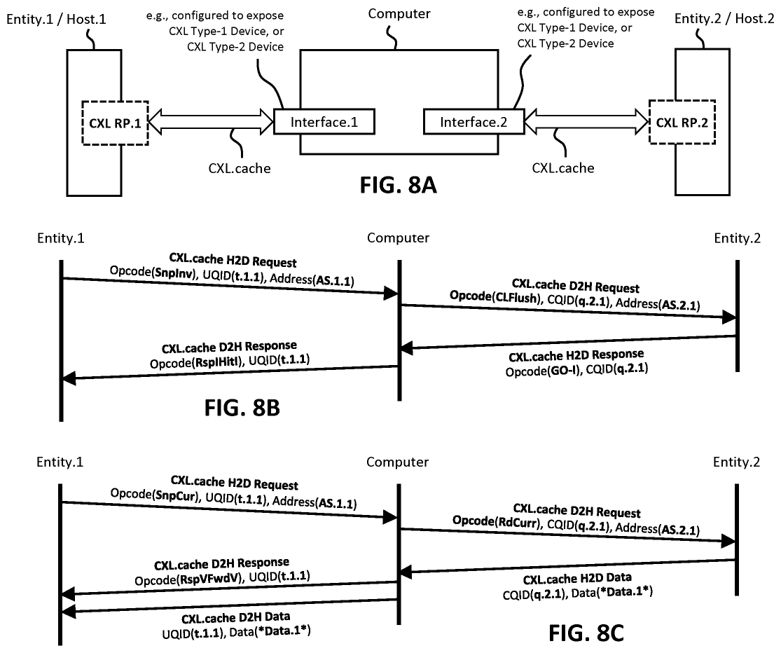

FIG. 8A illustrates an example of a system comprising a computer coupled between a first interface (Interface.1) and a second interface (Interface.2). The first interface may expose a CXL type-1 device or a CXL type-2 device, and may communicate according to a first CXL.cache with a first entity, such as a first host (Host.1), optionally via a first CXL root port (CXL RP.1) of the first entity. Similarly, the second interface may expose a CXL type-1 device or a CXL type-2 device, and may communicate according to a second CXL.cache with a second entity (Entity.2), such as a second host (Host.2), optionally via a second CXL root port (CXL RP.2) of the second entity. The computer may: extract physical addresses within messages received via the first interface, wherein these addresses may be from a first HPA space utilized by the first entity; translate these addresses; and generate messages carrying the translated physical addresses for transmission via the second interface; wherein these translated addresses may correspond to a second HPA space utilized by the second entity. Optionally, the interfaces may be implemented as internal and/or external interfaces of a semiconductor device comprising the computer.

FIG. 8B illustrates an example of a TFD demonstrating translations, performed by a computer, between first CXL.cache messages received from a first entity (Entity.1), such as a first host (Host.1), and second CXL.cache messages sent to a second entity (Entity.2), such as a second host (Host.2), possibly enabling the first entity to maintain, at least partly, memory sharing and/or memory coherency with the second entity, such as by enabling the first entity to invalidate cachelines in the second entity. The first entity may initiate a first CXL.cache transaction that includes a CXL.cache H2D request comprising Opcode(SnpInv), UQID(t.1.1), and Address(AS.1.1). The computer may translate the first CXL.cache transaction to a second CXL.cache transaction that includes a CXL.cache D2H request comprising Opcode(CLFlush), CQID(q.2.1), and Address(AS.2.1), and may send the CXL.cache D2H request to the second entity. Upon receiving a response from the second entity, which may include a CXL.cache H2D response comprising Opcode(GO-I) and CQID(q.2.1), the computer may translate the CXL.cache H2D response to a CXL.cache D2H response comprising Opcode(RspIHitI), and UQID(t.1.1). The computer may perform further translations, such as opcode translations, e.g., translating between CXL.cache H2D request opcodes, such as Snp* (e.g., SnpData, SnpInv, and SnpCur), and CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed. The computer may further perform other translations, such as field translations between messages conforming to the first CXL.cache transaction and messages conforming to the second CXL.cache transaction, such as translations between UQIDs and CQIDs, translations between reserved fields, and/or translations between reserved and non-reserved fields.

FIG. 8C illustrates an example of a TFD demonstrating translations performed by a computer between CXL.cache transactions, wherein the transactions may include messages such as requests, responses, and optionally data messages. A first entity (Entity.1), such as a first host (Host.1), may send to the computer a CXL.cache H2D request comprising Opcode(SnpCur), UQID(t.1.1), and Address(AS.1.1), wherein the CXL.cache H2D request may indicate a snoop request for the current version of a cacheline. The computer may translate the CXL.cache H2D request to a CXL.cache D2H request comprising Opcode(RdCurr), CQID(q.2.1), and Address(AS.2.1), wherein the CXL.cache D2H request may indicate a read request from the computer to the second entity for the current version of the cacheline. The computer may provide intent-based translations, such as by identifying intents in CXL.cache H2D requests received from the first entity, such as intents to get the current version of a cacheline, and utilizing the identified intents for translating between the CXL.cache H2D requests and the CXL.cache D2H requests. The second entity may respond to the CXL.cache D2H request comprising the RdCurr opcode with a CXL.cache H2D Data comprising CQID(q.2.1) and Data(*Data.1*). The computer may translate the CXL.cache H2D Data to a CXL.cache D2H response comprising Opcode(RspVFwdV) and UQID(t.1.1) and may send the CXL.cache D2H response to the first entity. The computer may further translate the CXL.cache H2D Data to a CXL.cache D2H Data comprising UQID(t.1.1) and Data(*Data.1*) and may send the CXL.cache D2H Data to the first entity.

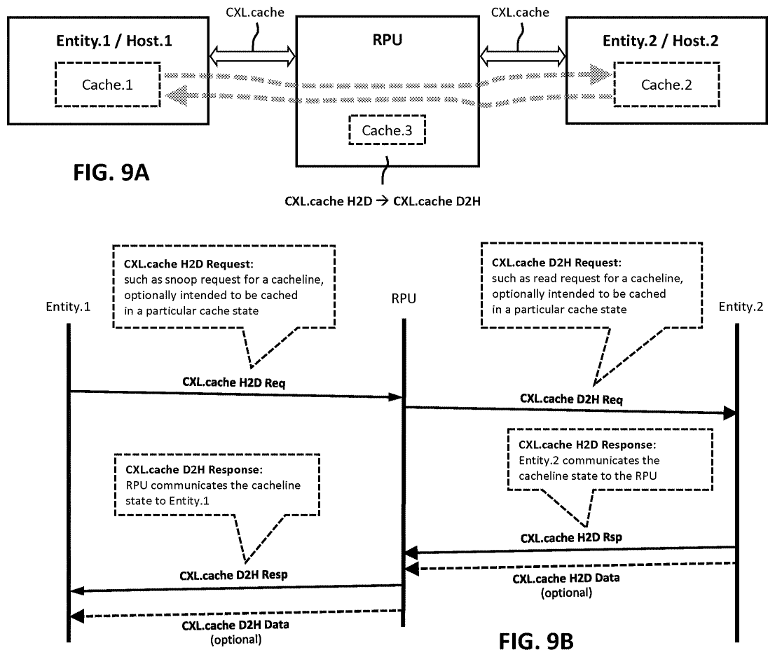

FIG. 9A illustrates an example of a system comprising an RPU and an optional third cache (Cache.3). The RPU may utilize CXL.cache for communicating with a first entity (Entity.1), such as a first host (Host.1), which may include a first cache (Cache.1). The RPU may further utilize CXL.cache for communicating with a second entity (Entity.2), such as a second host (Host.2), which may include a second cache (Cache.2). The RPU may translate between CXL.cache transactions, or between CXL.cache messages, such as between CXL.cache H2D requests and CXL.cache D2H requests, between CXL.cache H2D responses and CXL.cache D2H responses, and optionally between CXL.cache H2D Data messages and CXL.cache D2H Data messages, possibly enabling cacheline state orchestration between the first cache, the second cache, and optionally the third cache, wherein the cacheline state orchestration may be utilized, at least partly, for enabling memory sharing, such as cache-coherent memory sharing, between the first entity and the second entity. In some examples, the first entity may issue CXL.cache H2D requests, such as snoop requests, that may target a cache maintained by the RPU, such as the third cache (Cache.3) that may be included in the RPU. In other examples, the first entity may issue CXL.cache H2D requests, such as snoop requests, that may target a cache abstraction maintained by the RPU, wherein the RPU may act as a proxy for a cache included in the second entity, such as the second cache (Cache.2), and wherein the RPU may affect the second cache utilizing CXL.cache D2H requests that may cause cacheline state transitions in the second cache.

FIG. 9B illustrates an example of a TFD demonstrating translations, performed by an RPU, between CXL.cache transactions, wherein the transactions may include messages such as requests, responses, and optionally data messages. A first entity (Entity.1), such as a first host (Host.1), may send to the RPU a CXL.cache H2D request, such as a snoop request for a cacheline optionally intended to be cached in a particular cache state in the first entity. In a first example, the first entity may send to the RPU a CXL.cache H2D request comprising SnpData, that may indicate a snoop request from the first entity for a cacheline that is intended to be cached in either shared or exclusive state at the first entity. In a second example, the first entity may send to the RPU a CXL.cache H2D request comprising SnpInv, that may indicate a snoop request from the first entity for a cacheline that is intended to be cached in exclusive state at the first entity. The RPU may translate the CXL.cache H2D request to a CXL.cache D2H requests, such as a read request for a cacheline, optionally intended to be cached in particular cache state, and send the CXL.cache D2H requests to the second entity. The RPU may provide intent-based translations, such as by identifying intents in CXL.cache H2D requests received from the first entity and utilizing the identified intents for translating the CXL.cache H2D requests to the CXL.cache D2H requests.

In a first example, the RPU may translate a CXL.cache H2D request comprising SnpData, to a CXL.cache D2H request comprising RdShared, which requests a cacheline read to be cached in shared state, wherein the translation may enable the first entity to transition the cacheline state to shared, resulting in cacheline state orchestration between caches maintained by the first entity and caches maintained by the second entity. In a second example, the RPU may translate a CXL.cache H2D request comprising SnpInv to a CXL.cache D2H request comprising RdOwnNoData, requesting from the second entity to get exclusive ownership of a cacheline address, wherein the translation may invalidate the cacheline maintained by the second entity and may enable the first entity to acquire exclusive ownership and transition the cacheline state to exclusive, resulting in cacheline state orchestration between caches maintained by the first entity and caches maintained by the second entity.

The second entity may respond to the CXL.cache D2H request with a CXL.cache H2D response, which may communicate the cacheline state (e.g., via GO-S, GO-E) from the second entity to the RPU, wherein the RPU may translate the CXL.cache H2D response to a CXL.cache D2H response, which may communicate the cacheline state to the first entity. In some examples, the second entity may also respond to the CXL.cache D2H request with a CXL.cache H2D Data, such as when the second entity forwards modified data or when the CXL.cache D2H request comprises a read opcode, such as RdOwn, that return data. The RPU may translate the CXL.cache H2D Data to a CXL.cache D2H Data, and may send the CXL.cache D2H Data to the first entity. The RPU may perform further translations, such as opcode translations, e.g., translating between CXL.cache H2D request opcodes, such as snoops (e.g., SnpData, SnpInv, or SnpCur), and CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed. The RPU may further perform other translations, such as translations between CXL.cache messages, translations between reserved fields, and/or translations between reserved and non-reserved fields.

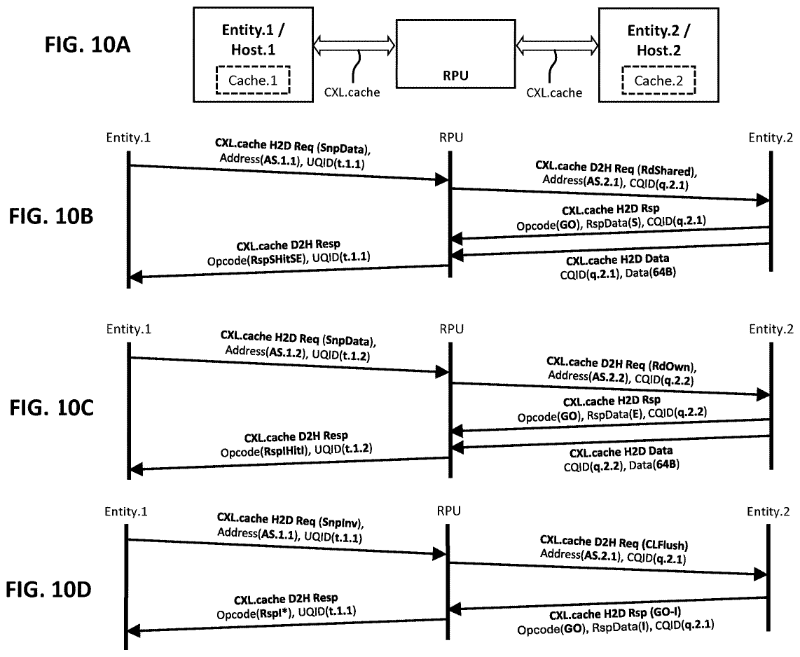

FIG. 10A illustrates an example of a system comprising an RPU that utilizes CXL.cache for communicating with a first entity (Entity.1), such as a first host (Host.1), which may include a first cache (Cache.1). The RPU may further utilize CXL.cache for communicating with a second entity (Entity.2), such as a second host (Host.2), which may include a second cache (Cache.2). The RPU may translate between CXL.cache transactions, or between CXL.cache messages, such as between CXL.cache H2D requests comprising snoops, and CXL.cache D2H requests comprising read opcodes, possibly enabling cacheline state orchestration between the first cache, and the second cache, wherein the cacheline state orchestration may be utilized, at least partly, for enabling memory sharing, such as cache-coherent memory sharing, between the first entity and the second entity.

FIG. 10B illustrates an example of a TFD demonstrating translations, performed by an RPU, between CXL.cache transactions, wherein the transactions may include messages such as requests, responses, and optionally data messages. A first entity (Entity.1), such as a first host (Host.1), may send to the RPU a CXL.cache H2D request comprising SnpData, Address(AS.1.1), and UQID(t.1.1), wherein the CXL.cache H2D request may indicate a snoop request from the first entity to the RPU for a cacheline that is intended to be cached in either shared or exclusive state at the first entity. The RPU may translate the CXL.cache H2D request to a CXL.cache D2H request comprising RdShared, Address(AS.2.1), and CQID(q.2.1), wherein the CXL.cache D2H request may indicate a read request from the RPU to the second entity for a cacheline to be cached in shared state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdShared with a CXL.cache H2D response comprising Opcode(GO), RspData(S), and CQID(q.2.1), and may further respond with a CXL.cache H2D Data comprising CQID(q.2.1) and Data(64 B), wherein the Opcode(GO) and RspData(S) may indicate a GO-S shared state of the cacheline received by the RPU from the second entity. The RPU may translate the CXL.cache H2D response to a CXL.cache D2H response comprising Opcode(RspSHitSE) and UQID(t.1.1), wherein the Opcode(RspSHitSE) may indicate that the line was hit in a clean state and its current state is shared, possibly resulting in cacheline state orchestration between the first cache and the second cache, where both caches may store the cacheline in a shared state. The RPU may further perform other translations, such as translations between CXL.cache messages, translations between reserved fields, and/or translations between reserved and non-reserved fields. In some examples, the first entity may issue CXL.cache H2D requests, such as snoop requests, that may target a cache abstraction maintained by the RPU, wherein the RPU may expose a device cache over CXL.cache that may act as a proxy for caches included in the second entity, and wherein the RPU may affect caches in the second entity utilizing CXL.cache D2H requests that may cause cacheline state transitions in these caches.

FIG. 10C illustrates another example of a TFD demonstrating translations between CXL.cache transactions. A first entity (Entity.1), such as a first host (Host.1), may send to the RPU a CXL.cache H2D request comprising SnpData, Address(AS.1.2), and UQID(t.1.2), wherein the CXL.cache H2D request may indicate a snoop request from the first entity to the RPU for a cacheline that is intended to be cached in either shared or exclusive state at the first entity. The RPU may translate the CXL.cache H2D request to a CXL.cache D2H request comprising RdOwn, Address(AS.2.2), and CQID(q.2.2), wherein the CXL.cache D2H request may indicate a read request to the second entity for a cacheline to be cached in exclusive state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests. The second entity may respond to the CXL.cache D2H request comprising RdOwn with a CXL.cache H2D response comprising Opcode(GO), RspData(E), and CQID(q.2.2), and may further respond with a CXL.cache H2D Data comprising CQID(q.2.2) and Data(64 B), wherein the Opcode(GO) and RspData(E) may indicate a GO-E exclusive state of the cacheline received by the RPU from the second entity. The RPU may translate the CXL.cache H2D response to a CXL.cache D2H response comprising Opcode(RspIHitI) and UQID(t.1.2), wherein the Opcode(RspIHitI) may indicate that the cacheline was not found in the caches, possibly resulting in cacheline state orchestration between the first cache and the second cache, wherein the first cache may transition the cacheline state to exclusive given that the second cache does not have that cacheline.

FIG. 10D illustrates an example of a TFD demonstrating translations, performed by an RPU, between CXL.cache transactions, wherein the transactions may include messages such as requests, responses, and optionally data messages. A first entity (Entity.1), such as a first host (Host.1), may send to the RPU a CXL.cache H2D request comprising SnpInv, Address(AS.1.1), and UQID(t.1.1), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising CLFlush, Address(AS.2.1), and CQID(q.2.1), wherein the CXL.cache D2H request may indicate a request from the RPU to the second entity to invalidate (flush) the cacheline. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests. The second entity may respond to the CXL.cache D2H request comprising CLFlush with a CXL.cache H2D response comprising Opcode(GO), RspData(I), and CQID(q.2.1), wherein the Opcode(GO) and RspData(I) may indicate a GO-I and may confirm the invalidation of the cacheline. The RPU may translate the CXL.cache H2D response to a CXL.cache D2H response comprising Opcode(RspI*) and UQID(t.1.1), wherein the Opcode(RspI*), such as RspIHitI, RspIHitSE, or RspIFwdM, may indicate that the line is no longer at the cache, possibly resulting in cacheline state orchestration between the first cache and the second cache, wherein the first cache may transition the cacheline state to exclusive, given that the second cache does not have that cacheline. In some examples, the first entity may issue CXL.cache H2D requests, such as snoop requests, that may target a cache abstraction maintained by the RPU, wherein the RPU may expose a device cache over CXL.cache that may act as a proxy for caches included in the second entity, and wherein the RPU may affect caches in the second entity utilizing CXL.cache D2H requests that may cause cacheline state transitions in these caches.

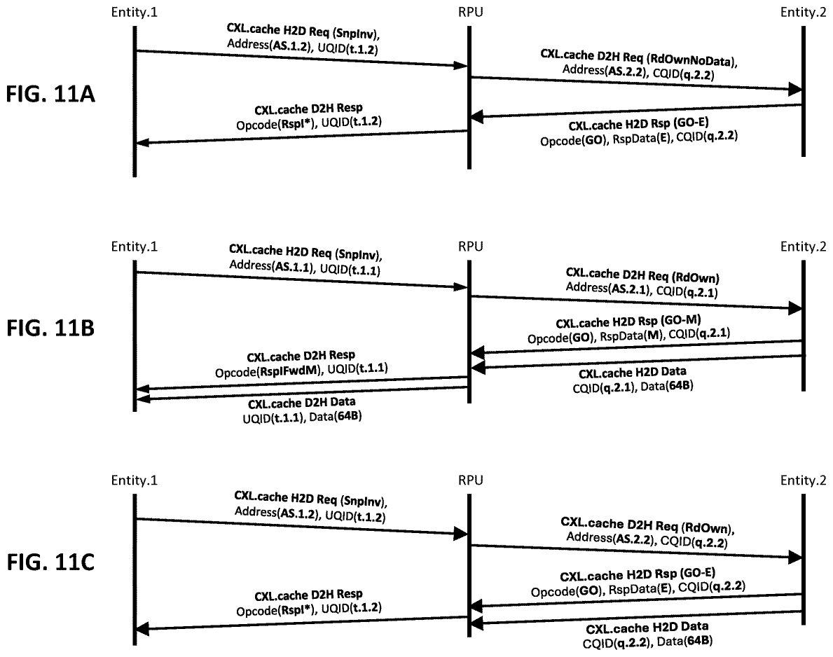

FIG. 11A illustrates an example of a TFD demonstrating translations performed by an RPU between CXL.cache transactions, wherein the transactions may include messages such as requests, responses, and optionally data messages. A first entity (Entity.1), such as a first host (Host.1), may send to the RPU a CXL.cache H2D request comprising SnpInv, Address(AS.1.2), and UQID(t.1.2), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising RdOwnNoData, Address(AS.2.2), and CQID(q.2.2), wherein the CXL.cache D2H request may indicate an intent to get exclusive ownership of the cacheline address indicated in the address field. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests. The second entity may respond to the CXL.cache D2H request comprising RdOwnNoData with a CXL.cache H2D response comprising Opcode(GO), RspData(E), and CQID(q.2.2), wherein the Opcode(GO) and RspData(E) may indicate a GO-E exclusive state of the cacheline received by the RPU from the second entity. The RPU may translate the CXL.cache H2D response to a CXL.cache D2H response comprising Opcode(RspI*) and UQID(t.1.2), wherein the Opcode(RspI*), such as RspIHitI, RspIHitSE, or RspIFwdM, may indicate that the line is no longer at the cache, possibly resulting in cacheline state orchestration between the first cache and the second cache, wherein the first cache may transition the cacheline state to exclusive given that the second cache does not have that cacheline.

FIG. 11B illustrates an example of a TFD demonstrating translations performed by an RPU between CXL.cache transactions, wherein the transactions may include messages such as requests, responses, and optionally data messages. A first entity (Entity.1), such as a first host (Host.1), may send to the RPU a CXL.cache H2D request comprising SnpInv, Address(AS.1.1), and UQID(t.1.1), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising RdOwn, Address(AS.2.1), and CQID(q.2.1), wherein the CXL.cache D2H request may indicate a read request from the RPU to the second entity for a cacheline to be cached in exclusive state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdOwn with a CXL.cache H2D response comprising Opcode(GO), RspData(M), and CQID(q.2.1), and may further respond with a CXL.cache H2D Data comprising CQID(q.2.1) and Data(64 B), wherein the Opcode(GO) and RspData(M) may indicate a GO-M, and wherein the RPU may receive the cacheline in Modified state. The RPU may translate the CXL.cache H2D response to a CXL.cache D2H response comprising Opcode(RspIFwdM) and UQID(t.1.1), that may indicate to the first entity that the cacheline being snooped is now in I (Invalid) state after having hit the line in M (Modified) state, possibly resulting in cacheline state orchestration between the first cache and the second cache, wherein the first cache may transition the cacheline state to modified given that the second cache delivered a modified cacheline and was further invalidated.

FIG. 11C illustrates an example of a TFD demonstrating translations performed by an RPU between CXL.cache transactions. A first entity (Entity.1), such as a first host (Host.1), may send to the RPU a CXL.cache H2D request comprising SnpInv, Address(AS.1.2), and UQID(t.1.2), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising RdOwn, Address(AS.2.2), and CQID(q.2.2), wherein the CXL.cache D2H request may indicate a read request from the RPU to the second entity for a cacheline to be cached in exclusive state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdOwn with a CXL.cache H2D response comprising Opcode(GO), RspData(E), and CQID(q.2.2), and may further respond with a CXL.cache H2D Data comprising CQID(q.2.2) and Data(64 B), wherein the Opcode(GO) and RspData(E) may indicate a GO-E exclusive state of the cacheline received by the RPU from the second entity. The RPU may translate the CXL.cache H2D response to a CXL.cache D2H response comprising Opcode(RspI*) and UQID(t.1.2), wherein the Opcode(RspI*), such as RspIHitI, RspIHitSE, or RspIFwdM, may indicate that the line is no longer at the cache, possibly resulting in cacheline state orchestration between the first cache and the second cache, wherein the first cache may transition the cacheline state to exclusive given that the second cache does not have that cacheline.

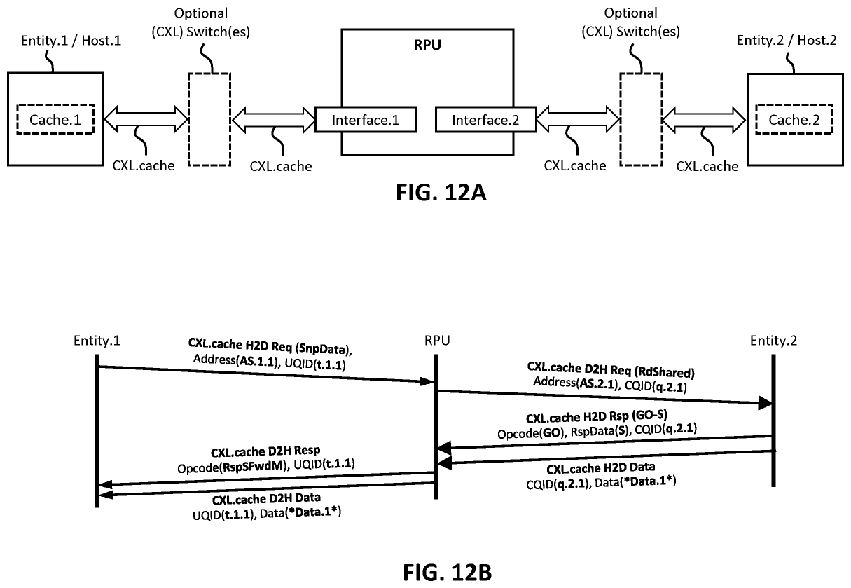

FIG. 12A illustrates an example of a system comprising an RPU that may utilize CXL.cache for communicating with a first entity (Entity.1), such as a first host (Host.1), which may include a first cache (Cache.1). The RPU may further utilize CXL.cache for communicating with a second entity (Entity.2), such as a second host (Host.2), which may include a second cache (Cache.2). The RPU may translate between CXL.cache transactions, and may further translate between CXL.cache messages, such as between CXL.cache H2D requests comprising snoop (e.g., SnpData) opcodes, and CXL.cache D2H requests comprising read opcodes (e.g., RdShared), possibly enabling cacheline state orchestration between the first cache and the second cache, such as cross coordination of cacheline states, wherein the cacheline state orchestration may be utilized, at least partly, for enabling memory sharing, such as cache-coherent memory sharing, between the first entity and the second entity. Optionally, the RPU may be implemented in an IC package having high-speed differential I/O balls positioned according to a ball grid array layout defined by the PCIe 5.0, 6.0, or 7.0 Retimer Supplemental Features and Standard BGA Footprint Specification. The RPU may extract physical addresses within messages received via the first interface, wherein these addresses may correspond to a first HPA space utilized by the first entity; translate these addresses; and generate messages carrying the translated physical addresses for transmission via the second interface; wherein these translated addresses may correspond to a second HPA space utilized by the second entity. Optional CXL switch(es) may be positioned between the first interface and the first entity, and/or between the second interface and the second entity.

FIG. 12B illustrates an example of a TFD demonstrating translations performed by an RPU between CXL.cache transactions, wherein the transactions may include messages such as requests, responses, and optionally data messages. A first entity (Entity.1), such as a first host (Host.1), may send to the RPU a CXL.cache H2D request comprising SnpData, Address(AS.1.1), and UQID(t.1.1), wherein the CXL.cache H2D request may indicate a snoop from the first entity to the RPU for a cacheline that is intended to be cached in either shared or exclusive state at the first entity (the exclusive state may be cached at the first entity only if all devices respond with RspI*). The RPU may translate the CXL.cache H2D request to a CXL.cache D2H request comprising RdShared, Address(AS.2.1), and CQID(q.2.1), wherein the CXL.cache D2H request may indicate a read request from the RPU to the second entity for a cacheline to be cached in shared state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdShared with a CXL.cache H2D response comprising Opcode(GO), RspData(S), and CQID(q.2.1), and may further respond with a CXL.cache H2D Data comprising CQID(q.2.1) and Data(*Data.1*), wherein the Opcode(GO) and RspData(S) may indicate a GO-S, and wherein the RPU may receive the cacheline in Shared state. The RPU may translate the CXL.cache H2D response to a CXL.cache D2H response comprising Opcode(RspSFwdM) and UQID(t.1.1), that may indicate to the first entity that the cacheline being snooped is now in S (Shared) state after having hit the line in M (Modified) state, possibly enabling an explicit delivery of data from the RPU to the first entity. The RPU may further translate the CXL.cache H2D Data to a CXL.cache D2H Data comprising UQID(t.1.1) and Data(*Data.1*). The RPU may utilize *FwdM such as RspSFwdM when translating the CXL.cache H2D response to the CXL.cache D2H response, wherein the *FwdM may enable data transfer from the RPU to the first entity utilizing the CXL.cache D2H Data, irrespective of the actual GO-S response from the second entity. Such translation may enable delivery of a cacheline data in shared state from the second entity to the first entity via the RPU, a path that is not supported by the CXL specification.

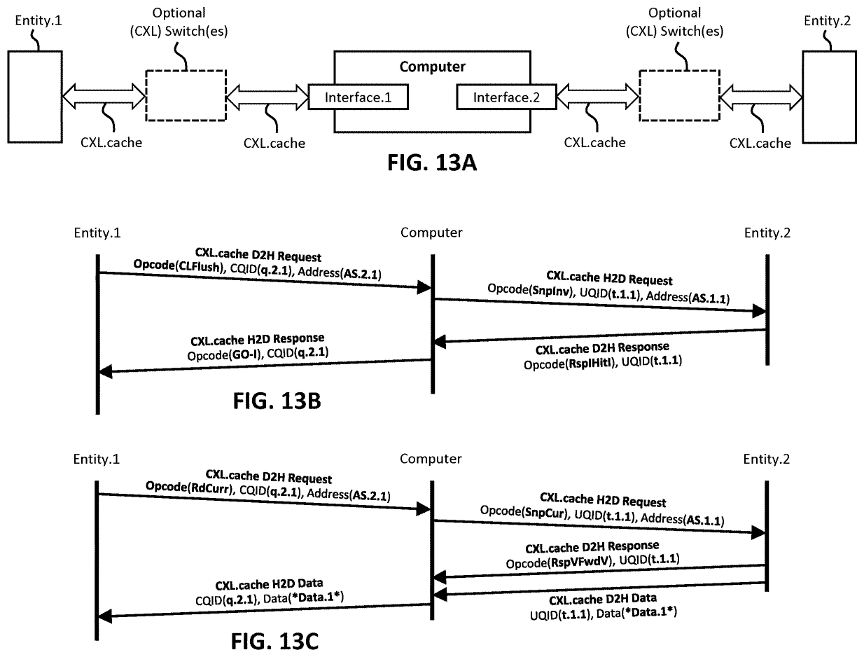

FIG. 13A illustrates an example of a system comprising a computer coupled between a first interface (Interface.1) that may communicate according to CXL.cache with a first entity (Entity.1), and a second interface (Interface.2) that may communicate according to CXL.cache with a second entity (Entity.2), possibly enabling the first entity to communicate with the second entity, such as via affecting cacheline state transitions in the second entity. The computer may extract physical addresses within messages received via the first interface, wherein these addresses may refer to a first physical address space utilized by the first entity; translate these addresses; and generate messages carrying the translated physical addresses for transmission via the second interface; wherein these translated addresses may correspond to a second physical address space utilized by the second entity. In some examples, the first address space and the second address space may be associated with a single HPA space. Optional CXL switch(es) may be positioned between the first interface and the first entity, and/or between the second interface and the second entity. In some examples, the computer may be implemented as a chiplet, or as a functional unit within an IC such as an accelerator, a processor, or a switch. In other examples, the computer may be implemented as a discrete component, such as in an IC package having high-speed differential I/O balls positioned according to a ball grid array layout defined by a PCIe Retimer Supplemental Features and Standard BGA Footprint Specification.

FIG. 13B illustrates an example of a TFD demonstrating translations, such as intent-based translations, performed by a computer, between first CXL.cache messages received from a first entity (Entity.1), such as a first device (Device.1), and second CXL.cache messages sent to a second entity (Entity.2), such as a second device (Device.2), possibly enabling the first entity to maintain, at least partly, cacheline state orchestration, memory coherency, and/or memory sharing with the second entity, such as by enabling the first entity to invalidate cachelines in the second entity. The first entity may initiate a first CXL.cache transaction that may include a CXL.cache D2H request comprising Opcode(CLFlush), CQID(q.2.1), and Address(AS.2.1). The computer may translate the first CXL.cache transaction to a second CXL.cache transaction that may include a CXL.cache H2D request comprising Opcode(SnpInv), UQID(t.1.1), and Address(AS.1.1), and may send the CXL.cache H2D request to the second entity. Upon receiving a response from the second entity, which may include a CXL.cache D2H response comprising Opcode(RspIHitI), and UQID(t.1.1), the computer may translate the CXL.cache D2H response to a CXL.cache H2D response comprising Opcode(GO-I) and CQID(q.2.1).

The computer may perform further translations, such as opcode translations, e.g., translating between CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed, and CXL.cache H2D request opcodes, such as Snp* (e.g., SnpData, SnpInv, and SnpCur). The computer may further perform other translations, such as field translations between messages conforming to the first CXL.cache transaction and messages conforming to the second CXL.cache transaction, such as translations between UQIDs and CQIDs, translations between reserved fields, and/or translations between reserved and non-reserved fields.

FIG. 13C illustrates an example of a TFD demonstrating translations performed by a computer between CXL.cache transactions, wherein the transactions may include messages such as requests, responses, and optionally data messages. A first entity (Entity.1), such as a first device (Device.1), may send to the computer a CXL.cache D2H request comprising Opcode(RdCurr), CQID(q.2.1), and Address(AS.2.1), wherein the CXL.cache D2H request may indicate a read request from the first entity to the computer for the current version of a cacheline. The computer may translate the CXL.cache D2H request to a CXL.cache H2D request comprising Opcode(SnpCur), UQID(t.1.1), and Address(AS.1.1), and may send the CXL.cache H2D request to the second entity, wherein the CXL.cache H2D request may indicate a snoop request from the computer to the second entity for the current version of the cacheline. The computer may provide intent-based translations, such as by identifying intents in CXL.cache D2H requests received from the first entity, such as intents to get the current version of a cacheline, and utilizing the identified intents for translating between the CXL.cache D2H requests and the CXL.cache H2D requests. The second entity may respond to the CXL.cache H2D request comprising the SnpCur with a CXL.cache D2H response comprising Opcode(RspVFwdV) and UQID(t.1.1), and with a CXL.cache D2H Data comprising UQID(t.1.1) and Data(*Data.1*). The computer may translate the CXL.cache D2H Data to a CXL.cache H2D Data comprising CQID(q.2.1) and Data(*Data.1*), and may send the CXL.cache H2D Data to the first entity.

In heterogeneous computing architectures, entities may communicate using different interconnect protocols while requiring coordinated access to shared resources. NVLink is a high-bandwidth interconnect technology utilized for communication among GPUs, accelerators, and switches, while PCIe is an interconnect technology utilized for communication between hosts and devices. NVLink-based PDUs utilize an NVLink-based address space, whereas PCIe TLPs utilize a PCIe address space, such as a Host Physical Address (HPA) space. In environments where a first entity communicating via NVLink needs to access resources coupled to a second entity communicating via PCIe, or vice versa, translations between NVLink-based PDUs and PCIe TLPs may facilitate memory operations and data transfers across the different protocol domains. Such translations may be performed by a computer, an apparatus, a cable, or other suitable devices positioned between the first entity and the second entity. The translations may include translating physical addresses between the NVLink-based address space and the PCIe address space, translating between NVLink-based request types and PCIe TLP types, and translating identifier fields such as Tags, SourceIDs, DestinationIDs, and RequesterIDs. The translations may support AI workloads, such as training and inference of large language models (LLMs), mixture-of-experts (MoE) models, multi-modal models, and diffusion models, which may involve transferring model weights, key-value (KV) cache entries, activation tensors, and embedding tables between NVLink-connected entities and PCIe-connected resources.

In various implementations, a method comprising: operating a computer coupled between a first interface that communicates according to an NVLink-based protocol with a first entity, and a second interface that communicates according to a PCI Express (PCIe) protocol with a second entity; translating, by the computer, between NVLink-based Protocol Data Units (PDUs) communicated via the first interface and PCIe Transaction Layer Packets (TLPs) communicated via the second interface, wherein the translating comprises: translating physical addresses between a first address space associated with the NVLink-based protocol and a second address space associated with the PCIe protocol; and translating between NVLink-based request types and PCIe TLP types. The computer may be implemented as a semiconductor device, an integrated circuit (IC), a chiplet, an active cable, a switch, or another suitable device positioned between the first entity and the second entity. The first address space may include an NVLink-based network address space or a GPU physical address space, and the second address space may include an HPA space or another PCIe memory address space. The computer may maintain address translation tables, such as Link TLBs or address mapping tables, to translate between addresses in the first and second address spaces. The translating may be bidirectional: in one direction, the computer may translate NVLink-based PDUs received from the first entity to PCIe TLPs sent to the second entity; in the opposite direction, the computer may translate PCIe TLPs received from the second entity to NVLink-based PDUs sent to the first entity. The NVLink-based request types may include NVLink read requests and NVLink write requests, and the PCIe TLP types may include Memory Read (MRd) requests, Memory Write (MWr) requests, and Completions. The method may be implemented in hardware, firmware, software, or combinations thereof. Additionally, the first and second entities may communicate through one or more intermediary components, such as a switch, a retimer, or another suitable entity that facilitates information transfer.

In some implementations of the method, the NVLink-based PDUs comprise an NVLink-based request from the first entity, the NVLink-based request comprising a first address in the first address space; wherein the PCIe TLPs comprise a PCIe Memory Read (MRd) request comprising a second address in the second address space; and wherein the translating further comprises translating the NVLink-based request to the PCIe MRd and sending the PCIe MRd to the second entity via the second interface. The NVLink-based request may be an NVLink read request carrying a GPU physical address or an NVLink-based network address. The computer may translate this address to an HPA or another address within the PCIe memory address space. The computer may further translate NVLink Tags or transaction identifiers to PCIe Tags for tracking the transaction.

In some implementations of the method, the PCIe TLPs further comprise a PCIe Completion with Data (CplD) from the second entity, the PCIe CplD comprising a data payload corresponding to the PCIe MRd; and wherein the translating further comprises translating the PCIe CplD to an NVLink-based response comprising the data payload. The computer may correlate the PCIe CplD with the previously sent PCIe MRd using the PCIe Tag, and may translate the PCIe Tag back to the corresponding NVLink Tag or transaction identifier. The data payload may be forwarded from the PCIe CplD into the NVLink-based response without modification.

In some implementations of the method, the PCIe TLPs comprise a PCIe Memory Read (MRd) request from the second entity, the PCIe MRd comprising a first address in the second address space; wherein the NVLink-based PDUs comprise an NVLink-based request comprising a second address in the first address space; and wherein the translating further comprises translating the PCIe MRd to the NVLink-based request and sending the NVLink-based request to the first entity via the first interface. In the opposite direction, the second entity may initiate a PCIe MRd targeting a resource accessible via the NVLink fabric. The computer may translate the PCIe address, such as an HPA, to an NVLink-based address, and may generate NVLink identifier fields such as SourceID and DestinationID that are not present in the PCIe domain. The computer may further translate the PCIe Tag to an NVLink Tag for transaction tracking.

In some implementations of the method, the NVLink-based PDUs further comprise an NVLink-based response from the first entity, the NVLink-based response comprising a data payload; and wherein the translating further comprises translating the NVLink-based response to a PCIe Completion with Data (CplD) comprising the data payload. The computer may translate the NVLink Tag back to the PCIe Tag of the original MRd and may generate PCIe completion header fields such as CompleterID and RequesterID. The data payload may be forwarded from the NVLink response into the PCIe CplD.

In some implementations of the method, the PCIe MRd further comprises a RequesterID, and wherein the PCIe CplD further comprises a CompleterID and the RequesterID, and wherein the computer generates the CompleterID for the PCIe CplD. The CompleterID may identify the computer as the PCIe Completer for the transaction. The RequesterID may be reflected from the original PCIe MRd to enable correct routing of the CplD back to the originating entity. These identifiers may be set during enumeration or initialization phases.

In some implementations of the method, the PCIe MRd further comprises a RequesterID and a first Tag, and wherein the NVLink-based request further comprises a SourceID, a DestinationID, and a second Tag; and wherein translating the PCIe MRd to the NVLink-based request comprises generating the SourceID and the DestinationID, and translating the first Tag to the second Tag. The PCIe domain utilizes RequesterID (Bus/Device/Function) for identifying the requester, whereas the NVLink domain utilizes separate SourceID and DestinationID fields for routing. The computer may generate the SourceID based on its own NVLink identity, and the DestinationID based on the target entity in the NVLink fabric. The computer may maintain a Tag mapping table to translate between PCIe Tags and NVLink Tags and to correlate responses with their corresponding requests.

In some implementations of the method, the PCIe TLPs communicated via the second interface utilize a Flit Mode (FM) format, and wherein the first entity comprises a GPU or an accelerator, and the second entity comprises a PCIe host or a PCIe device. Flit Mode may be supported by PCIe Revision 6.0 and above, and may provide increased bandwidth efficiency and support for 14-bit Tags. The second entity may be a PCIe host, such as a CPU or a Root Complex, or a PCIe device, such as an NVMe SSD, a network interface card (NIC), or a memory controller.

In some implementations of the method, the computer translates between Flit Mode (FM) and Non-Flit Mode (NFM) TLP formats for the PCIe TLPs communicated via the second interface, and wherein the NVLink-based PDUs carry data associated with an artificial intelligence (AI) model comprising at least one of: a large language model (LLM), a mixture-of-experts (MoE) model, a multi-modal model, or a diffusion model. When the second interface operates in a different data stream mode than an adjacent PCIe link segment, the computer may translate between FM and NFM TLP formats, including adapting header formats, Tag widths, and encoding mechanisms. LLMs may include transformer-based architectures, MoE models may route inputs to subsets of expert sub-networks, multi-modal models may process inputs across text, image, and video modalities, and diffusion models may generate content through iterative denoising.

In some implementations of the method, the PCIe TLPs carry a data payload not exceeding 64 Double Words (DWs), and wherein the computer translates an NVLink-based PDU to multiple PCIe TLPs. The 64 DW ceiling (256 bytes) may correspond to a maximum payload size supported by the NVLink-based protocol, which may be imposed on the PCIe domain. When an NVLink request targets a data block that exceeds the PCIe Maximum Payload Size or requires multiple completions, the computer may split the request into smaller PCIe TLPs and may reassemble the returned data before translating it back to the NVLink domain.

In some implementations of the method, at least one physical address within the second address space, which is a PCIe memory address space, is not mapped to an NVLink address in the first address space, and wherein the NVLink-based PDUs and the PCIe TLPs carry data associated with an artificial intelligence (AI) workload, the data comprising at least one of: model weights, key-value (KV) cache entries, activation tensors, or embedding tables. The computer may expose only a subset of the PCIe memory address space to the NVLink domain. Unmapped PCIe addresses may correspond to configuration registers, management interfaces, or memory regions reserved for local use by the second entity. KV cache entries may be utilized during autoregressive inference, activation tensors may represent intermediate computation results, and embedding tables may map discrete tokens to continuous vector representations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system translates between NVLink-based traffic and PCIe traffic. The system may support various form factors, including semiconductor devices packaged in retimer-compatible BGA layouts, active cables with optical or copper physical media, and chiplet-based implementations. The system may further include NVLink switches or PCIe switches positioned between the interfaces and the respective entities, enabling multi-entity topologies. The system may be deployed in datacenters, high-performance computing (HPC) environments, or AI/ML training and inference clusters, where NVLink-connected accelerators/GPUs need to access PCIe-attached resources such as host memory, NVMe storage, or network interface cards.

In various implementations, a system comprising: a first interface configured to communicate according to an NVLink-based protocol with a first entity; a second interface configured to communicate according to a PCI Express (PCIe) protocol with a second entity; and a computer coupled between the first and second interfaces, configured to translate between NVLink-based traffic communicated via the first interface and PCIe traffic communicated via the second interface, comprising translating physical addresses between a first address space associated with the NVLink-based protocol and a second address space associated with the PCIe protocol. The system may be deployed in environments where NVLink-connected entities, such as GPUs, accelerators, or NVLink switches, need to access resources coupled to PCIe-connected entities, such as PCIe hosts, NVMe SSDs, or network interface cards. The computer may be implemented as a semiconductor device comprising translation logic, address mapping tables, and pending transaction trackers. The first and second interfaces may support different link speeds, lane widths, and signaling technologies. The system may support bidirectional translation, wherein in one direction the computer translates NVLink-based traffic to PCIe traffic, and in the opposite direction the computer translates PCIe traffic to NVLink-based traffic. Optional switches may be positioned between the first interface and the first entity, and between the second interface and the second entity, to support multi-entity topologies.

In some implementations of the system, the computer is implemented in an IC package having differential input/output (I/O) balls positioned according to a ball grid array (BGA) layout, and wherein the system further comprises a cable including a first module and a second module coupled by a physical medium, the computer residing within the first module or the second module. The BGA layout may conform to a retimer specification, such as the PCIe 5.0, 6.0, or 7.0 Retimer Supplemental Features and Standard BGA Footprint Specification. The physical medium may include a copper wire, a twinaxial cable, a multimode fiber (MMF), or a single-mode fiber (SMF). The cable may be implemented as an Active Optical Cable (AOC) or an Active Copper Cable (ACC).

In some implementations of the system, the computer comprises an NVLink Fusion chiplet, and wherein an NVLink switch is coupled between the first interface and the first entity. The NVLink Fusion chiplet may integrate the translation logic, address mapping functionality, and NVLink interface within a chiplet package. The NVLink switch may enable multi-entity connectivity, allowing multiple accelerators (e.g., GPUs) to access PCIe resources through the same computer. The NVLink Fusion chiplet may be a component of an RPU within an active cable or a discrete semiconductor device.

In some implementations of the system, the second interface operates in Flit Mode (FM), and wherein the NVLink-based traffic and the PCIe traffic carry data associated with an artificial intelligence (AI) workload comprising at least one of: model training, model inference, or model fine-tuning. Flit Mode operation on the second interface may provide increased bandwidth efficiency and support for 14-bit Tags and UIO capabilities. Model training may involve distributing gradient computations and model parameters across NVLink-connected GPUs while accessing datasets stored on PCIe-attached storage. Model inference may involve transferring model weights and KV cache entries between memory tiers. Model fine-tuning may involve adapting pre-trained model parameters using task-specific data.

In some implementations, the translations between NVLink-based traffic and PCIe traffic may involve PCIe Unordered I/O (UIO) TLPs. UIO is an optional capability defined in PCIe that introduces TLP types associated with UIO Virtual Channels, including UIO Memory Read (UIOMRd) and UIO Read Completion with Data (UIORdCplD). UIO enables multi-path routing and may provide improved performance in fabric environments. In environments where a first entity communicating via NVLink needs to access resources coupled to a second entity via PCIe UIO, or vice versa, translations between NVLink-based PDUs and PCIe UIO TLPs may facilitate memory operations and data transfers. UIO TLPs are defined for Flit Mode and are associated with dedicated UIO Virtual Channels. The translations between NVLink-based PDUs and PCIe UIO TLPs may involve translating between NVLink identifier fields, such as SourceID and DestinationID, and PCIe UIO identifier fields, such as RequesterID and DestinationBDF/BF. The translations may support AI workloads such as training and inference of LLMs, MoE models, and multi-modal models.

In various implementations, a method comprising: operating a computer coupled between a first interface that communicates according to an NVLink-based protocol with a first entity, and a second interface that communicates according to a PCI Express (PCIe) protocol with a second entity; translating, by the computer, between NVLink-based Protocol Data Units (PDUs) communicated via the first interface and PCIe UIO Transaction Layer Packets (TLPs) communicated via the second interface. The computer may be implemented as a semiconductor device, an IC, a chiplet, an active cable, a switch, or another suitable device positioned between the first entity and the second entity. PCIe UIO TLPs are distinct from standard PCIe TLPs and are associated with UIO Virtual Channels. The method may be bidirectional: in one direction, the computer may translate NVLink-based PDUs received from the first entity to PCIe UIO TLPs sent to the second entity; in the opposite direction, the computer may translate PCIe UIO TLPs received from the second entity to NVLink-based PDUs sent to the first entity. The translating may include opcode translations, Tag translations, address translations, and identifier translations between the NVLink-based domain and the PCIe UIO domain. The PCIe UIO TLPs may include UIOMRd, UIOMWr, UIORdCplD, UIORdCpl, and UIOWrCpl. The method may be implemented in hardware, firmware, software, or combinations thereof. Additionally, the first and second entities may communicate through one or more intermediary components, such as a switch, a retimer, or another suitable entity that facilitates information transfer.

In some implementations of the method, the NVLink-based PDUs comprise an NVLink-based request from the first entity; wherein the PCIe UIO TLPs comprise a PCIe UIO Memory Read (UIOMRd) request; and wherein the translating further comprises translating the NVLink-based request to the PCIe UIOMRd and sending the PCIe UIOMRd to the second entity via the second interface. The NVLink-based request may be an NVLink read request comprising a physical address and a Tag or transaction identifier. The computer may translate the NVLink-based request to a PCIe UIOMRd carrying a translated address and a PCIe Tag. The UIOMRd may utilize a UIO Virtual Channel for transmission to the second entity.

In some implementations of the method, the PCIe UIO TLPs further comprise a PCIe UIO Read Completion with Data (UIORdCplD) from the second entity, the UIORdCplD comprising a data payload; and wherein the translating further comprises translating the UIORdCplD to an NVLink-based response comprising the data payload. The computer may correlate the UIORdCplD with the previously sent UIOMRd using the PCIe Tag, and may translate the response back to the NVLink domain. UIO completions may be received in any order by the requester, and the computer may handle out-of-order completions when reassembling data for the NVLink response.

In some implementations of the method, the PCIe UIO TLPs comprise a PCIe UIO Memory Read (UIOMRd) request from the second entity; wherein the NVLink-based PDUs comprise an NVLink-based request; and wherein the translating further comprises translating the UIOMRd to the NVLink-based request and sending the NVLink-based request to the first entity via the first interface. In the opposite direction, the second entity may initiate a PCIe UIOMRd targeting a resource accessible via the NVLink fabric. The computer may translate the UIOMRd to an NVLink-based request, generating NVLink SourceID and DestinationID fields and translating the PCIe Tag to an NVLink Tag. The UIOMRd may carry a RequesterID that the computer may store for generating the corresponding UIORdCplD.

In some implementations of the method, the NVLink-based PDUs further comprise an NVLink-based response from the first entity, the NVLink-based response comprising a data payload; and wherein the translating further comprises translating the NVLink-based response to a PCIe UIO Read Completion with Data (UIORdCplD) comprising the data payload. The computer may generate PCIe UIO completion header fields, such as CompleterID and DestinationBDF/BF, when constructing the UIORdCplD. The DestinationBDF/BF may correspond to the RequesterID of the originating UIOMRd. The data payload may be forwarded from the NVLink response into the UIORdCplD.

In some implementations of the method, the translating further comprises translating physical addresses between a first address space associated with the NVLink-based protocol and a second address space associated with the PCIe protocol. The address translation for UIO transactions may utilize the same address mapping tables or Link TLBs as standard PCIe translations. The first address space may include an NVLink-based network address space, and the second address space may include a PCIe memory address space. The address translation may be applied in both directions.

In some implementations of the method, the PCIe UIO TLPs carry a data payload not exceeding 64 Double Words (DWs), wherein the PCIe UIO TLPs are associated with a UIO Virtual Channel, and wherein the NVLink-based PDUs carry data associated with an artificial intelligence (AI) model comprising at least one of: a large language model (LLM), a mixture-of-experts (MoE) model, or a multi-modal model. The 64 DW ceiling (256 bytes) may correspond to a maximum payload size supported by the NVLink-based protocol. UIO TLPs may only be transmitted on Virtual Channels configured for UIO. The first UIO Virtual Channel may be VC2, and a second UIO Virtual Channel, if supported, may be VC4. LLMs may generate token sequences using autoregressive decoding, MoE models may route tokens to specialized expert sub-networks, and multi-modal models may fuse representations across text, image, and video inputs.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

In some implementations, translations between NVLink-based traffic and PCIe UIO TLPs may be implemented as a system comprising interfaces and a computer. The system may support PCIe UIO transactions that enable multi-path routing and out-of-order completions, providing performance benefits for fabric-based deployments. The system may be deployed in environments where NVLink-connected accelerators/GPUs need to access PCIe UIO-capable resources, or where PCIe UIO-capable entities need to access resources accessible via the NVLink fabric.

In various implementations, a system comprising: a first interface configured to communicate according to an NVLink-based protocol with a first entity; a second interface configured to communicate according to a PCI Express (PCIe) protocol with a second entity; and a computer coupled between the first and second interfaces, configured to translate between NVLink-based traffic communicated via the first interface and PCIe UIO Transaction Layer Packets (TLPs) communicated via the second interface. The system may be deployed in environments where NVLink-connected entities need to access PCIe UIO-capable resources, or vice versa. The computer may translate between NVLink-based PDUs and PCIe UIO TLPs, including UIOMRd, UIOMWr, and UIORdCplD. The system may support bidirectional translation: in one direction the computer translates NVLink-based traffic to PCIe UIO TLPs, and in the opposite direction the computer translates PCIe UIO TLPs to NVLink-based traffic. The second interface may operate in Flit Mode, as UIO TLPs are defined for Flit Mode. The system may be implemented in various form factors, including semiconductor devices, active cables, chiplets, and switches.

In some implementations of the system, at least one physical address within a PCIe memory address space is not mapped to an NVLink address, and wherein the first entity comprises a GPU, a CPU, or an accelerator, and the second entity comprises a PCIe host or a PCIe device. The partial address space exposure may allow the system to selectively map only certain PCIe memory regions to the NVLink domain. The first entity may be a GPU, a CPU, or an accelerator connected via NVLink. The second entity may be a PCIe host, such as a CPU comprising a Root Complex, or a PCIe device, such as an NVMe SSD or a network interface card.

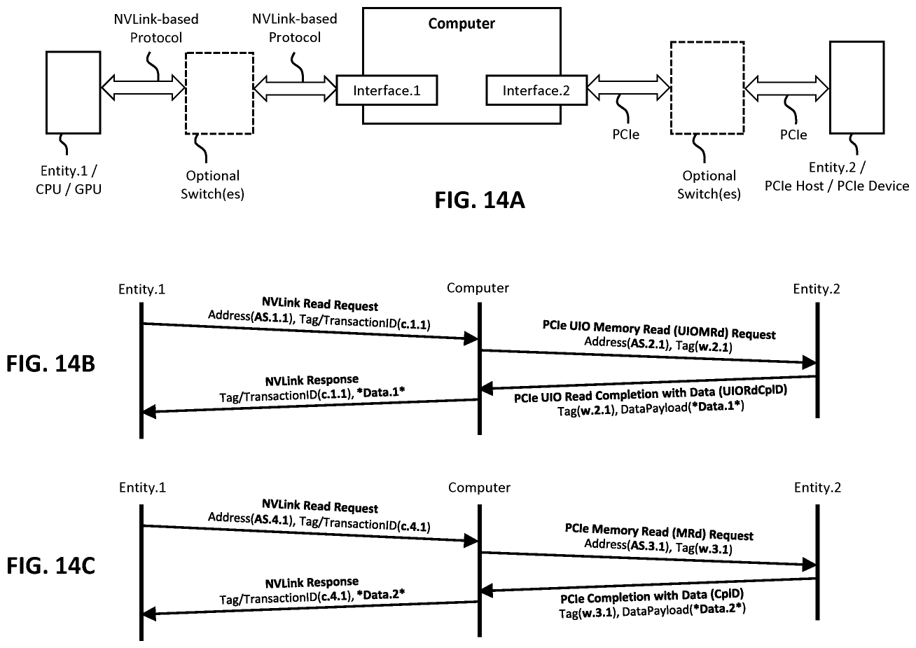

FIG. 14A illustrates an example of a system comprising a computer, which may be referred to as a semiconductor device, coupled between: (1) a first interface (Interface.1) that may communicate according to an NVLink-based protocol, such as a protocol utilizing an NVLink interconnect, with a first entity (Entity.1), which may be a CPU or a GPU; and (2) a second interface (Interface.2) that may communicate according to a PCIe-based protocol with a second entity (Entity.2), which may be a PCIe host or a PCIe device. The first interface may communicate bidirectionally with the first entity using the NVLink-based protocol. The second interface may communicate bidirectionally with the second entity using PCIe. The computer may be implemented in an IC package having high-speed differential I/O balls positioned according to a ball grid array (BGA) layout defined by a retimer specification, such as the PCIe 5.0, 6.0, or 7.0 Retimer Supplemental Features and Standard BGA Footprint Specification. The computer may translate between NVLink-based traffic communicated via the first interface and PCIe traffic communicated via the second interface, including translating physical addresses between a first address space associated with the NVLink-based protocol and a second address space associated with the PCIe protocol. Optional switch(es) may be positioned between the first interface and the first entity. Similarly, optional switch(es) may be positioned between the second interface and the second entity. The system may support bidirectional translation, wherein the computer may translate NVLink-based traffic to PCIe traffic in one direction, and may translate PCIe traffic to NVLink-based traffic in the opposite direction.

FIG. 14B illustrates an example of a TFD demonstrating translations, in one direction, between NVLink-based requests, such as NVLink read requests, received from a first entity (Entity.1), which may be a CPU or a GPU, and PCIe UIO TLPs sent to a second entity (Entity.2), which may be a PCIe host or a PCIe device. A semiconductor device or computer, positioned between the first entity and the second entity, may perform the translations, possibly enabling the first entity to access resources mapped to an address space utilized by the second entity. The first entity may initiate an NVLink request, which may be an NVLink read request, comprising a physical address Address(AS.1.1), such as a GPU physical address or an NVLink-based network address, and Tag/TransactionID(c.1.1), wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a PCIe UIO Memory Read (UIOMRd) request comprising Address(AS.2.1) and Tag(w.2.1), and may send the PCIe UIOMRd to the second entity. Upon receiving a completion from the second entity, which may include a PCIe UIO Read Completion with Data (UIORdCplD) comprising Tag(w.2.1) and DataPayload(*Data.1*), the computer may translate the PCIe UIORdCplD to an NVLink response comprising Tag/TransactionID(c.1.1) and *Data.1*, and may send the NVLink response to the first entity.

The computer may perform further translations, such as protocol translations, opcode translations, command translations, TLP type translations, and field translations between the NVLink-based domain and the PCIe domain. In some examples, the computer may issue multiple PCIe UIO memory read requests in response to receiving an NVLink request from the first entity, such as when splitting an NVLink request for a large block of data to smaller PCIe UIO memory read requests, or when prefetching data from the second entity. The computer may translate NVLink-based traffic to PCIe UIO traffic in one direction, and/or may translate PCIe UIO traffic to NVLink-based traffic in the opposite direction.

FIG. 14C illustrates an example of a TFD demonstrating translations, in one direction, between NVLink-based requests, such as NVLink read requests, received from a first entity (Entity.1), which may be a CPU or a GPU, and PCIe TLPs sent to a second entity (Entity.2), which may be a PCIe host or a PCIe device. A semiconductor device or computer, positioned between the first entity and the second entity, may perform the translations, possibly enabling the first entity to access resources mapped to an address space utilized by the second entity. The first entity may initiate an NVLink request, which may be an NVLink read request, comprising a physical address, such as a GPU physical address or an NVLink-based network address Address(AS.4.1), and Tag/TransactionID(c.4.1), wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a PCIe request, such as a PCIe Memory Read (MRd) request comprising a physical address, such as an HPA Address(AS.3.1), and Tag(w.3.1), and may send the PCIe MRd to the second entity. Upon receiving a completion from the second entity, which may include a PCIe Completion with Data (CplD) comprising Tag(w.3.1) and DataPayload(*Data.2*), the computer may translate the PCIe CplD to an NVLink response comprising Tag/TransactionID(c.4.1) and *Data.2*, and may send the NVLink response to the first entity.

The computer may perform further translations, such as protocol translations, opcode translations, command translations, TLP type translations, and field translations between the NVLink-based domain and the PCIe domain. In some examples, the computer may issue multiple PCIe memory read requests in response to receiving an NVLink request from the first entity, such as when splitting an NVLink request for a large block of data to smaller PCIe memory read requests, or when prefetching data from the second entity. The computer may translate NVLink-based traffic to PCIe traffic in one direction, and/or may translate PCIe traffic to NVLink-based traffic in the opposite direction.

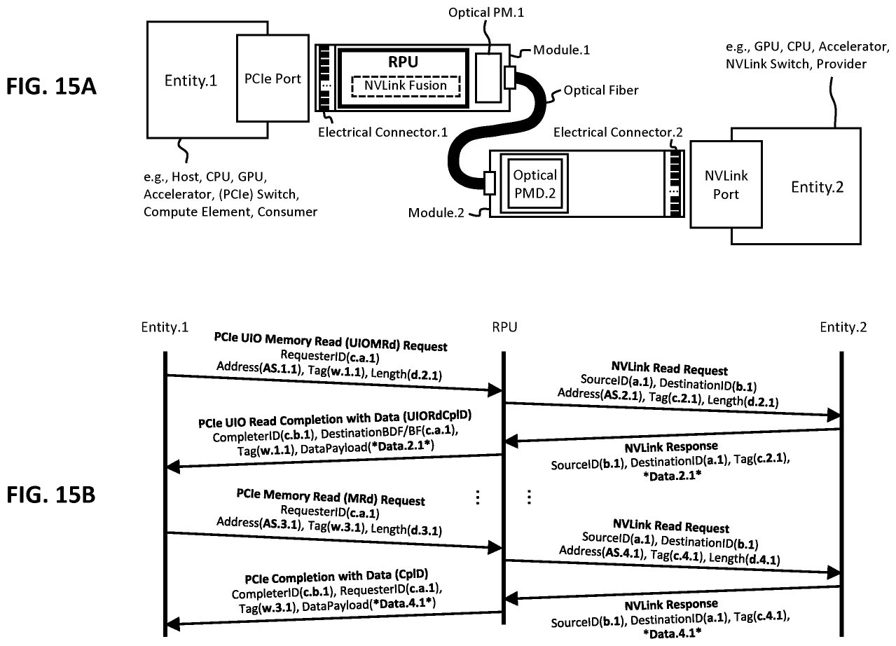

FIG. 15A illustrates an example of a cable comprising an RPU that translates between PCIe-based traffic and NVLink-based traffic. A first entity (Entity.1), which may be a host, a CPU, a GPU, an accelerator, a PCIe switch, or a compute element, and which may be referred to as a consumer, is coupled to a PCIe Port. The PCIe Port is coupled via a first electrical connector (Electrical Connector.1) to a first module (Module.1) within the cable. Module.1 may include an RPU, wherein the RPU may include an NVLink Fusion chiplet shown as an optional component, and an optical physical medium dependent (Optical PMD.1). The RPU within Module.1 may translate between PCIe-based traffic received from the first entity via the PCIe Port and NVLink-based traffic for transmission over the cable, and may translate between NVLink-based traffic received over the cable and PCIe-based traffic sent to the first entity. The cable may further include an optical fiber coupling Module.1 to a second module (Module.2), wherein the optical fiber carries NVLink-based traffic between the modules. Module.2 may include an optical physical medium dependent (Optical PMD.2). Module.2 is coupled via a second electrical connector (Electrical Connector.2) to an NVLink Port of a second entity (Entity.2), which may be a GPU, a CPU, an accelerator, or an NVLink switch, and which may be referred to as a provider. Placing the RPU in Module.1, closer to the PCIe Port, facilitates the translation from PCIe signaling to NVLink signaling at the entry point of the cable, such that the optical fiber carries NVLink-based traffic rather than PCIe-based traffic. NVLink may incorporate electrical signaling characteristics that are compatible with longer-reach interconnects, and may utilize a signaling rate higher than PCIe, and may therefore require fewer lanes for the same bandwidth. Consequently, placing the RPU closer to the PCIe Port may allow for reducing the number of optical fibers or optical wavelengths, which may simplify the cable design and reduce cost. In other examples, the RPU may reside in Module.2 instead of Module.1.

FIG. 15B illustrates an example of a TFD demonstrating translations, by an RPU, between PCIe-based requests received from a first entity (Entity.1) and NVLink-based requests sent to a second entity (Entity.2). The TFD illustrates two exemplary transactions, separated by a vertical ellipsis, demonstrating both PCIe UIO and standard PCIe paths. In a first exemplary transaction, the first entity may send a PCIe UIO Memory Read (UIOMRd) request comprising RequesterID(c.a.1), Address(AS.1.1), Tag(w.1.1), and Length(d.2.1). The RPU may translate the PCIe UIOMRd to an NVLink read request comprising SourceID(b.1), DestinationID(a.1), Address(AS.2.1), Tag(c.2.1), and Length(d.2.1), and may send the NVLink read request to the second entity. Upon receiving an NVLink response from the second entity comprising SourceID(b.1), DestinationID(a.1), Tag(c.2.1), and *Data.2.1*, the RPU may translate the NVLink response to a PCIe UIO Read Completion with Data (UIORdCplD) comprising CompleterID(c.b.1), DestinationBDF/BF(c.a.1), Tag(w.1.1), and DataPayload(*Data.2.1*), and may send the PCIe UIORdCplD to the first entity. The DestinationBDF/BF field in the UIORdCplD may correspond to the RequesterID of the originating UIOMRd, facilitating routing of the completion back to the requester.

In a second exemplary transaction, the first entity may send a PCIe Memory Read (MRd) request comprising RequesterID(c.a.1), Address(AS.3.1), Tag(w.3.1), and Length(d.3.1). The RPU may translate the PCIe MRd to an NVLink read request comprising SourceID(a.1), DestinationID(b.1), Address(AS.4.1), Tag(c.4.1), and Length(d.4.1), and may send the NVLink read request to the second entity. Upon receiving an NVLink response from the second entity comprising SourceID(b.1), DestinationID(a.1), Tag(c.4.1), and *Data.4.1*, the RPU may translate the NVLink response to a PCIe Completion with Data (CplD) comprising CompleterID(c.b.1), RequesterID(c.a.1), Tag(w.3.1), and DataPayload(*Data.4.1*), and may send the PCIe CplD to the first entity. In both transactions, the RPU may generate NVLink SourceID and DestinationID values when translating from PCIe requests, and may generate PCIe CompleterID values when translating NVLink responses to PCIe completions. The RPU may maintain state information, such as pending transaction tables, to correlate PCIe Tags with NVLink Tags and to associate completions with their corresponding requests. The RPU may translate physical addresses between the PCIe address space and the NVLink address space.

In various implementations, an apparatus comprising: an integrated circuit comprising processing cores comprising memory management units (MMUs) and coherent caches; wherein the processing cores are configured to respond to snoop requests that utilize physical addresses within a physical address space (PAS), and wherein the MMUs are configured to translate virtual addresses to physical addresses within the PAS; a coherent interconnect coupling the processing cores to memory controllers coupled to memory channels capable of supporting memory having a capacity of at least 64 GB, and wherein the processing cores are configured to execute an operating system (OS) that accesses the memory utilizing the physical addresses within the PAS; a resource provisioning unit (RPU) comprising an NVLink-based interface configured to communicate, according to an NVLink-based protocol, with an entity coupled to the apparatus; and wherein the RPU is further coupled to the coherent interconnect and configured to translate physical addresses associated with the NVLink-based protocol to physical addresses within the PAS; whereby the translate of the physical addresses enables the entity to access the memory via the NVLink-based interface and the memory controllers.

In some implementations of the apparatus, the NVLink-based interface comprises at least one differential pair and is configured to support reliable communication by utilizing at least one of: a replay buffer configured to enable retransmissions of packets that were not positively acknowledged by a receiver, or a Forward Error Correction (FEC) code configured to enable correction of symbol errors.

In some implementations of the apparatus, The apparatus of claim 1, wherein, in addition to the physical address translations, the RPU is further configured to translate between first fields conforming to the NVLink-based protocol message formats, and second fields conforming to message formats of a protocol utilized by the coherent interconnect.

In some implementations of the apparatus, the protocol utilized by the coherent interconnect is based on Coherent Hub Interface (CHI-based protocol), and the RPU is further configured to translate read requests corresponding to the NVLink-based protocol to requests corresponding to the CHI-based protocol carrying ReadOnce or ReadShared. The RPU may further translate CHI responses to NVLink responses, such as CHI responses carrying CompData to NVLink responses. Additionally, the RPU may maintain transaction context to properly correlate requests and responses across the protocol domains. The translation to CHI ReadOnce may be utilized for non-cacheable data accesses, while ReadShared may be utilized for cacheable shared data. The RPU may handle protocol-specific differences in flow control, credit management, and response ordering between the NVLink and CHI domains. The CompData responses from CHI may carry the requested data along with completion status, which the RPU translates into appropriate NVLink response formats.

In some implementations of the apparatus, the protocol utilized by the coherent interconnect is based on an Intel Coherent Processor Interconnect Protocol (ICPIP-based protocol) for scalable multiprocessors with a shared physical address space, and wherein the RPU is further configured to translate memory access requests corresponding to the NVLink-based protocol to requests corresponding to the ICPIP-based protocol, while maintaining coherency state tracking for physical addresses within the PAS that are associated with the coherent caches. Examples of ICPIP include Intel's Ultra Path Interconnect (UPI) and future Intel's Coherent Processor Interconnect Protocols. Optionally, the coherency state tracking between NVLink and ICPIP domains may include monitoring cacheline states and ensuring consistency across protocol boundaries. The RPU may include state machines to track outstanding transactions and their coherency implications. The translation may accommodate differences in data transfer granularity and response timing between NVLink and ICPIP protocols.

In some implementations of the apparatus, the protocol utilized by the coherent interconnect is based on Infinity Fabric (IF-based), and wherein the RPU is further configured to translate NVLink-based traffic to IF-based traffic, while preserving memory ordering required by the entity. The preservation of memory ordering may include tracking command dependencies and enforcing completion ordering as required by both NVLink and Infinity Fabric specifications. The RPU may include ordering enforcement logic that respect producer-consumer relationships and memory barrier semantics across the protocol boundary. The RPU may translate NVLink commands that include partial write indicators to appropriate Infinity Fabric write command types while maintaining data integrity.

In some implementations of the apparatus, the RPU is further configured to translate commands or encodings associated with the NVLink-based protocol to commands or opcodes associated with a protocol utilized by the coherent interconnect, based on a mapping between request types of the NVLink-based protocol and corresponding request types of the protocol utilized by the coherent interconnect. The mapping may be implemented utilizing lookup tables, state machines, or programmable translation logic. The RPU may handle various NVLink categories including memory reads, memory writes, and atomic operations, translating them to appropriate coherent interconnect opcodes while preserving transaction semantics.

In some implementations of the apparatus, the RPU is further configured to translate a request corresponding to the NVLink-based protocol to at least one message corresponding to the protocol utilized by the coherent interconnect; wherein the at least one message causes prefetch to a cache of a processor comprising the processing cores. The RPU may translate NVLink requests, such as requests carrying explicit or implicit prefetch hints, to messages of a protocol utilized by the coherent interconnect that effectively prefetch data into a cache of the processor, enabling reduced memory access latency for anticipated future accesses. An example of a prefetch hint may include a case wherein the RPU detects a pattern of reading pairs of addresses that are adjacent to each other or separated by a distinguishable stride.

In some implementations of the apparatus, the RPU is further configured to utilize an intermediate protocol selected from Peripheral Component Interconnect Express (PCIe) or Compute Express Link (CXL) when translating between the NVLink-based protocol and a protocol utilized by the coherent interconnect. The use of an intermediate protocol may facilitate translation by leveraging existing protocol conversion logic. When utilizing PCIe as an intermediate protocol, the RPU may translate NVLink traffic to PCIe Transaction Layer Packets (TLPs) and subsequently to coherent interconnect transactions. When utilizing CXL as an intermediate protocol, the RPU may leverage CXL.cache or CXL.mem as appropriate for the transaction type. The intermediate protocol stage may enable reuse of existing protocol bridges and translation logic.

In some implementations of the apparatus, the RPU is further configured to maintain mappings between transaction identifiers utilized by the NVLink-based protocol and transaction identifiers utilized by the coherent interconnect, enabling correlation of requests and responses across domains. The transaction identifier mappings may accommodate different identifier formats, sizes, and allocation schemes between NVLink and the coherent interconnect. Transaction identifiers may be used to identify a transaction, such as when supporting outstanding requests in-flight through the RPU, or may be used to convey properties associated with messages or transactions, such as trace identifiers used for debugging and performance measurements, or authorization identifiers used for security. The RPU may include identifier pools and allocation mechanisms to prevent identifier exhaustion and may support identifier recycling upon transaction completion. The mapping structures may be optimized for fast lookup during high-frequency transaction processing and may utilize on-silicon SRAM, content-addressable memory (CAM) or Ternary Content-Addressable Memory (TCAM) structures.

In some implementations of the apparatus, the RPU is further configured to: maintain a transaction tracking structure to monitor outstanding transactions from the entity, allocate coherent interconnect transaction identifiers for transactions initiated by the RPU, and release identifiers upon transaction completion. The transaction tracking structure may be implemented using content-addressable memories, linked lists, or circular buffers optimized for the expected transaction rates. The RPU may include timeout logic to handle lost or excessively delayed transactions and may support error recovery procedures. The tracking structure may maintain additional transaction attributes such as timestamps, retry counts, or quality-of-service parameters.

In some implementations of the apparatus, the RPU is further configured to enable bidirectional access by translating requests between messages conforming to the NVLink-based protocol and messages conforming to the protocol utilized by the coherent interconnect; whereby the entity accesses the memory according to the NVLink-based protocol, and the processing cores access resources attached to the entity via the coherent interconnect. The bidirectional access capability may enable memory pooling and memory sharing architectures wherein system memory and entity-attached memory form a memory space accessible from both domains via translations. The RPU may maintain separate translation contexts for each direction and may apply different translation policies based on the initiator and target of each transaction. The bidirectional capability may support various computing paradigms including GPU-direct operations and peer-to-peer transfers. When processing cores access entity-attached resources, such as High-Bandwidth Memory (HBM) resources, the RPU may handle different memory attributes between the two domains.

In some implementations of the apparatus, the entity comprises at least one of: high-bandwidth memory (HBM), High-Bandwidth Flash (HBF), Low-Power Double Data Rate (LPDDR) memory, or Graphics Double Data Rate (GDDR) memory; and wherein the RPU is further configured to map a portion of the entity memory into the PAS, enabling the processing cores to access the entity memory based on memory-mapped operations. The mapping of entity memory such as HBM, HBF, LPDDR, or GDDR memory into PAS may include establishing memory windows with specific attributes optimized for the memory type. The RPU may handle differences in memory access granularity, bandwidth characteristics, and latency profiles between system memory and entity memory. The memory-mapped operations may be subject to caching policies and coherency protocols appropriate for cross-domain memory access.

In some implementations of the apparatus, the RPU is further configured to provide access control by validating the physical addresses associated with the NVLink-based protocol against permitted address ranges for the entity, and blocking NVLink-based traffic targeting prohibited address ranges. The permitted address ranges may be configured utilizing secure configuration registers or loaded from trusted firmware during system initialization. The RPU may support different access control contexts for different operational modes or security domains. The blocking of prohibited traffic may generate error responses conforming to NVLink error reporting logic and may trigger security event logging.

In some implementations of the apparatus, the RPU is further configured to evaluate transaction attributes associated with the NVLink-based protocol, including source identifiers and access types, and to apply security policies to allow or deny traffic based on preconfigured security rules. The security policies may consider combinations of transaction attributes including source device identification, vendor-defined commands or fields, transaction type, address range, and temporal factors. The RPU may provide role-based access control wherein different entities have different access privileges. The security rules may be updateable utilizing authenticated channels and may support both static and dynamic security policy enforcement.

In some implementations of the apparatus, the RPU is further configured to detect access patterns in NVLink-based traffic from the entity, and generates prefetch requests based on predicted future accesses; and wherein the prefetch requests are routed via the coherent interconnect and the memory controllers. The access pattern detection may utilize algorithms such as stride detection, stream buffers, or correlation-based prediction algorithms. The RPU may maintain pattern history tables to track access behaviors and may adapt prefetching aggressiveness based on prefetch accuracy metrics. The prefetch requests may be tagged with lower priority to avoid interfering with demand requests and may be cancelled if subsequent access patterns diverge from predictions.

In some implementations of the apparatus, the RPU is further configured to coalesce coherent interconnect transactions targeting contiguous or nearby addresses into fewer NVLink-based transactions; whereby the coalescing improves memory bandwidth utilization. The request coalescing may consider factors including address proximity, request types, and timing windows when determining which transactions to combine. The RPU may include write combining buffers for write transactions and may support read coalescing for sequential read patterns. In one example, coherent interconnects may use up to 64-byte transfers, that may reflect a nominal cacheline size utilized by the coherent interconnect, whereas NVLink may use larger transfers up to 256 bytes, making coalescing beneficial for bandwidth efficiency.

In some implementations of the apparatus, the NVLink-based interface is configured to support virtual channels, and the RPU is further configured to map the virtual channels to quality-of-service (QoS) attributes in a protocol utilized by the coherent interconnect. The virtual channel to QoS mapping may enable differentiated service levels for different traffic classes, such as bulk data transfers versus latency-sensitive communications. The RPU may include programmable mapping tables to allow flexible QoS policy configuration. The mapping may consider both NVLink virtual channel priorities and coherent interconnect QoS mechanisms to maintain end-to-end service level objectives.

In some implementations of the apparatus, the memory comprises dynamic random-access memory (DRAM), and the entity comprises a graphics processing unit (GPU) or an accelerator coupled to the apparatus via the NVLink-based interface; and wherein the RPU enables the entity to access the DRAM with cache-line granularity. An entity, such as a GPU or an accelerator, may utilize the NVLink interface for memory access to memory resources attached to the processor. Optionally, when the entity is coupled through an NVLink switch, the RPU may handle switch-specific routing information and may support entities sharing the NVLink interface through switch-based connectivity. The GPU or accelerator entity may utilize the NVLink interface for high-bandwidth memory access patterns characteristic of parallel computing workloads. The RPU may optimize translations for the specific access patterns and bandwidth requirements of GPU or accelerator workloads.

In various implementations, a method for enabling an entity to access memory via an NVLink-based interface, comprising: operating a processor comprising processing cores, memory management units (MMUs), and coherent caches; wherein the processing cores respond to snoop requests that utilize physical addresses within a physical address space (PAS), and the MMUs translate virtual addresses to physical addresses within the PAS; communicating, via a coherent interconnect, between the processing cores and memory controllers that communicate with memory channels coupled to memory having a capacity of at least 64 GB; executing, by the processing cores, an operating system (OS) that accesses the memory utilizing the physical addresses within the PAS; communicating according to an NVLink-based protocol with the entity via an NVLink-based interface; and translating physical addresses associated with the NVLink-based protocol to physical addresses within the PAS.

In some implementations, the method further comprises translating from non-address fields conforming to the NVLink-based protocol message formats to corresponding fields conforming to message formats of a protocol utilized by the coherent interconnect; and wherein the translating of the physical addresses is performed by a resource provisioning unit (RPU) coupled between the NVLink-based interface and the coherent interconnect.

In some implementations of the method, the protocol utilized by the coherent interconnect is based on Coherent Hub Interface (CHI-based protocol); and wherein the translating between non-address fields comprises translating NVLink-based protocol read commands to CHI-based protocol opcodes or commands comprising ReadOnce or ReadShared. The method may further include translating CHI response opcodes to NVLink response opcodes, such as translating CHI responses carrying CompData to NVLink responses.

In some implementations of the method, the protocol utilized by the coherent interconnect is based on an Intel Coherent Processor Interconnect Protocol (ICPIP-based protocol) for scalable multiprocessors with a shared physical address space; and wherein the translating between non-address fields comprises translating NVLink-based protocol memory access commands to ICPIP-based protocol requests while maintaining coherency state tracking between domain of the NVLink-based protocol and domain of the ICPIP-based protocol.

In some implementations of the method, the protocol utilized by the coherent interconnect is based on Infinity Fabric (IF-based); and wherein the translating between non-address fields comprises translating NVLink-based commands to IF-based commands while preserving memory ordering required by the entity.

In some implementations, the method further comprises translating NVLink-based commands to commands associated with a protocol utilized by the coherent interconnect, based on a mapping between NVLink-based transaction types and corresponding transaction types of the protocol utilized by the coherent interconnect. It is noted that in the context of such implementations, NVLink-based commands and NVLink-based encodings may be used interchangeably.

In some implementations of the method, the translating of the physical addresses comprises utilizing an intermediate protocol selected from Peripheral Component Interconnect Express (PCIe) or Compute Express Link (CXL) as an intermediate stage between the NVLink-based protocol and a protocol utilized by the coherent interconnect.

In some implementations, the method further comprises translating transaction identifiers utilized by the NVLink-based protocol to transaction identifiers utilized by the coherent interconnect, maintaining a transaction tracking structure to monitor outstanding transactions from the entity, allocating coherent interconnect transaction identifiers for RPU-initiated transactions, and releasing identifiers upon transaction completion.

In some implementations, the method further comprises validating the physical addresses associated with the NVLink-based protocol against permitted address ranges for the entity, and blocking NVLink-based traffic targeting prohibited address ranges; and further comprising evaluating NVLink-based traffic attributes including source identifiers and access types, and applying security policies to allow or deny traffic based on preconfigured security rules.

In some implementations, the method further comprises detecting access patterns in NVLink-based traffic from the entity, and generating prefetch requests based on predicted future accesses, wherein the prefetch requests are routed via the coherent interconnect and the memory controllers.

In various implementations, a system comprising: a host processor; a memory having a capacity of at least 64 GB; a coherent interconnect architecture coupling processing elements to the memory, wherein the processing elements utilize a local physical address space to access the memory; and a resource provisioning unit (RPU) configured to translate physical addresses associated with an NVLink-based protocol, utilized by an entity coupled to the RPU via an NVLink-based interface, to physical addresses within the local physical address space; whereby the translate of the physical addresses enables the entity to utilize the memory as disaggregated memory accessed via the NVLink-based interface and the memory controllers.

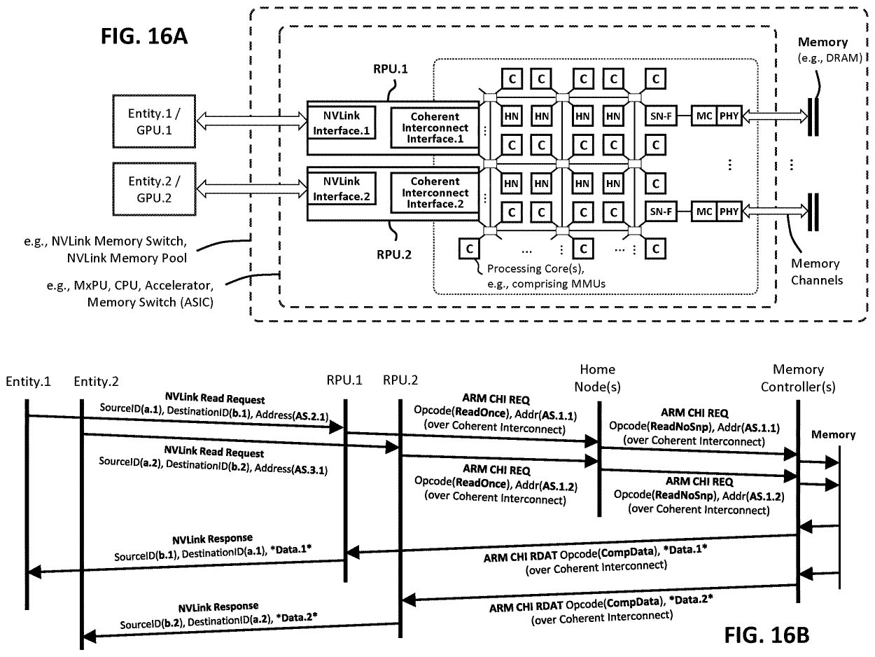

FIG. 16A illustrates an example of a system that may function as an NVLink memory switch appliance or an NVLink memory pool, and may include an MxPU, CPU, accelerator, or a memory switch ASIC, that is coupled to two entities denoted as Entity.1/GPU.1 and Entity.2/GPU.2. The MxPU includes processing cores and memory controllers coupled to a coherent interconnect that may be based on CHI. The MxPU utilizes translations, performed by the RPUs, between NVLink-based interfaces and an MxPU's coherent interconnect. The first RPU (RPU.1) may enable Entity.1/GPU.1 to access resources mapped to a physical address space utilized by the MxPU's coherent interconnect, wherein the access is via the first NVLink interface and the MxPU's coherent interconnect. Examples of resources mapped to the physical address space utilized by the MxPU's coherent interconnect include DRAM or other memory resources of the MxPU. Correspondingly, the second RPU (RPU.2) may enable Entity.2/GPU.2 to access, via the second NVLink interface and the MxPU's coherent interconnect, resources mapped to a physical address space utilized by the MxPU's coherent interconnect, such as memory resources of the MxPU.

FIG. 16B illustrates an example of a TFD depicting a multi-entity memory access scenario wherein first and second entities/GPUs access memory mapped to one or more physical address spaces utilized by the coherent interconnect (CohInterMappedMemory), through NVLink to ARM CHI translations. Entity.1/GPU.1 initiates a first NVLink request: Read with SourceID(a.1) to identify the source GPU, DestinationID(b.1) to identify the destination GPU, and Address(AS.2.1) representing an NVLink network address from a second physical address space. RPU.1 translates the first NVLink request to ARM CHI REQ carrying Opcode(ReadOnce), and Addr(AS.1.1) from a first physical address space utilized by the coherent interconnect. Concurrently or sequentially, Entity.2/GPU.2 may initiate a second NVLink request: Read with SourceID(a.2), DestinationID(b.2), and Address(AS.3.1) representing an NVLink network address optionally from a third physical address space or from the second physical address space. RPU.2 translates the second NVLink request to ARM CHI REQ carrying Opcode(ReadOnce) and Addr(AS.1.2) from the first physical address space utilized by the coherent interconnect.

Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively. The memory controller(s) retrieve the requested data from the CohInterMappedMemory and send first and second ARM CHI RDAT messages with Opcode(CompData) carrying *Data.1* and *Data.2*, representing the data retrieved from the addresses AS.1.1 and AS.1.2, respectively. RPU.1 translates the first ARM CHI RDAT message to NVLink response with SourceID(b.1), DestinationID(a.1), and *Data.1* for Entity.1/GPU.1. RPU.2 translates the second ARM CHI RDAT message to NVLink response with SourceID(b.2), DestinationID(a.2), and *Data.2* for Entity.2/GPU.2 . The illustrated example demonstrates how entities/GPUs may share access to the same CohInterMappedMemory through different RPUs that translate between NVLink and ARM CHI, including physical address translations. Alternatively, the illustrated example may be viewed as two separate NVLink transactions that utilize the same coherent interconnect infrastructure to access CohInterMappedMemory, wherein the GPU entities may access the CohInterMappedMemory via a shared or separate address spaces that are translated to the shared coherent interconnect physical address space. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

Depending on system characteristics, such as implementation choices and platform configurations, different physical addresses, such as (AS.1.1) and (AS.1.2), within a physical address space utilized by the coherent interconnect, may be typically partitioned, such as via hashing or interleaving schemes, across a set of home nodes. Such partitioning is typically performed in order to reduce bottleneck effects in the system and spread the load of transaction processing across home nodes of the coherent interconnect, and may result in mapping the different physical addresses, such as (AS.1.1) and (AS.1.2), to the same home node, or to different home nodes. Similarly, different physical addresses may be associated with one memory controller, or with different memory controllers, such as according to a separate mapping scheme, which may be different from the mapping scheme utilized for selecting a home node for processing the request. Alternatively, other implementations may co-locate the home node function with a specific memory controller, utilizing a unified mapping scheme that selects both a home node and a memory controller.

In some implementations, a computer, such as an RPU, may be coupled between an NVLink interface and a CXL interface, and may translate between NVLink-based traffic and CXL.mem traffic. The computer may receive NVLink-based requests from a first entity, such as a GPU or an accelerator, and may translate the NVLink-based requests to CXL.mem M2S requests for transmission to a second entity, such as a CXL device, a CXL memory expander, or a CXL memory pool. The translation may include address translation between physical address spaces, opcode translation between NVLink commands and CXL.mem memory opcodes, and Tag translation between NVLink transaction identifiers and CXL.mem Tags. The computer may be implemented as a discrete component, as a chiplet within an IC package, as an IP block within a processor, or may be integrated into an active cable or an NVLink switch. The translation may enable NVLink-coupled accelerators to access CXL memory resources for GPU memory disaggregation, capacity expansion, AI model parameter storage, key-value (KV) cache offloading, and other memory-intensive AI workloads.

In various implementations, a method comprising: receiving, by a computer from a first entity via a first interface that communicates according to an NVLink-based protocol, an NVLink-based request comprising a first physical address associated with a first address space; translating, by the computer, the first physical address to a second physical address associated with a second address space; generating, by the computer, a CXL.mem Master-to-Subordinate (M2S) request comprising a read-class memory opcode and the second physical address, wherein CXL denotes Compute Express Link; sending, by the computer via a second interface, the CXL.mem M2S request to a second entity; receiving, by the computer from the second entity, a CXL.mem Subordinate-to-Master Data Response with Status (S2M DRS) comprising data; and sending, by the computer to the first entity, an NVLink-based response comprising the data. The computer may translate the NVLink-based request by terminating the NVLink transaction and initiating a corresponding CXL.mem transaction. For example, the read-class memory opcode may include MemRd, MemRdData, or other read-class opcodes defined by CXL.mem. The address translation may be implemented utilizing lookup tables, page tables, base-and-offset calculations, or programmable translation functions. The computer may translate requests initiated from the NVLink-based domain to the CXL domain, may translate requests initiated from the CXL domain to the NVLink-based domain, or may translate requests initiated from both domains.

In some implementations of the method, the NVLink-based request is associated with a data payload size exceeding a maximum CXL.mem data payload size, and wherein generating the CXL.mem M2S request comprises generating CXL.mem M2S requests corresponding to the NVLink-based request. For example, an NVLink-based read request for 256 Bytes of data may be translated to four CXL.mem M2S requests, each targeting a 64-Byte cacheline. The computer may generate the CXL.mem M2S requests with sequential or non-sequential addresses derived from the first physical address.

In some implementations, the method further comprises accumulating data from CXL.mem S2M DRS responses corresponding to the CXL.mem M2S requests before sending the NVLink-based response to the first entity. The computer may buffer partial data from individual S2M DRS responses and assemble the complete data payload before generating the NVLink-based response. The S2M DRS responses may arrive out of order, and the computer may utilize Tag mappings to associate each response with the corresponding CXL.mem M2S request.

In some implementations, the method further comprises maintaining, by the computer, a mapping between a first Tag associated with the NVLink-based request and a second Tag associated with the CXL.mem M2S request, and utilizing the mapping to associate the CXL.mem S2M DRS with the NVLink-based request. The mapping may be stored in a tracker entry, a translation table, or a content-addressable memory. The first Tag may include an NVLink Tag or TransactionID, and the second Tag may be a CXL.mem Tag allocated from a Tag space utilized by the computer toward the second entity.

In some implementations, the method further comprises generating, by the computer, a second CXL.mem M2S request comprising a MemSpecRd opcode and a third physical address; and sending the second CXL.mem M2S request to the second entity. The computer may generate speculative read requests to prefetch data from the second entity before, or without, the first entity explicitly requesting it. The speculative reads may reduce read latency when the second entity exhibits long access times, such as when accessing slow memory media or remote memory resources over a fabric.

In some implementations of the method, the first address space comprises an NVLink-based network address space or a GPU physical address space, and the second address space comprises a Host Physical Address (HPA) space; and wherein the first entity comprises a GPU, an accelerator, or an NVLink switch, and the second entity comprises a CXL device, a CXL memory expander, or a CXL memory pool. The NVLink-based network address space may be utilized for routing NVLink requests across the NVLink fabric. The HPA space may be utilized by a CXL host or CXL device for memory access operations. The address translation may accommodate differences in size, base addresses, or memory layouts between the address spaces.

In some implementations of the method, the CXL.mem S2M DRS further comprises a Poison indication, and the NVLink-based response further comprises an error indication translated from the Poison indication. The Poison indication in CXL.mem S2M DRS may signal that the data contains an error. The computer may translate the Poison indication to an equivalent error indication in the NVLink-based response to propagate the error status to the first entity.

In some implementations, the method further comprises receiving, from the first entity via the first interface, an NVLink-based write request comprising write data; generating, by the computer, a CXL.mem Master-to-Subordinate Request with Data (M2S RwD) comprising MemWr* and the write data; sending the CXL.mem M2S RwD to the second entity via the second interface; receiving, from the second entity, a CXL.mem Subordinate-to-Master No Data Response (S2M NDR); and sending an NVLink-based write response to the first entity. For example, MemWr* may include MemWr, MemWrPtl, or other memory write opcode variants defined by CXL.mem. The write data may be transferred from the NVLink domain to the CXL.mem domain with optional byte enable manipulation when the write is partial. The S2M NDR may include a Cmp opcode indicating completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to an NVLink-based protocol and a second interface configured to communicate according to CXL, with a computer coupled between the interfaces. The computer may be implemented in various form factors, such as an IC package conforming to a retimer BGA specification, an NVLink Fusion chiplet within a processor IC package, a discrete bridge device, or a component integrated into an active cable or an NVLink switch. The system may include optional NVLink switches and CXL switches to support multi-entity topologies. The computer may translate between physical address spaces and between NVLink-based requests and CXL.mem M2S requests, enabling NVLink-coupled entities to access CXL memory resources.

In various implementations, a system comprising: a first interface configured to communicate according to an NVLink-based protocol with a first entity; a second interface configured to communicate according to Compute Express Link (CXL) with a second entity; and a computer coupled between the first and second interfaces, configured to: translate physical addresses associated with the NVLink-based protocol to physical addresses associated with CXL; and translate between NVLink-based requests received via the first interface and CXL.mem Master-to-Subordinate (M2S) requests transmitted via the second interface. The computer may further translate CXL.mem S2M responses received via the second interface to NVLink-based responses transmitted via the first interface. The computer may include logic for address translation, Tag management, protocol conversion, and transaction tracking. The system may be deployed in datacenters, HPC environments, or AI training and inference clusters to enable NVLink-coupled accelerators to access CXL-attached memory resources such as CXL memory expanders or CXL memory pools.

In some implementations of the system, the computer is packaged in an integrated circuit (IC) package comprising input/output (I/O) connection points arranged according to a retimer ball grid array (BGA) specification. The retimer BGA form factor may enable the computer to be deployed in existing retimer sockets within server platforms, optionally facilitating adoption without requiring board-level redesign.

In some implementations, the system further comprises at least one of: an NVLink switch coupled between the first interface and the first entity, the NVLink switch configured to route NVLink-based requests from NVLink entities to the first interface; or a CXL switch coupled between the second interface and the second entity, the CXL switch configured to route CXL.mem M2S requests to CXL devices or CXL memory pools. The NVLink switch may be an NVSwitch that aggregates traffic from accelerators/GPUs toward the computer. The CXL switch may enable the computer to access multiple CXL memory devices or memory pools via a CXL interface, expanding the addressable memory capacity.

In some implementations of the system, the computer comprises an NVLink Fusion chiplet within an integrated circuit (IC) package of a processor, the NVLink Fusion chiplet comprising the first interface and coupled to the processor via a die-to-die (D2D) interface, the D2D interface utilizing a Universal Chiplet Interconnect Express (UCIe) PHY or a proprietary chip-to-chip PHY. The NVLink Fusion chiplet may enable integration of NVLink connectivity into processors that may not have native NVLink support. The D2D interface may couple the chiplet to a coherent interconnect within the processor, such as an on-chip ring or mesh interconnect.

In some implementations of the system, the NVLink-based protocol and CXL are associated with a same physical address space, the same physical address space comprising a global address space, a pod address space, or a fabric address space. When both protocols are associated with the same physical address space, the computer may perform address translations between addresses within the same space, such as range adjustments or offset calculations, rather than translations between fundamentally different address spaces.

In some implementations, a computer may translate CXL.mem requests to NVLink-based requests, enabling CXL hosts or CPUs to access memory residing on an NVLink fabric via NVLink-coupled entities such as accelerators/GPUs. NVLink provides a distributed memory model where GPUs may access memory via other GPUs. This translation may provide a CXL.mem bridge or gateway for non-NVLink compute elements, such as CPUs, to access memory on the NVLink fabric. The computer may be implemented as a discrete component, integrated into an active cable, or included in an NVLink switch.

In various implementations, a method comprising: receiving, by a computer from a first entity via a first interface that communicates according to Compute Express Link (CXL), a CXL.mem Master-to-Subordinate (M2S) request comprising a read-class memory opcode and a first physical address associated with a first address space; translating, by the computer, the first physical address to a second physical address associated with a second address space; generating, by the computer, an NVLink-based request comprising the second physical address; sending, by the computer via a second interface that communicates according to an NVLink-based protocol, the NVLink-based request to a second entity; receiving, by the computer from the second entity, an NVLink-based response comprising data; and generating, by the computer, a CXL.mem Subordinate-to-Master Data Response with Status (S2M DRS) comprising the data, and sending the CXL.mem S2M DRS to the first entity. The computer may translate the CXL.mem M2S request by terminating the CXL.mem transaction and initiating a corresponding NVLink transaction. The read-class memory opcode in the CXL.mem M2S request may include opcodes such as MemRd, MemRdData, or MemSpecRd. The computer may translate the HPA from the CXL.mem M2S request to an NVLink network address utilized for routing the NVLink request to its destination on the NVLink fabric. The CXL.mem S2M DRS may carry a MemData opcode and the data retrieved from the second entity.

In some implementations, the method further comprises maintaining, by the computer, a mapping between a first Tag associated with the CXL.mem M2S request and a second Tag associated with the NVLink-based request, and utilizing the mapping to associate the NVLink-based response with the CXL.mem M2S request. Upon receiving the NVLink-based response, the computer may utilize the second Tag to retrieve the first Tag from the mapping and include the first Tag in the CXL.mem S2M DRS for transaction completion at the first entity.

In some implementations of the method, the first address space comprises a Host Physical Address (HPA) space, and the second address space comprises an NVLink-based network address space; and wherein the NVLink-based request further comprises a DestinationID derived from the first physical address, the DestinationID identifying a target entity on an NVLink fabric coupled to the second interface. The computer may derive the DestinationID from the translated address, from a routing table, or from address-range-to-destination mappings. The DestinationID may be utilized for routing the NVLink request through NVLink switches to the target entity on the NVLink fabric.

In some implementations of the method, the first entity comprises a CXL host or a CPU, and the second entity comprises a GPU, an NVLink switch, or an accelerator; and wherein the NVLink-based response comprises data retrieved from a memory accessible via the second entity on an NVLink fabric. The translation may enable CPUs to access GPU-attached memory, such as HBM and/or High-Bandwidth Flash (HBF), via the CXL.mem-to-NVLink bridge, facilitating scenarios where CPUs participate alongside NVLink GPUs in AI inference or training workloads.

In some implementations, the method further comprises receiving, from the second entity, a second NVLink-based response that does not carry data; and generating a CXL.mem Subordinate-to-Master No Data Response (S2M NDR) based on the second NVLink-based response, and sending the CXL.mem S2M NDR to the first entity. The S2M NDR may carry a Cmp opcode to indicate completion of a write or invalidation operation. The computer may translate NVLink completion indications to the corresponding CXL.mem S2M NDR opcode.

In some implementations, the method further comprises receiving, from the first entity via the first interface, a CXL.mem Master-to-Subordinate Request with Data (M2S RwD) comprising MemWr* and write data; generating, by the computer, an NVLink-based write request comprising the write data; sending the NVLink-based write request to the second entity via the second interface; receiving, from the second entity, an NVLink-based write response; and generating a CXL.mem Subordinate-to-Master No Data Response (S2M NDR), and sending the CXL.mem S2M NDR to the first entity. MemWr* may include MemWr, MemWrPtl, or other memory write opcode variants. The computer may translate the CXL.mem write data and byte enables to corresponding NVLink write request formats. The S2M NDR may be sent after the NVLink-based write response is received, or may be sent before the NVLink write completes as an early completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to CXL and a second interface configured to communicate according to an NVLink-based protocol, with a computer coupled between the interfaces to translate CXL.mem M2S requests to NVLink-based requests. The computer may be integrated into an active cable, included in an NVLink switch, or implemented as a discrete bridge device. The system may position the computer closer to the CXL interface for signal integrity, since CXL runs over PCIe electricals designed for shorter-reach connectivity, while NVLink may incorporate signaling compatible with longer-reach deployments.

In various implementations, a system comprising: a first interface configured to communicate according to Compute Express Link (CXL) with a first entity; a second interface configured to communicate according to an NVLink-based protocol with a second entity; and a computer coupled between the first and second interfaces, configured to: translate physical addresses associated with CXL to physical addresses associated with the NVLink-based protocol; and translate between CXL.mem Master-to-Subordinate (M2S) requests received via the first interface and NVLink-based requests transmitted via the second interface. The computer may further translate NVLink-based responses received via the second interface to CXL.mem S2M responses transmitted via the first interface. The system may enable CXL hosts or CPUs to access memory on an NVLink fabric, such as GPU-attached HBM and/or HBF, via the NVLink-based protocol. The computer may maintain transaction tracking structures for matching NVLink responses to pending CXL.mem requests.

In some implementations, the system further comprises an active cable comprising a first pluggable module coupled to the first interface, a second pluggable module coupled to the second interface, and a physical medium coupling the first and second pluggable modules; wherein the computer is integrated into the active cable and converts between CXL signaling conforming to PCIe electrical specifications at the first interface and NVLink signaling at the second interface. The physical medium may include twinaxial cable, multimode fiber, or single-mode fiber. The active cable may be implemented as an Active Optical Cable (AOC) or an Active Copper Cable (ACC). The signaling conversion within the cable may simplify system integration by presenting standard CXL and NVLink interfaces at each end.

In some implementations of the system, the second interface utilizes fewer lanes than the first interface, and wherein the NVLink-based protocol operates at a higher per-lane signaling rate than CXL, such that the second interface achieves a bandwidth comparable to the first interface utilizing the fewer lanes. The lane reduction may simplify cable design by reducing the number of copper wires or optical fibers, which may reduce cost and complexity of the interconnect while maintaining bandwidth parity between the two interfaces.

In some implementations of the system, the computer is positioned closer to the first interface than to the second interface; and wherein the first interface communicates via electrical signaling conforming to PCIe physical layer specifications designed for shorter-reach connectivity, and the second interface communicates via electrical signaling compatible with longer-reach interconnect deployments. Positioning the computer closer to the CXL interface may improve signal integrity for the shorter-reach CXL signaling, while the longer-reach NVLink signaling may tolerate the additional distance to the second entity.

In some implementations of the system, the computer is included in an NVLink switch, the NVLink switch coupled to NVLink entities via the second interface; and wherein the computer translates CXL.mem M2S requests from the first entity to NVLink-based requests directed to at least one of the NVLink entities. The NVLink switch may route the translated NVLink-based requests to the appropriate NVLink entity based on destination identifiers or address-based routing. Integrating the computer into the NVLink switch may enable a CXL host to access memory across multiple NVLink-coupled accelerators/GPUs.

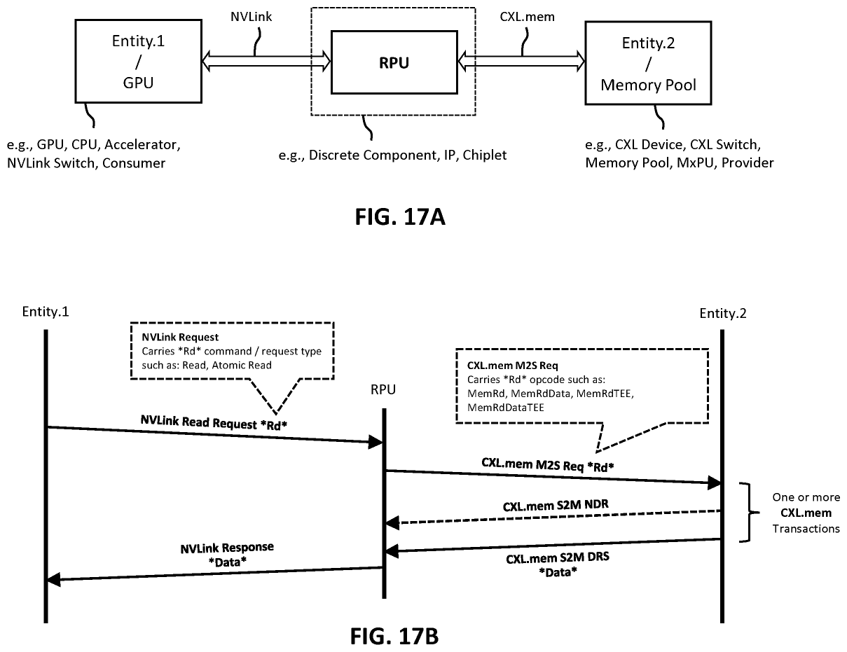

FIG. 17A illustrates an example of a system comprising an apparatus, such as an RPU, coupled between a first entity (Entity.1) and a second entity (Entity.2). The RPU may translate between NVLink-based traffic and CXL-based traffic, such as CXL.mem traffic. Entity.1, shown as a GPU, may communicate with the RPU according to an NVLink-based protocol, and may include a GPU, CPU, Accelerator, NVLink Switch (NVSwitch), or other resource consumer. Entity.2, shown as a Memory Pool, may communicate with the RPU according to CXL.mem, and may include a CXL Device, CXL Switch, Memory Pool, MxPU, or other resource provider. The RPU may be implemented as a discrete component, an IP block within a processor, or a chiplet within an IC package. Additionally or alternatively, the RPU may translate between the NVLink-based traffic and CXL.io traffic, and/or between the NVLink-based traffic and CXL.cache traffic.

FIG. 17B illustrates an example of a Transaction Flow Diagram (TFD) demonstrating an apparatus, such as an RPU, that may translate between NVLink-based traffic and CXL-based traffic, such as CXL.mem traffic. The TFD shows three entities: Entity.1 (a GPU or Consumer) on the left, the RPU in the center, and Entity.2 (a CXL Device or Provider) on the right. The first entity may send an NVLink Read Request carrying a *Rd* command or request type, such as Read or Atomic Read, to the RPU. The RPU may translate the NVLink Read Request to a CXL.mem M2S Req carrying a *Rd* opcode, such as MemRd, MemRdData, MemRdTEE, or MemRdDataTEE, and may send the CXL.mem M2S Req to the second entity. The second entity may respond with one or more CXL.mem transactions, including a CXL.mem S2M NDR and/or a CXL.mem S2M DRS carrying *Data*. The RPU may translate the CXL.mem S2M DRS to an NVLink Response carrying *Data* and send the NVLink Response to the first entity. In some examples, the RPU may translate an NVLink-based request to multiple CXL.mem request, such as when splitting an NVLink request for a data payload of 256 Bytes to CXL.mem M2S requests each carrying 64 Bytes. The RPU may accumulate data from one or more CXL.mem S2M DRS messages before sending the data via an NVLink-based response.

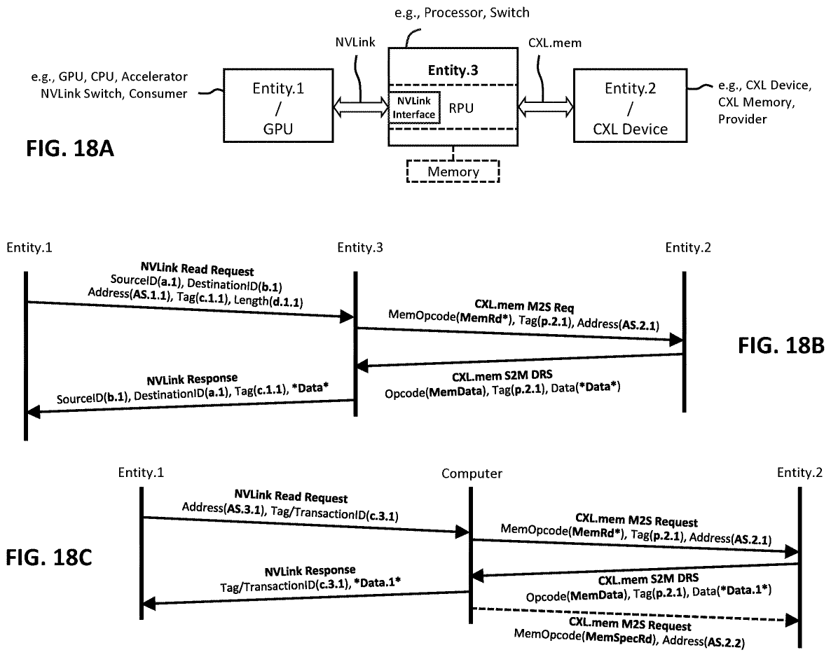

FIG. 18A illustrates an example of a system comprising a third entity (Entity.3), such as a processor or a switch. Entity.3 includes an NVLink Interface and an RPU, and includes or is coupled to an optional Memory. Entity.3 is coupled to a first entity (Entity.1), which may be a GPU, CPU, Accelerator, NVLink Switch (NVSwitch), or resource consumer, via an NVLink-based protocol. Entity.3 is further coupled to a second entity (Entity.2), which may be a CXL Device, CXL Memory, or resource provider, via CXL.mem. In some examples, messages conforming to the NVLink-based protocol may be associated with a first physical address (PA) space, such as a GPU physical address space or an NVLink-based network address space, and messages conforming to CXL.mem may be associated with a second PA space, such as HPA space. The RPU may perform address translations between addresses within the first PA space and addresses within the second PA space. In other examples, messages conforming to the NVLink-based protocol and messages conforming to CXL.mem may be associated with the same PA space, such as a global address space. Optionally, the RPU may perform further translations between the NVLink-based domain and CXL.mem domain, such as protocol translations, opcode translations, command translations, and field translations.

FIG. 18B illustrates an example of a TFD demonstrating translations performed by a third entity (Entity.3), such as a processor, a switch, or an RPU, between messages conforming to an NVLink-based protocol utilized for communicating with a first entity (Entity.1), such as a GPU, a CPU, or an accelerator, and messages conforming to CXL.mem utilized for communicating with a second entity (Entity.2), such as a CXL device or CXL memory. The first entity may initiate an NVLink Read Request comprising SourceID(a.1), DestinationID(b.1), Address(AS.1.1), Tag(c.1.1), and Length(d.1.1), wherein SourceID(a.1) may denote the NVLink interconnect address utilized by the requesting entity, and DestinationID(b.1) may denote the NVLink interconnect address utilized by the target of the NVLink request. The third entity may translate the NVLink request to a CXL.mem M2S Req comprising MemOpcode(MemRd*), Tag(p.2.1), and Address(AS.2.1), and may send the CXL.mem M2S Req to the second entity. Upon receiving a response from the second entity, which may include a CXL.mem S2M DRS comprising Opcode(MemData), Tag(p.2.1), and Data(*Data*), the third entity may translate the CXL.mem S2M DRS to an NVLink Response comprising SourceID(b.1), DestinationID(a.1), Tag(c.1.1), and *Data*. The third entity may perform further translations, such as protocol translations, opcode translations, command translations, or translations between PDUs conforming to the NVLink-based protocol and messages conforming to CXL.mem, such as translations of Tags and translations of error indications, such as poison.

FIG. 18C illustrates an example of a TFD demonstrating translations, such as address translations, optionally performed by a computer, between NVLink-based requests received from a first entity (Entity.1), which may be a CPU or a GPU, and CXL.mem requests sent to a second entity (Entity.2), which may be a CXL device. The first entity may initiate an NVLink Read Request comprising Address(AS.3.1) and Tag/TransactionID(c.3.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.mem M2S Request comprising MemOpcode(MemRd*), Tag(p.2.1), and Address(AS.2.1), and may send the CXL.mem M2S Request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to an NVLink response comprising Tag/TransactionID(c.3.1) and *Data.1*, and send the NVLink response to the first entity. The computer may further initiate speculative memory reads targeting the second entity, such as a CXL.mem M2S request comprising MemOpcode(MemSpecRd) and Address(AS.2.2), to facilitate data prefetches and potentially reduce read latency from the second entity. Optionally, the computer may utilize the speculative memory reads on behalf of the first entity. When utilizing MemSpecRd, some of the CXL.mem M2S Req fields, such as Tag, MetaField, MetaValue, and SnpType, may be reserved. In some examples, the computer may issue multiple CXL.mem reads in response to receiving an NVLink request from the first entity, such as when splitting an NVLink request for a large block of data (e.g., 256 B) to smaller CXL.mem reads (e.g., 64 B each), or when prefetching data from the second entity utilizing CXL.mem reads. The computer may translate requests or transactions initiated from the NVLink-based domain to the CXL domain, and/or may translate requests or transactions initiated from the CXL domain to the NVLink-based domain.

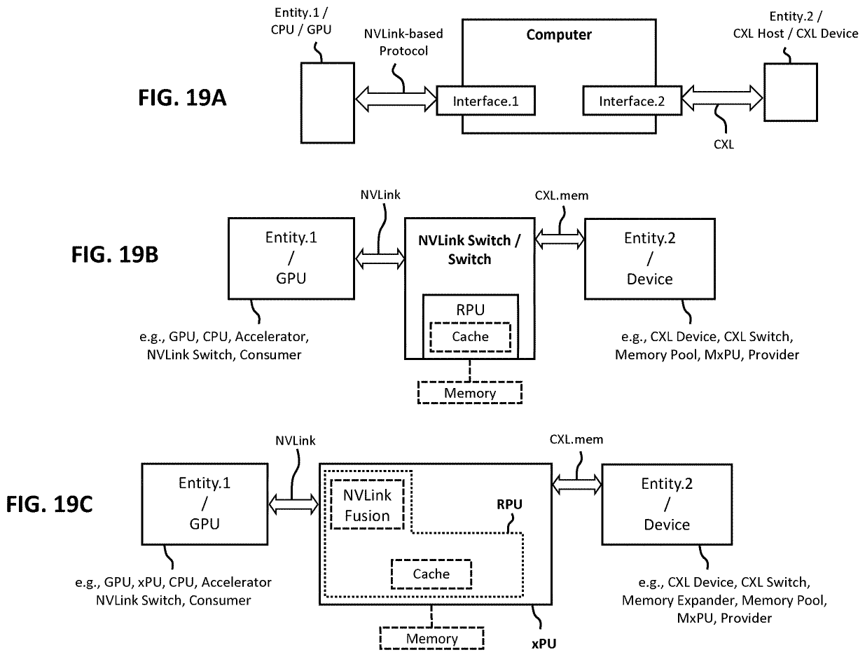

FIG. 19A illustrates an example of a system comprising a computer coupled between a first interface (Interface.1) and a second interface (Interface.2). Interface.1 may communicate according to an NVLink-based Protocol with a first entity (Entity.1), which may be a CPU or a GPU. Interface.2 may communicate according to CXL with a second entity (Entity.2), which may be a CXL host or a CXL device. The computer may extract addresses from requests received via the first interface, wherein these addresses may refer to a first address space, such as an NVLink-based address space, an NVLink-based network address space, or a GPU address space utilized by the first entity. The computer may further translate these addresses and generate requests carrying the translated addresses for transmission via the second interface, wherein the translated addresses may refer to a second address space utilized by the second entity. In other examples, the first address space and the second address space may be associated with the same address space, such as a common address space, a global address space, a pod address space, or a fabric address space. The computer may be implemented in an IC package having high-speed differential I/O balls positioned according to a ball grid array layout defined by a retimer specification. Optional switch(es), such as NVLink switches, may be positioned between the first interface and the first entity. Similarly, optional switch(es), such as CXL switches, may be positioned between the second interface and the second entity.

FIG. 19B illustrates an example of a system comprising an NVLink Switch, or Switch that includes an RPU and a Cache. The switch is coupled to a first entity (Entity.1), shown as a GPU, via an NVLink-based protocol, and to a second entity (Entity.2), shown as a Device, via CXL.mem. Entity.1 may be a GPU, CPU, Accelerator, NVLink Switch, or Consumer. Entity.2 may be a CXL Device, CXL Switch, Memory Pool, MxPU, or Provider. The switch may further be coupled to a Memory. The RPU within the switch may translate between NVLink-based requests received from the first entity and CXL.mem M2S requests transmitted to the second entity. The Cache within the switch may store data for reducing latency or accumulating data from multiple CXL.mem responses.

FIG. 19C illustrates an example of a system comprising a processor, such as an xPU, that includes an RPU that may include an NVLink Fusion chiplet or IP block. The RPU may further include a Cache, and may be coupled to a Memory. The RPU may be coupled, via the NVLink Fusion component, to a first entity (Entity.1) that may be a GPU, xPU, CPU, Accelerator, NVLink Switch, or Consumer. The RPU is coupled via CXL.mem to a second entity (Entity.2), shown as a Device. Entity.2 may be a CXL Device, CXL Switch, Memory Expander, Memory Pool, MxPU, or Provider. The NVLink Fusion chiplet may include the NVLink interface and may be part of the RPU, such that protocol translation between NVLink-based traffic and CXL.mem traffic may be performed within the NVLink Fusion chiplet. The NVLink Fusion chiplet may also include an NVLink PHY. In other examples, the NVLink interface and the RPU may be implemented as functional blocks on the same die with the xPU, or split between silicon dies or chiplets inside the IC package of the xPU.

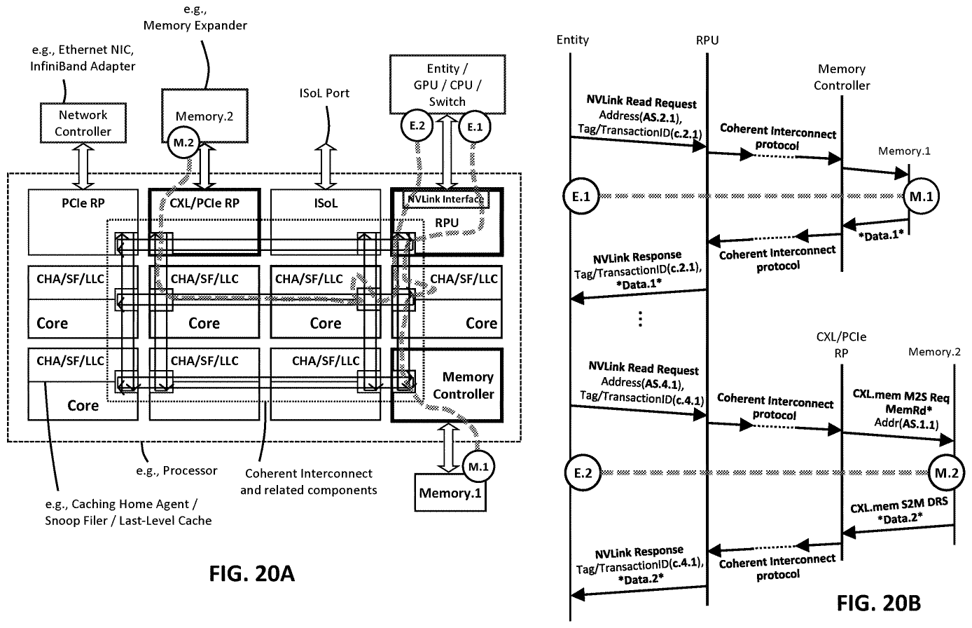

FIG. 20A illustrates an example of a system comprising a processor including a coherent interconnect, which may enable an external entity, such as a GPU, CPU, or Switch, to access memory resources mapped to an address space utilized by the coherent interconnect, such as via one or more of the two illustrated paths denoted as (E.1)-(M.1) and (E.2)-(M.2). The processor may include processing cores, and coherent interconnect, and related components, such as Caching Home Agent/Snoop Filter/Last-Level Cache (CHA/SF/LLC) slices. The processor may further include a PCIe RP coupled to a Network Controller (e.g., Ethernet NIC, InfiniBand Adapter), a CXL/PCIe RP coupled to a second memory (Memory.2, such as a Memory Expander), a memory controller coupled to a first memory (Memory.1), such as DRAM, and an ISoL port (e.g., utilizing NVIDIA NVLink-C2C, ARM CHI C2C, or Intel Coherent Processor Interconnect Protocol (ICPIP)). The processor includes an RPU coupled to an NVLink interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL/PCIe RP, such as over path (E.2)-(M.2). The illustrated RPU may be coupled to the coherent interconnect, and may translate between the NVLink-based protocol and a protocol utilized by the coherent interconnect. The processor may be implemented as a monolithic die, as chiplets within an IC package, or as components on a board, and may utilize a mesh-based coherent interconnect, or other types of coherent interconnects such as a ring, a crossbar, or a Network on Chip (NoC).

FIG. 20B illustrates an example of a TFD demonstrating two NVLink requests, such as NVLink read requests, received from an entity, such as a GPU or a CPU, processed by an RPU and forwarded, possibly using a protocol utilized by a coherent interconnect of a processor, to different memories that may be mapped to an address space utilized by the coherent interconnect. The paths from the RPU to the different memories may traverse other components, such as CHA/SF/LLC slices, memory controllers, or in other examples a home agent or a home node, optionally for resolving coherency. The RPU may perform physical address translations between first physical addresses, such as from GPU physical addresses or NVLink-based network addresses that may be carried in the NVLink requests, and second physical addresses, such as Host Physical Addresses (HPAs), which may refer to an address space utilized by the coherent interconnect, wherein the physical address translations may enable the entity to access the processor's memories. The processor may have multiple memory resources, such as first memory (Memory.1), which may be DRAM coupled to a memory controller of the processor, and/or second memory (Memory.2), which may be a CXL memory expander coupled to a CXL/PCIe RP of the processor. The RPU may further translate between NVLink-based requests and requests based on a protocol utilized by the coherent interconnect, and send the translated requests to the coherent interconnect, requesting read from memory. In some examples, the requested data may be provided by a processor cache, such as by an LLC, instead of by the memory. The data may then return over the coherent interconnect to the RPU, wherein the RPU may provide the data to the requesting entity via an NVLink response.

The TFD illustrates two exemplary transactions between the entity and the RPU, (Entity/GPU/CPU/Switch), processed by an RPU and forwarded via the coherent interconnect protocol to different memories. The TFD illustrates two exemplary transactions corresponding to two distinct memory read paths denoted as (E.1)-(M.1) and (E.2)-(M.2), each associated with a different physical address mapped to different memory resources. The first exemplary transaction (E.1) includes a first NVLink Read Request comprising Address(AS.2.1) and Tag/TransactionID(c.2.1). The RPU may translate the first NVLink request and forward the translated request via the Coherent Interconnect protocol, resulting in the retrieval of *Data.1* from the first memory (Memory.1) via the Memory Controller, wherein *Data.1* may be sent to the entity via the Coherent Interconnect protocol and via the RPU with the first NVLink Response comprising Tag/TransactionID(c.2.1) and *Data.1*.

The second exemplary transaction (E.2) includes a second NVLink Read Request comprising Address(AS.4.1) and Tag/TransactionID(c.4.1). The RPU may translate the second NVLink read request and may further translate the physical address (AS.4.1) carried in the second NVLink read request to a translated physical address (AS.1.1) which may refer to an address space utilized by the coherent interconnect. The RPU may forward the translated request, that may include the translated physical address (AS.1.1), via the coherent interconnect protocol, resulting in the retrieval of *Data.2* from the second memory (Memory.2) via the CXL/PCIe RP, utilizing a CXL.mem M2S request comprising MemRd* and Address(AS.1.1). The second memory (Memory.2) may respond with a CXL.mem S2M DRS comprising *Data.2*, which may be sent to the RPU via the coherent interconnect protocol. The RPU may then send *Data.2* to the entity via the second NVLink response. It is noted that the physical addresses (AS.2.1) and (AS.4.1) may refer to different memory regions within an address space, such as a GPU physical address space or an NVLink-based network address space, which may be exposed via an NVLink interface, enabling the entity to access memory resources based on the translation capabilities of the RPU.

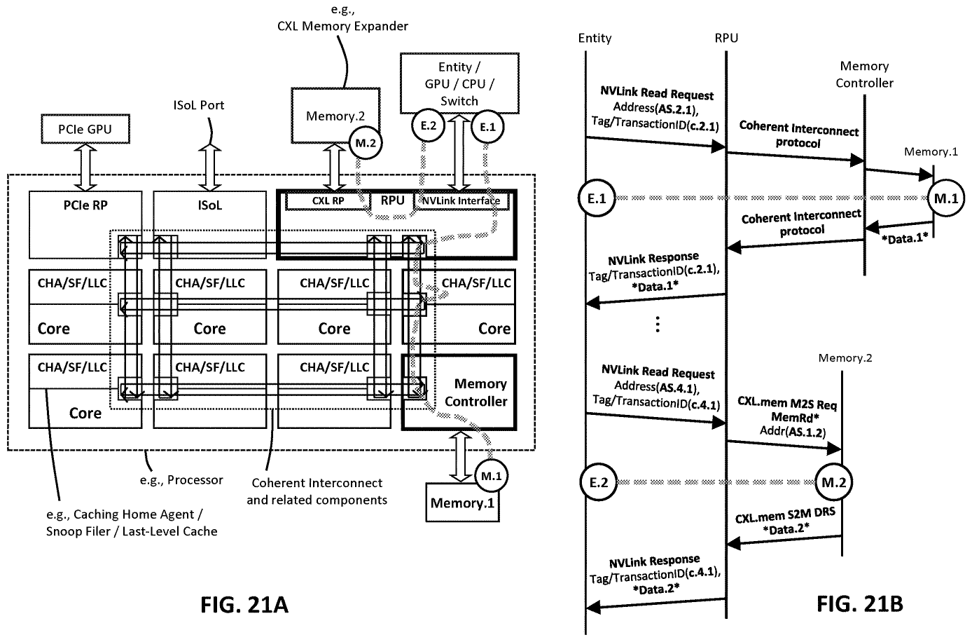

FIG. 21A illustrates an example of a system comprising a processor, including a coherent interconnect, capable of enabling an external entity, such as a GPU, CPU, or accelerator, to access memory resources mapped to an address space utilized by the coherent interconnect, such as via one or more of the two illustrated paths denoted as (E.1)-(M.1) and (E.2)-(M.2). The processor may include processing cores and CHA/SF/LLC, optionally implemented as distributed slices coupled to the coherent interconnect. The processor may further include a PCIe RP that may be coupled to a PCIe GPU, an ISoL port (e.g., utilizing NVLink-C2C, CHI C2C, or Intel Coherent Processor Interconnect Protocol (ICPIP), e.g., Intel UPI), and a Memory Controller coupled to a first memory (Memory.1). The processor includes an RPU that comprises a CXL RP, wherein the CXL RP is coupled to a second memory (Memory.2), such as a CXL Memory Expander. The RPU further includes an NVLink Interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL RP within the RPU, such as over path (E.2)-(M.2). The illustrated RPU and NVLink Interface are coupled to the coherent interconnect, and may translate between the NVLink-based protocol and a protocol utilized by the coherent interconnect. The processor may utilize a mesh-based coherent interconnect, or other types of coherent interconnects such as a ring, a crossbar, or a Network on Chip (NoC).

FIG. 21B illustrates an example of a TFD demonstrating two NVLink requests, such as NVLink read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations between first physical addresses, such as NVLink-based physical addresses, NVLink-based network addresses, or GPU physical addresses, and second physical addresses, such as Host Physical Addresses (HPAs) or System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between an NVLink-based protocol, such as a protocol utilizing an NVLink interconnect, and a protocol utilized by the coherent interconnect, wherein the RPU may send the optionally translated NVLink requests to the coherent interconnect, requesting reads from memory, such as from the first memory or from the second memory. Additionally or alternatively, the RPU may translate NVLink-based traffic to CXL-based traffic (e.g., CXL.mem), and send the translated NVLink traffic to the second memory via the CXL RP. In some examples, the requested data may be provided by a cache of the processor, such as by an LLC, instead of by the memory. The data may then return over the coherent interconnect to the RPU, wherein the RPU may provide an NVLink response to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first NVLink request comprising Address(AS.2.1) and Tag/TransactionID(c.2.1). The Tag/TransactionID may denote a Tag, a transaction Tag, a transaction identifier, or another field or set of fields carried in NVLink requests and/or NVLink responses, which may serve to associate the NVLink responses with the NVLink requests. The RPU may translate the first NVLink request and forward the translated request via the coherent interconnect protocol, resulting in the retrieval of *Data.1* from the first memory (Memory.1) via the memory controller, wherein *Data.1* may be sent to the entity via the coherent interconnect protocol and via the RPU with the first NVLink response. The second exemplary transaction corresponds to the memory read path denoted as (E.2)-(M.2), and may include a second NVLink request comprising Address(AS.4.1) and Tag/TransactionID(c.4.1). The RPU may translate the second NVLink request to a CXL.mem M2S request comprising MemRd* and translated Address(AS.1.2), wherein the RPU may send the translated request to the second memory (Memory.2) via the CXL RP. *Data.2* is retrieved from the second memory utilizing a CXL.mem S2M DRS, and sent to the RPU via the CXL RP, wherein the RPU may send *Data.2* to the entity via the second NVLink response.

In heterogeneous computing architectures, NVLink-based entities such as GPUs, accelerators, and NVLink switches may need to access resources coupled to CXL-based entities such as CXL hosts, CXL devices, CXL switches, or CXL-attached memory pools. NVLink-based protocols and CXL.io utilize different message formats, addressing schemes, and transaction semantics. NVLink-based requests may carry NVLink-based network addresses or GPU physical addresses within a first address space, while CXL.io requests may carry Host Physical Addresses (HPAs) within a second address space. A computer, which may be implemented as a processor, a switch, an RPU, a semiconductor device, a chiplet, an active cable, or other suitable device, may be positioned between an NVLink-based interface and a CXL.io interface to translate between these incompatible protocol domains. The computer may translate addresses, Tags, opcodes, and other fields, and may propagate QoS telemetry information carried in CDL fields of CXL.io UIO completions. The translation may be performed in one direction from NVLink to CXL.io, in the reverse direction from CXL.io to NVLink, or bidirectionally. In the reverse direction, the computer may generate CDL values in CXL.io UIO completions based on load or congestion information observed at the NVLink domain, even when the NVLink-based protocol does not natively carry CDL. Such CDL generation by a host-side entity may extend QoS telemetry capabilities beyond what CXL specifications define for CXL devices alone.

In various implementations, a method comprising: receiving, by a computer from a first entity via a first interface, an NVLink-based request comprising a first physical address; translating, by the computer, the NVLink-based request to a CXL.io request comprising a read-class Transaction Layer Packet (TLP) type and a second physical address, wherein CXL denotes Compute Express Link; sending, by the computer via a second interface, the CXL.io request to a second entity; receiving, by the computer from the second entity, a CXL.io completion comprising data and a Tag; translating, by the computer, the CXL.io completion to an NVLink-based response; and sending the NVLink-based response comprising the data to the first entity. The method may enable an NVLink-based entity, such as a GPU, an accelerator, or an NVLink switch, to access resources coupled to a CXL-based entity, such as a CXL host, a CXL device, a CXL switch, or a CXL-attached memory pool, by translating NVLink-based requests to CXL.io requests and translating CXL.io completions to NVLink-based responses. The computer may be a processor, a switch, an RPU, an active cable, or a semiconductor device positioned between the first entity and the second entity. The first interface may communicate according to an NVLink-based protocol, and the second interface may communicate according to CXL.io. The NVLink-based request may be an NVLink read request comprising fields such as SourceID, DestinationID, Address, Tag, and Length. The computer may translate the NVLink-based request to a CXL.io request comprising a read-class TLP type, which may be either a standard Memory Read (MRd) or a UIO Memory Read (UIOMRd). The CXL.io completion may be a CplD or a UIORdCplD, and may carry a CDL field when the UIO path is utilized. The computer may translate the data and Tag from the CXL.io completion into the NVLink-based response, reconstructing the NVLink response fields such as SourceID, DestinationID, and Tag for delivery to the first entity. In some examples, the computer may issue one or more CXL.io requests in response to an NVLink-based request, such as when splitting a large NVLink read into smaller CXL.io reads, or when prefetching data from the second entity into a cache coupled to the computer.

In some implementations of the method, the CXL.io request comprises a CXL.io Unordered Input/Output (UIO) Memory Read (UIOMRd) request, and the CXL.io completion comprises a CXL.io UIO Read Completion with Data (UIORdCplD). UIO may be utilized when the path between the computer and the second entity supports Flit Mode and has UIO enabled. The UIOMRd may provide multi-path routing and out-of-order completion delivery capabilities. The UIORdCplD may include a CDL that carries QoS telemetry populated by the second entity or intermediate components.

In some implementations of the method, the CXL.io UIORdCplD comprises a CXL DevLoad (CDL) field, and wherein the computer performs at least one of: (i) translating information carried in the CDL to one or more fields of the NVLink-based response, or (ii) utilizing information carried in the CDL for at least one of throttling subsequent requests to the second entity or collecting Quality-of-Service (QoS) telemetry. The CDL may carry device load indicators such as light load, optimal load, moderate overload, or severe overload encodings. The computer may translate CDL information to reserved fields, vendor-defined fields, or custom fields of the NVLink-based response, or may collect CDL values over time to build a telemetry profile of the second entity. When utilizing CDL for throttling, the computer may reduce or modulate the rate of subsequent CXL.io requests based on the observed loading state.

In some implementations of the method, the CXL.io request comprises a CXL.io Memory Read (MRd) request, and the CXL.io completion comprises a CXL.io Completion with Data (CplD). The standard MRd and CplD types may be utilized when the second entity does not support UIO, when UIO is not enabled along the path, or when the path between the computer and the second entity does not utilize Flit Mode. The CplD does not include a CDL, and the computer may populate any QoS-related fields in the NVLink-based response with locally generated information or default values.

In some implementations of the method, the first physical address refers to an NVLink-based network address or a GPU physical address belonging to a first address space, the second physical address refers to a Host Physical Address (HPA) belonging to a second address space, wherein the NVLink-based request further comprises a first Tag, the computer assigns a second Tag to the CXL.io request, and the computer maintains a mapping between the first Tag and the second Tag to correlate the CXL.io completion with the NVLink-based request. The address translation may be implemented utilizing lookup tables, page tables, base-and-offset calculations, or programmable translation functions. The Tag mapping may be maintained in tracker entries, content-addressable memory, or translation tables. Upon receiving the CXL.io completion comprising the Tag, the computer may look up the corresponding first Tag and include it in the NVLink-based response for proper correlation at the first entity.

In some implementations of the method, the computer translates an NVLink-based request to CXL.io requests, the computer prefetches data from the second entity into a cache coupled to the computer, the first entity comprises at least one of a GPU, an accelerator, or an NVLink switch, and the second entity comprises at least one of a CXL host, a CXL device, or a CXL switch. The computer may split a large NVLink read request, such as a 256-byte read, to smaller CXL.io read requests, such as 64-byte or 128-byte reads, to accommodate differences in maximum payload sizes between the NVLink-based protocol and CXL.io. The computer may additionally prefetch data from addresses adjacent to or following the requested address, storing the prefetched data in the cache for servicing anticipated subsequent requests from the first entity with reduced latency.

In some implementations of the method, the computer translates error indications between the CXL.io completion and the NVLink-based response, comprising translating at least one of a poison indication or a data corruption indication. The poison indication in CXL.io may indicate that the data payload has been corrupted or is otherwise invalid. The computer may translate this indication to a corresponding error indication in the NVLink-based response, enabling the first entity to handle the error accordingly.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system, which may be configured for translation from NVLink-based traffic to CXL.io traffic, may include a semiconductor device, a bridge, a switch, or another apparatus that includes a first interface configured to communicate according to an NVLink-based protocol and a second interface configured to communicate according to CXL.io. A computer coupled between the interfaces may translate physical addresses between a first address space, such as an NVLink-based network address space or a GPU physical address space, and a second address space, such as an HPA space, associated with CXL.io. The computer may additionally translate between NVLink-based requests and other CXL sub-protocols such as CXL.mem or CXL.cache. The system may include optional switches on one or both sides of the computer, and the computer may be implemented in various form factors including a retimer BGA package. Such systems may serve heterogeneous AI computing architectures where NVLink-based accelerators need to access CXL-attached resources including memory expansion devices, coherent memory pools, or host-managed device memory.

In various implementations, a system comprising: a first interface configured to communicate according to an NVLink-based protocol with a first entity; a second interface configured to communicate according to CXL.io with a second entity, wherein CXL denotes Compute Express Link; and a computer coupled between the first and second interfaces, configured to translate between NVLink-based requests received via the first interface and CXL.io requests transmitted via the second interface; wherein the computer is further configured to translate physical addresses between a first address space associated with the NVLink-based protocol and a second address space associated with CXL.io. The system may enable an NVLink-based entity, such as a GPU or an accelerator, to access resources coupled to a CXL-based entity, such as a CXL host, a CXL device, or a CXL-attached memory device, through the translating computer. The first interface may be coupled to the first entity directly or through one or more NVLink switches, and the second interface may be coupled to the second entity directly or through one or more CXL switches. The computer may be implemented as a processor, a switch, an RPU, a semiconductor device, or an active cable. The first address space may include an NVLink-based network address space or a GPU physical address space, and the second address space may include an HPA space. The computer may translate addresses utilizing lookup tables, page tables, base-and-offset calculations, or programmable translation functions. In some examples, the computer may additionally translate between NVLink-based requests and CXL.mem requests or CXL.cache requests, enabling access to different types of CXL-attached resources through the same system.

In some implementations of the system, the computer is further configured to translate between NVLink-based requests and at least one of CXL.mem requests or CXL.cache requests via the second interface; and wherein the NVLink-based requests comprise requests associated with an artificial intelligence (AI) model, comprising at least one of: requests for AI model parameters stored in a CXL-attached memory device accessible via CXL.mem, or requests for AI model data maintained in a cache coherency domain accessible via CXL.cache. The multi-channel CXL translation may enable AI accelerators to access model parameters from CXL-attached memory expansion devices via CXL.mem, while simultaneously accessing coherent data structures via CXL.cache. The computer may select the appropriate CXL sub-protocol based on the address range, transaction type, or memory attributes of each NVLink-based request.

In some implementations of the system, the computer is implemented in an integrated circuit (IC) package having high-speed differential I/O balls positioned according to a ball grid array (BGA) layout defined by a retimer specification. The retimer BGA form factor may enable the computer to be deployed in existing retimer sockets within server platforms, utilizing a standardized physical footprint such as the PCIe 5.0, 6.0, or 7.0 Retimer Supplemental Features and Standard BGA Footprint Specification.

In some implementations of the system, the computer comprises a cache configured to store prefetched data received via the second interface, the prefetched data comprising data associated with an artificial intelligence (AI) model comprising at least one of model weights, activation tensors, or embedding tables, and the computer comprises at least one of a processor, a switch, or a Request Processing Unit (RPU). The cache may store prefetched AI model data to reduce latency for subsequent NVLink-based requests from the first entity. AI model weights, activation tensors, and embedding tables may exhibit predictable sequential access patterns that benefit from prefetching. The RPU, processor, or switch may manage the prefetch scheduling and cache allocation policies.

In some implementations of the system, one or more NVLink switches are positioned between the first interface and the first entity, one or more CXL switches are positioned between the second interface and the second entity, and the first entity comprises an AI accelerator that processes an artificial intelligence (AI) model distributed across AI accelerators coupled via the one or more NVLink switches. The NVLink switches may couple AI accelerators that collectively process a distributed AI model, such as when model parameters or activations are partitioned across accelerators using model parallelism, tensor parallelism, or pipeline parallelism. The CXL switches may couple the second interface to one or more CXL-attached memory devices, memory pools, or hosts that store portions of the AI model data.

In some implementations, translation may be performed from CXL.io traffic to NVLink-based traffic. A first entity, such as a CXL host, may initiate CXL.io read requests targeting resources coupled to a second entity, such as a GPU, that communicates according to an NVLink-based protocol. The computer may translate CXL.io requests to NVLink-based requests and translate NVLink-based responses to CXL.io completions. The computer may determine NVLink routing fields such as SourceID and DestinationID based on routing information, since CXL.io requests do not natively carry NVLink routing fields. Additionally, when translating to CXL.io UIO completions such as UIORdCplD, the computer may populate a CDL field with QoS telemetry information derived from the NVLink domain, from locally observed load or congestion conditions, or from information carried in the NVLink-based response. This CDL generation by a host-side or bridge-side entity extends the telemetry model beyond the CXL specification, which defines CDL population for CXL devices under specific conditions. Such translation may enable CXL hosts to access GPU memory storing AI model data, intermediate computations, or inference results.

In various implementations, a method comprising: receiving, by a computer from a first entity via a first interface, a CXL.io request comprising a read-class Transaction Layer Packet (TLP) type and a first physical address, wherein CXL denotes Compute Express Link; translating, by the computer, the CXL.io request to an NVLink-based request comprising a second physical address; sending, by the computer via a second interface that communicates according to an NVLink-based protocol, the NVLink-based request to a second entity; receiving, by the computer from the second entity, an NVLink-based response comprising data; translating, by the computer, the NVLink-based response to a CXL.io completion comprising the data; and sending the CXL.io completion to the first entity. The method may enable a CXL-based entity, such as a CXL host or a CXL device, to access resources coupled to an NVLink-based entity, such as a GPU, by translating CXL.io requests to NVLink-based requests and translating NVLink-based responses to CXL.io completions. The computer may be a processor, a switch, an RPU, a bridge, an active cable, or a semiconductor device positioned between the first entity and the second entity. The first interface may communicate according to CXL.io, and the second interface may communicate according to an NVLink-based protocol. The CXL.io request may be a CXL.io MRd or a CXL.io UIOMRd, and the CXL.io completion may be a CplD or a UIORdCplD, respectively. The computer may translate the first physical address, which may be an HPA or an address within a CXL address space, to the second physical address, which may be an NVLink-based network address or a GPU physical address. The computer may additionally determine NVLink routing fields such as SourceID and DestinationID for the outgoing NVLink-based request based on routing information, address mapping tables, or configuration maintained by the computer. The NVLink-based response may include fields such as SourceID, DestinationID, Tag, and data, and the computer may translate these to the corresponding CXL.io completion fields. In some examples, the computer may aggregate CXL.io requests into an NVLink-based request, or may prefetch additional data from the second entity into a cache coupled to the computer.

In some implementations of the method, the CXL.io request comprises a CXL.io Unordered Input/Output (UIO) Memory Read (UIOMRd) request, and the CXL.io completion comprises a CXL.io UIO Read Completion with Data (UIORdCplD). The UIO path may be utilized when the first entity supports UIO capabilities and the path between the first entity and the computer has UIO enabled. The UIORdCplD may include a CDL that the computer may populate with telemetry information derived from the NVLink domain.

In some implementations of the method, the computer populates a CXL DevLoad (CDL) field in the CXL.io UIORdCplD with information based on at least one of: load information observed by the computer, congestion information associated with the second entity, or Quality-of-Service (QoS) telemetry derived from the NVLink-based response. The CDL generation by the computer may extend the CXL DevLoad telemetry model to the NVLink domain, where the NVLink-based protocol does not natively carry CDL. The computer may derive load or congestion information from the response latency, queue depth, or other observable characteristics of the second entity. The computer may populate the CDL utilizing the same encoding as defined for CXL devices, such as light load, optimal load, moderate overload, or severe overload, enabling the first entity to make informed scheduling or resource allocation decisions based on conditions at the second entity.

In some implementations of the method, the CXL.io request comprises a CXL.io Memory Read (MRd) request, and the CXL.io completion comprises a CXL.io Completion with Data (CplD). The standard MRd and CplD types may be utilized when the first entity does not support UIO or when UIO is not enabled along the path. The CplD does not include a CDL, and the computer may utilize any QoS or load information internally for traffic management or monitoring rather than propagating it to the first entity.

In some implementations of the method, the CXL.io request further comprises a first Tag, the NVLink-based request further comprises a second Tag assigned by the computer, the computer maintains a mapping between the first Tag and the second Tag, and translating the CXL.io request to the NVLink-based request comprises determining a SourceID and a DestinationID for the NVLink-based request based on routing information maintained by the computer. The computer may assign the second Tag from a pool of available NVLink Tags and store the mapping in a tracker entry. The SourceID and DestinationID may be determined based on routing tables, address range configurations, or forwarding information maintained by the computer, since CXL.io requests do not natively carry NVLink routing fields. Upon receiving the NVLink-based response comprising the second Tag, the computer may retrieve the corresponding first Tag for inclusion in the CXL.io completion.

In some implementations of the method, the computer aggregates CXL.io requests received from the first entity, and translates the aggregated CXL.io requests to an NVLink-based request. The computer may aggregate smaller CXL.io read requests targeting adjacent or contiguous addresses into a larger NVLink-based read request, leveraging the NVLink-based protocol's support for larger payload sizes to improve bandwidth utilization and reduce the number of transactions on the NVLink-based interface.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system may be configured to translate from CXL.io traffic to NVLink-based traffic. The system may include a computer coupled between a first interface configured to communicate according to CXL.io and a second interface configured to communicate according to an NVLink-based protocol. The computer may translate CXL.io requests received from a first entity, such as a CXL host, to NVLink-based requests transmitted to a second entity, such as a GPU. The computer may include an RPU with a cache, and may be implemented as a bridge, a switch, a standalone translation device, or a chiplet. The system may include optional NVLink switches or CXL switches on either side of the computer. Such systems may enable CXL hosts to access GPU memory resources, such as memory storing AI model data, intermediate computation results, or inference outputs, through the CXL.io interface.

In various implementations, a system comprising: a first interface configured to communicate according to CXL.io with a first entity, wherein CXL denotes Compute Express Link; a second interface configured to communicate according to an NVLink-based protocol with a second entity; and a computer coupled between the first and second interfaces, configured to translate between CXL.io requests received via the first interface and NVLink-based requests transmitted via the second interface. The system may enable a CXL-based entity, such as a CXL host, a CXL device, or a CXL switch, to access resources coupled to an NVLink-based entity, such as a GPU, an accelerator, or an NVLink switch, through the computer that performs translation between the CXL.io and NVLink-based protocol domains. The computer may translate addresses, Tags, routing fields, error indications, and other protocol-specific fields. The computer may additionally determine NVLink routing fields such as SourceID and DestinationID for outgoing NVLink-based requests, since CXL.io requests do not carry NVLink routing information. In some examples, the computer may include an RPU coupled to a cache, and may be coupled to a memory. The first interface may be coupled to the first entity directly or through one or more CXL switches, and the second interface may be coupled to the second entity directly or through one or more NVLink switches. The computer may be implemented as a bridge, a switch, a standalone translation device, a semiconductor device, or a chiplet.

In some implementations of the system, the computer is configured to determine a SourceID and a DestinationID for NVLink-based requests transmitted via the second interface based on routing information maintained by the computer. The routing information may include routing tables, address-to-destination mappings, forwarding information, or configuration data programmed by a management entity. The SourceID and DestinationID may be utilized by NVLink switches or the second entity to route and deliver the NVLink-based requests.

In some implementations of the system, the computer is further configured to translate at least one of poison indications or data corruption indications between messages communicated via the first interface and messages communicated via the second interface. The poison indication in CXL.io may be propagated to or from corresponding error fields in NVLink-based messages, enabling end-to-end error visibility across the protocol boundary.

In some implementations of the system, the computer comprises a Request Processing Unit (RPU) coupled to a cache configured to store data associated with translations between the CXL.io requests and the NVLink-based requests, and wherein the computer is further configured to translate between fields of the CXL.io requests and fields of the NVLink-based requests, comprising at least one of: Traffic Class (TC) to QoS priority, Tag to Tag, or length to length translations. The RPU may manage the translation state and orchestrate the protocol conversions. The cache may store data retrieved from the second entity to reduce latency for repeated or adjacent accesses. The cross-field translations may include mapping CXL.io Traffic Class values to NVLink QoS priority levels, mapping CXL.io Tags to NVLink Tags, and translating length fields to accommodate differences in granularity or maximum transfer sizes between the protocols.

In some implementations of the system, the computer is included in at least one of a bridge, a switch, or a standalone translation device, which enables the first entity to access, via CXL.io, GPU memory of the second entity storing data associated with an artificial intelligence (AI) model. The bridge, switch, or standalone translation device may be deployed in AI inference or training systems where CXL hosts need to read intermediate results, model outputs, or gradient data from GPU memory. The translation device may enable such access without requiring the GPU to natively support CXL.io.

In some implementations of the system, the computer comprises an NVLink Fusion chiplet coupled to a processing die via an NVLink Chip-to-Chip (NVLink-C2C) coherent interface; and wherein at least one of: one or more NVLink switches are positioned between the second interface and the second entity, or one or more CXL switches are positioned between the first interface and the first entity. The NVLink Fusion chiplet may implement the translation logic as a separate die within a multi-die package, communicating with the processing die via the NVLink-C2C coherent interface. The NVLink switches or CXL switches may extend the system topology to include multiple NVLink-based entities or multiple CXL-based entities, respectively.

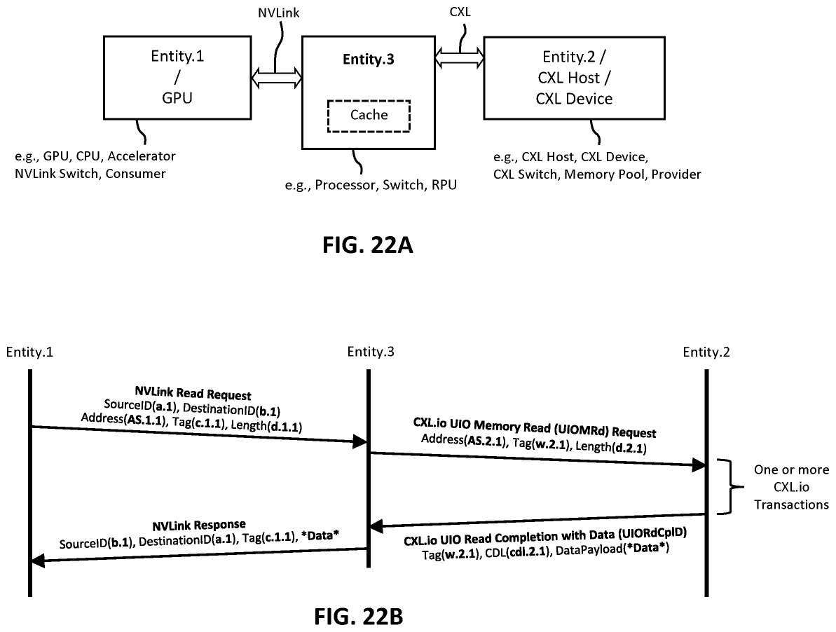

FIG. 22A illustrates an example of a system comprising a third entity (Entity.3), such as a processor, a switch, or an RPU, optionally comprising a cache, that may enable NVLink-based resource consumers to access resources coupled to CXL-based entities. The third entity is coupled to a first entity (Entity.1), which may be a GPU, a CPU, an accelerator, an NVLink switch, or a consumer, wherein the third entity may communicate with the first entity according to an NVLink-based protocol. The third entity is further coupled to a second entity (Entity.2), which may be a CXL host, a CXL device, a CXL switch, a CXL-based memory pool, or a resource provider, wherein the third entity may communicate with the second entity according to a CXL-based protocol, such as at least one of CXL.io, CXL.mem, or CXL.cache. In some examples, messages conforming to the NVLink-based protocol may be associated with a first address space, such as an NVLink-based address space, an NVLink-based network address space, or a GPU address space; and messages conforming to the CXL-based protocol, such as CXL.io, may be associated with a second address space, such as a System Physical Address (SPA) space or a Host Physical Address (HPA) space; wherein the third entity may perform address translations between addresses within the first and second address spaces, respectively. In other examples, messages conforming to the NVLink-based protocol and messages conforming to the CXL-based protocol may be associated with the same physical address space, such as a global address space, a pod address space, or a fabric address space; wherein the third entity may perform address translations between addresses within the same address space. The third entity may perform further translations, such as protocol translations, opcode translations, command translations, request translations, or TLP translations, such as when translating between NVLink requests and CXL.io requests. The third entity may further translate between PDUs of the NVLink-based protocol and PDUs of the CXL protocol, translate Tags, and/or translate error indications, such as data corruption indications or poison. The optional cache within the third entity, shown in dashed outline, may store prefetched data or data retrieved from the second entity to reduce latency for subsequent requests from the first entity. Optionally, the first entity may be a GPU, CPU, accelerator, NVLink switch, or consumer; the third entity may be a processor, switch, or RPU; and the second entity may be a CXL host, CXL device, CXL switch, memory pool, or provider.

FIG. 22B illustrates an example of a transaction flow diagram (TFD) demonstrating a third entity (Entity.3), such as a processor, a switch, or an RPU, that may translate between NVLink-based traffic and CXL-based traffic, such as CXL.io traffic. The third entity may receive from a first entity (Entity.1), which may be a GPU, an NVLink read request that may include SourceID(a.1), DestinationID(b.1), Address(AS.1.1), Tag(c.1.1), and Length(d.1.1), wherein SourceID(a.1) may denote the NVLink interconnect address utilized by the requesting entity, such as a source GPU, and wherein DestinationID(b.1) may denote the NVLink interconnect address utilized by the target of the NVLink request, and may be utilized for routing or forwarding the NVLink request to its destination. The third entity may translate the NVLink request to a CXL.io request that may include a CXL.io UIO Memory Read (UIOMRd) request comprising Address(AS.2.1), Tag(w.2.1), and Length(d.2.1), and may send the CXL.io UIOMRd to a second entity (Entity.2), which may be a CXL host or a CXL device. The third entity may further translate between other values of the NVLink request and the CXL.io request, such as between addresses, Tags, QoS-related values, or identifications (IDs), which may serve to route or forward the NVLink request to its destination. In some examples, the third entity may translate an NVLink request to multiple CXL.io request, such as in order to split a large data read request (e.g., splitting a large 256 B NVLink read request to smaller 64 B CXL.io read requests), or in order to prefetch data, optionally into a cache that may be included in or coupled to the third entity. Upon receiving a response from the second entity (Entity.2), which may include a CXL.io UIORdCplD comprising Tag(w.2.1), CDL(cdl.2.1), and DataPayload(*Data*), the third entity may translate the CXL.io UIORdCplD to an NVLink response comprising SourceID(b.1), DestinationID(a.1), Tag(c.1.1), and *Data*. The CDL that may be included in the CXL.io UIORdCplD may be populated with information related to QoS, such as QoS telemetry value or values. The third entity may translate information carried in the CDL and send it via one or more fields of the NVLink response, such as via reserved fields, vendor-defined fields, or custom fields. Alternatively or additionally, the third entity may collect QoS information, telemetry, or statistics from UIORdCplD completions.

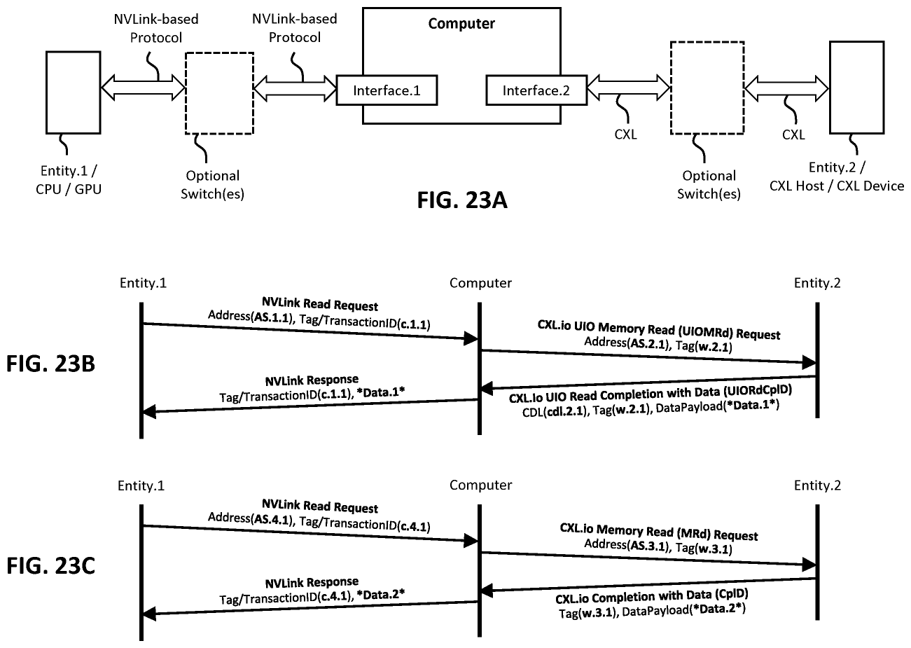

FIG. 23A illustrates an example of a system comprising a computer coupled between: (1) a first interface (Interface.1) that may communicate according to an NVLink-based protocol, such as a protocol utilizing an NVLink interconnect, with a first entity (Entity.1), which may be a CPU or a GPU; and (2) a second interface (Interface.2) that may communicate according to a CXL-based protocol, such as CXL.io, with a second entity (Entity.2), which may be a CXL host or a CXL device. Optionally, the computer may be implemented in a semiconductor device package. The computer may extract physical addresses from requests received via the first interface, wherein these addresses may refer to an NVLink-based address space, an NVLink-based network address space, or a GPU address space utilized by the first entity. The computer may further translate these addresses, and generate requests carrying the translated physical addresses for transmission via the second interface; wherein these translated addresses may correspond to an HPA space utilized by the second entity. Optional switch(es), such as NVLink switches, may be positioned between the first interface and the first entity, as shown in dashed outline on the left side of the figure. Similarly, optional switch(es), such as CXL switches, may be positioned between the second interface and the second entity, as shown in dashed outline on the right side of the figure. The NVLink-based protocol labels on the connections between the first entity, the optional switches, and the first interface indicate that NVLink-based traffic traverses the left side of the illustrated system. The CXL labels on the connections between the second interface, the optional switches, and the second entity indicate that CXL-based traffic traverses the right side of the illustrated system. Optionally, the computer may be included in a switch or a bridge. In some examples, the computer may be implemented in an IC package having high-speed differential I/O balls positioned according to a ball grid array layout defined by a retimer specification, such as the PCIe 5.0, 6.0, or 7.0 Retimer Supplemental Features and Standard BGA Footprint Specification.

FIG. 23B illustrates an example of a TFD demonstrating translations between NVLink-based requests, such as NVLink read requests, received from a first entity (Entity.1), which may be a CPU or a GPU, and CXL.io UIO TLPs sent to a second entity (Entity.2), which may be a CXL host or a CXL device, possibly enabling the first entity to access resources mapped to an address space utilized by the second entity. The first entity may initiate an NVLink request, which may be an NVLink read request, comprising a physical address, such as a GPU physical address or an NVLink-based network address Address(AS.1.1), and Tag/TransactionID(c.1.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.io request, such as a CXL.io UIO Memory Read (UIOMRd) request comprising a physical address, such as HPAs Address(AS.2.1), and Tag(w.2.1), and may send the CXL.io UIOMRd to the second entity. Upon receiving the CXL.io UIOMRd, the second entity may respond with a completion, which may include a CXL.io UIO Read Completion with Data (UIORdCplD) comprising CDL(cdl.2.1), Tag(w.2.1), and DataPayload(*Data.1*), wherein the CDL may be populated by the CXL device (or alternatively by the CXL host) with information related to QoS, such as QoS telemetry value or values. The computer may translate the CXL.io UIORdCplD to an NVLink response comprising Tag/TransactionID(c.1.1) and *Data.1*, and may send the NVLink response to the first entity. In some examples, the computer may issue multiple CXL.io UIO memory read requests in response to receiving an NVLink request from the first entity, such as when splitting an NVLink request for a large block of data to smaller CXL.io UIO memory read requests, or when prefetching data from the second entity. The computer may translate requests or transactions initiated from the NVLink-based domain to the CXL domain, or may translate requests or transactions initiated from the CXL domain to the NVLink-based domain.

FIG. 23C illustrates an example of a TFD demonstrating translations between NVLink-based requests, such as NVLink read requests, received from a first entity (Entity.1), which may be a CPU or a GPU, and CXL.io TLPs sent to a second entity (Entity.2), which may be a CXL host or a CXL device. The translation is performed by a computer, which may be a semiconductor device. The first entity may initiate an NVLink request, which may be an NVLink read request, comprising physical address Address(AS.4.1), and Tag/TransactionID(c.4.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.io request, such as a CXL.io Memory Read (MRd) request comprising physical address Address(AS.3.1) and Tag(w.3.1), and may send the CXL.io MRd to the second entity. Upon receiving a completion from the second entity, which may include a CXL.io Completion with Data (CplD) comprising Tag(w.3.1) and DataPayload(*Data.2*), the computer may translate the CXL.io CplD to an NVLink response comprising Tag/TransactionID(c.4.1) and *Data.2*, and may send the NVLink response to the first entity. In some examples, the computer may issue multiple CXL.io memory read requests in response to receiving an NVLink request from the first entity, such as when splitting an NVLink request for a large block of data to smaller CXL.io memory read requests, or when prefetching data from the second entity.

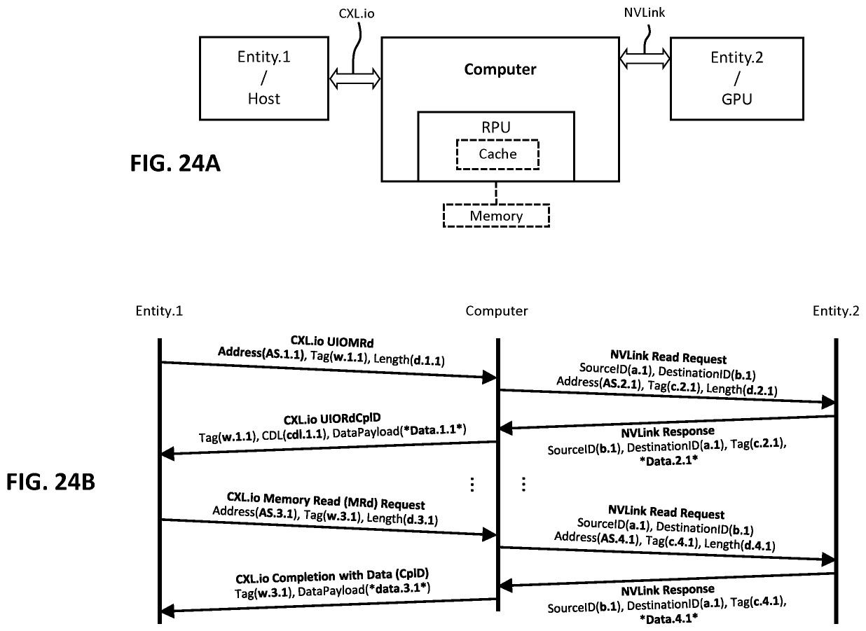

FIG. 24A illustrates an example of a system comprising a computer configured to translate between CXL.io traffic and NVLink-based traffic. A first entity (Entity.1), which may be a host, is coupled to the computer via a CXL.io interface. A second entity (Entity.2), which may be a GPU, is coupled to the computer via an NVLink interface. The computer includes an RPU that may orchestrate the protocol translation logic. The RPU may include an optional cache, which may store data associated with translations between CXL.io requests and NVLink-based requests, such as prefetched data, cached responses, or translation state. The computer is further coupled to an optional memory, shown in dashed outline below the computer, that may store routing tables, address translation tables, Tag mapping entries, or other state information utilized by the RPU during translation. The system enables the first entity (Host) to access resources coupled to the second entity (GPU) through the computer by translating CXL.io requests to NVLink-based requests and translating NVLink-based responses to CXL.io completions. The computer may determine NVLink routing fields such as SourceID and DestinationID for outgoing NVLink-based requests, since CXL.io requests do not natively carry NVLink routing fields. When translating NVLink-based responses to CXL.io UIO completions, the computer may populate a CDL field with QoS telemetry information derived from the NVLink domain, from load or congestion information observed by the computer, or from information carried in the NVLink-based response.

FIG. 24B illustrates an example of a TFD demonstrating translations between CXL.io read requests received from a first entity (Entity.1) and NVLink-based read requests sent to a second entity (Entity.2), with the translation performed by a computer positioned between the first and second entities. The figure shows two separate transaction flows separated by a vertical ellipsis, representing two alternative translation paths: an upper UIO path and a lower non-UIO path. In the upper UIO path, the first entity sends a CXL.io UIOMRd comprising Address(AS.1.1), Tag(w.1.1), and Length(d.1.1) to the computer. The computer translates the CXL.io UIOMRd to an NVLink read request comprising SourceID(a.1), DestinationID(b.1), Address(AS.2.1), Tag(c.2.1), and Length(d.2.1), and sends the NVLink read request to the second entity. The computer determines the SourceID(a.1) and DestinationID(b.1) based on routing information maintained by the computer, since the CXL.io UIOMRd does not carry NVLink routing fields. Upon receiving an NVLink Response from the second entity comprising SourceID(b.1), DestinationID(a.1), Tag(c.2.1), and *Data.2.1*, the computer translates the NVLink Response to a CXL.io UIORdCplD comprising Tag(w.1.1), CDL(cdl.1.1), and DataPayload(*Data.1.1*), and sends the CXL.io UIORdCplD to the first entity. The CDL(cdl.1.1) may be populated by the computer with QoS telemetry information based on load information observed by the computer, congestion information associated with the second entity, or information derived from the NVLink Response, since the NVLink-based protocol does not natively carry a CDL field.

In the lower non-UIO path, the first entity sends a CXL.io Memory Read (MRd) request comprising Address(AS.3.1), Tag(w.3.1), and Length(d.3.1) to the computer. The computer translates the CXL.io MRd to an NVLink read request comprising SourceID(a.1), DestinationID(b.1), Address(AS.4.1), Tag(c.4.1), and Length(d.4.1), and sends the NVLink read request to the second entity. Upon receiving an NVLink Response from the second entity comprising SourceID(b.1), DestinationID(a.1), Tag(c.4.1), and *Data.4.1*, the computer translates the NVLink Response to a CXL.io Completion with Data (CplD) comprising Tag(w.3.1) and DataPayload(*Data.3.1*), and sends the CXL.io CplD to the first entity. Unlike the upper UIO path, the CplD in the lower non-UIO path does not include a CDL. In both paths, the computer translates addresses between the CXL.io domain (Address AS.1.1 and AS.3.1) and the NVLink domain (Address AS.2.1 and AS.4.1), translates Tags between the CXL.io domain (Tag w.1.1 and w.3.1) and the NVLink domain (Tag c.2.1 and c.4.1), and determines NVLink SourceID and DestinationID routing fields for the outgoing NVLink read requests.

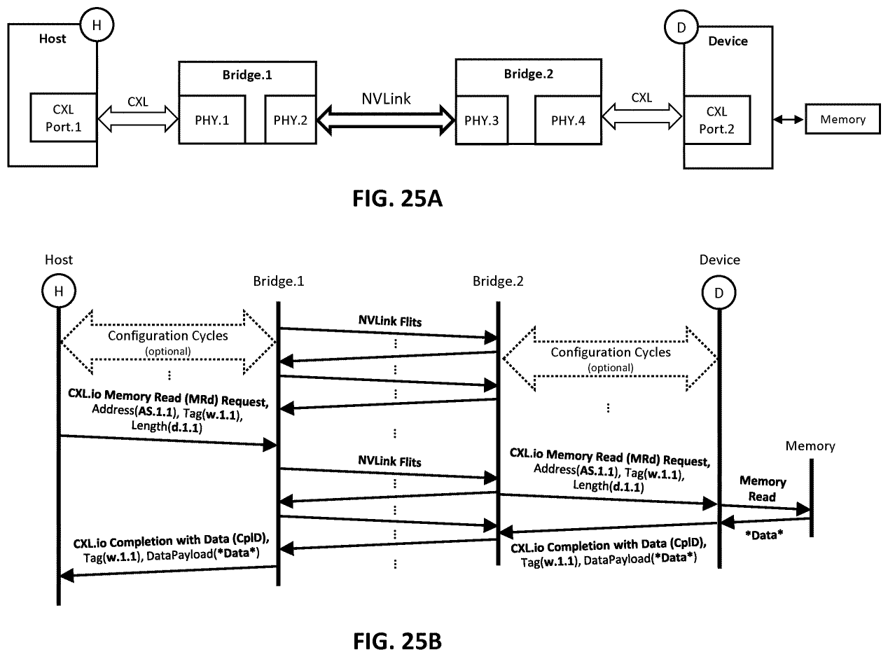

FIG. 25A illustrates an example of a system wherein a host comprising a first CXL port is coupled to Bridge.1 via a first PHY (PHY.1), which may be implemented as a Flex Bus PHY, a UCIe PHY, or an NVLink-C2C PHY. Bridge.1 communicates with Bridge.2 via a second PHY (PHY. 2) which may be based on IEEE 802.3 PMA and may include an NVLink PHY instead of a UALink PHY. Bridge.2 is coupled via a fourth PHY (PHY.4) to a device comprising a second CXL port. Using NVLink PHY for inter-bridge communication demonstrates the flexibility of the bridge architecture to support different high-speed interconnect protocols while maintaining CXL protocol compatibility at the host and device interfaces.

FIG. 25B illustrates an example of a TFD depicting tunneling of CXL.io transactions between a host and a device through bridge.1 and bridge.2, utilizing physical layers based on IEEE 802.3 PMA. The TFD shows CXL.io Memory Read (MRd) request transmitted from the host through bridge.1, which translates or encapsulates the request for transmission to bridge.2 over NVLink flits, wherein bridge.2 performs the applicable translations to forward the request as a CXL.io transaction to the device ‘D’, with the corresponding CXL.io Completion with Data (CplD) response following the reverse path from the device through bridge.2 and bridge.1 back to the host ‘H’.

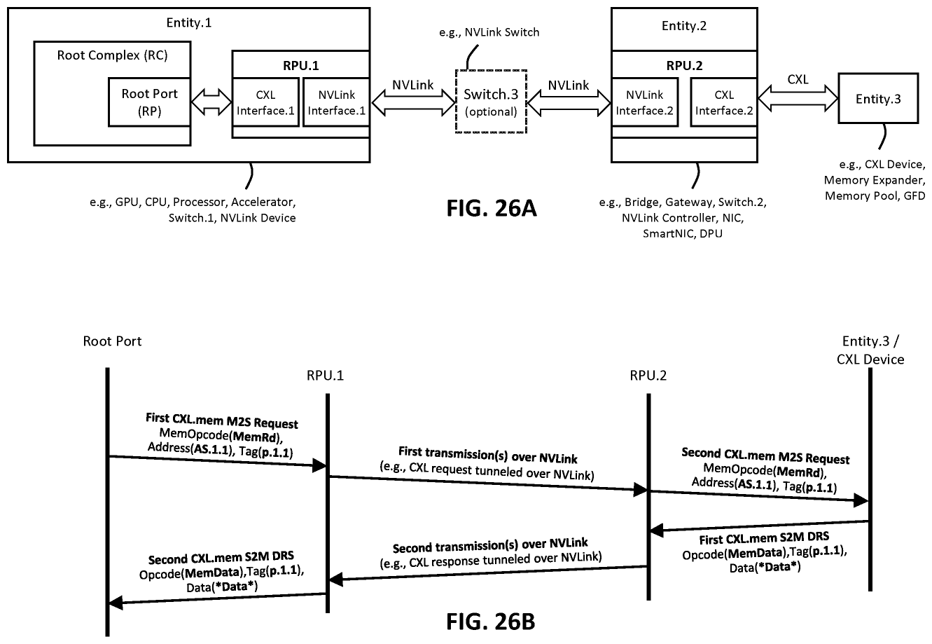

FIG. 26A illustrates an example of a system comprising a first entity (Entity.1), such as a GPU, a CPU, a processor, an accelerator, a first switch (Switch.1), or an NVLink device, wherein the first entity may include a Root Complex (RC) comprising a root port (RP), and may further include a first RPU (RPU.1) comprising a first CXL interface (CXL Interface.1) and a first NVLink Interface (NVLink Interface.1). The system may further include an optional third switch (Switch.3), such as an NVLink switch, and a second entity (Entity.2), such as a bridge, a gateway, a second switch (Switch.2), an NVLink controller, a Network Interface Card (NIC), e.g., an NVLink NIC, a SmartNIC, e.g., an NVLink SmartNIC, or a Data Processing Unit (DPU), e.g., an NVLink DPU. The second entity may include a second RPU (RPU.2) comprising a second CXL interface (CXL Interface.2) and a second NVLink Interface (NVLink Interface.2). The system further includes a third entity (Entity.3), such as a CXL device, a memory expander, a memory pool, or a GFD. The first and second RPUs may enable the first entity to communicate with the third entity according to a CXL-based protocol, via the second entity and optionally via the third switch, such as by translating between CXL-based PDUs (such as TLPs, requests, messages, or flits) and transmissions comprising data indicative of CXL PDUs, such as transmissions comprising data indicative of CXL opcodes and physical addresses, wherein the transmissions utilize NVLink PDUs (such as NVLink requests, NVLink packets, or NVLink flits), which may be sent and received via the first and second NVLink interfaces, optionally enabling the first entity to access resources of the third entity, such as registers or memory.

In some examples, translating between the CXL-based PDUs and the transmissions utilizing NVLink PDUs may enable CXL over NVLink, such as via CXL tunneling over NVLink, e.g., tunneling of CXL.mem requests and responses over NVLink, tunneling of CXL.io TLPs over NVLink, tunneling of CXL-based PDUs over NVLink, or tunneling of CXL transactions over NVLink. In some examples, the first NVLink Interface and the second NVLink Interface may utilize the same physical layer technology. In other examples, the first NVLink interface and the second NVLink interface may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in an NVLink switch.

In some examples, the first entity may be a first switch comprising the first NVLink interface, the second entity may be a second switch comprising the second NVLink interface, and the CXL traffic between the first and second switches may be tunneled over NVLink. Optionally, the first and second switches may be coupled by the third switch, which may be an NVLink switch. In other examples, the first entity may be a first switch comprising the first CXL interface (CLX Interface.1), the second entity may be a second switch comprising the second CXL Interface (CXL Interface.2), and the CXL traffic between the RP and the third entity (e.g., a CXL device) may be tunneled over NVLink via the second switch and optionally via the third switch, which may be an NVLink switch.

FIG. 26B illustrates an example of a TFD demonstrating a CXL communication between a first entity (Entity.1), such as a processor comprising a root port (RP), and a third entity (Entity.3), such as a CXL device, wherein the CXL communication may be tunneled over NVLink. The first entity may initiate a read from the third entity, such as by sending a first CXL.mem M2S request comprising MemOpcode(MemRd), Address(AS.1.1), and Tag(p.1.1) via the RP. The first RPU (RPU.1), which may reside in the first entity, may receive the first CXL.mem M2S request and translate it to first transmission(s) comprising data indicative of CXL PDU, such as transmission(s) comprising data indicative of CXL opcodes and physical addresses, wherein the first RPU may send the first transmission(s) which may utilize one or more NVLink PDUs (such as NVLink requests, NVLink packets, or NVLink flits), to a second RPU (RPU.2), which may reside in a second entity, such as a bridge or a gateway. The first RPU may further translate the first CXL.mem M2S request to the first transmission(s) in a manner that enables reconstruction of the first CXL.mem M2S request at the second RPU with minimal (or no) modifications, effectively tunneling the first CXL.mem M2S request over NVLink. For example, the first RPU may encapsulate the first CXL.mem M2S request into an NVLink request, such as an NVLink write request, and send the NVLink request to the second RPU, wherein the CXL request may be extracted from the NVLink request such as by decapsulation. Additionally or alternatively, the first RPU may encapsulate a CXL flit comprising the first CXL.mem M2S request into an NVLink request, such as an NVLink write request, and send the NVLink request to the second RPU, wherein the CXL flit comprising the first CXL.mem M2S request may be extracted from the NVLink request such as by decapsulation. The second RPU may receive the first transmission(s) and translate it to a second CXL.mem M2S request comprising MemOpcode(MemRd), Address(AS.1.1), and Tag(p.1.1), and send the second CXL.mem M2S request to the third entity. In some examples, the first CXL.mem M2S request and the second CXL.mem M2S request may be identical, whereas in other examples the second RPU may construct the second CXL.mem M2S request based on the first CXL.mem M2S request with variations such as utilizing a different opcode (e.g., MemRdData instead of MemRd), utilizing a different Tag namespace, e.g., Tag(q.2.1) instead of Tag (p.1.1), or utilizing address translations, e.g., Address(AS.2.1) instead of Address(AS.1.1).

The third entity may respond to the second CXL.mem M2S request by sending a first CXL.mem S2M DRS comprising Opcode(MemData), Tag(p.1.1), and Data(*Data*) to the second RPU, wherein the second RPU may translate the first CXL.mem S2M DRS to second transmission(s) comprising data indicative of CXL PDU, and send the second transmission(s) to the first RPU. The first RPU may further receive the second transmission(s) and translate it to a second CXL.mem S2M DRS comprising Opcode(MemData), Tag(p.1.1), and Data(*Data*), and send the second CXL.mem S2M DRS to the RP. In some examples, the first CXL.mem S2M DRS and the second CXL.mem S2M DRS may be identical, whereas in other examples the first RPU may construct the second CXL.mem S2M DRS based on the first CXL.mem S2M DRS with variations, such as updating fields, e.g., Device Load (DevLoad), MetaField, MetaValue, TRP, Opcode, or reserved fields. Additionally or alternatively, the first RPU may alter the structure of the second CXL.mem S2M DRS compared to the original first CXL.mem S2M DRS, such as by adding a trailer.

In some examples, the second CXL.mem M2S request may be different from the first CXL.mem M2S request due to differences in protocol revisions, such as when the first RPU communicates with the RP according to CXL 1.1, whereas the second RPU communicates with the third entity according to CXL 3.2, or such as when message format conversion is required between HBR and PBR formats, e.g., when the second RPU utilizes PBR mode or PBR messages, whereas, for example, the RP is associated with an HBR host. Similarly, the second CXL.mem S2M DRS may be different from the first CXL.mem S2M DRS due to differences in protocol revisions, or such as when message format conversion is required between HBR and PBR formats. In some examples, the first RPU and the second RPU may be coupled by a switch, such as a UALink switch.

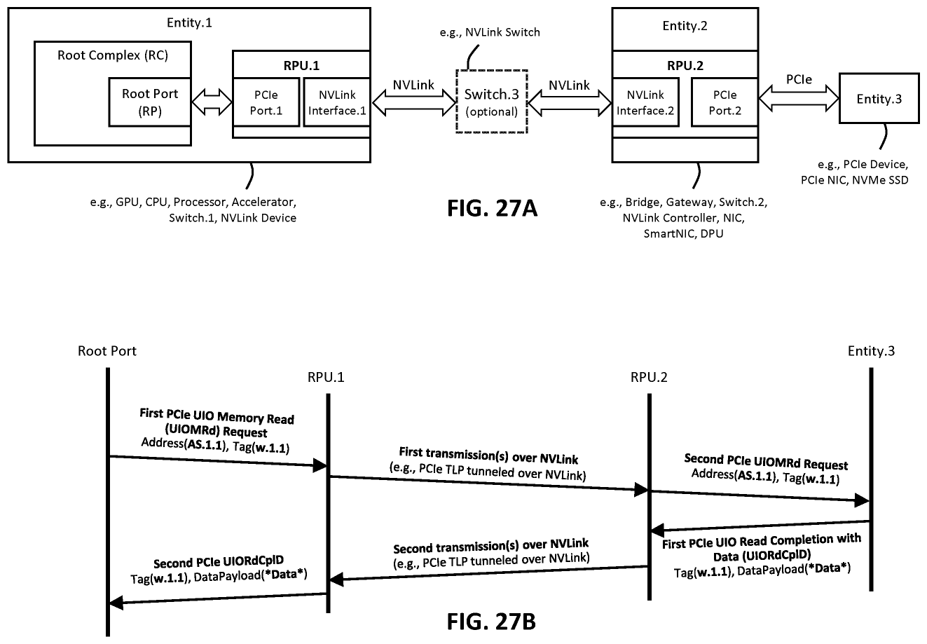

FIG. 27A illustrates an example of a system comprising a first entity (Entity.1), such as a GPU, a CPU, a processor, an accelerator, a first switch (Switch.1), or an NVLink device, wherein the first entity may include a Root Complex (RC) comprising a root port (RP), and may further include a first RPU (RPU.1) comprising a first PCIe port (PCIe Port.1) and a first NVLink Interface (NVLink Interface.1). The system may further include an optional third switch (Switch.3), such as a NVLink switch, and a second entity (Entity.2), such as a bridge, a gateway, a second switch (Switch.2), an NVLink controller, a Network Interface Card (NIC), e.g., an NVLink NIC, a SmartNIC, e.g., an NVLink SmartNIC, or a Data Processing Unit (DPU), e.g., an NVLink DPU. The second entity may include a second RPU (RPU.2) comprising a second PCIe port (PCIe Port.2) and a second NVLink Interface (NVLink Interface.2). The system further includes a third entity (Entity.3), such as a PCIe device, a PCIe NIC, or an NVMe SSD. The first and second RPUs may enable the first entity to communicate with the third entity according to a PCIe-based protocol, via the second entity and optionally via the third switch, such as by translating between PCIe-based PDUs (such as PCIe TLPs, requests, messages, or flits) and transmissions comprising data indicative of PCIe PDUs, such as transmissions comprising data indicative of PCIe TLP types and physical addresses, wherein the transmissions utilize NVLink PDUs (such as NVLink requests, NVLink packets, or NVLink flits), which may be sent and received via the first and second NVLink interfaces, optionally enabling the first entity to access resources of the third entity, such as registers or memory.

In some examples, translating between the PCIe-based PDUs and the transmissions utilizing NVLink PDUs may enable PCIe over NVLink, such as via PCIe tunneling over NVLink, e.g., tunneling of PCIe requests and completions over NVLink, tunneling of PCIe TLPs over NVLink, tunneling of PCIe-based PDUs over NVLink, or tunneling of PCIe transactions over NVLink. In some examples, the first NVLink Interface and the second NVLink Interface may utilize the same physical layer technology. In other examples, the first NVLink interface and the second NVLink interface may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in an NVLink switch.

In some examples, the first entity may be a first switch, such as a first PCIe switch comprising the first NVLink interface, the second entity may be a second switch, such as a second PCIe switch comprising the second NVLink interface, wherein the PCIe traffic between the first PCIe switch and the second PCIe switch may be tunneled over NVLink, and wherein the first PCIe switch and the second PCIe switch may be coupled by the third switch, that may be an NVLink switch. In other examples, the first entity may be a first switch, such as a first NVLink switch comprising the first PCIe Port (PCIe Port.1), the second entity may be a second switch, such as a second NVLink switch comprising the second PCIe Port (PCIe Port.2), wherein the PCIe traffic between the RP and the third entity (e.g., a PCIe device) may be tunneled over NVLink via the second NVLink switch and optionally via the third switch, such as a third NVLink switch.

FIG. 27B illustrates an example of a TFD demonstrating PCIe communication between a first entity (Entity.1), such as a processor comprising a root port (RP), and a third entity (Entity.3), such as a PCIe device, wherein the PCIe communication may be tunneled over NVLink. The first entity may initiate a read from the third entity, such as by sending a first PCIe UIO Memory Read (UIOMRd) request comprising Address(AS.1.1) and Tag(w.1.1) via the RP. The first RPU (RPU.1), which may reside in the first entity, may receive the first PCIe UIOMRd and translate it to first transmission(s) comprising data indicative of PCIe PDU, such as transmission(s) comprising data indicative of TLP types and physical addresses, wherein the first RPU may send the first transmission(s) which may utilize one or more NVLink PDUs (such as NVLink requests, NVLink packets, or NVLink flits), to a second RPU (RPU.2), which may reside in a second entity, such as a bridge or a gateway. The first RPU may further translate the first PCIe UIOMRd to the first transmission(s) in a manner that enables reconstruction of the first PCIe UIOMRd at the second RPU with minimal (or no) modifications, effectively tunneling the first PCIe UIOMRd over NVLink. For example, the first RPU may encapsulate the first PCIe UIOMRd into an NVLink request, such as an NVLink write request, and send the NVLink request to the second RPU, wherein the PCIe request may be extracted from the NVLink request such as by decapsulation. Additionally or alternatively, the first RPU may encapsulate a PCIe flit comprising the first PCIe UIOMRd into an NVLink request, such as an NVLink write request, and send the NVLink request to the second RPU, wherein the PCIe flit comprising the first PCIe UIOMRd may be extracted from the NVLink request such as by decapsulation.

The second RPU may receive the first transmission(s) and translate it to a second PCIe UIOMRd comprising Address(AS.1.1) and Tag(w.1.1), and send the second PCIe UIOMRd to the third entity. In some examples, the first PCIe UIOMRd and the second PCIe UIOMRd may be identical, whereas in other examples, the second RPU may construct the second PCIe UIOMRd based on the first PCIe UIOMRd with variations such as utilizing a different TLP type (e.g., MRd instead of UIOMRd), utilizing a different Tag namespace, e.g., Tag(q.2.1) instead of Tag(w.1.1), or utilizing address translations, e.g., Address(AS.2.1) instead of Address(AS.1.1). The third entity may respond to the second PCIe UIOMRd by sending a first PCIe UIO Read Completion with Data (UIORdCplD) comprising Tag(w.1.1) and DataPayload(*Data*) to the second RPU, wherein the second RPU may translate the first PCIe UIORdCplD to second transmission(s) comprising data indicative of PCIe PDU, and send the second transmission(s) to the first RPU. The first RPU may further receive the second transmission(s) and translate it to a second PCIe UIORdCplD comprising Tag(w.1.1) and DataPayload(*Data*), and send the second PCIe UIORdCplD to the RP.

In some examples, the first PCIe UIORdCplD and the second PCIe UIORdCplD may be identical, whereas in other examples, the first RPU may construct the second PCIe UIORdCplD based on the first PCIe UIORdCplD with variations, such as updating fields, e.g., reserved fields or fields treated as reserved, such as CDL that may represent CXL device load for QoS telemetry, where this field may be treated as reserved for use cases not covered by CXL. Additionally or alternatively, the first RPU may alter the structure of the second PCIe UIORdCplD compared to the original first PCIe UIORdCplD, such as by adding a TLP trailer, such as for supporting Transaction Layer end-to-end 32-bit CRC (ECRC) that may cover the path between the second RPU and the RP.

In some examples, the second PCIe UIOMRd may be different from the first PCIe UIOMRd due to differences in protocol revisions, such as when the first RPU communicates with the RP according to a first PCIe specification revision, whereas the second RPU communicates with the third entity according to a second PCIe specification revision (that may be different than the first PCIe specification revision), or such as when translation is required between Flit Mode (FM) and Non-Flit Mode (NFM) TLP formats. Similarly, the second PCIe UIORdCplD may be different from the first PCIe UIORdCplD due to differences in protocol revisions, or such as when translation is required between FM and NFM TLP formats. In some examples, the first RPU and the second RPU may be coupled by a switch, such as an NVLink switch.

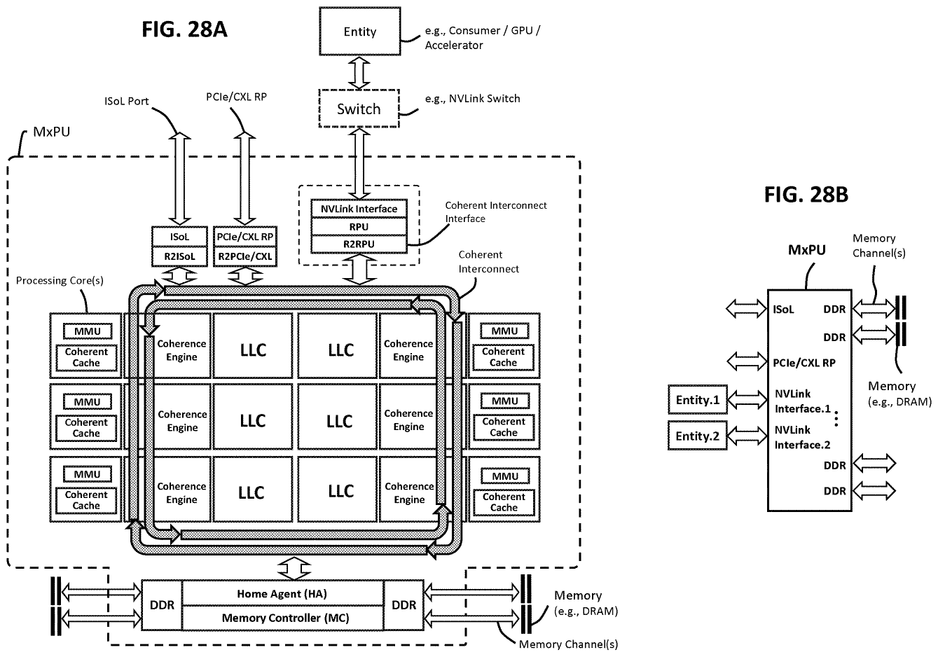

FIG. 28A illustrates an example of a processor (such as an MxPU that may be derived from an established processor design) comprising processing cores, last level cache (LLC), and a coherent interconnect utilizing a topology structure of a ring. Alternatively, the coherent interconnect may utilize other topology structures such as a mesh, a crossbar, or a custom topology. The processor may include an NVLink interface, and an ISoL port, such as a port utilizing ARM CHI C2C, NVIDIA NVLink-C2C, Intel UPI, or AMD Infinity Fabric. The processor may further include a PCIe/CXL root port (PCIe/CXL RP), and may be coupled to memory, such as DRAM, optionally via a memory controller and memory channels. The NVLink interface may communicate with an entity, such as a GPU or a CPU, optionally via a switch, according to an NVLink-based protocol, wherein an RPU may perform physical address translations that may enable the entity to access the memory via the NVLink interface. The illustrated RPU is coupled to the on-chip ring interconnect via a coherent interconnect interface, such as a Ring-to-RPU (R2RPU). Alternatively, the RPU may be coupled to the on-chip ring interconnect essentially directly. Similarly, the illustrated ISoL port is coupled to the on-chip ring interconnect via a coherent interconnect interface, such as a Ring-to-ISoL (R2ISoL), and the PCIe/CXL RP is coupled to the on-chip ring interconnect via a coherent interconnect interface, such as a Ring-to-PCIe/CXL (R2PCIe/CXL). The processor may be implemented as a monolithic die, as chiplets within an IC package, such as by utilizing separate compute die(s) and I/O die(s), or as components on a board.

FIG. 28B illustrates an example of a processor (such as an MxPU) comprising NVLink interfaces, DDR channels, at least one optional PCIe/CXL RP, and at least one optional ISoL. The NVLink interfaces may not utilize the same physical address space, may be coupled to entities, optionally via a switch, and may communicate with the entity according to one or more NVLink-based protocols.

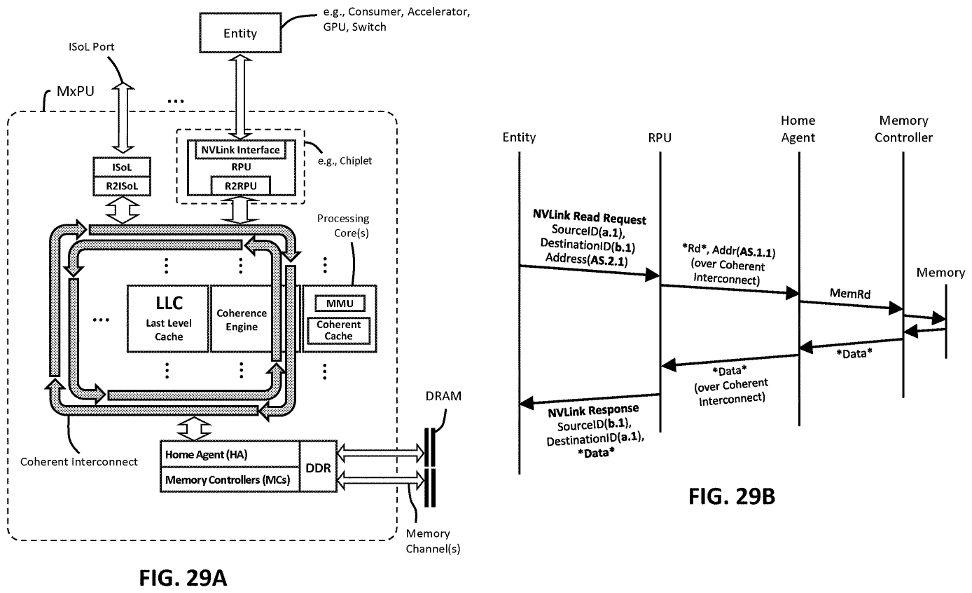

FIG. 29A illustrates an example of a processor (such as an MxPU) comprising processing cores, caches, and a coherent interconnect utilizing a topology structure of a ring. Alternatively, the coherent interconnect may utilize other topology structures such as a mesh, a crossbar, or a custom topology. The processor may further include an ISoL port such as ARM CHI C2C, NVIDIA NVLink-C2C, or Intel UPI, and memory controllers coupled via memory channels to memory, such as DRAM. The processor may include an NVLink interface that may communicate with an entity such as a GPU or an accelerator, according to an NVLink-based protocol, wherein an RPU may perform physical address translations to enable the entity to access the memory. The illustrated RPU is coupled to the coherent interconnect via a Ring-to-RPU (R2RPU) interconnect interface. Alternatively, the RPU may be coupled to the on-chip ring interconnect essentially directly. In some examples, the RPU, the NVLink interface, and the R2RPU may reside on a chiplet, such as an NVLink chiplet or NVLink Fusion, and coupled to the coherent interconnect via a chip-to-chip (C2C) interface. Similarly, the illustrated ISoL port may be coupled to the on-chip ring interconnect via a Ring-to-ISoL (R2ISoL) interconnect interface. The processor may be implemented as a monolithic die that includes the RPU and the NVLink interface, as silicon dies or chiplets within an IC package, such as by utilizing separate compute die(s) and I/O die(s), or as components on a board.

FIG. 29B illustrates an example of a TFD demonstrating an NVLink read request received from an entity, such as a GPU or an accelerator, wherein the RPU may translate a physical address (AS.2.1) carried in the NVLink request, to a physical address (AS.1.1) utilized for accessing the memory. The NVLink request may carry ID-based fields, such as source ID and destination ID, which may be utilized by NVLink switches for routing the request. In some examples, the NVLink request may further include a Tag that may be utilized to identify a transaction and match it with a corresponding NVLink response, and may further include a Length field that may specify the length of the data transfer requested. In some examples, the RPU may translate an NVLink request to multiple read transactions of the protocol utilized by the coherent interconnect, such as in order to fulfill the length of the data transfer specified in the NVLink request. The RPU may perform further translations, such as protocol translations from an NVLink-based protocol to a protocol utilized by the processor's coherent interconnect, and may further send the optionally translated request to a home agent (also known as home node), and/or to a memory controller, requesting the read of address (AS.1.1). In some examples, the requested data may be provided by a processor cache, such as by an LLC, instead of being provided by the memory. The data may then return over the processor's coherent interconnect to the RPU, wherein the RPU provides an NVLink response to the requesting entity. In some examples, the NVLink response may include a Tag that may identify the transaction and may enable matching the NVLink response with a corresponding NVLink request.

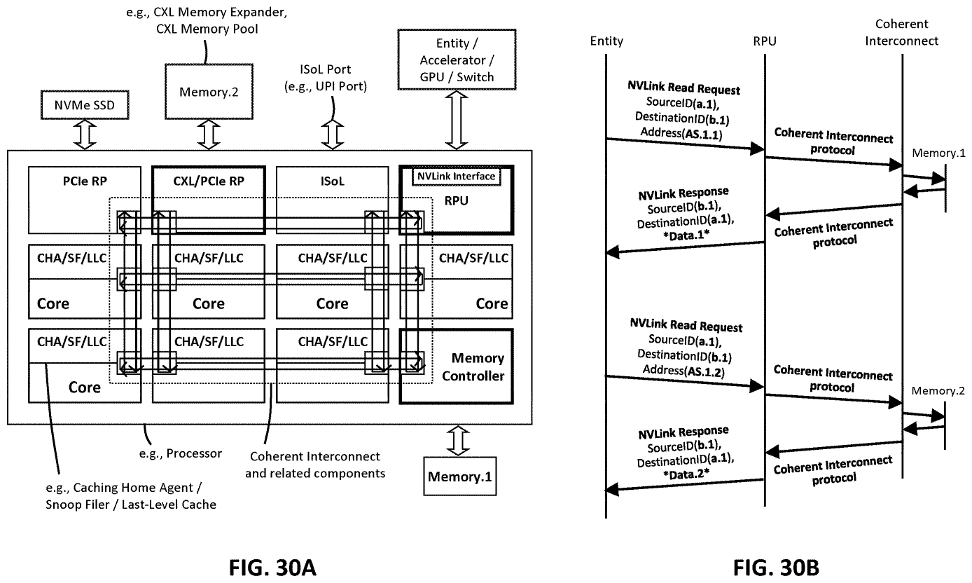

FIG. 30A illustrates an example of a system comprising a processor, including a coherent interconnect, capable of enabling an external entity to access memory resources mapped to the address space utilized by the coherent interconnect. Optionally, the processor may include an MxPU derived from an established processor design that may include processing cores, caching/home agent (CHA), snoop filter (SF), and last-level cache (LLC), optionally implemented as slices distributed across tiles on the coherent interconnect mesh. The processor may further include an ISoL port (such as a port utilizing Intel Coherent Processor Interconnect Protocol (ICPIP), or ARM CHI C2C), a PCIe RP that may be coupled to an NVMe SSD, a CXL/PCIe RP, and/or a memory controller that may be coupled to a first memory, such as DRAM. The processor may be coupled to a second memory, such as a CXL memory expander or a CXL memory pool, and may further include an RPU that includes or coupled to an NVLink interface that may communicate with an entity, such as an accelerator, according to an NVLink-based protocol, wherein the RPU may perform physical address translations to enable the entity to access the first memory (Memory.1) and/or the second memory (Memory.2). The illustrated RPU may be coupled to the coherent interconnect, and may translate between the NVLink-based protocol and a protocol utilized by the coherent interconnect. The processor may be implemented as a monolithic die, as chiplets within an IC package, such as by utilizing separate compute die(s) and I/O die(s), or as components on a board, and may utilize a mesh-based coherent interconnect, or in other examples may utilize a ring, a crossbar, or other types of coherent interconnects. In other examples, the NVLink interface may reside on a separate chiplet, such as an NVLink Fusion, and may be coupled to the coherent interconnect via a UCIe interface or a proprietary chip-to-chip or die-to-die interface.

FIG. 30B illustrates an example of a TFD demonstrating two NVLink requests, such as NVLink read requests, received from an entity (such as an accelerator, GPU, or a switch) and forwarded to different memories mapped to an address space utilized by the coherent interconnect. The RPU may perform physical address translations to enable the entity to access the processor's memories. The processor may have multiple memory resources, such as DRAM coupled to a memory controller of the processor, and/or memory expanders that may be coupled to a CXL RP of the processor. The RPU may further translate from NVLink-based traffic to traffic conforming to a protocol utilized by the coherent interconnect, and may send the optionally translated traffic to the coherent interconnect, requesting a read from memory. In some examples, the requested data may be provided by a processor cache, such as by an LLC, instead of by the memory. The data may then return over the coherent interconnect to the RPU, wherein the RPU provides an NVLink response to the requesting entity. The TFD illustrates two exemplary transactions carrying different physical addresses mapped to different memory resources. The first exemplary transaction includes an NVLink request comprising physical address (AS.1.1), which the RPU translates and forwards via the coherent interconnect protocol to Memory.1, resulting in the retrieval of *Data.1* that is returned to the entity with the first NVLink response. The second exemplary transaction includes an NVLink request comprising physical address (AS.1.2), which the RPU translates and forwards via the coherent interconnect protocol to Memory.2, resulting in the retrieval of *Data.2* that is returned to the entity with the second NVLink response. The physical addresses (AS.1.1) and (AS.1.2) may refer to different memory regions within the address space utilized by the coherent interconnect, enabling the entity to access memory resources based on the RPU's translation capabilities.

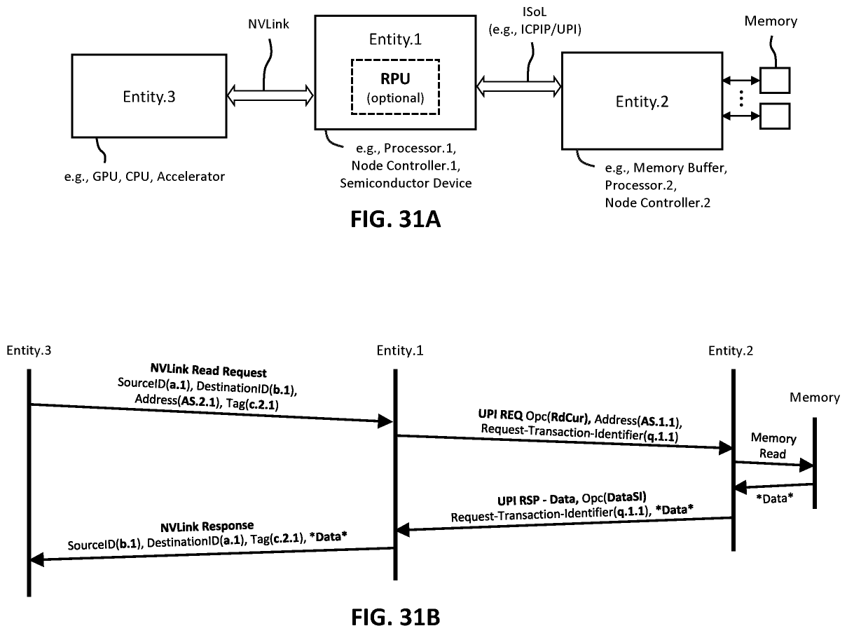

FIG. 31A illustrates an example of a system comprising a first entity (Entity.1), such as a first processor (Processor.1), a first node controller (Node Controller.1), or a semiconductor device, which may include an RPU. The first entity may be coupled to a third entity (Entity.3), which may be an accelerator, a GPU, a CPU, or an NVLink switch, wherein the first entity may communicate with the third entity according to an NVLink-based protocol, such as a protocol utilizing an NVLink interconnect. The first entity may be further coupled to a second entity (Entity.2), which may be a second processor (Processor.2), a memory buffer, or a second node controller (Node Controller.2), wherein the second entity may be coupled to memory, and wherein the first entity may communicate with the second entity according to an ISoL protocol, such as ARM CHI C2C, a protocol utilizing an NVIDIA NVLink-C2C interconnect, or Intel Coherent Processor Interconnect Protocol (ICPIP), such as Intel UPI. The first node controller (Node Controller.1) and the second node controller (Node Controller.2) may each include an ICPIP node controller, such as a UPI node controller (UNC), or an external node controller (e.g., XNC).

The first entity, optionally via the RPU, may translate between messages conforming to the NVLink-based protocol and messages conforming to the ISoL protocol, such as ICPIP, enabling the third entity to access resources coupled to the first entity (Entity.1), such as the memory that may be coupled to the second entity. In some examples, messages conforming to the NVLink-based protocol may be associated with a first address space, such as an NVLink-based address space, an NVLink-based network address space, or a GPU address space; and messages conforming to the ISoL protocol, such as ICPIP (e.g., Intel UPI), may be associated with a second address space, such as a System Physical Address (SPA) space or a Host Physical Address (HPA) space; wherein the first entity, optionally via the RPU, may perform address translations between addresses within the first and second address spaces, respectively, such as between addresses within the NVLink-based address space and addresses within the SPA space or the HPA space. In other examples, messages conforming to the NVLink-based protocol and messages conforming to the ISoL protocol, such as ICPIP (e.g., Intel UPI), may be associated with the same physical address space, such as with a global address space, a partitioned global address space (PGAS), a pod address space, a virtual pod address space, or a fabric address space; wherein the first entity, optionally via the RPU, may perform address translations between addresses within the same address spaces.

The first entity, optionally via the RPU, may perform further translations, such as protocol translations, opcode translations, command translations, TLP translations, or field translations (e.g. cross-field translations), such as between request types of NVLink requests and opcodes in requests conforming to the ISoL Protocol (e.g., Intel UPI RdCur opcode). The first entity, optionally via the RPU, may further translate between values of fields carried in PDUs of the NVLink-based protocol and in PDUs of the ISoL Protocol, e.g., translate traffic class (TC) and/or Tags, wherein the first entity, optionally via the RPU, may maintain tracking between Tags associated with the NVLink-based protocol and Tags associated with the ISoL protocol, such as in order to associate responses with their corresponding requests, within the same domain and/or between different domains.

FIG. 31B illustrates an example of a TFD demonstrating translations performed by a first entity (Entity.1), such as a first processor (Processor.1), a first node controller (Node Controller.1), or a semiconductor device, optionally via an RPU, between NVLink-based traffic and ISoL traffic, such as ICPIP traffic. The NVLink-based traffic may be utilized for communicating with a third entity (Entity.3), such as an accelerator, and the ISoL traffic may be utilized for communicating with a second entity (Entity.2), such as a second processor (Processor.2), or a second node controller (Node Controller.2). The second entity may be coupled to a memory, such as DRAM, which may be mapped to a physical address space (PAS) utilized by the first entity. The third entity may initiate an NVLink request, such as an NVLink read request, comprising SourceID(a.1), DestinationID(b.1), Address(AS.2.1), and Tag(c.2.1), wherein SourceID(a.1) may identify the source entity in the NVLink interconnect, such as the source GPU, wherein DestinationID(b.1) may identify the destination entity in the NVLink interconnect, such as the destination GPU, and wherein the NVLink interconnect may utilized ID-based routing when forwarding the NVLink request. The first entity, optionally via the RPU, may translate the NVLink request to an ISoL (e.g., ICPIP) transaction, such as an Intel UPI transaction that may include a UPI request (REQ message class) comprising Opc(RdCur), Address(AS.1.1), and Request-Transaction-Identifier(q.1.1), wherein the Request-Transaction-Identifier (e.g., RTID) may denote a Tag, a transaction Tag, a transaction identifier, or another field or set of fields carried in UPI transactions which may serve to associate responses with their corresponding requests. The first entity may send the UPI request (REQ) to the second entity.

Upon receiving a response from the second entity, that may include a UPI data response (“RSP-Data” message class, which may also be denoted by “RSP4-Data”) comprising Opc(DataSI), Request-Transaction-Identifier(q.1.1), and *Data*, the first entity, optionally via the RPU, may translate the UPI response (RSP-Data) to an NVLink response comprising SourceID(b.1), DestinationID(a.1), Tag(c.2.1), and *Data*. In some examples, the requested data may be provided by a processor cache instead of by the memory, such as wherein the requested data may be provided by an LLC that may be included in the first entity, or by an LLC that may be included in the second entity. In other examples, the first entity (Entity.1), optionally via the RPU, may translate the NVLink request to an ICPIP transaction, such as an Intel UPI transaction, that may include message classes such as REQ, SNP, WB, RSP (such as RSP2 or RSP4), NCB, or NCS, that may include commands, operations, or opcodes (e.g., Opc), such as RdCode, RdCur, RdData, RdInv, RdInvOwn, SnpCode, SnpCur, SnpData, SnpInv, WbMtoS, WcWr, WcWrPtl, DataE, DataSI, or DataM_CmpO. The first entity, optionally via the RPU, may perform further translations, such as protocol translations, opcode translations, command translations, or translations between protocol data units (PDUs) of the NVLink-based traffic and PDUs of the ISoL traffic (e.g., Intel UPI), such as traffic class (TC) translations, cross-field translations, or Tag translations. The first entity, optionally via the RPU, may maintain tracking between Tags in the NVLink-based domain and Tags in the ISoL domain, such as in order to associate responses with their corresponding requests, within the same domain and/or between different domains.

In various implementations, a method for translating between Compute Express Link (CXL) messages, comprising: receiving a first CXL message from a first entity; identifying a cacheline state intent based on at least one of a first opcode, a Snoop Type (SnpType), a Metadata Field (MetaField), or a Metadata Value (MetaValue) of the first CXL message, wherein the cacheline state intent pertains to a cacheline address specified in the first CXL message; translating the first CXL message to a second CXL message comprising a second opcode selected based at least in part on the identified cacheline state intent, wherein the second opcode differs from the first opcode; and sending the second CXL message to a second entity. The first entity may include a first host, the second entity may include a second host, and the entities may communicate using CXL. The cacheline state intent may indicate a desired cache state, such as Modified, Exclusive, Shared, or Invalid (MESI) that an entity seeks to acquire or affect for the cacheline address. For CXL.cache messages, the intent may be derived from the opcode, such as SnpData, SnpInv, or SnpCur for H2D requests, or RdOwn, RdShared, or CLFlush for D2H requests. For CXL.mem messages, the intent may be derived from the opcode, the SnpType, or a combination thereof, wherein the SnpType may indicate No-Op, SnpInv, or SnpData snoop requirements. By identifying the intent from the incoming message, the translation logic may select an appropriate opcode for the outgoing message that achieves the desired cache state transition, wherein the selected opcode differs from the incoming opcode due to differences in protocol direction or protocol type. The method may be performed by an RPU, a semiconductor device, or other computing apparatus positioned between the first entity and the second entity.

In some implementations of the method, the first CXL message comprises a CXL.cache Host-to-Device (H2D) request, and the first opcode is selected from SnpData, SnpInv, or SnpCur; and wherein the second CXL message comprises a CXL.cache Device-to-Host (D2H) request, and the second opcode is selected from RdOwn, RdShared, RdOwnNoData, RdCurr, RdAny, or CLFlush. The translation from CXL.cache H2D request to CXL.cache D2H request may enable inter-host communication via a device positioned between the hosts, wherein the device may expose CXL.cache interfaces to each host. H2D requests comprise snoops, such as SnpData, SnpInv, or SnpCur that indicate different cacheline state intents, while D2H requests comprise read or cache operation opcodes such as RdOwn, RdShared, RdOwnNoData, RdCurr, or CLFlush that achieve the corresponding cache state transitions.

In some implementations of the method, the first opcode comprises SnpData, the second opcode is selected from RdShared or RdOwn, whereby RdShared is selected to enable both the first entity and the second entity to retain cached copies of the cacheline in shared state, and whereby RdOwn is selected to cause the second entity to relinquish ownership and provide cacheline data for exclusive state acquisition by the first entity. SnpData indicates a snoop request for a cacheline that is intended to be cached in either shared or exclusive state at the first entity. The translation logic may determine whether shared or exclusive state is desired based on additional context, system configuration, or bias state information. RdShared requests a cacheline to be cached in shared state, enabling concurrent caching by multiple entities. RdOwn requests a cacheline to be cached in exclusive or modified state, causing the second entity to relinquish ownership and provide cacheline data to the translation logic for forwarding to the first entity.

In some implementations of the method, the first opcode comprises SnpInv, the second opcode is selected from CLFlush, RdOwnNoData, or RdOwn, whereby CLFlush is selected to invalidate the cacheline at the second entity without data return, whereby RdOwnNoData is selected to acquire exclusive ownership of the cacheline without data return, and whereby RdOwn is selected to acquire exclusive ownership of the cacheline with cacheline data return from the second entity. SnpInv indicates a snoop request that invalidates the cacheline at the receiving device and signals intent to acquire exclusive state at the first entity. The translation logic may determine whether data transfer is required based on data caching policies associated with the translation logic, the first entity's cache state, pending write operations, or other context. CLFlush requests flushing of the cacheline at the second entity, which may include data return if the cacheline is in Modified state, and may be selected when invalidation of the second entity's cached copy is the primary intent. RdOwnNoData requests exclusive ownership without data return and may be selected when the first entity will overwrite the entire cacheline. RdOwn requests exclusive ownership with data return and may be selected when the first entity requires current cacheline contents before modification.

In some implementations of the method, the first opcode comprises SnpCur, the second opcode comprises RdCurr, and whereby the translation enables the first entity to obtain current cacheline data from the second entity without modifying cache states at either the first entity or the second entity. SnpCur indicates a snoop request to obtain the current version of the cacheline without requiring change of cache states in the hierarchy. RdCurr indicates a read request to get the most current data without changing the existing state in any cache. The translation from SnpCur to RdCurr may enable the first entity to read current data from the second entity without affecting cache coherency states, which may be useful for I/O data operations, such as I/O-coherent reads (e.g., I/O-coherency mode), monitoring, debugging, or speculative operations.

In some implementations of the method, the first CXL message comprises a CXL.cache Device-to-Host (D2H) request, and the first opcode is selected from RdOwn, RdOwnNoData, RdShared, RdCurr, or CLFlush; and wherein the second CXL message comprises a CXL.cache Host-to-Device (H2D) request, and the second opcode is selected from SnpData, SnpInv, or SnpCur based on the cacheline state intent indicated by the first opcode. The translation from CXL.cache D2H request to CXL.cache H2D request may enable inter-device communication, wherein a read request or cache operation from one device is translated to a snoop request targeting another device. The translation logic may map RdShared to SnpData when the intent is to acquire shared state with possible data return, may map RdOwn, CLFlush, or RdOwnNoData to SnpInv when the intent is exclusive ownership acquisition or invalidation, and may map RdCurr to SnpCur when the intent is non-state-changing data access.

In some implementations of the method, the first CXL message comprises a CXL.mem Master-to-Subordinate (M2S) request; and wherein the second CXL message comprises a CXL.cache Device-to-Host (D2H) request, and the second opcode is selected from RdOwn, RdOwnNoData, RdShared, RdCurr, RdAny, or CLFlush. The translation from CXL.mem M2S request to CXL.cache D2H request may enable memory access operations from a first entity utilizing CXL.mem to be translated into cache coherency operations targeting a second entity utilizing CXL.cache. A set of fields in the M2S request, which may include SnpType, MetaField, or MetaValue, may indicate the cacheline state intent, which may be utilized to select an appropriate D2H request opcode. The translation logic may bridge between the CXL.mem and CXL.cache domains while preserving the intent of the memory operation.

In some implementations of the method, the CXL.mem M2S request comprises the SnpType and the MetaValue, the CXL.cache D2H request comprises the second opcode, and the second opcode is selected based on the SnpType and the MetaValue. The combination of SnpType and MetaValue in the M2S request may provide finer-grained indication of the cacheline state intent than SnpType alone. For example, an M2S request with SnpType indicating SnpData and MetaValue indicating Shared(S) may result in selection of RdShared. The translation logic may utilize both fields to determine the appropriate D2H request opcode.

In some implementations of the method, the CXL.mem M2S request comprises the SnpType that comprises SnpCur, and the CXL.cache D2H request comprises the second opcode that comprises RdCurr. The SnpCur to RdCurr translation may enable requests for a non-cacheable but current value of a cacheline, such as for I/O-coherent reads. The M2S request may further include MetaValue indicating Invalid (I) to indicate that the requester will not cache the line. RdCurr may retrieve the most current data from the second entity without causing state transitions in any cache. Upon receiving a response, such as a CXL.cache H2D Data, the computer may translate the response to a CXL.mem S2M DRS comprising MemData and a CXL.mem S2M NDR comprising Cmp.

In some implementations of the method, the CXL.mem M2S request comprises the SnpType that comprises SnpData, and the CXL.cache D2H request comprises the second opcode that comprises RdShared. The SnpData to RdShared translation may enable the requester to acquire a cacheline in shared state, permitting concurrent caching by multiple entities. The M2S request may further include MetaValue indicating Shared(S) to indicate the host may have at most a shared copy of the line. Upon receiving a response from the second entity, which may include a CXL.cache H2D response comprising GO-S, the computer may translate the response to a CXL.mem S2M NDR comprising Cmp-S, providing an indication for Shared state.

In some implementations of the method, the CXL.mem M2S request comprises the SnpType that comprises SnpInv, and the CXL.cache D2H request comprises the second opcode that comprises RdOwn. The SnpInv to RdOwn translation may enable the requester to acquire exclusive ownership of a cacheline, causing the second entity to relinquish any cached copies. The M2S request may further include MetaValue indicating Any (A) to indicate the host may have a shared, exclusive, or modified copy of the line. Upon receiving a response from the second entity, which may include a CXL.cache H2D response comprising GO-E or GO-M, the computer may translate the response to a CXL.mem S2M NDR comprising Cmp-E, providing an indication for Exclusive ownership.

In some implementations of the method, the second opcode is selected based on the SnpType as follows: RdOwn or RdOwnNoData is selected when the SnpType indicates SnpInv for exclusive ownership acquisition with or without data return respectively, CLFlush is selected when the SnpType indicates SnpInv for cacheline invalidation without ownership acquisition, and RdShared is selected when the SnpType indicates SnpData for shared state acquisition. The SnpType in the M2S request may indicate SnpInv for invalidation snoops or SnpData for data snoops. When SnpType indicates SnpInv, the translation logic may select RdOwn if data return is required, RdOwnNoData if exclusive ownership without data is sufficient, or CLFlush if invalidation is needed. When SnpType indicates SnpData, the translation logic may select RdShared to acquire the cacheline in shared state. This mapping enables CXL.mem operations to be properly coordinated with CXL.cache coherency.

In some implementations of the method, the first CXL message comprises a CXL.cache Device-to-Host (D2H) request, and the first opcode is selected from RdOwn, RdShared, RdCurr, RdAny, or CLFlush; and wherein the second CXL message comprises a CXL.mem Master-to-Subordinate (M2S) request comprising MemRd* and a second SnpType. The translation from CXL.cache D2H request to CXL.mem M2S request may enable cache coherency operations from a first entity utilizing CXL.cache to be translated into memory access operations targeting a second entity utilizing CXL.mem. The D2H request opcode may indicate the cacheline state intent, which may be utilized to select an appropriate SnpType value for the M2S request. For example, a D2H request comprising RdOwn may be translated to an M2S request comprising MemRd with SnpType set to SnpInv, while a D2H request comprising RdShared may be translated to an M2S request comprising SnpType set to SnpData.

In some implementations of the method, the CXL.cache D2H request comprises the first opcode, and the second SnpType is set based on the cacheline state intent indicated by the first opcode. The translation logic may analyze the first opcode to determine the cacheline state intent and set the second SnpType accordingly. For example, RdOwn may indicate intent to acquire exclusive state, resulting in SnpType being set to SnpInv, while RdShared may indicate intent to acquire shared state, resulting in SnpType being set to SnpData. This intent-based translation may enable CXL.cache operations to be properly coordinated with CXL.mem coherency semantics.

In some implementations of the method, the CXL.cache D2H request comprises the first opcode that comprises RdCurr, and the CXL.mem M2S request comprises the second SnpType that comprises SnpCur. The RdCurr to SnpCur translation may enable requests for a non-cacheable but current value of a cacheline via the CXL.mem interface. The M2S request may further include MetaField indicating MS0 and MetaValue indicating Invalid (I) to indicate that the requester may not cache the line. Upon receiving a response from the second entity, which may include a CXL.mem S2M DRS comprising MemData and a CXL.mem S2M NDR comprising Cmp, the computer may translate the response to a CXL.cache H2D Data for delivery to the first entity.

In some implementations of the method, the CXL.cache D2H request comprises the first opcode comprising RdShared, and the CXL.mem M2S request comprises the second SnpType comprising SnpData. The RdShared to SnpData translation may enable the CXL.cache requester to acquire a cacheline in shared state via the CXL.mem interface. The M2S request may further include MetaField indicating MS0 and MetaValue indicating Shared(S). Upon receiving a response from the second entity, which may include a CXL.mem S2M NDR comprising Cmp-S providing an indication for Shared state, the computer may translate the response to a CXL.cache H2D response comprising GO-S and a CXL.cache H2D Data comprising the cacheline data.

In some implementations of the method, the CXL.cache D2H request comprises the first opcode comprising RdOwn, and the CXL.mem M2S request comprises the second SnpType comprising SnpInv. The RdOwn to SnpInv translation may enable the CXL.cache requester to acquire exclusive ownership of a cacheline via the CXL.mem interface, typically receiving the cacheline in Exclusive or Modified state. The M2S request may further include MetaField indicating MS0 and MetaValue indicating Any (A). Upon receiving a response from the second entity, which may include a CXL.mem S2M NDR comprising Cmp-E providing an indication for Exclusive ownership, the computer may translate the response to a CXL.cache H2D response comprising GO-E and a CXL.cache H2D Data comprising the cacheline data.

In some implementations, the method further comprises maintaining a mapping between cacheline state intents and corresponding opcodes for the second CXL message, wherein the cacheline state intent indicates whether the first entity seeks to acquire a cache state that permits concurrent caching by other entities, a cache state that requires exclusive ownership, or invalidation of the cacheline at the second entity; and wherein the translating comprises utilizing the mapping to select the second opcode to achieve the indicated cache state transition at the second entity. The mapping may be implemented as a lookup table, combinational logic, or programmable translation function that associates each cacheline state intent with one or more candidate opcodes for the second CXL message. The cacheline state intent may be categorized as shared state acquisition (permitting concurrent caching), exclusive state acquisition (requiring the second entity to relinquish cached copies), or invalidation (causing the second entity to discard cached copies without ownership transfer). The translation logic may utilize the mapping to select an opcode that achieves the desired cache state transition while considering additional context such as whether data return is required.

In some implementations, the method further comprises receiving, from the second entity, a response message indicating a cache state based on at least one of a third opcode or cacheline data included in the response message; translating the response message to a translated response message comprising a fourth opcode selected based on the cache state indicated by the response message; wherein the fourth opcode differs from the third opcode; and sending the translated response message to the first entity. The response message may include a CXL.cache H2D response such as GO-M, GO-E, GO-S, or GO-I indicating Modified, Exclusive, Shared, or Invalid (MESI) cacheline state, respectively. The translation logic may select an opcode for the translated response message, such as a CXL.cache D2H response comprising RspIHitI, RspSHitSE, RspIFwdM, or similar, which communicates the resulting cacheline state to the first entity. The translation may utilize a previously stored identifier mapping to correctly route the response back to the originating transaction.

In some implementations of the method, the cache state indicated by the response message indicates shared state, exclusive state, or modified state; and wherein the fourth opcode is selected as follows: RspSHitSE is selected when the third opcode indicates GO-S for shared state to communicate that the cacheline is available in shared state, RspIHitI or RspIHitSE is selected when the third opcode indicates GO-E for exclusive state to communicate that the cacheline is no longer present in the cache abstraction, and RspIFwdM is selected when the third opcode indicates GO-M for modified state to communicate that modified data is being forwarded. The GO-S indication signifies that the second entity is providing the cacheline in shared state, permitting concurrent caching by multiple entities, and the translation logic may select RspSHitSE to indicate to the first entity that the cacheline was hit in a clean state and its current state is shared. The GO-E indication signifies that the second entity has granted exclusive ownership, and the translation logic may select RspIHitI or RspIHitSE to indicate that the cacheline is no longer present in the cache abstraction. The GO-M indication signifies that the second entity previously held the cacheline in modified state and is relinquishing ownership along with modified data, and the translation logic may select RspIFwdM to indicate that modified data is being forwarded.

In some implementations, the method further comprises exposing a cache abstraction to the first entity, wherein the cache abstraction appears to the first entity as a device cache accessible via CXL transactions, whereby the cache abstraction acts as a proxy for cache resources maintained by the second entity, and wherein the first entity issues CXL messages targeting the cache abstraction that are translated to outgoing CXL messages affecting actual caches in the second entity based on the identified cacheline state intent. The cache abstraction may be exposed as a CXL Type-1 or CXL Type-2 device interface that the first entity may enumerate and interact with as a local device cache. The first entity may issue CXL messages, such as snoop requests, that target the cache abstraction, wherein the translation logic may identify the cacheline state intent from these messages and translate them to appropriate outgoing CXL messages that affect actual caches in the second entity. This proxy arrangement may enable cache coherency operations between entities that cannot communicate directly due to protocol direction constraints or address space differences.

In some implementations of the method, the translating enables cacheline state orchestration between a first cache maintained by the first entity and a second cache maintained by the second entity; wherein the cacheline state orchestration enables the first entity to affect cache states in the second cache through the translated second CXL message, and indicates transitions between at least two states selected from Modified, Exclusive, Shared, or Invalid (MESI) according to a cache coherency protocol. Cacheline state orchestration may encompass coordinated transitions between various cache states according to MESI or similar cache coherency protocols. The translation logic may enable the first entity to cause invalidation, downgrade, or ownership transfer of cachelines in the second entity's cache hierarchy by translating the first entity's CXL messages into appropriate CXL messages for the second entity.

In some implementations of the method, the cacheline state orchestration further enables cache-coherent memory sharing between the first entity and the second entity by allowing both entities to access shared memory resources while maintaining data consistency. The translation logic may track pending transactions and coordinate state transitions to maintain coherency invariants across both cache hierarchies, enabling cache-coherent memory sharing in disaggregated memory systems, multi-GPU clusters, heterogeneous computing platforms, or other multi-entity architectures.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: a computer configured to: receive, from a first entity, a first Compute Express Link (CXL) message; identify a cacheline state intent based on at least one of a first opcode, a Snoop Type (SnpType), a Metadata Field (MetaField), or a Metadata Value (MetaValue) of the first CXL message, wherein the cacheline state intent pertains to a cacheline address specified in the first CXL message; translate the first CXL message to a second CXL message comprising a second opcode selected based at least in part on the identified cacheline state intent, wherein the second opcode differs from the first opcode; and send the second CXL message to a second entity. The computer may include processing logic, memory for storing translation tables and transaction state, and interface controllers for managing CXL communications with each entity. The system may be implemented as a standalone device, integrated into a larger semiconductor component, or distributed across multiple components within a computing platform. The translation capabilities may enable diverse system architectures such as disaggregated memory systems, multi-host configurations, multi-GPU clusters, or heterogeneous computing platforms.

In some implementations of the system, the computer is included within a semiconductor device comprising a first CXL.cache interface configured to receive CXL.cache Host-to-Device (H2D) requests from the first entity and a second CXL.cache interface configured to send CXL.cache Device-to-Host (D2H) requests to the second entity; wherein the semiconductor device is positioned between the first entity and the second entity to enable inter-entity communication based on translating snoops received from the first entity to read or cache operation opcodes sent to the second entity based on the identified cacheline state intent. The semiconductor device may be implemented as an ASIC, FPGA, SoC, RPU, or other integrated circuit technology. The first CXL.cache interface may receive H2D requests comprising snoops such as SnpData, SnpInv, or SnpCur, and the second CXL.cache interface may send D2H requests comprising opcodes such as RdOwn, RdShared, RdOwnNoData, or CLFlush selected based on the cacheline state intent. Each interface may include physical layer circuits, link layer controllers, and protocol layer engines specifically designed for CXL.cache communication.

In some implementations of the system, the first CXL message comprises a CXL.mem Master-to-Subordinate (M2S) request, the second CXL message comprises a CXL.cache Device-to-Host (D2H) request, and wherein the computer is configured to bridge between CXL.mem and CXL.cache by identifying the cacheline state intent, based on at least one of the SnpType or the first opcode, and selecting an opcode for the D2H request that achieves a corresponding cache state transition at the second entity. The computer may be configured to bridge between CXL.mem and CXL.cache domains, enabling memory access operations from entities utilizing CXL.mem to be coordinated with cache coherency operations targeting entities utilizing CXL.cache. The system may analyze SnpType values to determine whether SnpInv or SnpData is indicated, and may select corresponding D2H request opcodes such as RdOwn, RdOwnNoData, CLFlush, or RdShared to achieve the intended cache state transition. This bridging capability may enable heterogeneous systems where different entities utilize different CXL protocols.

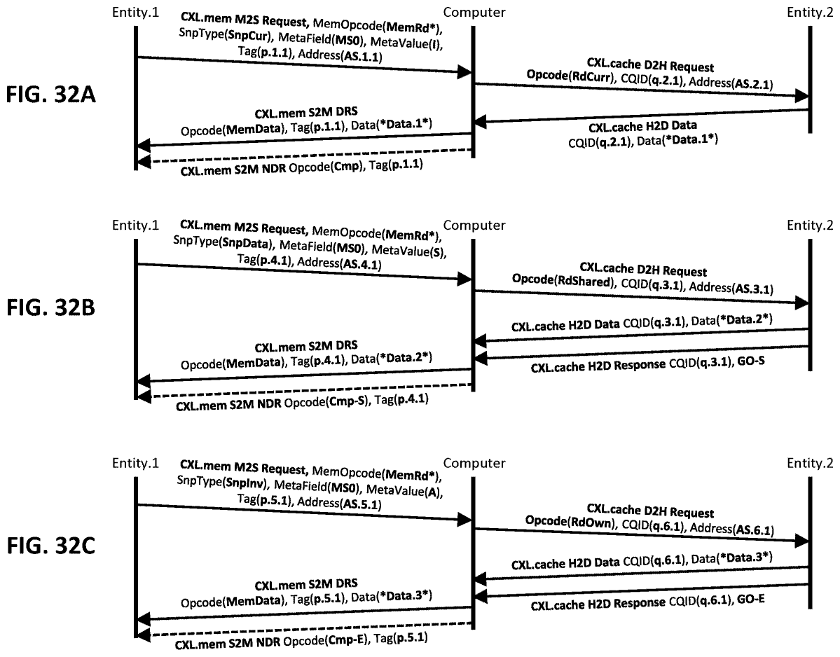

FIG. 32A illustrates an example of a TFD demonstrating intent-based translations between CXL.mem messages received from a first entity (Entity.1), such as a first host (Host.1), and CXL.cache messages sent to a second entity (Entity.2), such as a second host (Host.2), possibly enabling the first entity to access resources mapped to an address space utilized by the second entity. The first entity may initiate a CXL.mem transaction that may include a CXL.mem M2S request comprising MemOpcode(MemRd*), SnpType(SnpCur), MetaField(MS0), MetaValue(I), Tag(p.1.1), and Address(AS.1.1), wherein the CXL.mem M2S request may indicate an intent to request a non-cacheable but current value of a cacheline. The computer may perform intent-based translation between the CXL.mem domain and the CXL.cache domain, by translating the CXL.mem transaction to a CXL.cache transaction that may include a CXL.cache D2H request comprising Opcode(RdCurr), CQID(q.2.1), and Address(AS.2.1), wherein the CXL.cache D2H request may indicate a corresponding intent to request a non-cacheable but current value of a cacheline by utilizing RdCurr. The computer may send the CXL.cache D2H request to the second entity. Upon receiving a response from the second entity, which may include a CXL.cache H2D Data comprising CQID(q.2.1) and Data(*Data.1*), the computer may translate the CXL.cache H2D Data to a CXL.mem S2M DRS comprising Opcode(MemData), Tag(p.1.1), and Data(*Data.1*), and may further translate the CXL.cache H2D Data to a CXL.mem S2M NDR comprising Opcode(Cmp) and Tag(p.1.1). The computer may perform further translations, such as address translations, translations between CXL.mem Tags and CXL.cache CQIDs, translations between reserved fields, and/or opcode translations, e.g., translating between CXL.mem M2S request opcodes, such as MemRd*, and CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed.

FIG. 32B illustrates an example of a TFD demonstrating intent-based translations wherein a first entity may initiate a CXL.mem transaction that may include a CXL.mem M2S request comprising MemOpcode(MemRd*), SnpType(SnpData), MetaField(MS0), MetaValue(S), Tag(p.4.1), and Address(AS.4.1), wherein the CXL.mem M2S request may indicate an intent to request a shared copy of the cacheline. A computer may perform intent-based translation between the CXL.mem domain and the CXL.cache domain, and may translate the CXL.mem transaction to a CXL.cache transaction that may include a CXL.cache D2H request comprising Opcode(RdShared), CQID(q.3.1), and Address(AS.3.1), wherein the CXL.cache D2H request may indicate a corresponding intent to request a cacheline to be cached in shared state by utilizing RdShared. The computer may send the CXL.cache D2H request to a second entity. Upon receiving a response from the second entity, which may include a CXL.cache H2D Data comprising CQID(q.3.1) and Data(*Data.2*), and may further include CXL.cache H2D response comprising CQID(q.3.1) and GO-S, the computer may translate the CXL.cache H2D Data to a CXL.mem S2M DRS comprising Opcode(MemData), Tag(p.4.1), and Data(*Data.2*), and may further translate the CXL.cache H2D response to a CXL.mem S2M NDR comprising Opcode(Cmp-S) and Tag(p.4.1), wherein Cmp-S may provide an indication from the DCOH to the first entity for Shared state.

FIG. 32C illustrates an example of a TFD demonstrating intent-based translations wherein a first entity may initiate a CXL.mem transaction that may include a CXL.mem M2S request comprising MemOpcode(MemRd*), SnpType(SnpInv), MetaField(MS0), MetaValue(A), Tag(p.5.1), and Address(AS.5.1), wherein the CXL.mem M2S request may indicate an intent to request an exclusive copy of the cacheline. A computer may perform intent-based translation between the CXL.mem domain and the CXL.cache domain, and may translate the CXL.mem transaction to a CXL.cache transaction that may include a CXL.cache D2H request comprising Opcode(RdOwn), CQID(q.6.1), and Address(AS.6.1), wherein the CXL.cache D2H request may indicate a corresponding intent to request a cacheline to be cached in any writeable state by utilizing RdOwn, typically receiving the cacheline in Exclusive (GO-E) or Modified (GO-M) state, and wherein the computer may send the CXL.cache D2H request to a second entity. Upon receiving a response from the second entity, which may include a CXL.cache H2D Data comprising CQID(q.6.1) and Data(*Data.3*), and may further include a CXL.cache H2D response comprising CQID(q.6.1) and GO-E, the computer may translate the CXL.cache H2D Data to a CXL.mem S2M DRS comprising Opcode(MemData), Tag(p.5.1), and Data(*Data.3*), and may further translate the CXL.cache H2D response to a CXL.mem S2M NDR comprising Opcode(Cmp-E) and Tag(p.5.1), wherein Cmp-E may provide an indication from the DCOH to the first entity for Exclusive ownership.

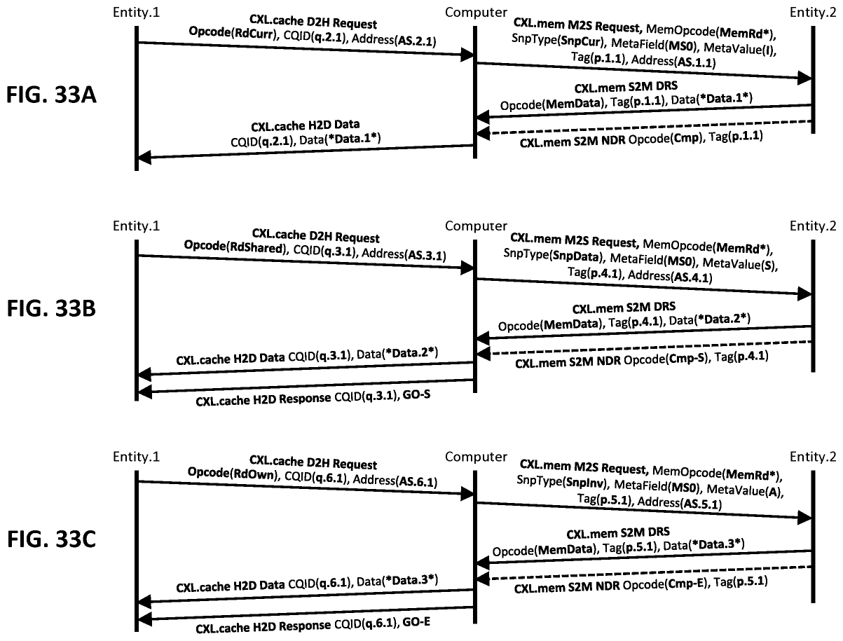

FIG. 33A illustrates an example of a TFD demonstrating intent-based translations between CXL.cache messages received from a first entity (Entity.1), such as a first device (Device.1), and CXL.mem messages sent to a second entity (Entity.2), such as a second device (Device.2), possibly enabling the first entity to access resources mapped to an address space utilized by the second entity. The first entity may initiate a CXL.cache transaction that may include a CXL.cache D2H request comprising Opcode(RdCurr), CQID(q.2.1), and Address(AS.2.1), wherein the CXL.cache D2H request may indicate an intent to request a non-cacheable but current value of a cacheline by utilizing RdCurr.

The computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpCur), MetaField(MS0), MetaValue(I), Tag(p.1.1), and Address(AS.1.1). The CXL.mem M2S request may indicate a corresponding intent to request a non-cacheable but current value of a cacheline. The computer may send the CXL.mem M2S request to the second entity. Upon receiving a response from the second entity, which may include a CXL.mem S2M DRS comprising Opcode(MemData), Tag(p.1.1), and Data(*Data.1*), and may further include a CXL.mem S2M NDR comprising Opcode(Cmp) and Tag(p.1.1), the computer may translate the CXL.mem S2M DRS to a CXL.cache H2D Data comprising CQID(q.2.1) and Data(*Data.1*). The computer may perform further translations, such as address translations, translations between CXL.cache CQIDs and CXL.mem Tags, translations between reserved fields, and/or opcode translations, e.g., translating between CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed, and CXL.mem M2S request opcodes, such as MemRd*.

FIG. 33B illustrates an example of a TFD demonstrating intent-based translations wherein a first entity may initiate a CXL.cache transaction that may include a CXL.cache D2H request comprising Opcode(RdShared), CQID(q.3.1), and Address(AS.3.1), wherein the CXL.cache D2H request may indicate an intent to request a cacheline to be cached in shared state by utilizing RdShared. A computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpData), MetaField(MS0), MetaValue(S), Tag(p.4.1), and Address(AS.4.1), wherein the CXL.mem M2S request may indicate a corresponding intent to request a shared copy of the cacheline, and wherein the computer may send the CXL.mem M2S request to the second entity. Upon receiving a response from the second entity, which may include a CXL.mem S2M DRS comprising Opcode(MemData), Tag(p.4.1), and Data(*Data.2*), and may further include a CXL.mem S2M NDR comprising Opcode(Cmp-S) and Tag(p.4.1), the Cmp-S may provide an indication from the DCOH to the computer for Shared state. The computer may translate the CXL.mem S2M DRS to a CXL.cache H2D Data comprising CQID(q.3.1) and Data(*Data.2*), and may further translate the CXL.mem S2M DRS and/or the CXL.mem S2M NDR to a CXL.cache H2D response comprising CQID(q.3.1) and GO-S.

FIG. 33C illustrates an example of a TFD demonstrating intent-based translations wherein a first entity may initiate a CXL.cache transaction that may include a CXL.cache D2H request comprising Opcode(RdOwn), CQID(q.6.1), and Address(AS.6.1), wherein the CXL.cache D2H request may indicate an intent to request a cacheline to be cached in any writeable state by utilizing RdOwn, typically receiving the cacheline in Exclusive (GO-E) or Modified (GO-M) state. A computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpInv), MetaField(MS0), MetaValue(A), Tag(p.5.1), and Address(AS.5.1), wherein the CXL.mem M2S request may indicate a corresponding intent to request an exclusive copy of the cacheline, and wherein the computer may send the CXL.mem M2S request to a second entity. Upon receiving a response from the second entity, which may include a CXL.mem S2M DRS comprising Opcode(MemData), Tag(p.5.1), and Data(*Data.3*), and may further include a CXL.mem S2M NDR comprising Opcode(Cmp-E) and Tag(p.5.1), the Cmp-E may provide an indication from the DCOH to the computer for Exclusive ownership. The computer may translate the CXL.mem S2M DRS to a CXL.cache H2D Data comprising CQID(q.6.1) and Data(*Data.3*), and may further translate the CXL.mem S2M DRS and/or the CXL.mem S2M NDR to a CXL.cache H2D response comprising CQID(q.6.1) and GO-E.

In environments where entities may utilize different protocols while requiring access to shared memory resources, there may be scenarios where a first entity communicating according to UPLI, such as an accelerator or a UALink switch, needs to access memory resources residing in a CXL domain, such as host memory accessible via a CXL host. An RPU or other suitable device may translate between UPLI and CXL.cache to facilitate memory operations across different protocol domains. The translation may involve converting UPLI requests comprising read or write commands to CXL.cache D2H requests comprising corresponding read or write opcodes, and converting CXL.cache H2D data messages and responses to UPLI read responses, including translations of addresses, Tags, CQIDs, and data formats.

In various implementations, a method comprising: receiving, from a first entity, an Ultra Accelerator Link Protocol Level Interface (UPLI) request comprising a read command; translating, by a Resource Provisioning Unit (RPU), the UPLI request to a CXL.cache Device-to-Host (D2H) request comprising a read opcode, wherein CXL denotes Compute Express Link; sending the CXL.cache D2H request to a second entity; receiving, from the second entity, a CXL.cache Host-to-Device (H2D) data message; translating, by the RPU, the CXL.cache H2D data message to a UPLI read response; and sending the UPLI read response to the first entity. The method translates between UPLI and CXL.cache domains. The RPU receives UPLI requests containing read commands which may include Read commands, AtomicR commands, Vendor Defined Commands with read data returned over the UPLI read response/data (Rd Rsp/Data) Channel, or other read command types supported by UPLI. The RPU translates these read commands into corresponding CXL.cache read opcodes such as RdCurr, RdOwn, RdShared, or RdAny. The translation adapts the operation to the requirements and capabilities of the domain. Upon receiving data responses from the CXL host, the RPU translates the data for the originator, which enables communication between the UPLI and CXL domains while abstracting the protocol differences from both sides.

In some implementations of the method, the UPLI request comprises a source accelerator identifier and a destination accelerator identifier, and the UPLI read response comprises a destination accelerator identifier carrying a value that matches the source accelerator identifier from the UPLI request, and wherein the RPU saves at least the source accelerator identifier from the UPLI request for use in generating the UPLI read response. In some examples, the UPLI request includes identifiers that specify both the source and destination accelerators. The RPU saves at least the source accelerator identifier upon receiving the UPLI request. When generating the UPLI read response, the RPU uses the saved source accelerator identifier from the request as the destination accelerator identifier in the response for proper message routing back to the original requester. In some examples, the RPU may also save the destination accelerator identifier from the UPLI request, and include a source accelerator identifier in the UPLI read response, such as for debugging purposes, however such inclusion is not required for basic functionality.

In some implementations of the method, the UPLI request further comprises a first address and a first Tag, the CXL.cache D2H request comprises a second address translated from the first address and a command queue identifier (CQID) associated with the first Tag, and the UPLI read response comprises the first Tag. In some examples, the RPU performs address translation between physical addresses within UALink address space and physical addresses within CXL.cache address space while maintaining correlations between requests and responses utilizing Tag/CQID mapping. The RPU translates the UALink address to a corresponding CXL.cache address based on configured address mappings. Additionally, the RPU maintains a mapping between UPLI Tags and CXL.cache CQIDs to properly associate responses with their originating requests. This mapping enables the RPU to include the original UPLI Tag in the UPLI read response, allowing the originator to correlate responses with its outstanding requests.

In some implementations of the method, the UPLI request further comprises a length field indicating an amount of data requested; and wherein translating the UPLI request comprises generating multiple CXL.cache D2H requests when the amount of data requested exceeds a maximum CXL.cache transaction size. The RPU may handle UPLI requests that specify data transfers larger than what a CXL.cache transaction can support. The length field in the UPLI request indicates the amount of data requested, which can be up to 256 bytes, while CXL.cache transactions typically handle up to 64 bytes each. When the requested data size exceeds the CXL.cache transaction size limit, the RPU may segment the request into multiple CXL.cache transactions. For example, a 256-byte UPLI request would be translated into four 64-byte CXL.cache transactions, and the RPU manages these multiple transactions while maintaining the appearance of a single operation to the originator.

In some implementations of the method, the UPLI request comprises a Tag, the CXL.cache D2H requests comprise command queue identifiers (CQIDs); and wherein generating the multiple CXL.cache D2H requests comprises associating multiple CQIDs with the Tag. When handling large data transfers that require multiple CXL.cache transactions, the RPU may implement Tag-to-CQID mapping. For a UPLI comprising one Tag, the RPU may generate and track multiple CQIDs, one for each CXL.cache transaction. For example, if a UPLI request comprising Tag #1 requires four CXL.cache transactions, the RPU may generate CQIDs #1 through #4, maintaining mappings between the CQIDs and the original Tag #1. This mapping enables the RPU to associate the relevant CXL.cache responses with the original UPLI request and generate a consolidated response.

In some implementations of the method, translating the CXL.cache H2D data message further comprises: receiving multiple CXL.cache H2D data messages corresponding to the multiple CXL.cache D2H requests, aggregating data from the multiple CXL.cache H2D data messages, and including the aggregated data in the UPLI read response. When handling large data transfers that were split into multiple CXL.cache transactions, the RPU may perform data aggregation before generating the UPLI read response. The RPU receives multiple CXL.cache H2D data messages collectively containing the requested data, which are collected and optionally reassembled in a predetermined order to form a complete data payload. The RPU may manage this aggregation process while maintaining data integrity and proper ordering, such that the originator receives a single, coherent response containing the requested data.

In some implementations of the method, the read opcode of the CXL.cache D2H request is RdCurr, and processing the CXL.cache D2H request does not change existing state in a cache accessible to the RPU. In some examples, the RPU translates the UPLI read command into a CXL.cache D2H request comprising RdCurr, thereby indicating that the memory read is performed using a current state read function, which means that the RPU either does not issue cache commands, or processing the CXL.cache RdCurr request does not change existing state in a cache accessible to the RPU.

In some implementations of the method, the read command is selected from at least one of: a Read command, an AtomicR command, or a Vendor Defined Command with read data returned over a UPLI read response/data (Rd Rsp/Data) Channel; and wherein the read opcode is selected from at least one of: RdCurr, RdOwn, RdShared, or RdAny. The RPU may support translation between various types of read commands in the UPLI domain and read opcodes in the CXL domain. The UPLI read commands may include one or more of memory reads, atomic operations that provide atomicity guarantees, and/or Vendor Defined read commands for custom functionality. The UPLI read commands are translated to appropriate CXL.cache read opcodes based on the operation's requirements. For example, RdCurr requests the current value without changing cache states, RdOwn obtains exclusive ownership, RdShared enables shared access, and RdAny allows flexible coherency state transitions.

In some implementations of the method, the CXL.cache H2D data message comprises first data in a first format; and wherein translating the CXL.cache H2D data message comprises transforming the first data to second data in a second format for the UPLI read response. The RPU may need to transform data between different formats as it moves between UPLI and CXL.cache domains, which may involve changes in data organization, alignment, or representation. The RPU can maintain data integrity while performing the applicable format conversions to meet the requirements of the protocol. The first format may be optimized for CXL.cache operations, while the second format adheres to UPLI specifications for data transfer.

In some implementations, the method further comprises receiving, from the first entity, a UPLI request comprising a write command and write data; translating, by the RPU, the UPLI request comprising the write command to a CXL.cache D2H request comprising a write opcode selected from at least one of: DirtyEvict, ItoMWr, WrCur, or WrInv; and sending the CXL.cache D2H request comprising the write opcode and the write data to the second entity; wherein the first entity comprises a UPLI originator, an accelerator, or a UALink switch; and wherein the second entity comprises a CXL host; and wherein the RPU comprises a CXL device exposing a CXL endpoint to the second entity. The RPU may translate UPLI write commands to CXL.cache D2H write opcodes. DirtyEvict may be utilized when evicting a modified cacheline from the RPU, ItoMWr may be utilized for write operations that upgrade the cacheline from Invalid to Modified state, WrCur may write to a cacheline on a cache hit or to memory on a cache miss, and WrInv may write data while invalidating the cacheline. In some examples, the first entity may be a UPLI originator, such as an accelerator or a UALink switch, that initiates the write transaction, and the second entity may be a CXL host that receives the translated CXL.cache D2H write request. The RPU may expose a CXL endpoint, such as a Type-1 or Type-2 CXL device, to the CXL host for CXL.cache communication.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

An apparatus may include a first interface configured to communicate according to UPLI and a second interface configured to communicate according to CXL.cache, with a computer coupled to both interfaces and configured to translate between the two protocol domains. The apparatus may be implemented as a discrete component, an IP block embedded within an accelerator or a processor, a chiplet within an IC package, or may be integrated into an active cable. The computer may maintain mappings between UPLI Tags and CXL.cache CQIDs, perform address translations between UALink and CXL address spaces, and aggregate data from multiple CXL.cache transactions when a UPLI request exceeds a maximum CXL.cache transaction size. The first interface may include a UPLI completer that receives UPLI requests from a UPLI originator.

In various implementations, an apparatus comprising: a first interface configured to communicate according to an Ultra Accelerator Link Protocol Level Interface (UPLI); a second interface configured to communicate according to CXL.cache, wherein CXL denotes Compute Express Link; and a computer coupled to the first interface and the second interface, the computer configured to: translate a UPLI request comprising a read command, received via the first interface, to a CXL.cache Device-to-Host (D2H) request comprising a read opcode, and send the CXL.cache D2H request via the second interface; and translate a CXL.cache Host-to-Device (H2D) data message, received via the second interface, to a UPLI read response, and send the UPLI read response via the first interface.

In some implementations of the apparatus, the UPLI request comprises a source accelerator identifier and a destination accelerator identifier, the UPLI read response comprises a destination accelerator identifier carrying a value that matches the source accelerator identifier from the UPLI request; and wherein the computer is configured to save at least the source accelerator identifier from the UPLI request for use in generating the UPLI read response. In some examples, the computer processes identifier information embedded in UPLI messages by saving at least the source accelerator identifiers from incoming UPLI requests, and generating UPLI read responses by using the saved source accelerator identifier as the destination accelerator identifier in the response for proper message routing back to the original requester. Optionally, the computer may also save the destination accelerator identifier from the UPLI request, and include a source accelerator identifier in the UPLI read response, such as for debugging purposes, however such inclusion is not required for basic functionality.

In some implementations of the apparatus, the UPLI request further comprises a first address and a first Tag, the CXL.cache D2H request comprises a second address translated from the first address and a command queue identifier (CQID) associated with the first Tag, and the UPLI read response comprises the first Tag; and wherein the computer is further configured to receive, via the second interface, a CXL.cache H2D response comprising a Global Observation (GO) opcode and the CQID, the GO opcode indicating a cache coherency state. In some examples, the computer performs address translation between physical addresses within UALink address space and physical addresses within CXL.cache address space, while maintaining correlations between requests and responses utilizing Tag/CQID mapping. The computer translates the UALink address to a corresponding CXL.cache address based on configured address mappings. Additionally, the computer maintains a mapping between UPLI Tags and CXL.cache CQIDs to properly associate responses with their originating requests. This mapping enables the computer to include the original UPLI Tag in the UPLI read response, allowing the originator to correlate responses with its outstanding requests.

In some implementations of the apparatus, the UPLI request further comprises a length field indicating an amount of data requested; and wherein the computer is further configured to generate multiple CXL.cache D2H requests when the amount of data requested exceeds a maximum CXL.cache transaction size. The computer may handle UPLI requests that specify data transfers larger than what a single CXL.cache transaction can support. The length field in the UPLI request indicates the amount of data requested, which can be up to 256 bytes, while CXL.cache transactions typically handle up to 64 bytes each. When the requested data size exceeds the CXL.cache transaction size limit, the computer may segment the request into multiple CXL.cache transactions. For example, a 256-byte UPLI request would be translated into four 64-byte CXL.cache transactions, and the computer manages these multiple transactions while maintaining the appearance of a single operation to the originator.

In some implementations of the apparatus, the UPLI request comprises a Tag, the CXL.cache D2H requests comprise command queue identifiers (CQIDs); and wherein the computer is further configured to associate multiple CQIDs with the Tag when generating the multiple CXL.cache D2H requests. When handling large data transfers that require multiple CXL.cache transactions, the computer may implement Tag-to-CQID mapping. For a UPLI request comprising one Tag, the computer may generate and track multiple CQIDs, one for each CXL.cache transaction. This mapping enables the computer to associate the relevant CXL.cache responses with the original UPLI request and generate a consolidated response.

In some implementations of the apparatus, the computer is further configured to: receive multiple CXL.cache H2D data messages corresponding to the multiple CXL.cache D2H requests, aggregate data from the multiple CXL.cache H2D data messages, and include the aggregated data in the UPLI read response. When handling large data transfers that were split into multiple CXL.cache transactions, the computer may perform data aggregation before generating the UPLI read response. The computer receives multiple CXL.cache H2D data messages collectively containing the requested data, which are collected and optionally reassembled in a predetermined order to form a complete data payload. The computer may manage this aggregation process while maintaining data integrity and proper ordering, such that the originator receives a single, coherent response containing the requested data.

In some implementations of the apparatus, the read opcode of the CXL.cache D2H request is RdCurr, and as a result of processing the CXL.cache D2H request the computer is further configured not to change existing state in a cache accessible to the computer. In some examples, the computer translates the UPLI read command into a CXL.cache D2H request comprising RdCurr, thereby indicating that the memory read is performed using a current state read function. In some examples, the apparatus either does not issue cache commands, or when processing the CXL.cache RdCurr request it retrieves data in a manner that does not alter the existing state in a cache accessible to the apparatus.

In some implementations of the apparatus, the read command is selected from at least one of: a Read command, an AtomicR command, or a Vendor Defined Command with read data returned over a UPLI read response/data (Rd Rsp/Data) Channel; and wherein the read opcode is selected from at least one of: RdCurr, RdOwn, RdShared, or RdAny. The computer may support translation between various types of read commands in the UPLI domain and read opcodes in the CXL domain. The UPLI read commands may include one or more of memory reads, atomic operations that provide atomicity guarantees, and/or Vendor Defined read commands for custom functionality. The UPLI read commands are translated to appropriate CXL.cache read opcodes based on the operation's requirements. For example, RdCurr requests the current value without changing cache states, RdOwn obtains exclusive ownership, RdShared enables shared access, and RdAny allows flexible coherency state transitions.

In some implementations of the apparatus, the CXL.cache H2D data message comprises first data in a first format; and wherein the computer is further configured to transform the first data to second data in a second format for the UPLI read response. The computer may need to transform data between different formats as it moves between UPLI and CXL.cache domains, which may involve changes in data organization, alignment, or representation. The computer can maintain data integrity while performing the applicable format conversions to meet the protocol requirements. The first format may be optimized for CXL.cache operations, while the second format adheres to UPLI specifications for data transfer.

In some implementations of the apparatus, the computer is further configured to: translate a UPLI request comprising a write command and write data, received via the first interface, to a CXL.cache D2H request comprising a write opcode selected from at least one of: DirtyEvict, ItoMWr, WrCur, or WrInv; and send the CXL.cache D2H request comprising the write opcode and the write data via the second interface; wherein the first interface comprises a UPLI completer. The computer may translate UPLI write commands to CXL.cache D2H write opcodes. The first interface may include a UPLI completer, which may receive UPLI requests from a UPLI originator, such as an accelerator or a UALink switch.

In some implementations of the apparatus, the apparatus comprises a chiplet within an integrated circuit (IC) package of a processor, the processor comprising a coherent interconnect coupling processing cores to a memory controller; and wherein the second interface is coupled to the coherent interconnect via a CXL root port; whereby the computer translates UPLI requests to CXL.cache D2H requests that traverse the coherent interconnect to access memory coupled to the memory controller. The apparatus may be implemented as a chiplet within an IC package of a processor, such as an MxPU. The coherent interconnect, such as a ring or mesh interconnect, may couple processing cores, an LLC, a CXL RP, and a memory controller. The computer may utilize CXL.cache as an intermediate protocol for translating between UPLI and a protocol utilized by the coherent interconnect. The CXL root port may be included in the chiplet or may be part of the processor, and may communicate with the coherent interconnect via a Ring-to-CXL (R2CXL) interconnect interface.

In some implementations of the apparatus, an active cable comprising: a first pluggable module coupled to a first physical medium, a second pluggable module coupled to a second physical medium, and an apparatus according to claim 13 coupling the first and second physical media.

In AI inference environments, accelerators may execute neural network models whose aggregate data requirements exceed the capacity of the accelerator's local memory. Model data such as expert weights, KV cache entries, and attention parameters may be stored in host memory and fetched on demand during inference. An RPU may translate between UPLI utilized by the accelerator and CXL.cache utilized by the host, enabling the accelerator to read model data from the host memory and write inference context data back to the host memory across the protocol domain boundary.

In various implementations, a method comprising: executing, by an accelerator comprising local memory, an inference workload on a neural network model; sending, by the accelerator, an Ultra Accelerator Link Protocol Level Interface (UPLI) request comprising a read command for model data stored in a host memory of a host; translating, by a Resource Provisioning Unit (RPU), the UPLI request to a CXL.cache Device-to-Host (D2H) request comprising a read opcode, wherein CXL denotes Compute Express Link; sending the CXL.cache D2H request to the host; receiving, from the host, a CXL.cache Host-to-Device (H2D) data message comprising the model data; translating, by the RPU, the CXL.cache H2D data message to a UPLI read response comprising the model data; and sending the UPLI read response to the accelerator. The method enables an accelerator executing an inference workload to access model data stored in a host memory via the RPU. The RPU translates between the UPLI domain utilized by the accelerator and the CXL.cache domain utilized by the host, enabling the accelerator to extend its accessible memory capacity beyond the local memory. The model data may include neural network weights, activation data, intermediate computation results, or other data associated with inference processing. The host memory may provide larger capacity than the accelerator's local memory, and the RPU may bridge the two protocol domains to enable memory capacity expansion for inference workloads.

In some implementations of the method, the model data comprises at least one of: expert weights associated with a Mixture-of-Experts (MoE) model, the expert weights fetched from the host memory when a gating network of the MoE model routes one or more tokens to an expert; key-value (KV) cache entries previously offloaded from the local memory to the host memory during inference of a sequence; or attention parameters associated with a transformer-based model. In MoE models, only a subset of expert sub-networks may be active for any given input token. Inactive expert weights may be offloaded to the host memory to free accelerator local memory capacity, and activated expert weights may be fetched from the host memory when the gating network routes tokens to those experts. KV cache entries may be offloaded to host memory during inference of long sequences to free local memory for active computation, and may be fetched back when needed for attention computation. This dynamic staging may enable inference of models that exceed the available local memory capacity.

In some implementations, the method further comprises sending, by the accelerator, a UPLI request comprising a write command and inference context data; translating, by the RPU, the UPLI request comprising the write command to a CXL.cache D2H request comprising a write opcode; and sending the CXL.cache D2H request and the inference context data to the host for storage in the host memory. The write direction may enable the accelerator to offload inference context data to the host memory, such as KV cache entries that are not actively needed, intermediate computation results, or checkpoint data. The RPU may translate the UPLI write command to a CXL.cache D2H write opcode, such as DirtyEvict, ItoMWr, WrCur, or WrInv, and may forward the inference context data to the host for storage in the host memory.

A system may include an accelerator with local memory, a host with host memory, and an RPU coupled between them to bridge the UPLI and CXL.cache protocol domains. The RPU may enable the accelerator to access host memory capacity beyond its local memory, addressing memory capacity limitations for workloads such as AI inference and high-performance computing. The host memory may include removable DDR modules or CXL-attached memory, providing larger but higher-latency capacity compared to the accelerator's local HBM. A UALink switch may couple accelerators to the RPU, enabling accelerators to share access to the host memory via the RPU.

In various implementations, a system comprising: an accelerator comprising local memory and configured to communicate according to an Ultra Accelerator Link Protocol Level Interface (UPLI); a host comprising host memory and configured to communicate according to CXL.cache, wherein CXL denotes Compute Express Link; and a Resource Provisioning Unit (RPU) coupled between the accelerator and the host, the RPU comprising a first interface configured to communicate with the accelerator according to UPLI and a second interface configured to communicate with the host according to CXL.cache; wherein the RPU is configured to: translate a UPLI request comprising a read command, received from the accelerator via the first interface, to a CXL.cache Device-to-Host (D2H) request comprising a read opcode, and send the CXL.cache D2H request to the host via the second interface; and translate a CXL.cache Host-to-Device (H2D) data message, received from the host via the second interface, to a UPLI read response, and send the UPLI read response to the accelerator via the first interface; whereby the accelerator accesses the host memory via the RPU. The system may enable an accelerator to access host memory through protocol translation performed by the RPU. The RPU may bridge the UPLI domain of the accelerator and the CXL.cache domain of the host, translating read commands to CXL.cache D2H read opcodes and translating CXL.cache H2D data messages back to UPLI read responses. The system may address memory capacity limitations of the accelerator by enabling access to the host memory, which may provide larger capacity than the accelerator's local memory. The RPU may be a discrete component, an IP block embedded in a processor, or a chiplet within an IC package.

In some implementations of the system, a capacity of the host memory exceeds a capacity of the local memory; and wherein the local memory comprises high-bandwidth memory (HBM) and the host memory comprises removable DDR modules, or CXL-attached memory; whereby the accelerator accesses a combined memory capacity comprising the local memory and the host memory; and wherein the RPU is further configured to: translate a UPLI request comprising a write command and write data, received from the accelerator, to a CXL.cache D2H request comprising a write opcode; and send the CXL.cache D2H request comprising the write opcode and the write data to the host for storage in the host memory. In one example, the removable DDR modules refer to a standardized hardware assembly comprising one or more memory integrated circuits disposed on a substrate and encompassing various form factors and mounting architectures, including but not limited to: dual in-line memory modules (DIMMs), compression-attached memory modules (CAMM or CAMM2), and any future iterations of modular memory form factors.

In some implementations, the system further comprises a UALink switch coupled between the accelerator and the RPU; wherein the UALink switch routes the UPLI request from the accelerator to the RPU based on a destination accelerator identifier carried in the UPLI request; and wherein accelerators are coupled to the UALink switch, the accelerators sharing access to the host memory via the RPU. The UALink switch may route UPLI traffic based on the destination accelerator identifier, such as the ReqDstPhysAccID field, utilizing a route table to map the destination identifier to an egress port coupled to the RPU. The accelerators may share access to the host memory via the RPU, enabling accelerators to extend their accessible memory capacity. In some examples, the UALink switch may also route UPLI responses from the RPU back to the originating accelerator based on the destination accelerator identifier in the response.

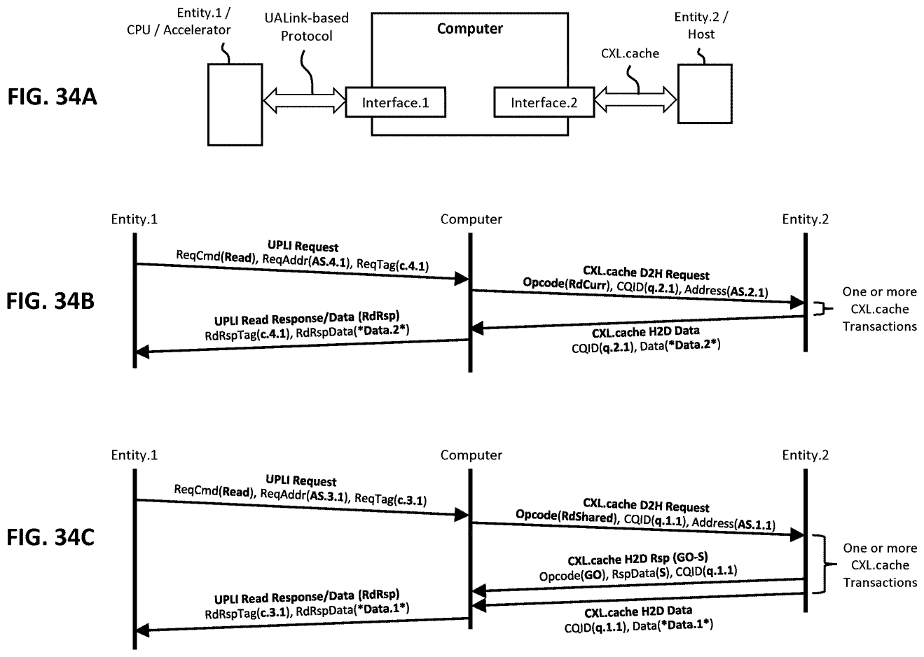

FIG. 34A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.cache, with a second entity (Entity.2), such as a host. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In some examples, the first address space and the second address space may be associated with the same address space, such as a common address space, a global address space, a pod address space, or a fabric address space, wherein the computer may perform address translations between addresses within the same common address space. In other examples, the computer may be implemented in an IC package having high-speed differential I/O balls positioned according to a ball grid array layout defined by a retimer specification.

FIG. 34B illustrates an example of a TFD demonstrating translations, such as protocol translations, between UALink-based requests, such as UPLI requests, received from a first entity (Entity.1), which may be a CPU or an accelerator, and CXL requests, such as CXL.cache D2H requests, sent to a second entity (Entity.2), which may be a host, possibly enabling the first entity to access resources mapped to an address space utilized by the second entity. The first entity may initiate a UPLI transaction that may include a UPLI request comprising ReqCmd(Read), ReqAddr(AS.4.1), and ReqTag(c.4.1). The computer may translate the UPLI transaction to a CXL transaction that may include a CXL.cache D2H request comprising Opcode(RdCurr), CQID(q.2.1), and Address(AS.2.1), and may send the CXL.cache D2H request to the second entity. Upon receiving one or more responses from the second entity, which may include a CXL.cache H2D Data comprising CQID(q.2.1) and Data(*Data.2*), the computer may translate the one or more responses, such as translating the CXL.cache H2D Data to a UPLI read response/data (RdRsp) comprising RdRspTag(c.4.1) and RdRspData(*Data.2*), and send the UPLI RdRsp to the first entity. In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity.

The computer may perform further translations, such as opcode translations, command translations, TLP type translations, and field translations between the UALink-based domain and the CXL domain. In some examples, the computer may issue multiple CXL.cache D2H requests in response to receiving a UPLI request from the first entity, such as when splitting a UPLI request for a large block of data (e.g., 256 B) to smaller CXL.cache D2H requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

FIG. 34C illustrates an example of a TFD demonstrating translations, such as protocol translations, between UALink-based requests, such as UPLI requests, received from a first entity (Entity.1), which may be a CPU or an accelerator, and CXL requests, such as CXL.cache D2H requests, sent to a second entity (Entity.2), which may be a host, possibly enabling the first entity to access resources mapped to an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.cache D2H request comprising Opcode(RdShared), CQID(q.1.1), and Address(AS.1.1), and send the CXL.cache D2H request to the second entity. Upon receiving one or more responses from the second entity, which may include a CXL.cache H2D Rsp comprising Opcode(GO), RspData(S), and CQID(q.1.1), and may further include a CXL.cache H2D Data comprising CQID(q.1.1) and Data(*Data.1*), the computer may translate the one or more responses, such as translating the CXL.cache H2D Data to a UPLI read response/data (RdRsp) comprising RdRspTag(c.3.1) and RdRspData(*Data.1*), and may send the UPLI RdRsp to the first entity. In some examples, the computer may include a cache or may control a cache that is external to the computer, wherein the computer may be configured to select the CXL.cache D2H request opcode according to a cacheline state intent that may be identified based on the UPLI request, or according to a caching policy, such as selecting RdShared for storing a shared copy of the cacheline in the cache, or selecting RdOwn for storing an exclusive copy of the cacheline in the cache.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache D2H requests in response to receiving a UPLI request from the first entity, such as when splitting a UPLI request for a large block of data (e.g., 256 B) to smaller CXL.cache D2H requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

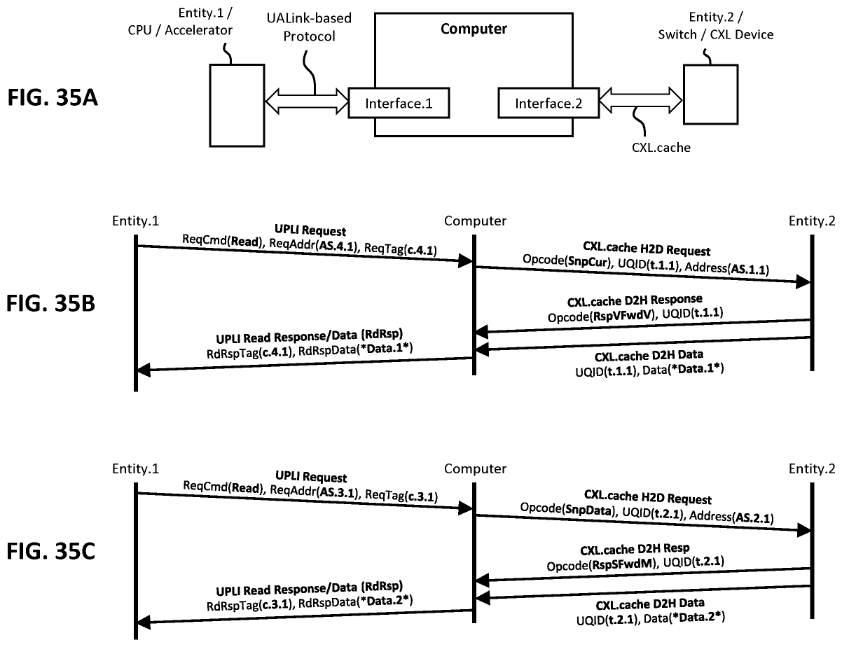

FIG. 35A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.cache, with a second entity (Entity.2), such as a switch, or a CXL device, which may be a CXL memory expander, a CXL memory pool, a GFD, or a CXL accelerator. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In some examples, the first address space and the second address space may be associated with the same address space, such as a common address space, a global address space, a pod address space, or a fabric address space, wherein the computer may perform address translations between addresses within the same common address space. In some examples, the computer may be implemented in an IC package having high-speed differential I/O balls positioned according to a ball grid array layout defined by a retimer specification.

FIG. 35B illustrates an example of a TFD demonstrating translations, such as protocol translations, between UALink-based requests, such as UPLI requests, received from a first entity (Entity.1), which may be a CPU or an accelerator, and CXL requests, such as CXL.cache H2D requests, sent to a second entity (Entity.2), which may be a switch or a CXL device, possibly enabling the first entity to access resources associated with an address space utilized by the second entity. The first entity may initiate a UPLI transaction that may include a UPLI request comprising ReqCmd(Read), ReqAddr(AS.4.1), and ReqTag(c.4.1). The computer may translate the UPLI transaction to a CXL transaction that may include a CXL.cache H2D request comprising Opcode(SnpCur), UQID(t.1.1), and Address(AS.1.1), and may send the CXL.cache H2D request to the second entity. Upon receiving one or more responses from the second entity, which may include a CXL.cache D2H response comprising Opcode(RspVFwdV) and UQID(t.1.1), and may further include a CXL.cache D2H Data comprising UQID(t.1.1) and Data(*Data.1*), the computer may translate the one or more responses, such as translating the CXL.cache D2H Data to a UPLI read response/data (RdRsp) comprising RdRspTag(c.4.1) and RdRspData(*Data.1*), and may send the UPLI RdRsp to the first entity. In some examples, the computer may include a cache or may control a cache that is external to the computer, wherein the computer may be configured to select the CXL.cache H2D request opcode according to a cacheline state intent that may be identified based on the UPLI request, or according to a caching policy, such as selecting SnpData for a cacheline that is intended to be cached in either Shared or Exclusive state, or selecting SnpCur to get the current version of a cacheline without requiring change of any cache state in the hierarchy.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache H2D requests in response to receiving a UPLI request from the first entity, such as when splitting a UPLI request for a large block of data (e.g., 256 B) to smaller CXL.cache H2D requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

FIG. 35C illustrates an example of a TFD demonstrating translations, such as protocol translations, between UALink-based requests, such as UPLI requests, received from a first entity (Entity.1), which may be a CPU or an accelerator, and CXL requests, such as CXL.cache H2D requests, sent to a second entity (Entity.2), which may be a switch or a CXL device, possibly enabling the first entity to access resources associated with an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.cache H2D request comprising Opcode(SnpData), UQID(t.2.1), and Address(AS.2.1), and may send the CXL.cache H2D request to the second entity. Upon receiving one or more responses from the second entity, which may include a CXL.cache D2H response comprising Opcode(RspSFwdM) and UQID(t.2.1), and may further include a CXL.cache D2H Data comprising UQID(t.2.1) and Data(*Data.2*), the computer may translate the one or more responses, such as translating the CXL.cache D2H Data to a UPLI read response/data (RdRsp) comprising RdRspTag(c.3.1) and RdRspData(*Data.2*), and may send the UPLI RdRsp to the first entity. In some examples, the computer may include a cache or may control a cache that is external to the computer, wherein the computer may be configured to select the CXL.cache H2D request opcode according to a cacheline state intent that may be identified based on the UPLI request, or according to a caching policy, such as selecting SnpData for a cacheline that is intended to be cached in either Shared or Exclusive state, or selecting SnpCur to get the current version of a cacheline without requiring change of any cache state in the hierarchy.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache H2D requests in response to receiving a UPLI request from the first entity, such as when splitting a UPLI request for a large block of data (e.g., 256 B) to smaller CXL.cache H2D requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

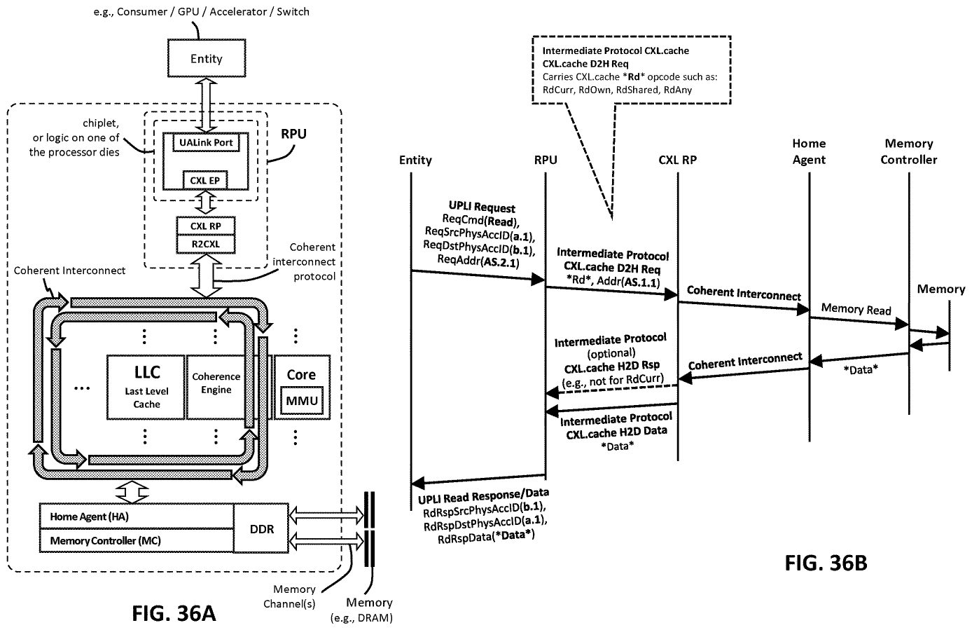

FIG. 36A illustrates an example of a system comprising a processor (such as an MxPU) comprising processing cores, LLC, a CXL RP, and a memory controller optionally coupled via memory channels to memory, such as DRAM. The CXL RP may be coupled to an on-chip coherent interconnect, such as a CHI ring or mesh interconnect, via a Ring-to-CXL (R2CXL) interconnect interface that may communicate with the coherent interconnect according to a protocol utilized by the coherent interconnect, such as ARM CHI, Intel UPI, or AMD Infinity Fabric. An RPU, which may be included in the MxPU, performs physical address translations that may enable an entity such as a GPU to access the memory. The MxPU may expose to the entity, optionally via the RPU, a UALink port that may communicate with the entity according to UPLI. The RPU may further perform translations, such as from UPLI to a protocol utilized by the coherent interconnect, wherein the RPU may utilize an intermediate protocol, such as CXL (e.g., CXL.cache), to provide the translations. The RPU may expose to the processor, via a CXL RP that may be included in the RPU, a CXL device utilizing a CXL endpoint (CXL EP), such as a Type-1 CXL device or a Type-2 CXL device, where an R2CXL, that may reside in the RPU, may communicate with the coherent interconnect and complete the translation path from UPLI to a protocol utilized by the coherent interconnect. In some examples, the RPU, the UALink port and the CXL device may be implemented in a chiplet inside an IC package of an MxPU, whereas in other examples they may be implemented as functional blocks on the same die with the CXL RP of the processor, or split between processor dies or chiplets.

FIG. 36B illustrates an example of a TFD demonstrating a UPLI request (Req) received from an entity, such as a GPU or an accelerator, wherein the RPU may translate a physical address (AS.2.1) carried in the UPLI request, to a physical address (AS.1.1) utilized for accessing the memory. The RPU may perform further translations, such as protocol translations from UPLI to a protocol utilized by the processor's coherent interconnect, possibly utilizing an intermediate protocol such as CXL.cache. The RPU may perform further translations, such as opcode translations and Tag translations, e.g., of transaction Tags, such as translating from UPLI Tags to CQIDs. The CXL.cache request, carrying the translated address (AS.1.1), is sent to the CXL RP for further processing and fetching of the requested data, such as from an LLC over the on-chip ring interconnect, or from memory, such as DRAM via the memory channels. The data may then return over the on-chip ring interconnect to the RPU, wherein the RPU provides UPLI read response/data (RdRsp) to the requesting entity.

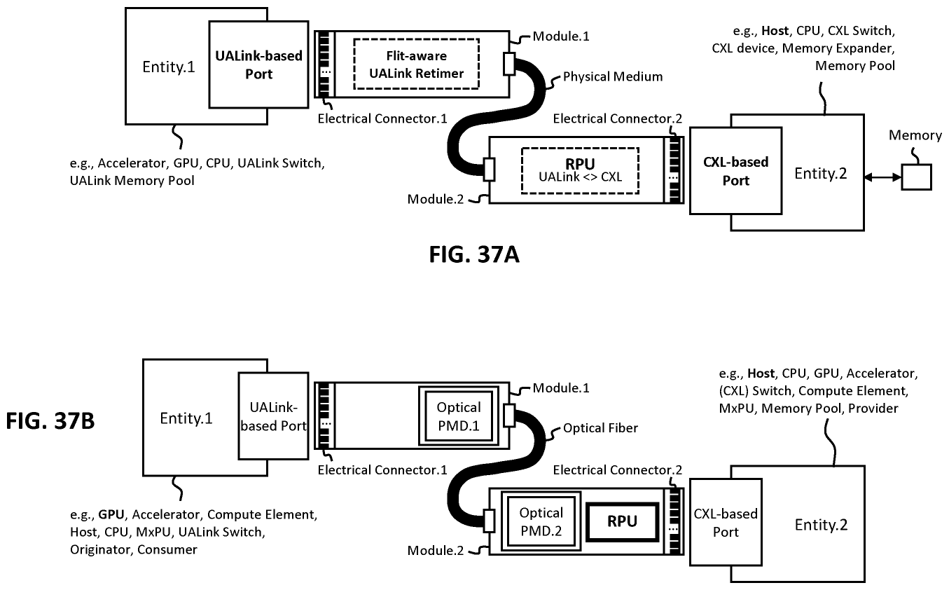

FIG. 37A illustrates an example of a system comprising a cable, such as an active cable, referred to as Cable/RPU, which may translate between UALink-based traffic and CXL-based traffic, such as at least one of CXL.io, CXL.mem, or CXL.cache traffic. The Cable/RPU enables a first entity (Entity.1), which may be an accelerator, a GPU, a CPU, a UALink switch, a UPLI originator, or a resource consumer, to access, via a UALink-based port, via the Cable/RPU, and via a CXL-based port, resources, such as memory, coupled to a second entity (Entity.2), which may be a host, a CPU, a CXL switch, a CXL device, a memory expander, a memory pool, or a resource provider. The Cable/RPU, which may include an RPU, may communicate with the first entity according to a UALink-based protocol, such as a UPLI, and may communicate with the second entity according to a CXL-based protocol, such as at least one of CXL.io, CXL.mem, or CXL.cache. In some examples, the UALink-based protocol, such as UPLI, may be associated with a first address space, such as an NPA space, and the CXL-based protocol, such as CXL.mem, may be associated with a second address space, such as a System Physical Address (SPA) space or a Host Physical Address (HPA) space; wherein the Cable/RPU may perform address translations between addresses within the first and second address spaces, respectively, such as between addresses within the NPA space and addresses within the SPA space or the HPA space.

In other examples, the UALink-based protocol, such as UPLI, and the CXL-based protocol, such as CXL.mem, may be associated with the same physical address space, such as a global address space, a pod address space, or a fabric address space; wherein the Cable/RPU may perform address translations between addresses within the same address spaces. The Cable/RPU may perform further translations, such as opcode, command, or TLP translations, e.g., translating between Read commands in UPLI requests and read opcodes in CXL.cache D2H requests. The Cable/RPU may further translate between messages conforming to the UALink-based protocol and messages conforming to the CXL-based protocol, translate Tags, and/or translate error indications, such as data corruption indications or poison.

In some examples, the Cable/RPU, such as an OSFP copper cable, an OSFP-XD copper cable, an OSFP Active Optical Cable (AOC), or an OSFP-XD AOC cable, may further include a first module (Module.1), which may include a flit-aware UALink retimer, a PAM4 retimer, or a retimer PHY, and may further include a second module (Module.2), which may include the RPU, optionally included in a discrete component compatible with a retimer form-factor. The Cable/RPU may conform to a standard specification, an industry standard, an implementation agreement (IA), or a multi-source agreement (MSA), such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard (such as SFF-8665), an Optical Internetworking Forum (OIF) implementation agreement, or an Institute of Electrical and Electronics Engineers (IEEE) standard. The Cable/RPU may further include a physical medium that may include a copper wire or an optical fiber. In some examples, the Cable/RPU may be coupled to the UALink-based port via a first electrical connector (Electrical Connector.1) and may be further coupled to the CXL-based port via a second electrical connector (Electrical Connector.2), whereas in other examples the Cable/RPU may be coupled to the UALink-based port and/or the CXL-based port via optical connectors.

FIG. 37B illustrates an example of a system comprising an active optical cable. The active optical cable may couple a first entity (Entity.1), such as a GPU, an accelerator, a compute element, a host, a CPU, an MxPU, a UALink switch, a UPLI originator, or a consumer, to a second entity (Entity.2), such as a host, a CPU, a GPU, an accelerator, a CXL switch, a compute element, an MxPU, a memory pool, or a provider. In some examples, the first entity may be coupled to a first port (Port.1), such as a UALink port, via a first electrical connector (Electrical Connector.1). The active optical cable may include a first module (Module.1) comprising a first optical physical media dependent (Optical PMD.1) device, and a second module (Module.2) comprising a second optical physical media dependent (Optical PMD.2) device and an RPU. The first module may be coupled to the first electrical connector and may convert electrical signals from the first entity to optical signals for transmission over an optical fiber. The second module may convert the optical signals back to electrical signals and may further comprise the RPU, which may translate between a UALink-based protocol, such as UPLI, and a CXL-based protocol, such as at least one of CXL.io, CXL.mem, or CXL.cache. The second module may be coupled to the second entity via a second electrical connector (Electrical Connector.2), wherein the second entity may be coupled to a second port (Port.2), such as a CXL port.

In some examples, the RPU within the active optical cable may perform address translations between addresses within a first address space associated with the UALink-based protocol, such as a NPA space, and addresses within a second address space associated with the CXL-based protocol, such as HPA space. The RPU may further perform opcode translations, command translations, Tag translations, and translations of error indications such as data corruption indications or poison. In some examples, the active optical cable may conform to a standard specification, an industry standard, an implementation agreement, or a multi-source agreement, such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard, an Optical Internetworking Forum (OIF) implementation agreement, or an IEEE standard. In other examples the active optical cable may utilize other form factors or standards as they become available.

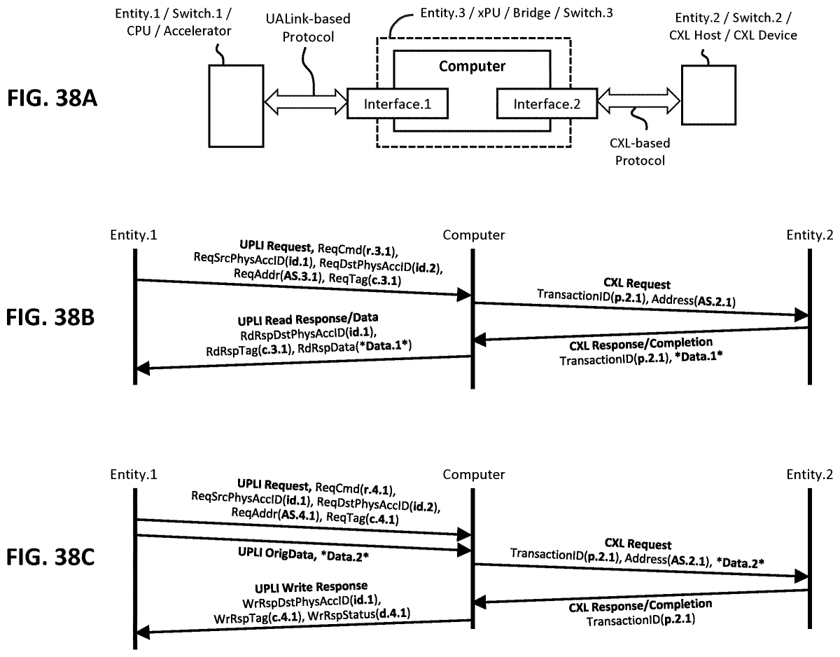

FIG. 38A illustrates an example of a system comprising a third entity (Entity.3), such as an xPU, a bridge, or a third switch (Switch.3). The third entity includes a computer comprising a first interface (Interface.1) and a second interface (Interface.2). The first interface may communicate according to a UALink-based protocol, such as UPLI, with a first entity (Entity.1), such as a first switch (Switch.1), a CPU, or an accelerator. The second interface may communicate according to a CXL-based protocol, such as CXL.io, CXL.mem, or CXL.cache, with a second entity (Entity.2), such as a second switch (Switch.2), a CXL host, or a CXL device which may be a CXL memory expander, a CXL-based memory pool, a GFD, or a CXL accelerator. The computer may perform translations, such as protocol translations between the UALink-based protocol and the CXL-based protocol, transaction translations, protocol data unit (PDU) translations, message translations, and/or address translations between the UALink-based protocol domain and the CXL-based protocol domain. In some examples, the computer may extract addresses from requests received via the first interface, wherein these addresses may refer to a first address space, such as a Network Physical Address (NPA) space utilized by the first entity. The computer may translate these addresses, and generate requests carrying the translated addresses for transmission via the second interface; wherein these translated addresses may refer to a second address space, such as a Host Physical Address (HPA) space utilized by the second entity. In other examples the first address space and the second address space may be associated with the same address space, such as a common address space, a global address space, a pod address space, or a fabric address space, wherein the computer may perform address translations between addresses within the same common address space. In some examples, the computer may be implemented in a chiplet, may utilize UCIe for chip-to-chip or die-to-die connectivity, or may be implemented in an IC package having high-speed differential I/O balls positioned according to a ball grid array layout defined by a retimer specification.

FIG. 38B illustrates an example of a TFD demonstrating translations, such as protocol translations, transaction translations, protocol data unit (PDU) translations, message translations, and/or address translations, which may be performed by a computer, between a UALink-based protocol, such as UPLI, utilized by a first entity (Entity.1), such as a first switch (Switch.1), a CPU, or an Accelerator, and a CXL-based protocol, such as CXL.io, CXL.mem, or CXL.cache, utilized by a second entity (Entity.2), such as a second switch (Switch.2), a CXL host, or a CXL device. The first entity may initiate a UPLI transaction that may include a UPLI request comprising ReqCmd(r.3.1), such as Read or Read class Vendor Defined Command, ReqSrcPhysAccID(id.1), ReqDstPhysAccID(id.2), ReqAddr(AS.3.1), and ReqTag(c.3.1). The computer may translate the UPLI transaction to a CXL transaction that may include a CXL request comprising TransactionID(p.2.1) and Address(AS.2.1), and may send the CXL request to the second entity. In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. Upon receiving from the second entity a CXL response or completion (CXL Response/Completion) comprising TransactionID(p.2.1) and *Data.1*, the computer may translate the CXL Response/Completion to a UPLI read response/data comprising RdRspDstPhysAccID(id.1), RdRspTag(c.3.1), and RdRspData(*Data.1*), and may send the UPLI read response/data to the first entity.

The computer may perform further translations, such as opcode translations, command translations, TLP type translations, or other translations between the UALink-based protocol domain and the CXL-based protocol domain. In some examples, the computer may issue multiple CXL requests in response to receiving a UPLI request from the first entity. For example, the computer may issue CXL.mem M2S requests comprising MemRd or MemRdData, such as when splitting a UPLI request for a large block of data (e.g., 256 B) to smaller CXL.mem reads (e.g., 64 B each), or when prefetching data from the second entity utilizing CXL.mem reads. The computer may translate requests or transactions initiated from the UALink-based protocol domain to the CXL-based protocol domain, may translate requests or transactions initiated from the CXL-based protocol domain to the UALink-based protocol domain, or may translate requests or transactions initiated from the protocol domains.

FIG. 38C illustrates an example of a TFD demonstrating translations, such as protocol translations, transaction translations, protocol data unit (PDU) translations, message translations, and/or address translations, which may be performed by a computer, between a UALink-based protocol, such as UPLI, utilized by a first entity (Entity.1), such as a first switch (Switch.1), a CPU, or an Accelerator, and a CXL-based protocol, such as CXL.io, CXL.mem, or CXL.cache, utilized by a second entity (Entity.2), such as a second switch (Switch.2), a CXL host, or a CXL device. The first entity may initiate a UPLI transaction that may include a UPLI request comprising ReqCmd(r.4.1), such as Write or Write class Vendor Defined Command, ReqSrcPhysAccID(id.1), ReqDstPhysAccID(id.2), ReqAddr(AS.4.1), and ReqTag(c.4.1). The UPLI transaction may further include a UPLI OrigData comprising *Data.2*. The computer may translate the UPLI transaction to a CXL transaction that may include a CXL request comprising TransactionID(p.2.1), Address(AS.2.1), and *Data.2*, and may send the CXL request to the second entity. In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. Upon receiving from the second entity a CXL response or completion (CXL Response/Completion) comprising TransactionID(p.2.1), the computer may translate the CXL Response/Completion to a UPLI write response comprising WrRspDstPhysAccID(id.1), WrRspTag(c.4.1), and WrRspStatus(d.4.1), and may send the UPLI write response to the first entity.

The computer may perform further translations, such as opcode translations, command translations, TLP type translations, or other translations between the UALink-based protocol domain and the CXL-based protocol domain. In some examples, the computer may issue CXL requests in response to receiving a UPLI request from the first entity. For example, the computer may issue multiple CXL.mem M2S RwD comprising MemWr or MemWrTEE, such as when splitting a UPLI request writing a large block of data (e.g., 256 B) to smaller CXL.mem writes (e.g., 64 B each). The computer may translate requests or transactions initiated from the UALink-based protocol domain to the CXL-based protocol domain, may translate requests or transactions initiated from the CXL-based protocol domain to the UALink-based protocol domain, or may translate requests or transactions initiated from the protocol domains.

In various implementations, an apparatus comprising: processing cores coupled via an interconnect to memory controllers coupled to memory channels capable of supporting memory having a capacity of at least 64 GB; wherein the interconnect utilizes a protocol based on Coherent Hub Interface (CHI-based protocol); first and second resource provisioning units (RPUs) comprising first and second NVLink interfaces and first and second CHI interfaces; wherein the first and second NVLink interfaces utilize differential pairs and are capable of communicating according to NVLink-based protocol with first and second entities external to the apparatus, respectively; and wherein the first and second RPUs are configured to translate between messages conforming to the NVLink-based protocol and messages conforming to the CHI-based protocol to enable the first and second entities to access in parallel the memory via the respective first and second NVLink interfaces and the interconnect. Sentences in the form of “access the memory” encompass accessing at least a portion of the memory, where the portion may range from a minimal addressable unit to the entire memory capacity, indicating open-ended claim language.

In some implementations of the apparatus, the first entity comprises a graphics processing unit (GPU) configured to: access dynamic random-access memory (DRAM) coupled to the memory channels via the first NVLink interface and the first RPU, and receive memory access requests from the processing cores targeting GPU-attached memory; wherein the first RPU is further configured to translate CHI-based requests to NVLink-based requests. The bidirectional communication may enable the GPU to function as both an initiator of memory transactions to system DRAM and a target for processor-initiated accesses to GPU-attached memory such as HBM. The RPU may maintain transaction context for both directions, managing protocol differences in flow control, credit management, and response generation between the NVLink and CHI-based domains.

In some implementations of the apparatus, the interconnect is a coherent interconnect, the GPU comprises on-package high-bandwidth memory (HBM), and the first RPU translates CHI-based write-back traffic targeting the HBM to NVLink-based traffic.

In some implementations of the apparatus, the interconnect is a coherent interconnect, the first RPU is further configured to maintain translations from first physical addresses associated with the first NVLink interface to physical addresses associated with the coherent interconnect, and the second RPU is further configured to maintain separate translations from second physical addresses associated with the second NVLink interface to the physical addresses associated with the coherent interconnect.

In some implementations of the apparatus, the interconnect comprises first and second interconnect components, the first RPU is coupled to the first interconnect component, and the second RPU is coupled to the second interconnect component, whereby the apparatus provides distributed bandwidth for the first and second entities to access resources.

In some implementations of the apparatus, a path between at least one of the first or second RPUs and at least one memory controller and/or processing core comprises one interconnect component. In some implementations, the RPU and at least one memory controller may be coupled to the same interconnect component, providing a low-latency communication path between the NVLink interface and memory attached to the xPU.

In some implementations of the apparatus, each of the first and second RPUs exposes registers accessible utilizing memory-mapped I/O (MMIO) operations via an Advanced Microcontroller Bus Architecture (AMBA) Advanced Peripheral Bus (APB) interface, enabling detection of RPU presence, NVLink-interface status, and translation capabilities.

In some implementations of the apparatus, each of the first and second RPUs is configured to: translate physical addresses associated with the respective NVLink-based protocol to physical addresses associated with the CHI-based protocol, and translate NVLink command encodings to corresponding CHI opcodes.

In some implementations of the apparatus, at least one of the first or second RPUs comprises a gateway utilizing a streaming interface protocol based on Advanced Microcontroller Bus Architecture (AMBA) Credited eXtensible Stream (CXS); and wherein the first and second entities are accelerators, from which at least one comprises a graphics processing unit (GPU).

In some implementations of the apparatus, each of the first and second RPUs comprises a request node that does not include a hardware-coherent cache and is configured to communicate with the interconnect according to the CHI-based protocol; and wherein the first and second entities are accelerators, from which at least one comprises a graphics processing unit (GPU).

In some implementations of the apparatus, at least one of the request nodes comprises an I/O-coherent request node (RN-I) or an I/O-coherent Request Node with Distributed Virtual Memory support (RN-D).

In some implementations of the apparatus, the interconnect comprises at least one crosspoint comprising at least four mesh ports and at least two device ports, wherein at least one of the first or second RPUs is coupled to one of the at least two device ports; and wherein the first and second entities are accelerators, from which at least one comprises a graphics processing unit (GPU).

In some implementations of the apparatus, each of the first and second NVLink interfaces supports virtual channels, and the respective RPUs map the virtual channels to corresponding quality-of-service fields of the CHI-based protocol.

In some implementations of the apparatus, the mapping between NVLink virtual channels and CHI quality-of-service fields is programmable via the MMIO registers exposed by the RPUs.

In some implementations of the apparatus, the memory comprises dynamic random-access memory (DRAM) having a capacity of at least 256 GB; wherein the first and second entities are accelerators, from which at least one comprises a graphics processing unit (GPU); and wherein the first and second entities can access in parallel different regions of the DRAM.

In some implementations, the apparatus further comprises a third NVLink interface coupled via a third RPU to the interconnect, enabling a third entity to access resources via the third NVLink interface and the interconnect, while maintaining I/O-coherency without cache coherency participation. The implementation may be scaled to support multiple NVLink-coupled entities, with their own translation paths through the I/O-coherent or non-coherent nodes, enabling high-bandwidth parallel access to system memory resources while the CHI-based protocol maintains appropriate ordering and coherency at the I/O level without requiring the NVLink entities to participate in cache coherency protocols.

In some implementations of the apparatus, each of the first and second RPUs maintains a link translation look-aside buffer that translates NVLink network addresses, including destination identifiers, into physical addresses employed by the interconnect.

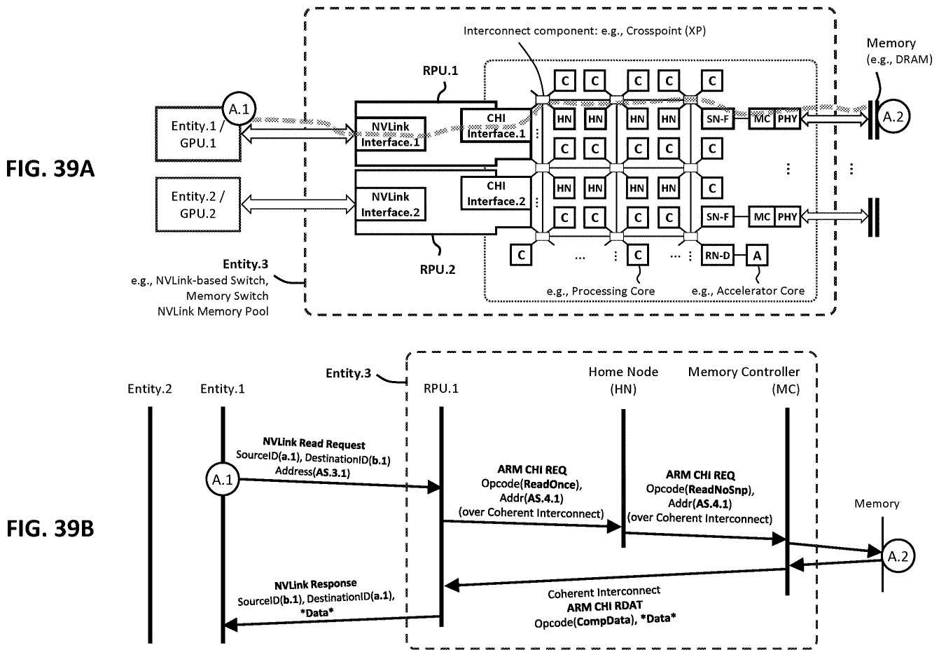

FIG. 39A illustrates an example of a memory switch configured to provide memory to entities coupled to it. Entity.1 is coupled to the memory switch wherein the entity may utilize the memory coupled to the coherent interconnect. The memory switch may function as an NVLink-based switch or an NVLink memory pool, providing switching capabilities between entities while also enabling access to memory resources.

FIG. 39B illustrates an example of a TFD demonstrating an NVLink request from Entity.1 to access memory. RPU.1 receives an NVLink request carrying a read request comprising an address, and translates it to an ARM CHI request comprising ReadOnce, potentially with a different address due to address translation. The request flows through the coherent interconnect to a home node (HN), which may translate it to a ReadNoSnp transaction destined to a memory controller (MC). The MC retrieves the data from memory and may return the data to RPU.1 without routing through the HN, or alternatively may send the data through the HN to RPU.1. Then RPU.1 generates the NVLink response with the data to Entity.1.

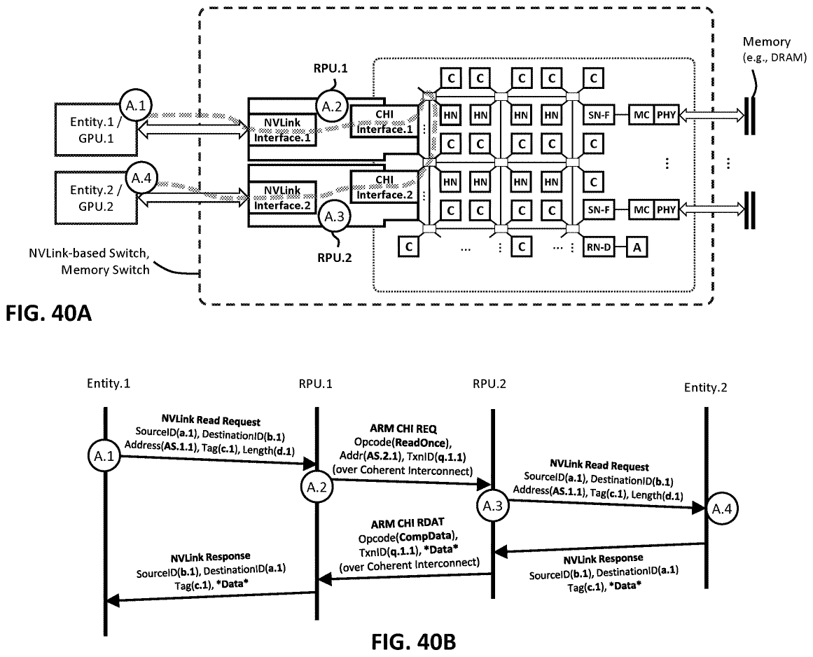

FIG. 40A illustrates an example of a system that implements an NVLink-based switch, or an NVLink Memory Switch, utilizing a CHI-based interconnect. The switch is coupled to two entities marked in the figure as Entity.1/GPU.1 and Entity.2/GPU.2 . The switch may include processing cores, accelerator cores such as security accelerators, and memory controllers, coupled to the CHI-based interconnect. The switch utilizes translations, performed by each of the RPUs, between NVLink-based interfaces and the switch interconnect. The first RPU may enable Entity.1/GPU.1 to access, via the first NVLink interface and the switch interconnect (which may be a coherent interconnect), resources mapped to the address space utilized by the switch interconnect, such as memory resources of the switch. Correspondingly, the second RPU may enable Entity.2/GPU.2 to access, via the second NVLink interface and the switch interconnect, resources mapped to the address space utilized by the switch interconnect, such as memory resources of the switch. The first RPU may map resources of Entity.1/GPU.1, such as memory resources, to the physical address space associated with the switch interconnect, and may further enable Entity.2/GPU.2 to access resources mapped to the address space utilized by the switch interconnect, so that Entity.2/GPU.2 is able to access memory resources of Entity.1/GPU.1, via the second NVLink interface, the switch interconnect, and the first NVLink interface. Correspondingly, the second RPU may map resources of Entity.2/GPU.2 , such as memory resources, to the physical address space associated with the switch interconnect, and may further enable Entity.1/GPU.1 to access resources mapped to the address space utilized by the switch interconnect, so that Entity.1/GPU.1 is able to access memory resources of Entity.2/GPU.2 , via the first NVLink interface, the switch interconnect, and the second NVLink interface.

FIG. 40B illustrates an example of a TFD demonstrating NVLink switching operation between entities through a switch interconnect. Entity.1/GPU.1 issues a first NVLink request comprising source ID, destination ID and an address (AS.1.1). The first NVLink request is switched through the switch interconnect wherein a first RPU (RPU.1) translates it to an ARM CHI request comprising ReadOnce. The example demonstrates a switching operation wherein the switch typically does not change the message or the PDU, similar to how an Ethernet switch typically does not change an Ethernet frame. The first NVLink request is translated to an ARM CHI request that is translated to a second NVLink request, resulting in a switching operation of an NVLink request that passes from Entity.1/GPU.1 to Entity.2/GPU.2 through the first RPU, the switch interconnect, and a second RPU (RPU.2). The first RPU converts the first NVLink request to an ARM CHI request carrying ReadOnce, possibly utilizing user-defined fields within the switch interconnect protocol to pass fields of the first NVLink request such as NVLink source ID, destination ID, Tags, and length, to the second RPU, wherein the ARM CHI request is translated to the second NVLink request that is sent to Entity.2/GPU.2. ARM CHI may include fields such as RSVDC that may be utilized as user-defined fields for passing transaction-related information such as fields from the first NVLink request of Entity.1/GPU.1 to the second NVLink request sent to Entity.2/GPU.2. Some of the fields of the NVLink traffic received from Entity.1/GPU.1 may be translated, whereas some of the fields may be truncated or compressed to fit within the available user-defined field widths. The second RPU translates the ReadOnce ARM CHI request to the second NVLink request, and translates the first NVLink response to an ARM CHI RDAT. The first RPU on the receiving side may translate the ARM CHI response (ARM CHI RDAT) with CompData and data back to a second NVLink response. The ARM CHI RDAT may also utilize user-defined fields for passing information to the other side, while the data itself may be passed natively through the ARM CHI RDAT data field.

In AI inference systems, accelerators such as GPUs or TPUs may generate and consume large volumes of inference context data, including key-value (KV) cache data, model weight parameters, activation tensors, and embedding vectors. When the volume of inference context data exceeds the capacity of the accelerator's local memory, such as HBM, the data may be staged to external memory resources that provide larger capacity at lower cost, such as CXL memory devices, CXL memory pools, or GFDs. In environments where accelerators are coupled via a UALink switch and the CXL memory devices are accessible via CXL.mem, an RPU may translate between UPLI and CXL.mem to enable the accelerators to migrate inference context data between their local memory and the CXL memory devices across the UALink and CXL protocol domain boundaries. The accelerator may initiate migration by sending UPLI requests to the RPU via the UALink switch, and the RPU may translate these requests to CXL.mem M2S requests targeting the CXL memory device. The migration may be bidirectional: the accelerator may write inference context data to the CXL memory device when evicting data from local memory, and may read inference context data from the CXL memory device when the data is needed for active computation. The RPU may perform address translations between address spaces utilized by the UALink domain and the CXL domain, such as between NPA or SPA addresses and HPA addresses, and may further perform Tag and opcode translations between UPLI and CXL.mem message formats.

In various implementations, a method for migrating inference context data across protocol domain boundaries, comprising: sending, by an accelerator coupled to an Ultra Accelerator Link (UALink) switch, a UALink Protocol Level Interface (UPLI) request via the UALink switch to a resource provisioning unit (RPU), the UPLI request associated with the inference context data stored in a local memory of the accelerator, the UPLI request comprising a first physical address; translating, by the RPU, the UPLI request to a Compute Express Link (CXL) CXL.mem Master-to-Subordinate (M2S) request comprising a second physical address; and sending, by the RPU, the CXL.mem M2S request to a CXL memory device; wherein the inference context data is migrated between the local memory of the accelerator and the CXL memory device across a UALink protocol domain and a CXL protocol domain. The method may be utilized in AI inference systems where accelerator working memory, such as HBM, is insufficient to retain all inference context data simultaneously. The RPU may translate between UPLI and CXL.mem including translations of opcodes, commands, addresses, Tags, and additional fields. The migration may be performed by the accelerator without host intervention, such as when the accelerator determines that certain inference context data is no longer actively needed and may be offloaded to a lower-cost memory tier. Alternatively, the migration may be coordinated by a host or a scheduler that directs the accelerator to evict or fetch specific data. The UPLI request may include a write command when data is being evicted from local memory to the CXL memory device, carrying the inference context data on the UPLI Originator Data Channel. The UPLI request may alternatively comprise a read command when data is being fetched from the CXL memory device to local memory, in which case the data is returned via the CXL.mem S2M data response path and translated to a UPLI read response. The method may be implemented in hardware, firmware, software, or combinations thereof, and may be performed by various types of devices, such as a processor, a switch, a bridge, an RPU, or a semiconductor device.

In some implementations of the method, the inference context data comprises key-value (KV) cache data generated during attention computation in a transformer-based inference model, the KV cache data comprising key tensors and value tensors associated with one or more attention layers of the transformer-based inference model. The KV cache data may grow proportionally to the sequence length and the number of attention layers. As context lengths increase, the KV cache may consume a substantial portion of accelerator HBM, motivating migration of less-recently-accessed KV cache entries to CXL memory.

In some implementations of the method, the transformer-based inference model utilizes at least one of: (i) grouped query attention (GQA) wherein a plurality of query heads share a reduced number of key-value heads, or (ii) multi-latent attention (MLA) wherein the key tensors and the value tensors are compressed into a low-rank latent representation; and wherein the KV cache data corresponds to the reduced number of key-value heads or to the low-rank latent representation, respectively. GQA may reduce KV cache size by sharing key-value heads across multiple query heads, as utilized in models such as Llama. MLA may further compress the KV cache by projecting key and value tensors into a lower-dimensional latent space, as utilized in models such as DeepSeek. The reduced KV cache size per token may affect staging granularity and transfer efficiency.

In some implementations of the method, the inference context data comprises at least one of: model weight parameters, activation tensors generated during inference computation, or embedding vectors associated with an input sequence. Model weight parameters may be staged when different models or model components are loaded on demand, such as in multi-tenant serving or model-switching scenarios. Activation tensors may be checkpointed to CXL memory during long inference sequences. Embedding vectors, such as token embeddings or positional embeddings, may be pre-staged from CXL memory before inference begins.

In some implementations of the method, the accelerator executes a mixture-of-experts (MoE) inference model comprising a gating network and expert sub-networks, and wherein the inference context data comprises weight parameters of at least one expert sub-network of the expert sub-networks; and wherein the UPLI request is sent based on a routing decision of the gating network indicating that the at least one expert sub-network is to be activated or deactivated. In MoE models, only a subset of expert sub-networks may be active for any given input token. Inactive expert weights may be offloaded to CXL memory to free accelerator HBM capacity, and activated expert weights may be fetched from CXL memory when the gating network routes tokens to those experts. This dynamic staging may enable serving MoE models that are larger than the available HBM capacity.

In some implementations, the method further comprises sending, by the accelerator, a second UPLI request comprising a read command and a third physical address via the UALink switch to the RPU; translating, by the RPU, the second UPLI request to a second CXL.mem M2S request comprising a fourth physical address; sending, by the RPU, the second CXL.mem M2S request to the CXL memory device; receiving, by the RPU, a CXL.mem Subordinate-to-Master Data Response (S2M DRS) comprising second inference context data from the CXL memory device; translating, by the RPU, the CXL.mem S2M DRS to a UPLI read response (RdRsp) comprising the second inference context data; and sending, by the RPU, the UPLI RdRsp to the accelerator via the UALink switch; wherein the second inference context data is stored in the local memory of the accelerator. The fetch direction may be utilized when inference context data that was previously offloaded to the CXL memory device is needed again for active computation. The RPU may translate the CXL.mem S2M DRS, including by translating the Tag back to the original UPLI ReqTag and formatting the data as UPLI RdRspData. In some examples, the RPU may accumulate data from CXL.mem S2M DRS messages before sending a UPLI RdRsp, such as when the CXL.mem cacheline size differs from the UPLI transfer size.

In some implementations of the method, the CXL memory device comprises a Global Fabric-Attached Memory Device (GFD), the local memory comprises at least one of high-bandwidth memory (HBM) or High-Bandwidth Flash (HBF), the first physical address refers to a Network Physical Address (NPA) or a System Physical Address (SPA), and the second physical address refers to a Host Physical Address (HPA); and wherein the translating comprises translating the first physical address to the second physical address. The GFD may provide large-capacity memory accessible by both accelerators via the RPU and hosts via direct CXL.mem access. The address translation between NPA or SPA and HPA may be performed utilizing lookup tables, base-and-offset calculations, or programmable translation functions within the RPU.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In AI inference systems, a host such as a CPU may orchestrate the staging of inference context data between CXL memory devices and accelerators that reside in the UALink domain. The host may read inference context data from a CXL memory device via CXL.mem and write the data to an accelerator by sending a CXL.mem M2S request to an RPU, which translates the request to a UPLI request and forwards it to the accelerator via a UALink port. This host-initiated staging may be utilized in scenarios where the host manages a tiered memory hierarchy, determines which inference context data to pre-stage to accelerators based on scheduling policies, inference request queues, or predicted workload patterns, and coordinates data movement between the CXL and UALink protocol domains. The host may also orchestrate reading inference context data from accelerators via the RPU and writing it to CXL memory devices for longer-term retention. This bidirectional host-orchestrated staging may support a variety of inference architectures and model types, including transformer models with large KV caches, mixture-of-experts models with dynamic expert activation, disaggregated prefill and decode architectures, speculative decoding, hybrid attention and state-space models, multimodal models, and retrieval-augmented generation pipelines. In each case, the CXL memory device may serve as an intermediate staging area that bridges the capacity gap between accelerator working memory and the volume of inference context data associated with the workload.

In various implementations, a method for staging inference context data across protocol domain boundaries, comprising: reading, by a host, inference context data from a Compute Express Link (CXL) memory device via CXL.mem; sending, by the host, a CXL.mem Master-to-Subordinate (M2S) request to a resource provisioning unit (RPU), the CXL.mem M2S request associated with the inference context data and comprising a first physical address; translating, by the RPU, the CXL.mem M2S request to an Ultra Accelerator Link (UALink) Protocol Level Interface (UPLI) request comprising a second physical address; and sending, by the RPU, the UPLI request to an accelerator via a UALink port; wherein the inference context data is staged from the CXL memory device to a local memory of the accelerator across a CXL protocol domain and a UALink protocol domain. The host-initiated staging may enable the host to manage a tiered memory hierarchy comprising accelerator local memory as a working memory tier, host memory as an intermediate tier, and CXL memory devices as a capacity tier. The host may determine which inference context data to stage based on scheduling policies, inference request queues, or predictions about upcoming workload requirements. The RPU may be a discrete component, an IP block embedded in an accelerator, or a chiplet within an IC package. The CXL.mem M2S request may include a write command carrying the inference context data, and the translated UPLI request may carry the data on the UPLI Originator Data Channel to the accelerator. The RPU may perform address translations between HPA addresses utilized by the host and NPA or SPA addresses utilized by the UALink domain, and may further perform Tag and opcode translations between CXL.mem and UPLI message formats. The host may access the CXL memory device via CXL.mem without translation, and may access the accelerator via the RPU that translates between CXL.mem and UPLI. The method may be implemented in hardware, firmware, software, or combinations thereof.

In some implementations, the method further comprises reading, by the host, second inference context data from the accelerator, wherein the reading comprises the host sending a second CXL.mem M2S request to the RPU, the RPU translating the second CXL.mem M2S request to a second UPLI request comprising a read command and sending the second UPLI request to the accelerator via the UALink port, the RPU receiving a UPLI read response (RdRsp) comprising the second inference context data from the accelerator, and the RPU returning the second inference context data to the host; and writing, by the host, the second inference context data to the CXL memory device via CXL.mem. This direction may enable the host to evict inference context data from accelerator local memory to the CXL memory device when the data is no longer actively needed or when the local memory capacity is exceeded. The host may coordinate both staging and eviction to maintain a working set of inference context data in accelerator local memory that matches the current workload.

In some implementations of the method, the accelerator executes a mixture-of-experts (MoE) inference model comprising a gating network and expert sub-networks, and the second inference context data comprises weight parameters of an inactive expert sub-network of the expert sub-networks, the inactive expert sub-network identified based on a routing decision of the gating network. Evicting inactive expert weights to CXL memory may free accelerator HBM capacity for the active experts, enabling the system to serve MoE models whose total expert weight parameters exceed the HBM capacity.

In some implementations of the method, the second inference context data comprises key-value (KV) cache entries that have been evicted from the local memory of the accelerator based on at least one of: an access frequency, an access recency, or the KV cache entries exceeding a capacity of the local memory. Long-context inference models may generate KV cache entries that exceed the accelerator HBM capacity. Eviction policies based on access frequency or recency may retain the most relevant KV cache entries in HBM while offloading less-accessed entries to CXL memory for potential later retrieval.

In some implementations of the method, the inference context data comprises key-value (KV) cache data associated with a transformer-based inference model, and wherein the host stages the KV cache data from the CXL memory device to the local memory of the accelerator based on a scheduled inference request or a predicted inference request. The host may maintain a scheduling queue of inference requests and may pre-stage KV cache data associated with upcoming requests to reduce latency when the request is dispatched to the accelerator. Prediction of upcoming requests may be based on session affinity, user activity patterns, or model serving policies.

In some implementations of the method, the accelerator comprises a decode accelerator, the inference context data comprises key-value (KV) cache data generated during a prefill phase of an inference operation by a prefill accelerator, and the KV cache data is staged from the CXL memory device to the local memory of the decode accelerator for use in a decode phase of the inference operation; and wherein the CXL memory device serves as an intermediate storage between the prefill accelerator and the decode accelerator. In disaggregated inference architectures, the prefill phase and the decode phase may be performed by different accelerators to optimize resource utilization. The prefill accelerator may write the generated KV cache data to the CXL memory device, and the host may subsequently stage the KV cache data from the CXL memory device to the decode accelerator. The CXL memory device may thus serve as a shared staging area that decouples the prefill and decode phases across protocol domain boundaries.

In some implementations of the method, the accelerator performs speculative decoding comprising a draft model generating candidate token sequences and a verification model accepting or rejecting the candidate token sequences, and wherein the inference context data comprises at least one of: draft model weight parameters, draft model KV cache data, or verification context data associated with the speculative decoding. Speculative decoding may utilize a smaller draft model to generate candidate tokens that a larger verification model subsequently accepts or rejects. The draft model weight parameters or the draft model KV cache data may be staged from CXL memory to accelerator HBM when speculative decoding is activated for a given inference session.

In some implementations of the method, the inference context data comprises state data associated with a hybrid inference model, the hybrid inference model comprising attention layers that generate key-value (KV) cache data and state-space model layers that maintain recurrent state vectors; and wherein the staging comprises staging at least one of the KV cache data or the recurrent state vectors from the CXL memory device to the local memory of the accelerator. Hybrid models, such as those combining attention layers with Mamba-style state-space model (SSM) layers, may maintain both KV cache data for attention layers and recurrent state vectors for SSM layers. The staging may include both data types, which may have different sizes, access patterns, and staging priorities.

In some implementations of the method, the inference context data comprises visual embeddings generated by an image encoder or a video encoder of a multimodal inference model; and wherein the staging comprises staging the visual embeddings from the CXL memory device to the local memory of the accelerator for processing alongside text token embeddings by the multimodal inference model. Multimodal inference models may process both visual and textual inputs. Visual embeddings generated by an image or video encoder may be large and may be pre-computed and stored in CXL memory, then staged to the accelerator when a multimodal inference request is dispatched.

In some implementations of the method, the inference context data comprises pre-computed embeddings associated with retrieved documents in a retrieval-augmented generation (RAG) pipeline; and wherein the staging comprises staging the pre-computed embeddings from the CXL memory device to the local memory of the accelerator for concatenation with an input query during inference. In RAG pipelines, retrieved document embeddings may be pre-computed and stored in the CXL memory device as a large-capacity embedding store. When a query triggers retrieval, the relevant embeddings may be staged from the CXL memory device to the accelerator for concatenation with the query tokens before the generation phase.

In some implementations of the method, the inference context data comprises key-value (KV) cache entries associated with token positions in an input sequence, and the staging comprises staging a subset of the KV cache entries from the CXL memory device to the local memory of the accelerator, the subset selected based on the token positions being predicted to be accessed during a subsequent inference step; and wherein remaining KV cache entries associated with remaining token positions are retained in the CXL memory device. For long-context inference, the host may stage only the KV cache entries associated with token positions predicted to be attended during the next decoding step, retaining the remaining entries in CXL memory. This selective staging may reduce transfer volume and accelerator memory pressure while maintaining the full context available for on-demand retrieval.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In AI inference deployments, a system may include a cluster of accelerators coupled via a UALink switch, one or more CXL memory devices providing large-capacity memory, an RPU that translates between UPLI and CXL.mem, and a host that orchestrates workload scheduling and data movement. Such a system may be configured to migrate inference context data between accelerator local memory and the CXL memory devices across the UALink and CXL protocol domain boundaries, enabling the system to serve inference workloads whose aggregate inference context data exceeds the capacity of any single accelerator's local memory. The host may access the CXL memory devices via CXL.mem, while the accelerators access the same CXL memory devices via the RPU that translates between UPLI and CXL.mem. This architecture may support tiered memory management, where inference context data is staged between accelerator HBM, HBF, host memory, and CXL memory based on access patterns, scheduling policies, or memory capacity constraints.

In various implementations, a system comprising: an Ultra Accelerator Link (UALink) switch; accelerators coupled to the UALink switch, each accelerator of the accelerators comprising a local memory; a Compute Express Link (CXL) memory device; a resource provisioning unit (RPU) coupled to the UALink switch and to the CXL memory device, the RPU configured to translate between UALink Protocol Level Interface (UPLI) and CXL.mem; and a host coupled to the CXL memory device via CXL.mem; wherein the system is configured to migrate inference context data between the local memory of at least one accelerator of the accelerators and the CXL memory device across a UALink protocol domain and a CXL protocol domain. The system may enable both accelerator-initiated and host-initiated data migration across the protocol domain boundaries. The accelerators may communicate with one another and with the RPU via the UALink switch utilizing UPLI, while the host may communicate with the CXL memory device utilizing CXL.mem. The RPU may be implemented as a discrete component coupled to the UALink switch, as an IP block embedded within one of the accelerators, or as a chiplet within an IC package. The system may support various inference workloads, and the inference context data may include KV cache data, model weight parameters, activation tensors, embedding vectors, or other data generated or consumed during inference computation. The CXL memory device may include a CXL memory expander, a CXL memory pool, or a GFD.

In some implementations of the system, the at least one accelerator is configured to initiate migration of the inference context data by sending a UPLI request via the UALink switch to the RPU, and the RPU is configured to translate the UPLI request to a CXL.mem M2S request and send the CXL.mem M2S request to the CXL memory device. The accelerator may determine when to migrate inference context data based on local memory capacity utilization, access patterns, or workload scheduling signals received from the host or from other accelerators.

In some implementations of the system, the local memory comprises a first memory tier, the system further comprises host memory coupled to the host, the host memory comprising a second memory tier, and the CXL memory device comprises a third memory tier; and wherein the inference context data is migrated between the first memory tier and the third memory tier based on at least one of: access frequency, access recency, a capacity of the first memory tier, or a scheduling policy of the host. The tiered memory hierarchy may enable the system to retain actively-accessed inference context data in the highest-bandwidth tier (accelerator local memory) while staging less-accessed data to lower-cost, higher-capacity tiers (CXL memory). The second memory tier (host memory) may serve as an intermediate staging buffer.

In some implementations, the system further comprises a second CXL memory device and a CXL fabric coupling the RPU to the CXL memory device and the second CXL memory device; wherein at least one of the CXL memory device or the second CXL memory device comprises at least one of: a CXL memory expander, a CXL memory pool, or a Global Fabric-Attached Memory Device (GFD). The CXL fabric may include one or more CXL switches and may provide connectivity between the RPU and CXL memory devices. The RPU may route translated requests to specific CXL memory devices based on the physical addresses carried in the UPLI requests.

In some implementations of the system, the inference context data comprises key-value (KV) cache data associated with a transformer-based inference model, the local memory comprises high-bandwidth memory (HBM), and the at least one accelerator comprises at least one of: a graphics processing unit (GPU) or a tensor processing unit (TPU). GPUs and TPUs are accelerators commonly utilized for transformer-based inference workloads that generate substantial KV cache data. HBM provides the high-bandwidth, low-latency access needed for active inference computation, while the CXL memory device may provide the additional capacity needed for KV cache entries that are not actively accessed.

In environments where accelerators communicate utilizing NVLink-based protocols, such as GPUs coupled via NVLink or NVSwitches, the accelerators may similarly need to migrate inference context data to CXL memory devices that reside in a different protocol domain. An RPU may translate between NVLink-based protocol messages and CXL.mem messages to enable accelerators in the NVLink domain to stage inference context data to and from CXL memory devices. The RPU may be integrated into an active cable, an NVSwitch, or a discrete bridge device, and may perform address translations between NVLink addresses and CXL.mem addresses, as well as command and Tag translations between the two protocol domains. This NVLink-to-CXL.mem translation path may enable heterogeneous computing environments where different clusters of accelerators utilize different interconnect protocols while sharing access to common CXL memory resources.

In various implementations, a method for migrating inference context data across protocol domain boundaries, comprising: sending, by an accelerator, a request conforming to an NVLink-based protocol to a resource provisioning unit (RPU), the request associated with the inference context data stored in a local memory of the accelerator, the request comprising a first physical address; translating, by the RPU, the request to a Compute Express Link (CXL) CXL.mem Master-to-Subordinate (M2S) request comprising a second physical address; and sending, by the RPU, the CXL.mem M2S request to a CXL memory device; wherein the inference context data is migrated between the local memory of the accelerator and the CXL memory device across an NVLink protocol domain and a CXL protocol domain. The method may enable accelerators communicating according to an NVLink-based protocol to access CXL memory resources for staging inference context data. The RPU may translate between NVLink-based protocol messages and CXL.mem messages, including translations of addresses, commands, and identifiers. The first physical address may be an NVLink Network Address, and the second physical address may be an HPA utilized by the CXL memory device. The RPU may be integrated into an active cable, an NVSwitch, or a discrete bridge device. In some examples, the RPU may be positioned closer to the CXL port to optimize signal integrity, since CXL runs over PCIe electricals designed for shorter-reach connectivity while NVLink may incorporate signaling characteristics compatible with longer-reach interconnects.

In some implementations of the method, the accelerator is coupled to the RPU via an NVLink switch (NVSwitch), and the request conforming to the NVLink-based protocol is sent via the NVSwitch to the RPU. The NVSwitch may route the NVLink-based request from the accelerator to the RPU based on routing information carried in the request. The NVSwitch may couple accelerators to the RPU, enabling accelerators within the NVLink domain to access the CXL memory device for inference context data staging.

In some implementations of the method, the inference context data comprises key-value (KV) cache data generated during attention computation in a transformer-based inference model, and the local memory comprises high-bandwidth memory (HBM). KV cache data generated by NVLink-coupled accelerators during transformer-based inference may be staged to CXL memory devices when the KV cache exceeds the HBM capacity.

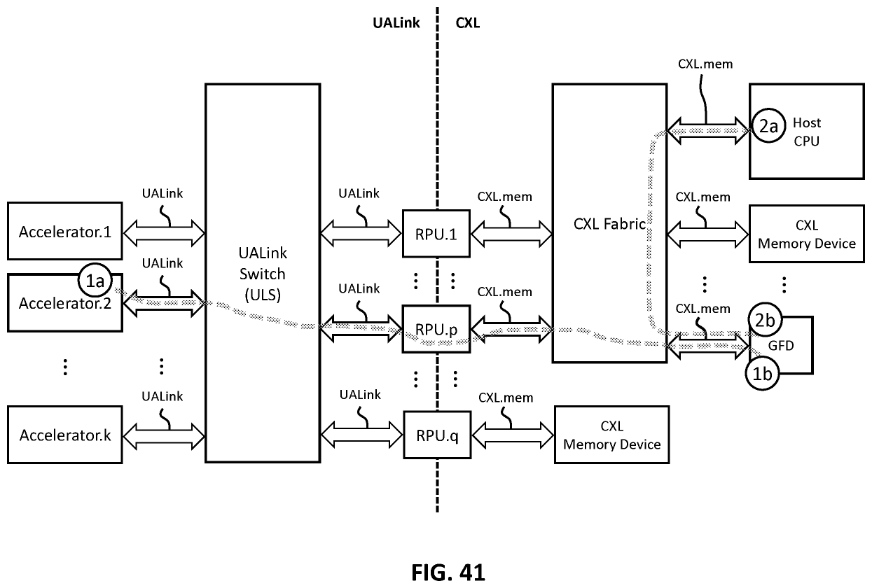

FIG. 41 illustrates an example of a system comprising a cluster of accelerators (e.g., GPUs or TPUs) interconnected by a UALink switch, an RPU coupled to the UALink switch, CXL memory devices coupled to the RPU via a CXL fabric, and a host coupled to the CXL memory devices via CXL.mem. Path 1a to 1b illustrates an accelerator-initiated data migration path. Accelerator.2 sends a UPLI request via the UALink switch to RPU.p. RPU.p translates the UPLI request to a CXL.mem M2S request and sends the CXL.mem M2S request to a GFD via the CXL fabric. The RPU may translate addresses between the UALink address space (e.g., NPA or SPA) and the CXL address space (e.g., HPA), and may translate opcodes, Tags, and additional fields between UPLI and CXL.mem message formats. In the write direction, the accelerator may evict inference context data from its local memory, such as HBM and/or HBF, to the GFD by sending a UPLI write request carrying the data on the Originator Data Channel. In the read direction, the accelerator may fetch inference context data from the GFD by sending a UPLI read request, and the RPU may receive a CXL.mem S2M DRS from the GFD, translate the CXL.mem S2M DRS to a UPLI RdRsp, and return the data to the accelerator via the UALink switch.

Path 2a to 2b illustrates a host-initiated access path. The host accesses the GFD via CXL.mem, without translation by the RPU. The host may read inference context data from the GFD via CXL.mem, and may subsequently write the inference context data to an accelerator by sending a CXL.mem M2S RwD to the RPU, which translates the CXL.mem M2S request to a UPLI request and sends the UPLI request to the accelerator via the UALink switch. Conversely, the host may read inference context data from an accelerator by sending a CXL.mem M2S request to the RPU, which translates the request to a UPLI read request, receives a UPLI RdRsp from the accelerator, and returns the data to the host; the host may then write the data to the GFD via CXL.mem. The host may thus orchestrate bidirectional data staging between the CXL memory devices and the accelerators across the CXL and UALink protocol domain boundaries.

In one example, the host may bring inference context data, such as KV cache data, from storage (e.g., NVMe or remote storage) into a CXL memory device such as the GFD. The accelerator may then fetch the KV cache data from the GFD to its local memory (e.g., HBM and/or HBF) for active inference computation. When the KV cache data is no longer actively accessed, or when the local memory capacity is exceeded, the accelerator may migrate the colder KV cache data from its HBM back to the GFD. In this manner, the system may maintain a tiered memory hierarchy where the accelerator HBM serves as a working memory tier for actively-accessed inference context data, and the CXL memory device serves as a capacity tier for less-frequently-accessed inference context data. The RPU may enable the data migration between these tiers by translating between UPLI and CXL.mem across the protocol domain boundaries.

The CXL memory devices shown in FIG. 41 may include CXL memory expanders, CXL memory pools, or GFDs, and may be coupled to the RPU via the CXL fabric, which may include one or more CXL switches. The RPU may route translated requests to specific CXL memory devices based on the physical addresses carried in the translated CXL.mem M2S requests. The system may support various types of inference context data, including KV cache data associated with transformer-based models, model weight parameters associated with mixture-of-experts models, activation tensors, embedding vectors, and other data generated or consumed during inference computation.

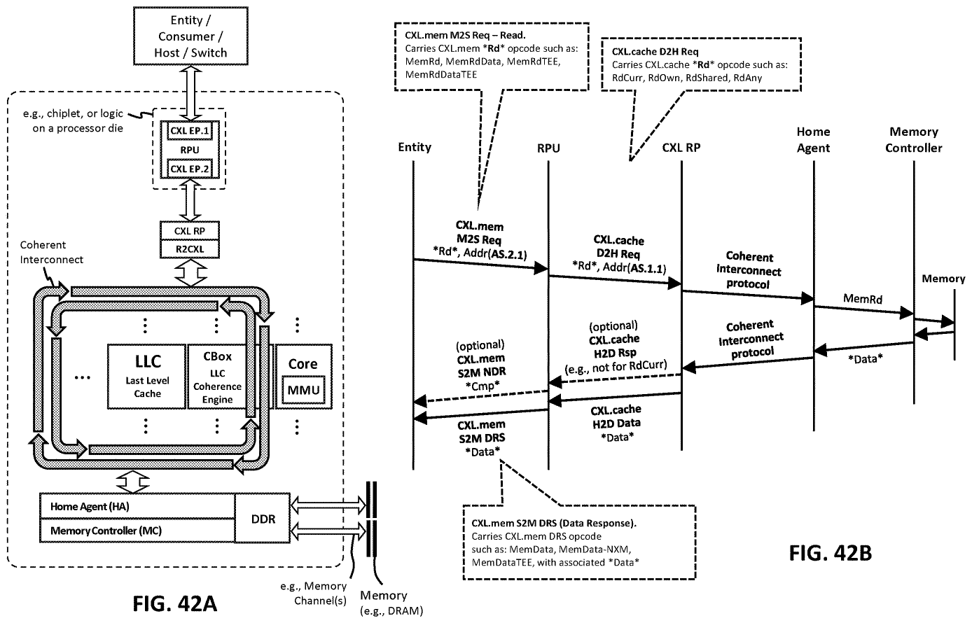

FIG. 42A illustrates an example of a system comprising a processor, including a coherent interconnect, capable of enabling an external entity to access memory resources mapped to the address space utilized by the coherent interconnect. Optionally, the processor is an MxPU derived from an established processor design that may include coherent interconnect (such as a ring-based or a mesh-based coherent interconnect), processing cores, LLC, a CXL RP, and a memory controller optionally coupled via memory channels to memory, such as DRAM. The CXL RP may be coupled to the coherent interconnect via a Ring-to-CXL (R2CXL) logic. An RPU, which may be included in the MxPU, performs address translations that may enable an entity such as a host to access the memory. The MxPU may expose to the entity, optionally via the RPU, a first CXL device, such as a Type-3 CXL device or a Type-2 CXL device, utilizing a first CXL endpoint (CXL EP.1). The first CXL device may communicate with the entity according to a protocol based on CXL, such as CXL.mem. The MxPU may further expose, optionally via the RPU and the CXL RP, a second CXL device such as a Type-1 CXL device or a Type-2 CXL device, utilizing a second CXL endpoint (CXL EP.2). In some examples, the RPU and its CXL devices may be implemented in a chiplet inside an IC package of a processor, such as inside an IC package of an MxPU, whereas in other examples, the RPU and its CXL devices may be implemented as functional blocks on the same die with the CXL RP, or split between processor dies or chiplets. Alternatively, the RPU may be implemented as a discrete component coupled to a processor component.

FIG. 42B illustrates an example of a TFD demonstrating a CXL.mem read request (M2S request *Rd*) received from an entity, such as a host or a switch, wherein the RPU may translate between CXL.mem and CXL.cache, and may further translate a physical address (AS.2.1) from a second host physical address space, carried in the CXL.mem M2S request, to a physical address (AS.1.1) from a first HPA space, carried in a CXL.cache D2H request, wherein the first HPA space is utilized by the processor and/or by the coherent interconnect. The RPU may perform further translations, such as opcode translations and Tag to CQID translations. The CXL.cache request, carrying the translated address (AS.1.1), is sent to the CXL RP for further processing and fetching of the requested data, such as from the LLC over the on-chip ring-based coherent interconnect, or from the DRAM via the memory controller. The data may then return over the coherent interconnect to the RPU, via the CXL RP, wherein the RPU may perform further translations between CXL.cache and CXL.mem and provide CXL.mem Data Response (DRS) and optionally CXL.mem No Data Response (NDR) to the requesting entity.

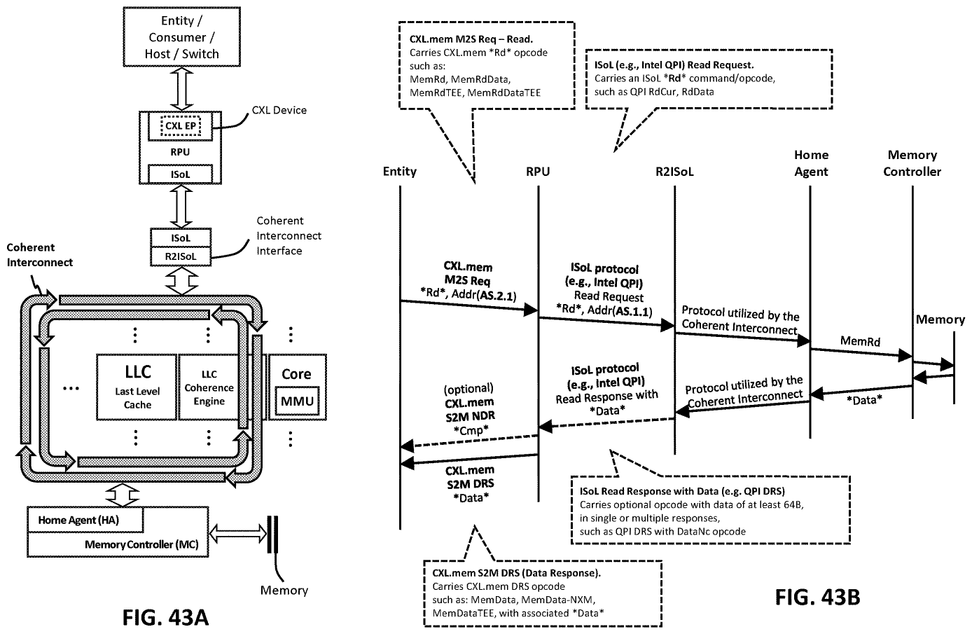

FIG. 43A illustrates an example of a system comprising a processor, including a coherent interconnect, capable of enabling an external entity to access memory resources mapped to the address space utilized by the coherent interconnect. Optionally, the processor is an MxPU derived from an established processor design that may include an RPU that may include, or be coupled to, a CXL device, such as a GFD, a CXL Type-3 device, or a CXL Type-2 device. The CXL device may include a CXL EP, wherein the RPU may be implemented as a chiplet, a logic on the processor die, a discrete component coupled to the processor, or other implementations. The processor may further include processing cores with MMUs, LLC, and LLC Coherence Engine (such as CBox) coupled via an on-chip coherent interconnect that may utilize a ring topology as one example. The processor may further include a Home Agent (HA) and Memory Controller (MC) coupled to memory, such as DRAM, optionally via memory channels. The RPU may be coupled to the coherent interconnect via an ISoL interface, such as Intel QPI, Intel UPI, or CHI C2C, and via a coherent interconnect interface, such as Ring-to-ISoL (R2ISoL) logic. The CXL device, which may reside within the RPU, may communicate with an entity, such as a host, according to a protocol based on CXL, such as CXL.mem, wherein the RPU performs address translations between the host's HPA space and the processor's physical address space to enable the host to access the memory and other resources accessible via the coherent interconnect. Alternatively, the figure may illustrate some examples of a two-socket (2S) or a two-processor (2P) system that may function as a memory switch or a memory pool, wherein the RPU may be embedded in the first processor coupled to the entity, and further coupled to a second processor via an ISoL interface, whereas the RPU enables the entity to access memory of the second processor, via the first processor and the ISoL interface.

FIG. 43B illustrates an example of a TFD demonstrating a CXL.mem M2S Read request received from an entity, such as a host or a switch. The request carries a CXL.mem read opcode such as MemRd, MemRdData, MemRdTEE, or MemRdDataTEE, along with a physical address (AS.2.1) from a second host physical address space utilized by the entity. The RPU translates the physical address (AS.2.1) to a physical address (AS.1.1) from a first HPA space utilized by the processor and/or the coherent interconnect. The RPU may also translate the CXL.mem request to an ISoL request (such as Intel QPI read request) including a read command/opcode such as QPI RdCur or RdData. The translated request is sent via the coherent interconnect to fetch the requested data, which may be retrieved from the LLC or from DRAM. The requested data returns to the RPU via the coherent interconnect and the ISoL interface using the ISoL protocol. The RPU then provides responses to the requesting entity including: CXL.mem S2M DRS carrying CXL.mem DRS opcodes such as MemData, MemData-NXM, or MemDataTEE with associated data, and optionally CXL.mem S2M NDR with a completion status. The ISoL read response may carry optional opcodes with data of at least 64 B, in single or multiple responses, such as QPI DRS with DataNc opcode.

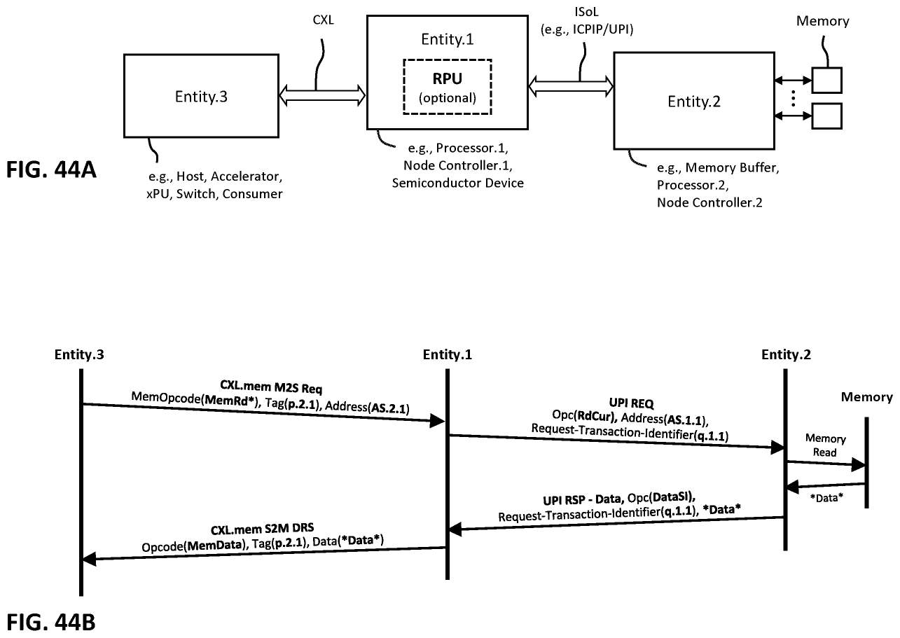

FIG. 44A illustrates an example of a system comprising a first entity (Entity.1), such as a first processor (Processor.1), a first node controller (Node Controller.1), or a semiconductor device, that may include an RPU. The first entity may be coupled to a third entity (Entity.3), which may be a host, an accelerator, an xPU, a switch (e.g., a CXL switch), or a resource consumer, wherein the first entity may communicate with the third entity according to a CXL-based protocol, such as at least one of CXL.mem, CXL.io, or CXL.cache. The first entity may be further coupled to a second entity (Entity.2), which may be a second processor (Processor.2), a memory buffer, or a second node controller (Node Controller.2), wherein the second entity may be coupled to a memory, and wherein the first entity may communicate with the second entity according to an ISoL protocol, such as ARM CHI C2C, a protocol utilizing an NVIDIA NVLink-C2C interconnect, or an Intel Coherent Processor Interconnect Protocol (ICPIP), such as Intel UPI. The first node controller (Node Controller.1) and the second node controller (Node Controller.2) may each include an ICPIP node controller, such as a UPI node controller (UNC), or an external node controller (e.g., XNC). The first entity, optionally via the RPU, may translate between the CXL-based protocol, such as CXL.mem, and the ISoL protocol, such as ICPIP, enabling the third entity to access resources coupled to the first entity, such as the memory that may be coupled to the second entity.

In some examples, the CXL-based protocol, such as CXL.mem, may be associated with a first address space, such as a first Host Physical Address (HPA) space, and the ISoL protocol, such as ICPIP, may be associated with a second address space, such as a System Physical Address (SPA) space or a second Host Physical Address (HPA) space; wherein the first entity, optionally via the RPU, may perform address translations between addresses within the first and second address spaces, respectively, such as between addresses within the first HPA space and addresses within the SPA space or within the second HPA space. In other examples, the CXL-based protocol, such as CXL.mem, and the ISoL protocol, such as ICPIP, may be associated with the same physical address space, such as with the same HPA space, the same SPA space, or with a global address space, a partitioned global address space (PGAS), a pod address space, a virtual pod address space, or a fabric address space; wherein the first entity, optionally via the RPU, may perform address translations between addresses within the same address spaces. The first entity (Entity.1), optionally via the RPU, may perform further translations, such as opcode, command, or TLP translations, e.g., translating between commands or opcodes in requests conforming to the CXL-based protocol (e.g. CXL.mem M2S Req MemRd) to opcodes in requests conforming to the ISoL Protocol (e.g., Intel UPI RdCur). The first entity, optionally via the RPU, may further perform other translations, such as translations between messages conforming to the CXL-based protocol and protocol data units (PDUs) conforming to the ISoL Protocol, Tag translations, traffic class (TC) translations, and/or cross-field translations, wherein the first entity, optionally via the RPU, may maintain tracking between Tags associated with the CXL-based protocol and Tags associated with the ISoL protocol, such as in order to associate responses with their corresponding requests.

FIG. 44B illustrates an example of a TFD demonstrating translations between CXL.mem traffic and ISoL traffic, such as ICPIP (e.g., Intel UPI) traffic. The translations may be performed by a first entity (Entity.1), such as a first processor (Processor.1), a first node controller (Node Controller.1), or a semiconductor device, optionally via an RPU. The CXL-based protocol may be utilized for communicating with a third entity (Entity.3), such as a host, and the ISoL protocol may be utilized for communicating with a second entity (Entity.2), such as a second processor (Processor.2), or a second node controller (Node Controller.2). The second entity may be coupled to a memory, such as DRAM, which may be mapped to a physical address space (PAS) utilized by the first entity. The third entity may initiate a CXL transaction that may include a CXL.mem M2S Req comprising MemOpcode(MemRd*), Tag(p.2.1), and Address(AS.2.1). The first entity, optionally via the RPU, may translate the CXL transaction to an ISoL (e.g., ICPIP) transaction, such as an Intel UPI transaction that may include a UPI request (REQ message class) comprising Opc(RdCur), Address(AS.1.1), and Request-Transaction-Identifier(q.1.1), wherein the Request-Transaction-Identifier (e.g., RTID) may denote a Tag, a transaction Tag, a transaction identifier, or another field or set of fields carried in UPI transactions which may serve to associate responses with their corresponding requests.

The first entity (Entity.1) may send the UPI request (REQ) to the second entity. Upon receiving a response from the second entity, that may include a UPI data response (“RSP-Data” message class, which may also be denoted by “RSP4-Data”) comprising Opc(DataSI), Request-Transaction-Identifier(q.1.1), and *Data*, the first entity, optionally via the RPU, may translate the UPI response (RSP-Data) to a CXL.mem S2M DRS comprising Opcode(MemData), Tag(p.2.1), and Data(*Data*). In some examples, the requested data may be provided by a processor cache instead of by the memory, such as where the requested data may be provided by an LLC that may be included in the first entity, or by an LLC that may be included in the second entity. In other examples, the first entity, optionally via the RPU, may translate the CXL transaction to an ICPIP transaction, such as an Intel UPI transaction, that may include message classes such as REQ, SNP, WB, RSP (such as RSP2 or RSP4), NCB, or NCS, that may include commands, operations, or opcodes (e.g., Opc), such as RdCode, RdCur, RdData, RdInv, RdInvOwn, SnpCode, SnpCur, SnpData, SnpInv, WbMtoS, WcWr, WcWrPtl, DataE, DataSI, or DataM_CmpO.

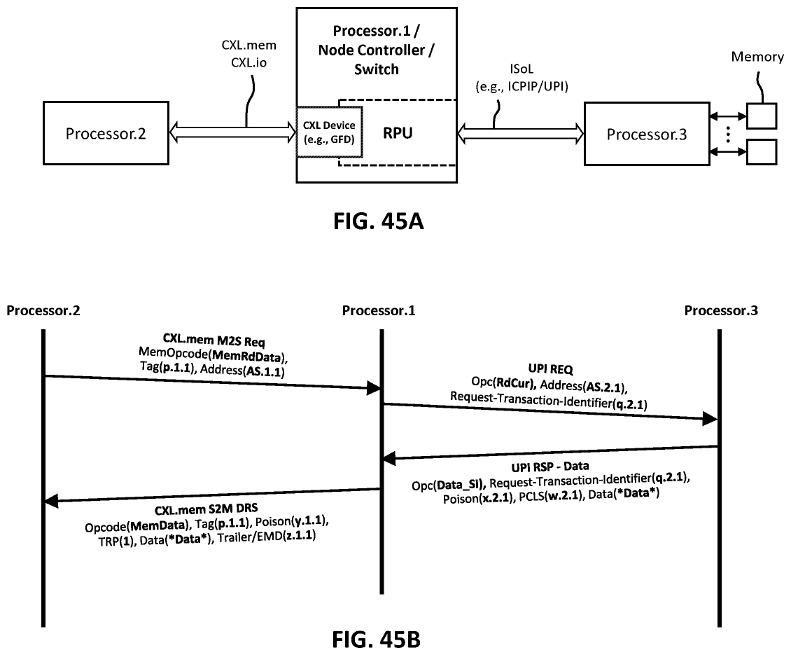

FIG. 45A illustrates an example of a system comprising a first processor (Processor.1), a node controller, or a switch, that may include an RPU and a CXL device, such as a Global Fabric-Attached Memory (G-FAM) Device (GFD), wherein the CXL device may be included in or coupled to the RPU. The first processor may be coupled to a second processor (Processor.2), wherein the first processor may communicate with the second processor, via the CXL device, according to a CXL-based protocol, such as at least one of CXL.mem, CXL.io, or CXL.cache. The first processor may be further coupled to a third processor (Processor.3) that may be coupled to memory, and wherein the first processor may communicate with the third processor according to an ISoL protocol, such as NVIDIA NVLink-C2C, ARM CHI C2C, or Intel Coherent Processor Interconnect Protocol (ICPIP), such as Intel UPI. The first processor, optionally via the RPU, may translate between the CXL-based protocol, such as CXL.mem or CXL.io, and the ISoL protocol, such as ICPIP (e.g., Intel UPI), enabling the second processor to access, via the CXL device, resources coupled to the third processor, such as the memory.

In some examples, the CXL-based protocol, may be associated with a first address space, such as a first Host Physical Address (HPA) space, and the ISoL protocol, such as ICPIP, may be associated with a second address space, such as a System Physical Address (SPA) space or a second Host Physical Address (HPA) space; wherein the first processor, optionally via the RPU, may perform address translations between addresses within the first and second address spaces, respectively, such as between addresses within the first HPA space and addresses within the SPA space or within the second HPA space. In other examples, messages conforming to the CXL-based protocol and messages conforming to the ISoL protocol may be associated with the same physical address space, such as with the same HPA space; wherein the first processor, optionally via the RPU, may perform address translations between addresses within the same address spaces. The first processor, optionally via the RPU, may perform further translations, such as protocol translations, opcode translations, command translations, TLP translations, or translations between messages conforming to the CXL-based protocol and PDUs conforming to the ISoL Protocol, Tag translations, traffic class (TC) translations, and/or cross-field translations; wherein the first processor, optionally via the RPU, may maintain tracking between Tags associated with the CXL-based protocol and Tags associated with the ISoL protocol, such as in order to associate responses with their corresponding requests.

FIG. 45B illustrates an example of a TFD demonstrating translations between CXL.mem and UPI. The illustrated translations are performed by a first processor (Processor.1), a node controller, or a switch, optionally via an RPU, between a CXL-based protocol, such as CXL.io and/or CXL.mem, utilized for communicating with a second processor (Processor.2), and an ISoL protocol, such as ICPIP (e.g., Intel UPI), utilized for communicating with a third processor (Processor.3) that may be coupled to memory, such as DRAM, which may be mapped to a physical address space (PAS) utilized by the first processor. The first processor may utilize translations, such as protocol translations, to convey indications, metadata, and other information, which may be related to the transaction, such as error and data corruption indications, such as poison, status indications, or directory information such as prior cacheline state (PCLS), which may be used to gather performance statistics. The second processor may initiate a CXL transaction that may include a CXL.mem M2S Req comprising MemOpcode(MemRdData), Tag(p.1.1), and Address(AS.1.1). The first processor, optionally via the RPU, may translate the CXL transaction to an ISoL (e.g., ICPIP) transaction, such as an Intel UPI transaction that may include UPI REQ comprising Opc(RdCur), Address(AS.2.1), and Request-Transaction-Identifier RTID(q.2.1), wherein the first processor may send the UPI REQ to the third processor.

Upon receiving a response from the third processor, that may include a UPI RSP-Data comprising Opc(Data_SI), Request-Transaction-Identifier (RTID) (q.2.1), Poison(x.2.1), PCLS(w.2.1) and Data(*Data*), the first processor, optionally via the RPU, may translate the UPI RSP-Data to a CXL.mem S2M DRS comprising Opcode(MemData), Tag(p.1.1), Poison(y.1.1), TRP(1), Data(*Data*), and Trailer/EMD(z.1.1), whereas TRP(1) indicates Trailer Present, i.e., indicating that a trailer is included in the message, wherein the first processor, optionally via the RPU, may utilize the CXL.mem S2M DRS trailer for conveying status information such as the PCLS, optionally as EMD (Extended Metadata) information. Other revisions of the CXL specifications may utilize a Byte-Enables Present (BEP) field instead of the Trailer Present (TRP) field. The first processor, optionally via the RPU, may perform further translations, such as translations of error indications, such as poison, from the ISoL (e.g., ICPIP/UPI) domain, to the CXL-based domain, wherein poison (e.g., a bit in the protocol message or PDU) may indicate that the data contains an error, and may be logged, ignored, or silently discarded, possibly causing Silent Data Corruption (SDC). The first processor, optionally via the RPU, may further perform other translations, such as translations between messages conforming to the CXL-based protocol and PDUs conforming to the ISoL Protocol (e.g., Intel UPI), Tag translations, traffic class (TC) translations, and/or cross-field translations.

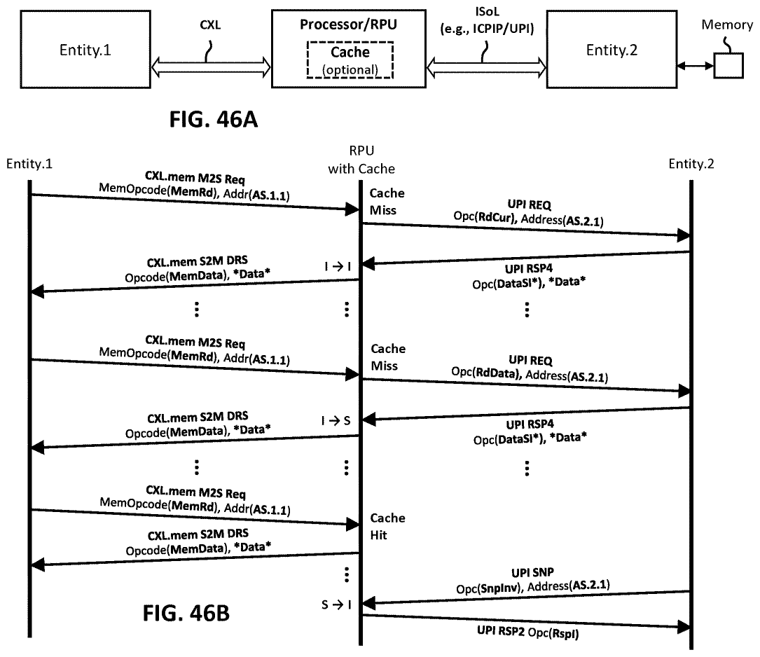

FIG. 46A illustrates an example of a system comprising a processor or an RPU, denoted as Processor/RPU, which may include a cache. The Processor/RPU may be coupled to a first entity (Entity.1), which may be a host, a second processor, a CXL Switch, or a resource consumer, wherein the Processor/RPU may communicate with the first entity according to a CXL-based protocol, such as at least one of CXL.mem, CXL.io, or CXL.cache. The Processor/RPU may be further coupled to a second entity (Entity.2), which may be a third processor, a node controller, or a memory buffer, wherein the second entity may be coupled to a memory, and wherein the Processor/RPU may communicate with the second entity according to an ISoL protocol, such as NVIDIA NVLink-C2C, ARM CHI C2C, or Intel Coherent Processor Interconnect Protocol (ICPIP), such as Intel UPI. The Processor/RPU may translate between the CXL-based protocol, such as at least one of CXL.io, CXL.mem, or CXL.cache, and the ISoL protocol, such as ICPIP, enabling the first entity to access resources coupled to the second entity, such as the memory. The Processor/RPU may cache data retrieved from the second entity and may respond to CXL requests received from the first entity with data from the cache, instead of issuing read requests to the second entity. Additionally or alternatively, the Processor/RPU may prefetch data from the second entity into the cache. The Processor/RPU may perform further translations between the CXL-based domain and the ISoL domain, such as protocol translations, address translations, opcode translations, command translations, TLP translations, and translations between messages conforming to the CXL-based protocol and PDUs conforming to the ISoL Protocol, Tag translations, traffic class (TC) translations, and/or cross-field translations; wherein the Processor/RPU may maintain tracking between Tags associated with the CXL-based protocol and Tags associated with the ISoL protocol, such as in order to associate responses with their corresponding requests.

FIG. 46B illustrates an example of a TFD demonstrating translations performed by a processor or an RPU, denoted as Processor/RPU, that may include a cache, between CXL-based traffic, such as at least one of CXL.io, CXL.mem, or CXL.cache, utilized for communicating with a first entity (Entity.1), and ISoL traffic, such as ICPIP (e.g., Intel UPI), utilized for communicating with a second entity (Entity.2) that may be coupled to memory, such as DRAM, wherein the memory may be mapped to a physical address space (PAS) utilized by the Processor/RPU. The Processor/RPU may translate between the CXL-based domain and the ISoL domain, such as translate between messages conforming to the CXL-based protocol and messages conforming to the ISoL protocol, for example translations between CXL.mem and ICPIP. The TFD illustrates three exemplary transactions between the first entity and the Processor/RPU. The first exemplary transaction may include CXL.mem M2S Req comprising MemOpcode(MemRd) and Address(AS.1.1), wherein the Processor/RPU may translate the request address (AS.1.1) to a translated address (AS.2.1) and may look up the data associated with the address and/or with the translated address in the cache before issuing a UPI request to the second entity. The lookup of the data may result in a cache miss, wherein the Processor/RPU may translate the CXL.mem M2S Req to UPI REQ comprising Opc(RdCur) and Address(AS.2.1), wherein the Processor/RPU may send the UPI REQ to the second entity. Upon receiving a response from the second entity, which may include UPI RSP4 comprising Opc(DataSI*) and *Data*, the Processor/RPU may translate the UPI RSP4 to a CXL.mem S2M DRS comprising Opcode(MemData) and *Data*, without storing the data retrieved from the second entity in the cache, denoted in the drawing by “I-to-I”, indicating that the cache state associated with the cacheline address remains invalid.

The second exemplary transaction may include CXL.mem M2S Req comprising MemOpcode(MemRd) and Address(AS.1.1), referencing the same address as the first exemplary transaction, wherein the Processor/RPU may translate the request address (AS.1.1) to a translated address (AS.2.1) and may look up the data associated with the address and/or with the translated address in the cache before issuing a UPI request to the second entity. The lookup of the data may result in a cache miss, wherein the Processor/RPU may translate the CXL.mem M2S Req to UPI REQ comprising Opc(RdData) and Address(AS.2.1), wherein the Processor/RPU may send the UPI REQ to the second entity. Upon receiving a response from the second entity, which may include UPI RSP4 comprising Opc(DataSI*) and *Data*, the Processor/RPU may translate the UPI RSP4 to a CXL.mem S2M DRS comprising Opcode(MemData) and *Data*, and may store the data retrieved from the second entity in the cache, denoted in the drawing by “I-to-S”, indicating that the cache state associated with the cacheline address transitioned from invalid to shared, possibly indicating that the cacheline data is shared between the Processor/RPU and the second entity.

The third exemplary transaction may include CXL.mem M2S Req comprising MemOpcode(MemRd) and Address(AS.1.1), referencing the same address as the first and the second transaction, wherein the Processor/RPU may translate the request address (AS.1.1) to a translated address (AS.2.1) and may look up the data associated with the address and/or with the translated address in the cache before issuing a UPI request to the second entity. The lookup of the data may result in a cache hit, wherein the Processor/RPU may respond to the request from the first entity with CXL.mem S2M DRS comprising Opcode(MemData) and *Data* from the cache, without sending a translated UPI REQ to the second entity. Following the third transaction, the second entity may invalidate the cacheline address (AS.2.1) associated with the UPI domain, which may be stored in the Processor/RPU cache. The second entity may send to the Processor/RPU a UPI SNP comprising Opc(SnpInv) and Address(AS.2.1), wherein the Processor/RPU may respond to the UPI SNP by sending to the second entity a UPI RSP (e.g., UPI RSP2) comprising Opc(RspI), indicating that the Processor/RPU invalidated the associated cacheline address from the cache, denoted in the drawing by “S-to-I”, indicating that the cache state associated with the cacheline address transitioned from shared to invalid.

In some examples, the Processor/RPU may perform cache lookups before performing translations related to the CXL request received from the first entity, or may perform cache lookups after performing some or all of the translations related to the CXL request received from the first entity. In some examples, the Processor/RPU may be further organize the cache and perform cache lookups according to addresses associated with the CXL-based domain (e.g., CXL.mem domain). Additionally or alternatively, the Processor/RPU may be further organize the cache and perform cache lookups according to translated addresses associated with the ISoL domain (e.g., UPI domain).

### Terminology

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and Infinity Fabric, ARM's CHI C2C, and NVIDIA's NVLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D1.4 ), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### General Considerations

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CplD), a PCIe UIO Read Completion with Data (UIORdCplD), a UALink UPLI Data Beat carrying Read Response Data, or an NVLink data transmission. *Data* may also denote PDUs having collectively essentially the same payload, such as when splitting a 128 B cacheline into two 64 B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/sending, receive/receiving, communicate/communicating, or exchange/exchanging when used to describe elements (e.g., computer, RPU, MxPU, processor, semiconductor device, switch, port, interface) involved in data, message, packet, or other information exchanges, may refer to direct or indirect operation(s) that facilitate information transfer to/from/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCIe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS.1.1)=00-00-CA-FE in a protocol that utilizes 32-bit address fields, which corresponds to the address (AS.2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. A method comprising:
receiving, by a resource provisioning unit (RPU) from a first entity via an NVLink interface that communicates according to an NVLink-based protocol, an NVLink-based request comprising a first physical address;
translating, by the RPU, the NVLink-based request to a CXL.cache Device-to-Host (D2H) request comprising an opcode and a second physical address, wherein CXL denotes Compute Express Link;
sending, by the RPU, the CXL.cache D2H request to a second entity;
receiving, by the RPU from the second entity, a CXL.cache Host-to-Device (H2D) response comprising data accessed via the second physical address; and
sending, by the RPU, an NVLink-based response comprising the data to the first entity.

2. The method of claim 1, wherein the second entity comprises a CXL root port (RP) coupled to a coherent interconnect of a processor, and the data is retrieved via the coherent interconnect from at least one of: a cache of the processor, a memory controller coupled to memory, or a CXL memory expander.

3. The method of claim 2, wherein the CXL RP is coupled to the coherent interconnect via an interconnect interface, and the coherent interconnect utilizes a protocol selected from at least one of: ARM CHI, Intel UPI, or AMD Infinity Fabric.

4. The method of claim 1, wherein the translating comprises translating an NVLink Tag carried in the NVLink-based request to a command queue identifier (CQID) carried in the CXL.cache D2H request, and maintaining a mapping between the NVLink Tag and the CQID for correlating the CXL.cache H2D response with the NVLink-based response.

5. The method of claim 1, wherein the translating comprises translating the NVLink-based request to CXL.cache D2H requests when the NVLink-based request specifies a data payload larger than a cacheline, and wherein each of the CXL.cache D2H requests comprises an opcode selected from RdOwn or RdShared.

6. The method of claim 1, wherein the translating comprises translating the first physical address from a GPU physical address or an NVLink network address to a Host Physical Address (HPA) carried as the second physical address in the CXL.cache D2H request.

7. The method of claim 1, wherein the RPU, the NVLink interface, and a CXL device are implemented in a chiplet within an integrated circuit (IC) package of a processor, and the second entity comprises a CXL root port (RP) of the processor.

8. The method of claim 1, wherein the RPU presents as a CXL endpoint (CXL EP) to the second entity, the CXL EP comprising a Type-1 CXL device or a Type-2 CXL device, and wherein the opcode of the CXL.cache D2H request comprises RdCurr.

9. The method of claim 1, wherein the opcode of the CXL.cache D2H request comprises RdCurr, and further comprising forwarding the data received via the CXL.cache H2D response to the first entity without caching it by the RPU, whereby the RPU provides I/O-coherent access to resources accessible via the second entity.

10. The method of claim 1, wherein the RPU comprises a cache, and the opcode of the CXL.cache D2H request is selected from RdOwn, RdShared, or RdAny; further comprising storing the data received via the CXL.cache H2D response in the cache of the RPU; and further comprising receiving, by the RPU from the second entity, a CXL.cache H2D request comprising a snoop opcode targeting a cacheline stored in the cache, and sending, by the RPU, a CXL.cache D2H response to the second entity.

11. A non-transitory computer-readable medium comprising instructions which, when executed by a processor, cause the processor to perform the method of claim 1.

12. An active cable comprising first and second pluggable modules coupled by a physical medium; wherein the active cable further comprises hardware circuitry, integrated into the active cable, configured to perform the method of claim 1.

13. An apparatus configured to operate as a switch, wherein the apparatus comprises switching circuitry and is configured to perform the method of claim 1.

14. A system comprising:
a processor comprising a Compute Express Link (CXL) root port (RP), a coherent interconnect, and memory controllers; wherein the memory controllers are coupled to the coherent interconnect and coupled to memory;
a resource provisioning unit (RPU) comprising: an NVLink interface configured to communicate with an entity according to an NVLink-based protocol, and a CXL endpoint (CXL EP) coupled to the CXL RP; and
wherein the RPU is configured to translate between NVLink-based requests received via the NVLink interface and CXL.cache Device-to-Host (D2H) requests sent to the CXL RP, to enable the entity to access memory resources via the coherent interconnect.

15. The system of claim 14, wherein the CXL EP comprises a Type-1 CXL device or a Type-2 CXL device, and the coherent interconnect utilizes a protocol selected from at least one of: ARM CHI, Intel UPI, or AMD Infinity Fabric.

16. The system of claim 14, further comprising processing cores and a last level cache (LLC) coupled to the coherent interconnect, and wherein the CXL RP is coupled to the coherent interconnect via an interconnect interface.

17. The system of claim 14, wherein the RPU, the NVLink interface, and the CXL EP are on a first silicon die, and the CXL RP and the coherent interconnect are on a second silicon die, the first and second silicon dies within an IC package.

18. The system of claim 14, wherein the RPU is further configured to translate CXL.cache Host-to-Device (H2D) requests received from the CXL RP to NVLink-based requests sent to the entity via the NVLink interface, enabling the processor to access resources of the entity.

19. A method comprising:
receiving, by a computer from a first entity, a CXL.cache Host-to-Device (H2D) request comprising an opcode and a first address, wherein CXL denotes Compute Express Link;
translating, by the computer, the CXL.cache H2D request to an NVLink-based request comprising a second physical address;
sending, by the computer via an NVLink interface that communicates according to an NVLink-based protocol, the NVLink-based request to a second entity;
receiving, by the computer from the second entity, an NVLink-based response; and
translating, by the computer, the NVLink-based response to one or more CXL.cache Device-to-Host (D2H) messages, and sending the one or more CXL.cache D2H messages to the first entity.

20. The method of claim 19, wherein the translating of the CXL.cache H2D request comprises translating a Unique Queue ID (UQID) carried in the CXL.cache H2D request to an NVLink Tag carried in the NVLink-based request, and maintaining a mapping between the UQID and the NVLink Tag for correlating the NVLink-based response with the one or more CXL.cache D2H messages.

21. The method of claim 19, wherein the opcode of the CXL.cache H2D request comprises a snoop opcode selected from SnpData, SnpInv, or SnpCur, the NVLink-based request comprises a read or invalidation request type corresponding to the snoop opcode, the first entity comprises a CXL host, and the second entity comprises a GPU, an NVLink switch, or an accelerator.

22. The method of claim 19, wherein the NVLink-based response comprises data, and the one or more CXL.cache D2H messages comprise a CXL.cache D2H response comprising a snoop response opcode and a Unique Queue ID (UQID), and a CXL.cache D2H Data comprising the data and the UQID.

23. The method of claim 19, further comprising issuing, by the computer via the NVLink interface, additional NVLink-based requests to the second entity as prefetch requests based on a detected access pattern of CXL.cache H2D requests received from the first entity.

24. A non-transitory computer-readable medium comprising instructions which, when executed by a processor, cause the processor to perform the method of claim 19.

25. One or more integrated circuits configured to perform the method of claim 19, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

26. An active cable comprising first and second pluggable modules coupled by a physical medium; wherein the active cable further comprises hardware circuitry, integrated into the active cable, configured to perform the method of claim 19.

27. A system comprising:
a first interface configured to communicate according to CXL.cache with a first entity, wherein CXL denotes Compute Express Link;
a second interface configured to communicate according to an NVLink-based protocol with a second entity; and
a computer coupled between the first and second interfaces, configured to translate CXL.cache Host-to-Device (H2D) requests received via the first interface to NVLink-based requests transmitted via the second interface, and to translate NVLink-based responses received via the second interface to CXL.cache Device-to-Host (D2H) messages transmitted via the first interface.

28. The system of claim 27, wherein the CXL.cache D2H messages comprise a CXL.cache D2H response comprising an opcode selected from RspSFwdM, RspIFwdM, or RspVFwdV, and a CXL.cache D2H Data comprising data sourced from a memory or a cache of the second entity.

29. The system of claim 27, wherein the computer is configured to translate Host Physical Addresses (HPAs) carried in the CXL.cache H2D requests to NVLink network addresses or GPU physical addresses carried in the NVLink-based requests.

30. The system of claim 27, wherein the computer is included in a switch or a bridge, and the computer is further configured to translate NVLink-based requests received via the second interface to CXL.cache D2H requests transmitted via the first interface, enabling the second entity to access resources coupled to the first entity.
